(19) United States
(12) Patent Application Publication
(10) Pub. No.: US 2020/0071617 A1
(43) Pub. Date: Mar. 5, 2020

(54) LIQUID CRYSTAL DISPLAY ELEMENT

(71) Applicant: DIC Corporation, Tokyo (JP)

(72) Inventors: Toru Fujisawa, Kitaadachi-gun (JP); Masayuki Iwakubo, Kitaadachi-gun (JP); Hiroshi Hasebe, Kitaadachi-gun (JP); Fumiaki Kodera, Kitaadachi-gun (JP); Keumhee Jang, Kitaadachi-gun (JP)

(73) Assignee: DIC Corporation, Tokyo (JP)

(21) Appl. No.: 16/338,063

(22) PCT Filed: Sep. 26, 2017
(86) PCT No.: PCT/JP2017/034660

§ 371 Date: Mar. 29, 2019

(30) Foreign Application Priority Data
Sep. 29, 2016 (JP) 2016-191423

(51) Int. Cl. C09K 19/38; C09K 19/54; C09K 19/30; C09K 19/22; C09K 19/20; C09K 19/34; C09K 19/12; C09K 19/32; C09K 19/18

(52) U.S. Cl. CPC C09K 19/3852; C09K 2019/304; C09K 19/3003; C09K 19/22; C09K 19/2014; C09K 19/3402; C09K 19/12; C09K 19/322; C09K 19/18; C09K 19/3028; C09K 2019/3009; C09K 2019/301; C09K 2019/3016; C09K 2019/2035; C09K 2019/2042; C09K 2019/2078; C09K 2019/3422; C09K 2019/122; C09K 2019/123; C09K 19/54

(57) ABSTRACT

“Object” To provide a tilt-imparted liquid crystal display element that is obtained through UV irradiation of a polymerizable liquid crystal composition, whose drive voltage can be reduced with a fast decay time maintained, and that is well balanced between characteristics, such as decay time, drive voltage, and transmittance. A polymerizable liquid crystal composition for use in it is also provided. “Solution” A liquid crystal display element has polymer networks formed in the liquid crystal phase 5 in FIG. 3. The polymer networks are formed by polymerizing a polymerizable liquid crystal composition that contains, as essential ingredients, a radically polymerizable monomer component (A), a liquid crystal material (B), and a polymerization initiator (C) that has a molecular structure resulting from substituting any two or more hydrogen atoms in the aromatic nucleus in the molecular structure of an alkylphenone-based photopolymerization initiator, for example with a C1-10 alkyl group (i).

### TECHNICAL FIELD

The present invention relates to a polymerizable liquid crystal composition, a liquid crystal display element, and a method for producing a liquid crystal display element.

### BACKGROUND ART

Liquid crystal materials are commonly used in flat-panel displays, for example of TVs, monitors, cellular phones, smartphones, and tablet computers. Nematic liquid crystals, however, are slow in optical switching, approximately tens of milliseconds to milliseconds. Seeking faster display, the field of already widespread liquid crystal TVs often employs PS (polymer-stabilised) or PSA (polymer-sustained alignment) displays. They primarily use, for example, the vertical alignment mode and their rise time are accelerated in the voltage-on state (on-response) by virtue of a tilt angle given to the liquid crystal material (see PTL 1 to 5).

Such a PS or PSA display is specifically obtained by adding 0.3% by mass or more and less than 1% by mass polymerizable compound to the liquid crystal medium and polymerizing or crosslinking the polymerizable compound at the interface on the glass substrates by UV photopolymerization, with or without applying a voltage, to form microscopic projections (protrusion or bumps) to induce a pretilt angle to liquid crystal molecules. This helps accelerate the rise time in the voltage-on state (on-response).

However, as a result of the recent increase in the size of liquid crystal TVs, the movement of things on the screen has become even faster. For this reason, there is a need for a further improvement in the response time of liquid crystals.

To improve the response time, therefore, the industry has sought not only to accelerate the rise time in the voltage-on state (on-response) but also to improve the decay time when the liquid crystal is released from the application of a voltage (when switched off). For example, PTL 5 discloses a liquid crystal display element obtained by sealing, in a liquid crystal material in a liquid crystal display cell, a liquid crystal composition and a polymer component that makes up 1% by mass or more and less than 40% by mass of the liquid crystal material. As a result of containing a predetermined amount of polymer in a liquid crystal material, such a liquid crystal display element achieves faster response time when switched off (hereinafter simply referred to as “decay time”) by accelerating the process of relaxation to initial alignment during the decay time with the use of attractive interactions between the polymer and liquid crystal molecules.

Such a liquid crystal display element described in PTL 5, in which a polymer or copolymer is more highly concentrated than in a PS or PSA, tends to be sensitive in characteristics, such as decay time, drive voltage, and transmittance, to the concentration, chemical structure, and process for the production of a liquid crystal display element. To achieve fast response time with a minimum detrioration of drive voltage or transmittance, or to attain a liquid crystal display element well balanced between characteristics, it is required to optimize the concentration, chemical structure, or the process for the production of a liquid crystal display element.

For this optimization to be done swiftly, it is required that measured decay time, drive voltage, and transmittance be immediately assessed for whether they are balanced. Determining whether they are balanced, however, requires conducting many experiments and measurements under varying conditions to understand the impact of the individual factors on the decay time, drive voltage, and transmittance and trade-offs therebetween. It is therefore troublesome and time-consuming to find out the conditions for optimization. Worse yet, even if optimization is tried, there is a trade-off between decay time and drive voltage: raising the drive voltage will increase the decay time, and lowering the drive voltage will reduce the decay time. This makes it difficult to reduce the drive voltage while keeping a high level of decay time.

PTL 5 also discloses, as a method for producing a liquid crystal display element, a method in which, for example, a liquid crystal cell is filled with a liquid crystal composition and a monomer-containing composition, and then the compositions are irradiated with ultraviolet radiation to form a polymer in the liquid crystal cell.

A known disadvantage of this method is that if the amount of ultraviolet radiation used is not sufficient for the monomer to polymerize, characteristics change over time. If the amount of ultraviolet radiation is sufficient to meet the need, the characteristics (decay time, drive voltage, and transmittance) are probably stable and do not change over time. However, too much ultraviolet radiation may result in chemical deterioration of the liquid crystal material caused by the ultraviolet irradiation. Such a deterioration would affect the voltage holding ratio, an important reliability measure of a liquid crystal display element.

With the liquid crystal display element described in PTL 5, therefore, it is difficult to achieve a balance between changes over time in characteristics, such as decay time, drive voltage, and transmittance, and the voltage holding ratio.

### CITATION LIST

### Patent Literature

PTL 1: Japanese Patent No. 4175826

PTL 2: Japanese Patent No. 5020203

PTL 3: Japanese Patent No. 5383994

PTL 4: U.S. Pat. No. 8,940,375

PTL 5: WO 2015/122457

### SUMMARY OF INVENTION

### Technical Problem

The problem to be solved by the present invention is therefore to provide a tilt-imparted liquid crystal display element that is obtained through UV irradiation of a polymerizable liquid crystal composition; whose drive voltage can be reduced with a fast decay time maintained; and that is well balanced between characteristics, such as decay time, drive voltage, and transmittance. A polymerizable liquid crystal composition for use in it is also provided.

### Solution to Problem

After extensive research to solve the above problem, the inventors found that when the photopolymerization initiator used in the polymerizable liquid crystal composition is an initiator resulting from substituting any two or more hydrogen atoms in the aromatic nucleus of an alkylphenone-based photopolymerization initiator with an alkyl group or analogous structural unit, a dramatic improvement occurs in the balance between changes over time in characteristics and the voltage holding ratio because the decay time of the liquid crystal display element is improved with a limited increase in drive voltage by virtue of good uniformity of the liquid crystal composition resulting from increased affinity with the liquid crystal material and the polymerizable compound, and because ultraviolet irradiation leaves only a small quantity of monomers. Based on these findings, the inventors completed the present invention.

That is, the present invention relates to a polymerizable liquid crystal composition. The composition contains, as essential ingredients, a radically polymerizable monomer component (A), a liquid crystal material (B), and a polymerization initiator (C) having a molecular structure resulting from substituting any two or more hydrogen atoms in the aromatic nucleus in the molecular structure of an alkylphenone-based photopolymerization initiator with an alkyl group (i) having number of carbon atoms from 1 to 10 (hereinafter simply referred to as “C1-10”), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom.

The present invention further relates to a liquid crystal display element. The liquid crystal display element includes two transparent substrates at least one of which has electrodes and a polymer of a radically polymerizable monomer component (A) and a liquid crystal material (B) sandwiched therebetween. In the liquid crystal material (B) is a polymer derived from a polymerization-induced phase separation structure obtained by polymerizing the above polymerizable liquid crystal composition.

The present invention further relates to a method for producing a liquid crystal display element. The method includes sandwiching the above polymerizable liquid crystal composition between two transparent substrates at least one of which has electrodes and polymerizing the polymerizable liquid crystal composition by irradiation with active energy radiation with the liquid crystal layer held at −50° C. to 30° C. to form a polymer having refractive index anisotropy or an easy axis of orientation.

### Advantageous Effects of Invention

According to the present invention, there is provided, in the field of liquid crystal display elements with polymer-stabilized alignment liquid crystals of polymer-network type, including tilt-imparted ones obtained through UV irradiation of a polymerizable liquid crystal composition, a liquid crystal display element whose drive voltage can be reduced with a fast decay time maintained and that is well balanced between changes over time in characteristics, such as decay time, drive voltage, and transmittance, and the voltage holding ratio. A polymerizable liquid crystal composition for use in it is also provided.

### BRIEF DESCRIPTION OF DRAWINGS

FIG. 1 is a schematic view of a liquid crystal display element according to the present invention.

FIG. 2 is a partially enlarged view of FIG. 1.

FIG. 3 is a cross-sectional view of a liquid crystal display element according to the present invention.

FIG. 4 is a partially enlarged view of FIG. 1.

FIG. 5 is a cross-sectional view of a liquid crystal display element according to the present invention.

FIG. 6 is a schematic view of a liquid crystal display element according to the present invention.

FIG. 7 is a partially enlarged view of FIG. 6.

FIG. 8 is a cross-sectional view of a liquid crystal display element according to the present invention.

FIG. 9 is a graph that represents the impact of the duration of UV exposure on drive voltage V90.

FIG. 10 is a graph that represents the impact of the duration of UV exposure on Toff.

FIG. 11 is a graph that represents the relationship between Toff and V90 at V90.

FIG. 12 is a graph that represents power approximation lines for the relationship between Toff and V90.

FIG. 13 includes schematic diagrams illustrating the electrode structure of and alignments of liquid crystal molecules in an oblique-field liquid crystal display device according to the present invention.

FIG. 14 is a schematic diagram illustrating the electrode structure of an eight-domain oblique-field liquid crystal display device according to the present invention.

FIG. 15 is a schematic view of the electrode structure of a fishbone VA liquid crystal cell in an Example.

### DESCRIPTION OF EMBODIMENTS

As stated above, a polymerizable liquid crystal composition according to the present invention contains, as essential ingredients, a radically polymerizable monomer component (A), a liquid crystal material (B), and a polymerization initiator (C) having a molecular structure resulting from substituting any two or more hydrogen atoms in the aromatic nucleus in the molecular structure of an alkylphenone-based photopolymerization initiator with a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom.

In the present invention, this approach of using an alkylphenone-based photopolymerization initiator with the alkyl group (i), organic group (ii), or halogen-containing hydrocarbon group (iii) introduced to at least two substitutable sites in the aromatic nucleus in the molecular structure of the alkylphenone-based photopolymerization initiator improves the compatibility between the initiator and the liquid crystal. The improvement influences the polymerization-induced phase separation structure, which is highly relevant to electrooptical characteristics. As a result, the decay time is improved with a limited increase in drive voltage in comparison with an initiator having no alkyl group.

Here, the decay time is the very process of relaxation from the state in which a voltage is applied to initial alignment in which no voltage is applied. This relaxation process is known to be influenced by the elastic constant of the liquid crystal material if the liquid crystal material contains no polymer or copolymer. In a system in which polymer networks are formed in a liquid crystal, by contrast, not only the overall viscoelastic properties of the system but also intermolecular interactions between the polymer networks and the liquid crystal synergistically accelerate the relaxation process, acting on the decay time to make it shorter. That is, too strong interactions shorten the decay time but at the same time cause a need for a high voltage when a voltage is applied to change the alignment of the liquid crystal material, giving rise to an increase in driving voltage and a decrease in transmittance.

Moreover, the countless polymer networks formed in the liquid crystal probably have great impact on the decay time and driving voltage also with their morphology, such as spacing and density, and in the process of irradiating the polymerizable liquid crystal composition with ultraviolet radiation to polymerize its monomer component and thereby form a polymerization-induced phase separation structure, the polymer networks form two phases, a monomer-rich phase and a liquid-crystal-rich phase. During this, the photopolymerization initiator tends to concentrate either the monomer or the liquid crystal, whichever the initiator is more compatible with, causing a localization of concentration. Localized presence of the photopolymerization initiator in the monomer-rich phase promotes the polymerization of monomers gathering in the monomer-rich phase, but in the liquid-crystal-rich phase, monomers remaining there delay progression of polymerizing. The monomers remaining in the liquid-crystal-rich phase crosslink by gathering in the monomer-rich phase, for example by using cohesive force. Increased solubility of the photopolymerization initiator in the liquid-crystal-rich phase, by contrast, promotes the polymerization of monomers remaining in the liquid-crystal-rich phase, thereby increasing the molecular weight of the polymers formed by the monomers remaining in the liquid crystal. This results in the formation of a new, polymerization-induced phase separation structure and also contributes to reducing the quantity of remaining monomers. In the present invention, the polymerization of the remaining monomers is promoted by virtue of the excellent compatibility of the polymerization initiator (C) with the monomer. The resulting polymer networks, moreover, are obtained with a high degree of alignment and microscopic structures because the photopolymerization initiator (C) cures the monomers relatively slowly and therefore gives the resulting polymers a high molecular weight. As a result, the polymer networks have high intermolecular interactions with the liquid crystal compound, and the decay time is improved dramatically. Furthermore, the high degree of alignment and continuity of the polymer networks enhance the alignment of the liquid crystal itself and reduce the disorder in the orientation of molecules in response to an electric field. A highly ordered molecular alignment is formed, allowing for switching at a low drive voltage. The resulting liquid crystal display element is faster than ever in decay time and has a low drive voltage.

As stated above, the photopolymerization initiator (C) used in the present invention has a molecular structure resulting from substituting any two or more hydrogen atoms in the aromatic nucleus in the molecular structure of an alkylphenone-based photopolymerization initiator with a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom.

Here, examples of C1-10 alkyl groups (i) include linear or branched C1-10 alkyl groups, such as methyl, ethyl, propyl, isopropyl, n-butyl, isobutyl, t-butyl, s-butyl, pentyl, neo-pentyl, hexyl, heptyl, octyl, nonyl, and decyl groups, and cyclic alkyl groups, such as cyclopentyl and cyclohexyl groups.

Examples of organic groups (ii) having a chemical structure resulting from substituting one —CH₂— present in a C2-10 alkyl chain, or each of nonadjacent two or more independently, with —O—, —CO—, —COO—, —OCO—, or —O—CO—O— include alkoxy groups, such as methoxy, ethoxy, propoxy, isopropoxy, t-butoxy, and pentyloxy groups; acyl groups, such as acetyl, propionyl, hexanoyl, and cyclohexyl carbonyl groups; ether-structure-containing alkyl groups, such as ethoxyethyl and 2-methoxy-2-methyl propyl groups; alkyl groups having a ketone structure, such as propanone-1-yl, 2-butanon-1-yl, and 2,4-pentanedion-1-yl groups; groups having an ester structure, such as acetyloxy, propionyloxy, hexanoyloxy, cyclohexylcarbonyloxy, acetyloxymethyl, acetyloxyethyl, acetyloxypropyl, propionyloxymethyl, propionyloxyethyl, propionyloxypropyl, hexanoyloxymethyl, hexanoyloxyethyl, hexanoyloxypropyl, cyclohexylcarbonyloxymethyl, cyclohexylcarbonyloxyethyl, and cyclohexylcarbonyloxypropyl groups; alkyl groups having an oxycarbonyl structure, such as methoxycarbonylethyl, methoxycarbonylpropyl, ethoxycarbonylethyl, ethoxycarbonylpropyl, propoxycarbonylethyl, propoxycarbonylpropyl, isopropoxycarbonylethyl, isopropoxycarbonylpropyl, t-butoxycarbonylethyl, t-butoxycarbonylpropyl, pentyloxycarbonylethyl, and pentyloxycarbonylpropyl groups; and alkyl groups having a carbonate structure, such as 1,3-dioxolan-2-on-4-yl and 2-oxo-1,3-dioxolane-4-methyl groups.

Examples of halogen-containing hydrocarbon groups (iii) resulting from substituting one hydrogen atom present in the alkyl group or organic group, or each of two or more independently, with a fluorine or chlorine atom include 2-chloropropyl, 2-bromoethyl, and 5-chloro-2-iodoheptyl groups.

Specific examples of such photopolymerization initiators (C) include the alkylphenone-based photopolymerization initiators represented by formulae (I) to (III) below.

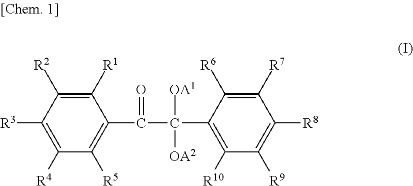

[In formula (I), each of R¹, R², R³, R⁴, R⁵, R⁶, R⁷, R⁸, R⁹, and R¹⁰ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, R⁹, and R¹⁰ are the alkyl (i), organic (ii), or halogen-containing hydrocarbon groups (iii).]

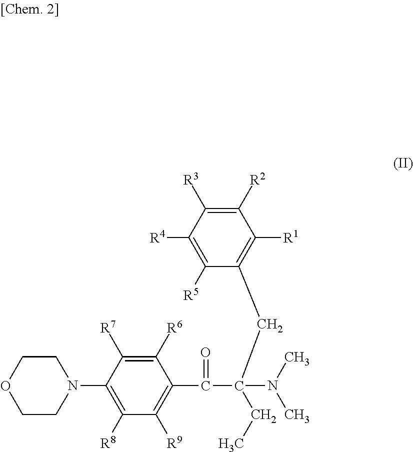

[In formula (II), each of R¹, R², R³, R⁴, R⁵, R⁶, R⁷, R⁸, and R⁹ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, and R⁹ are the alkyl (i), organic (ii), or halogen-containing hydrocarbon groups (iii).]

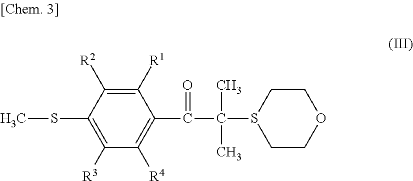

[In formula (II), each of R¹, R², R³, R⁴, R⁵, R⁶, R⁷, R⁸, and R⁹ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, and R⁹ are the alkyl (i), organic (ii) or halogen-containing hydrocarbon groups (iii).]

Here, for those compounds represented by formula (I) above

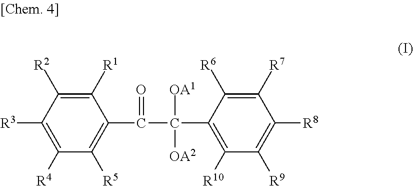

[In formula (I), each of R¹, R², R³, R⁴, R⁵, R⁶, R⁷, R⁸, R⁹, and R¹⁰ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, R⁹, and R¹⁰ are the alkyl (i), organic (ii), or halogen-containing hydrocarbon groups (iii).], specific examples of preferred ones have a structure represented by formulae (I-a) to (I-c) below. Such compounds are preferred because they are superior in solubility in the liquid crystal phase and because by-products resulting from the breakage to produce radicals have little impact on the voltage holding ratio.

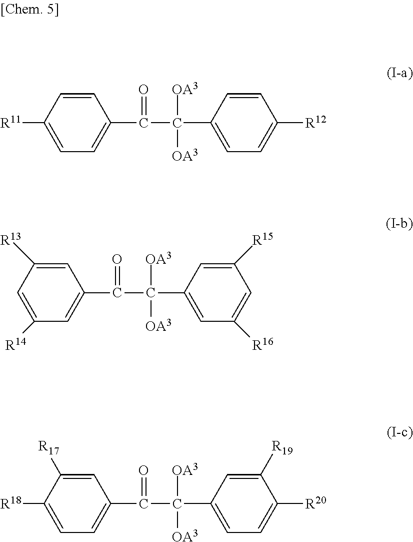

In these formulae, R¹¹ and R¹² each represent a C1-6 alkyl or C1-5 alkoxyl group, at least one of R¹³, R¹⁴, R¹⁵, and R¹⁶ represents a C1-6 alkyl group, at least one of R¹⁷, R¹⁸, R¹⁹, and R²⁰ represents a C1-6 alkyl group, and A³ represents a C1-5 alkyl group. Since a double bond present in the molecule may affect its curing performance, R¹¹ to R²⁰ are preferably C1-5 alkyl groups.

Among the compounds represented by formulae (I-a) to (I-c) above, those represented by formula (I-a) above are particularly preferred because they are superior in curing properties, solubility in the liquid crystal phase, and voltage holding ratio. Specific examples of such formula (I-a) include those represented by formulae (I-a-1) to (I-a-13) below.

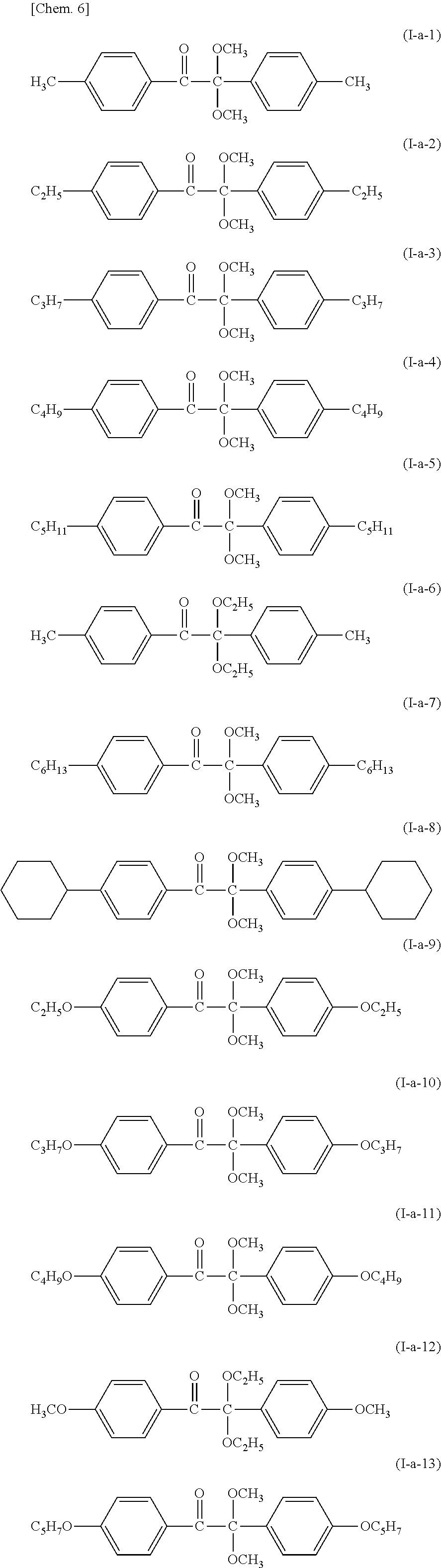

Among such formulae (I-a-1) to (I-a-13) above, as mentioned above, those in which the alkyl groups corresponding to R¹¹ and R¹², located at both terminals of the molecule, are C1-5 alkyls are preferred. It is therefore particularly preferred that the compound be one according to formulae (I-a-1) to (I-a-6).

Next, for the compounds represented by above-described formula (II) below,

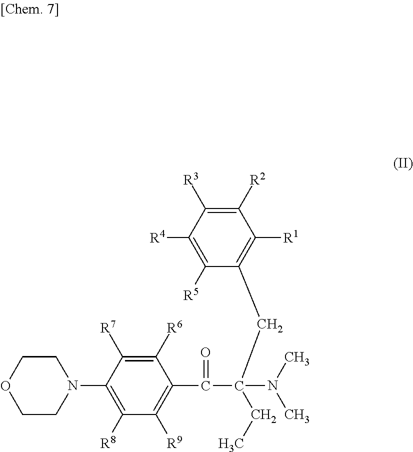

[In formula (II), each of R¹, R², R³, R⁴, R⁵, R⁶, R⁷, R⁸, and R⁹ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, and R⁹ are the alkyl (i), organic (ii) or halogen-containing hydrocarbon groups (iii).], the alkyl group (i), organic group (ii), or halogen-containing hydrocarbon group (iii) has the same definition as in formula (I), and specific examples of these compounds include those represented by formulae (II-1) to (11-6) below.

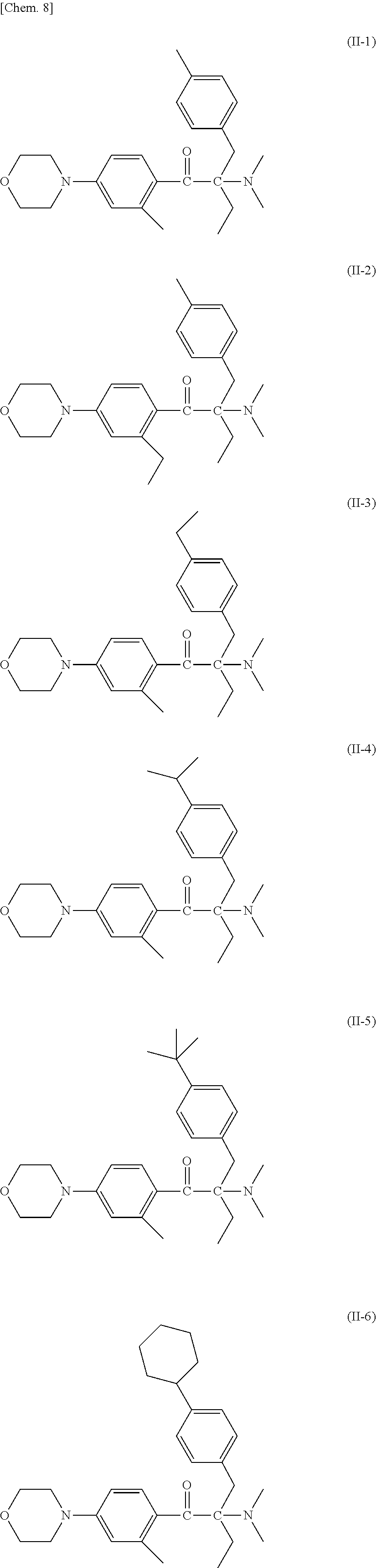 [SMILES: CCC(Cc1ccc(C)cc1)(C(=O)c1ccc(N2CCOCC2)cc1C)N(C)C ; CCc1cc(N2CCOCC2)ccc1C(=O)C(CC)(Cc1ccc(C)cc1)N(C)C ; CCc1ccc(CC(CC)(C(=O)c2ccc(N3CCOCC3)cc2C)N(C)C)cc1 ; CCC(Cc1ccc(C(C)C)cc1)(C(=O)c1ccc(N2CCOCC2)cc1C)N(C)C ; CCC(Cc1ccc(C(C)(C)C)cc1)(C(=O)c1ccc(N2CCOCC2)cc1C)N(C)C ; CCC(Cc1ccc(C2CCCCC2)cc1)(C(=O)c1ccc(N2CCOCC2)cc1C)N(C)C]

Next, for the compounds represented by above-described formula (III) below.

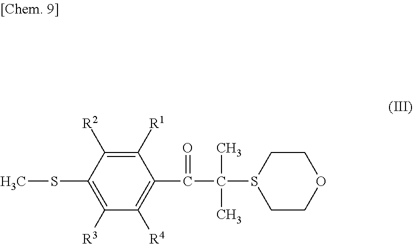

[In general formula (II), each of R¹, R², R³, R⁴, R⁵, R⁶, R⁷, R⁸, and R⁹ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, and R⁹ are the alkyl (i), organic (ii) or halogen-containing hydrocarbon groups (iii).], the alkyl group (i), organic group (ii), or halogen-containing hydrocarbon group (iii) has the same definition as in formula (I), and specific examples of these compounds include those represented by formulae (III-1) to (111-7) below.

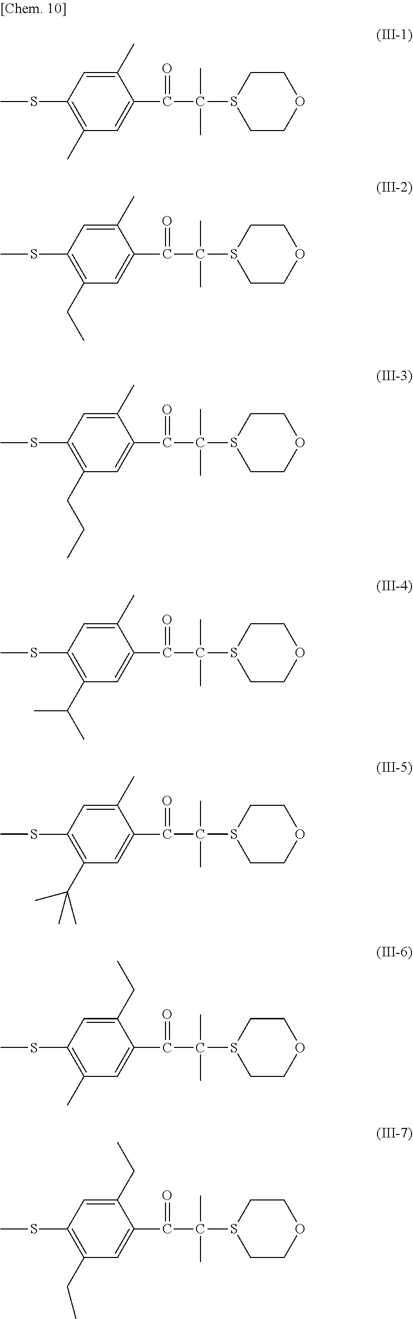

Among formulae (I) to (III) specified above, the alkylphenone-based photopolymerization initiators represented by formula (I) are particularly preferred because they are superior in curing properties, solubility in the liquid crystal phase, and voltage holding ratio.

Next, the radically polymerizable monomer component (A) used in the polymerizable liquid crystal composition according to the present invention is preferably liquid-crystalline monomer(s). That is, the liquid crystal display element according to the present invention preferably has the following structure, preferred because it helps accelerating the decay time: polymer network layers have been formed in the liquid crystal phase throughout the liquid crystal display element, and the liquid crystal phase is continuous; the easy axis of orientation or uniaxial optical axis of the polymer networks is substantially in the same direction as the easy axis of orientation of the low-molecular liquid crystal; and the polymer networks are formed in such a manner as to induce a pretilt angle of the low-molecular liquid crystal. For this reason, it is preferred that the polymerizable monomer(s) forming the radically polymerizable monomer component (A) be a liquid-crystalline monomer or monomers, which have a mesogenic structure in their molecular structure. In the liquid crystal display element according to the present invention, it is preferred that the polymer network layers be formed by polymer networks whose average void spacing is smaller than the visible spectrum, or that the average void spacing be less than 450 nm, because this will prevent light scattering.

For such liquid-crystalline monomers, general formula (P1) below

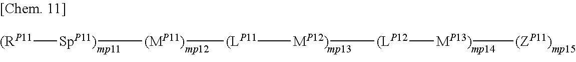

represents some examples.

Here, Z^{P11} represents a fluorine atom, a cyano group, a hydrogen atom, a C1-15 alkyl group optionally having hydrogen atoms(s) substituted with a halogen atom, a C1-15 alkoxy group optionally having hydrogen atom(s) substituted with a halogen atom, a C1-15 alkenyl group optionally having hydrogen atom(s) substituted with a halogen atom, a C1-15 alkenyloxy group optionally having hydrogen atom(s) substituted with a halogen atom, or -Sp^{p12}-R^{p12}. Among these, it is particularly preferred that Z^{P11} be a fluorine atom or C1-15 alkyl group optionally having its oxygen atom(s) substituted with a halogen atom because this helps increase the voltage holding ratio of the liquid crystal display element. Moreover, it is preferred that Z^{P11} be -Sp^{p12}-R^{p12} for the stability of the tilt.

Here, R^{P11} and R^{p12} each independently represent any of formulae (RP11-1) to (RP11-4) below (* in the formulae indicates the binding site).

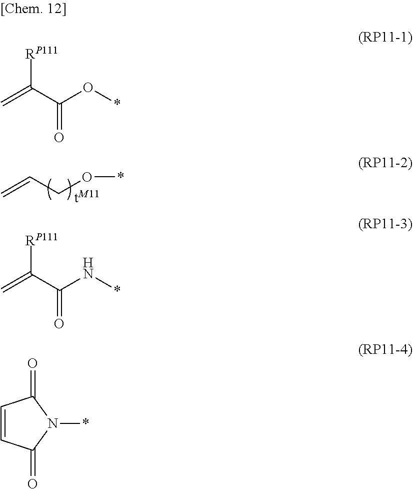

In formulae (RP11-1) to (RP11-4) above, each of RP11 and R^{P112} is independently a hydrogen atom or C1-5 alkyl group, and t represents 0, 1, or 2. Among these, it is preferred that R^{P111} R^{P112} be (meth)acryloyl groups, represented by formula (RP11-1) above with R^{P111} in the formula being a hydrogen atom or methyl group, because this helps, in the production of the liquid crystal display element, reduce the amount of ultraviolet irradiation used to polymerize the monomer and minimize the amount of ultraviolet radiation emitted to the liquid crystal material and thereby avoid deterioration of the liquid crystal material and liquid crystal display element.

Sp^{P11} and Sp^{p12} each independently represent a single bond, a linear or branched C1-12 alkylene group, or a structural unit resulting from substituting carbon atom(s) in this linear or branched alkylene structure with an oxygen atom or carbonyl group with no oxygen atoms at adjacent positions. Among these, linear or branched C1-12 alkylene groups are particularly preferred because they improve the compatibility with the liquid crystal material (B), and C1-6 alkylene groups, similar to the alkyl groups the liquid crystal molecules have, are particularly preferred. If the radically polymerizable monomer component (A) and the liquid material (B) are not sufficiently compatible with each other or if the aforementioned polymerization initiator (C) is not sufficiently compatible with the liquid crystal material (B), variation in the density of polymer networks, sparse in some portions and dense in others, will affect the device characteristics, often causing in-plane nonuniformity in characteristics. If the radically polymerizable monomer component (A) and the liquid crystal material (B) are highly compatible with each other in the present invention, this high compatibility, together with that between the polymerization initiator (C) and the liquid crystal material (B), ensures the formation of a uniform polymerization-induced phase separation structure. The polymer networks formed in the liquid crystal are also uniform, and, as a result, the liquid crystal display element achieves in-plane consistency in characteristics. Here, if a liquid-crystalline monomer has Sp^{p11} and Sp^{p12} that are linear or branched C1-12 alkylene groups, they are preferably the same because this makes the monomer easier to produce and because the physical properties of such a monomer can be easily controlled by using multiple compounds with different alkylene chain lengths in appropriate proportions. If Sp^{P11} and Sp^{p12} are single bonds, the monomer component is more effective in imparting a pretilt to vertical alignment films and fixing it than in accelerating response by the formation of polymer networks because monomers in this case tend to gather on the substrate surfaces and therefore are likely more to form a thin film on the surface of the alignment films than to form polymer networks.

Moreover, if the percentage of the radically polymerizable monomer component (A) in the polymerizable liquid crystal composition is less than 0.5% by mass, Sp^{p11} and Sp^{p12} are preferably single bonds for the aforementioned impartation of a pretilt angle to the alignment films and fixing of it. If the percentage is in the range of 0.5% by mass to 20% by mass, Sp^{P1} and Sp^{p}l² are preferably linear or branched C1-12 alkylene groups because this helps form polymer networks, which will accelerate the decay time. It is preferred that the percentage be in the range of 1% by mass to 10% by mass, particularly for a fast decay time and a low drive voltage. The number of carbon atoms in the linear or branched alkylene groups is preferably between 2 and 8, more preferably between 2 and 6. Substituting carbon atom(s) on the alkylene groups with an oxygen atom or carbonyl group with no oxygen atoms at adjacent positions is preferred. Introducing an oxygen atom at a position where it binds to M^{P11} or M^{P13} is particularly preferred because it helps expand, for the overall liquid crystal material, the upper limit of temperatures at which it forms a liquid crystal and also helps increase the sensitivity of the liquid crystal material to ultraviolet radiation during polymerization.

Next, in general formula (P1) above, L^{P11} and L^{P12} each independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{P13}—, —NR^{P113}—CO—, —SCH₂—, —CH₂S—, —CH═CR^{P113}—COO—, —CH═CR^{P1113}—OCO—, —COO—CR^{P113}═CH—, —OCO—CR^{aP113}═CH—, —COO—CR^{P113}═CH—COO—, —COO—CR^{P113}═CH—OCO—, —OCO—CR^{P113}═CH—COO—, —OCO—CR^{P113}═CH—OCO—, —(CH₂)ₜₘ₁₂—C(═O)—O—, —(CH₂)ₜₘ₁₂—O—(C═O)—, —O—(C═O)—(CH₂)ₜₘ₁₂—, —(C═O)—O—(CH₂)ₜₘ₁₂, —CH═CH—, —CF═CF—, —CF═CH—, —CH═CF—, —CF₂—, —CF₂O—, —OCF₂—, —CF₂CH₂—, —CH₂CF₂—, —CF₂CF₂—, —C═C—, —N═N—, —CH═N—, or —C═N—N═C— (where each R^{P113} independently represents a hydrogen atom or C1-4 alkyl group, and tm12 in the formulae denotes an integer of 1 to 4).

Among these, it is particularly preferred that L^{P11} and L^{P12} be single bonds, —C₂H₄—, —COO—, —OCO—, —CH═CH—COO—, —OCO—CH═CH—, —(CH₂)₂—C(═O)—O—, —(CH₂)₂—O—(C═O)—, —O—(C═O)—(CH₂)₂—, —(C═O)—O—(CH₂)₂—, —CH═CH—, —CF═CF—, —CF═CH—, —CH═CF—, —CF₂O—, —OCF₂—, —CF₂CH₂—, —CH₂CF₂—, —CF₂CF₂—, —C≡C—, —N═N—, or —C═N—N═C— in light of the high crystallinity they give to the radically polymerizable monomer component (A) and of the prevention of uneven alignment in the liquid crystal display element.

Moreover, it is preferred that L^{P11} and L^{P12} be —CH═CH—, —CF═CF—, —CF═CH—, —CH═CF—, or —N═N— because they give the monomer the photoisomerization capability and thereby makes available the photoalignment capability, or light-induced alignment with the use of the Weigert effect. It is preferred to select —CH═CH— and —N═N—, in particular that L^{P11} and L^{P12} be —N═N—. It is particularly preferred that L^{P11} and L^{P12} be —N═N— for improved alignment of the polymer networks.

Next, each of M^{P11}, M^{P12}, and M^{P13} in general formula (P1) can independently be, for example, a 1,4-phenylene, 1,3-phenylene, 1,2-phenylene, 1,4-cyclohexylene, 1,3-cyclohexylene, 1,2-cyclohexylene, 1,4-cyclohexenylene, 1,3-cyclohexenylene, 1,2-cyclohexenylene, anthracen-2,6-diyl, phenanthren-2,7-diyl, pyridin-2,5-diyl, pyrimidin-2,5-diyl, naphthalen-2,6-diyl, naphthalen-1,4-diyl, indan-2,5-diyl, fluoren-2,6-diyl, fluoren-1,4-diyl, phenanthren-2,7-diyl, anthracen-2,6-diyl, anthracen-1,4-diyl, 1,2,3,4-tetrahydronaphthalen-2,6-diyl, or 1,3-dioxan-2,5-diyl group or a structure resulting from substituting their aromatic nucleus with a C1-12 alkyl group, a C1-12 halogenated alkyl group, a C1-12 alkoxy group, a C1-12 halogenated alkoxy group, a halogen atom, a cyano group, or a nitro group.

It is preferred that the M^{P11}, M^{P12}, and M^{P13} be groups resulting from substituting the aromatic nucleus of the structures listed above with -Sp^{P11}-R^{P11} because this makes the radically polymerizable monomer component superior in reactivity. R^{p11} in this case is preferably a (meth)acryloyl group, which is formula (RP11-1) with R^{P111} being a hydrogen atom or methyl group.

Among these, it is particularly preferred that M^{p11}, M^{p12}, and M^{p13} be 1,4-phenylene, 1,4-cyclohexylene, 1,4-cyclohexenylene, anthracen-2,6-diyl, phenanthren-2,7-diyl, pyridin-2,5-diyl, pyrimidin-2,5-diyl, naphthalen-2,6-diyl, indan-2,5-diyl, fluoren-2,6-diyl, fluoren-1,4-diyl, phenanthren-2,7-diyl, anthracen-2,6-diyl, 1,2,3,4-tetrahydronaphthalen-2,6-diyl, or 1,3-dioxan-2,5-diyl groups or 2,3-difluoro-1,4-phenylene or 2-fluoro-1,4-phenylene groups for the compatibility with the liquid crystal.

In general formula (P1), moreover, mp12 represents 1 or 2, mp13 and mp14 each independently represent 0, 1, 2, or 3, and mp11 and mp15 each independently represent 1, 2, or 3. Here, multiple Z^{P11}s may be the same or different. Multiple R^{P11}s may be the same or different. Multiple R^{p12}s may be the same or different. Multiple Sp^{P11}s may be the same or different. Multiple Sp^{p12}s may be the same or different. Multiple L^{P11}s may be the same or different. Multiple L^{P12}s may be the same or different. Multiple M^{P12}s may be the same or different. Multiple M^{P13}s may be the same or different is preferably a compound represented by formula (RP11-1). It is preferred that one or two or more such materials be contained.

For the mp12 to mp14, it is preferred that their total be in the range of 1 to 6, preferably in the range of 2 to 4, in particular 2. If two or more monomers are used, it is preferred to select these numbers to make the average, calculated by multiplying the concentration of the relevant monomers with respect to all monomers by the total of mp12 to mp14, between 1.6 and 2.8, more preferably between 1.7 and 2.4, in particular between 1.8 and 2.2.

The total of mp1 and mp15 is preferably between 1 and 6, more preferably between 2 and 4, in particular 2. If two or more monomers are used, it is preferred to select these numbers to make the average, calculated by multiplying the concentration of the relevant monomers with respect to all monomers by the total of mp11^{p1} and mp15, between 1.6 and 2.8, more preferably between 1.7 and 2.4, in particular between 1.8 and 2.2. An average close to 1 tends to help reduce the drive voltage of the liquid crystal display element, and a high average tends to help accelerate the decay time.

Substituting M^{P11}, M^{P12}, and M^{P13} with a fluorine atom is preferred because it helps control the magnitude of interactions and solubility between the liquid crystal material and the polymer or copolymer without affecting the voltage holding ratio of the liquid crystal display element. Preferred numbers of substitutions are 1 to 4.

Among formula (P1) specified above, the use of a compound represented by formulae (P2-1) to (P2-11) below is particularly effective in limiting changes over time in tilt angle.

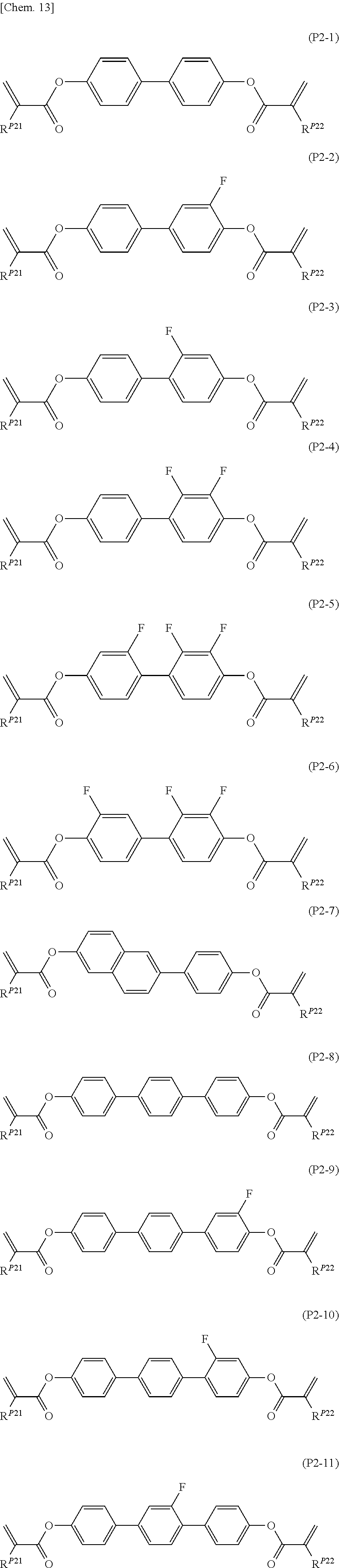

(where R^{P21} and R^{P22} each independently represent a hydrogen atom or methyl group)

Such compounds are admittedly useful, but can be poor in solubility in the liquid crystal material. Such compounds are therefore contained preferably to make up 90% by mass or less, more preferably 70% by mass or less, in particular 50% by mass or less, of the total quantity of monomers used.

Among formula (P1), furthermore, the use of a compound represented by formulae (P3-1) to (P3-11) below is particularly preferred because it helps limit changes over time in tilt angle while ensuring solubility in the liquid crystal material.

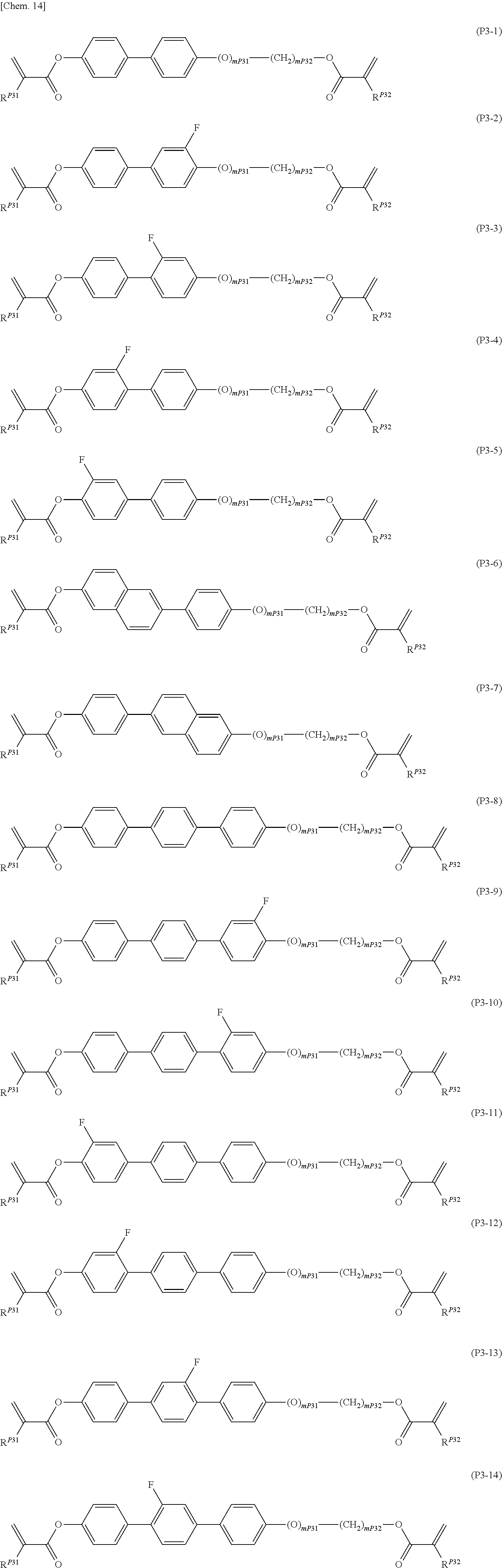

(where R^{P31} and R^{P32} each independently represent a hydrogen atom or methyl group, and mp31 represents an integer of 0 or 1. If mP31 is 0, mP32 represents an integer of 1 to 6. If mp31 is 1, mP32 represents an integer of 2 to 6.)

Among formula (P1), the use of a compound represented by formulae (P4-1) to (P4-11) below is particularly preferred because it is beneficial in improving the decay time effectively.

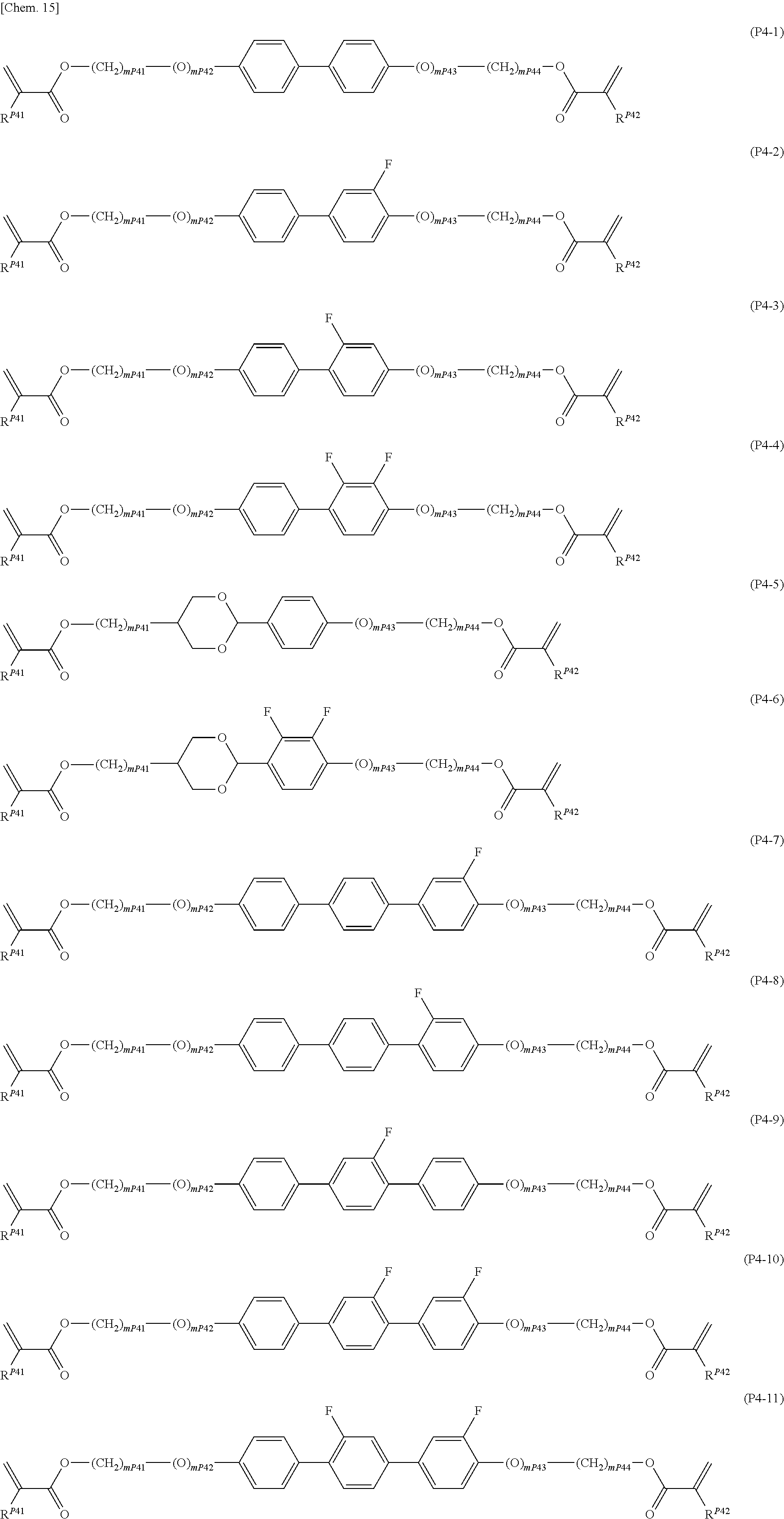

(where R^{P41} and R^{P42} each independently represent a hydrogen atom or methyl group, and mP42 and mP43 each independently represent an integer of 0 or 1. If mP42 is 0, mP41 represents an integer of 1 to 6. If mp42 is 1, mP41 represents an integer of 2 to 6. If mP43 is 0, mP44 represents an integer of 1 to 6. If mP43 is 1, mp44 represents an integer of 2 to 6.)

Such compounds are contained preferably to make up 40% by mass or more, more preferably 50% by mass or more, in particular 60% by mass or more, of the total quantity of monomers used.

Among formula (P1), those compounds represented by formulae (P5-1) to (P5-11), which have an aryl ester structure in their mesogen, are particularly preferred because they help reduce the amount of polymerization initiator added by virtue of their ability to start polymerization in response to ultraviolet irradiation.

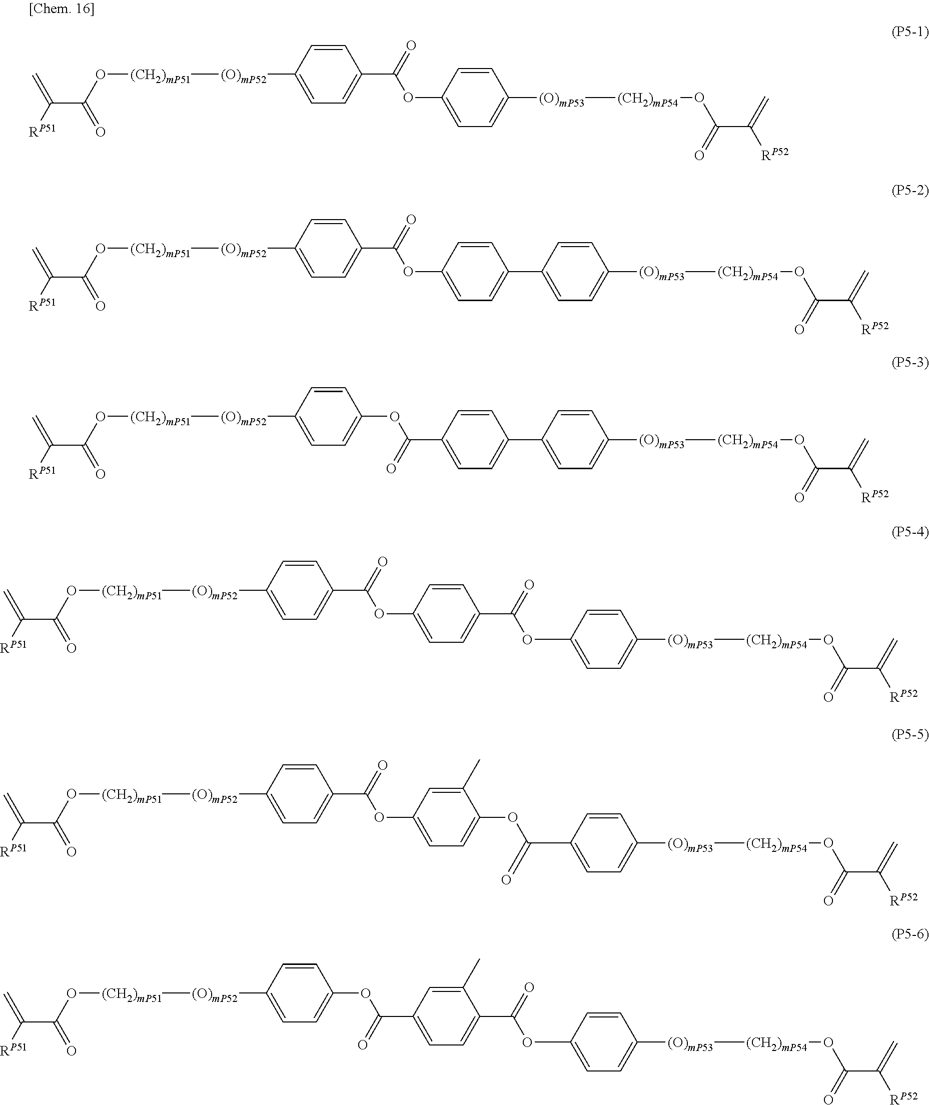

(where R and R^{P52} each independently represent a hydrogen atom or methyl group, and mP52 and mP53 each independently represent an integer of 0 or 1. If mP52 is 0, mP51 represents an integer of 1 to 6. If mp52 is 1, mP51 represents an integer of 2 to 6. If mP53 is 0, mP54 represents an integer of 1 to 6. If mP53 is 1, mp54 represents an integer of 2 to 6.)

Adding such a compound in a large amount tends to affect the voltage holding ratio of the liquid crystal display element. Thus, such compounds are contained preferably to make up 30% by mass or less, more preferably 20% by mass or less, in particular 10% by mass or less, with respect to all monomers used.

Among formula (P1), it is also particularly preferred to introduce a cinnamate group into the mesogen as in the compounds represented by formulae (P6-1) to (P6-11).

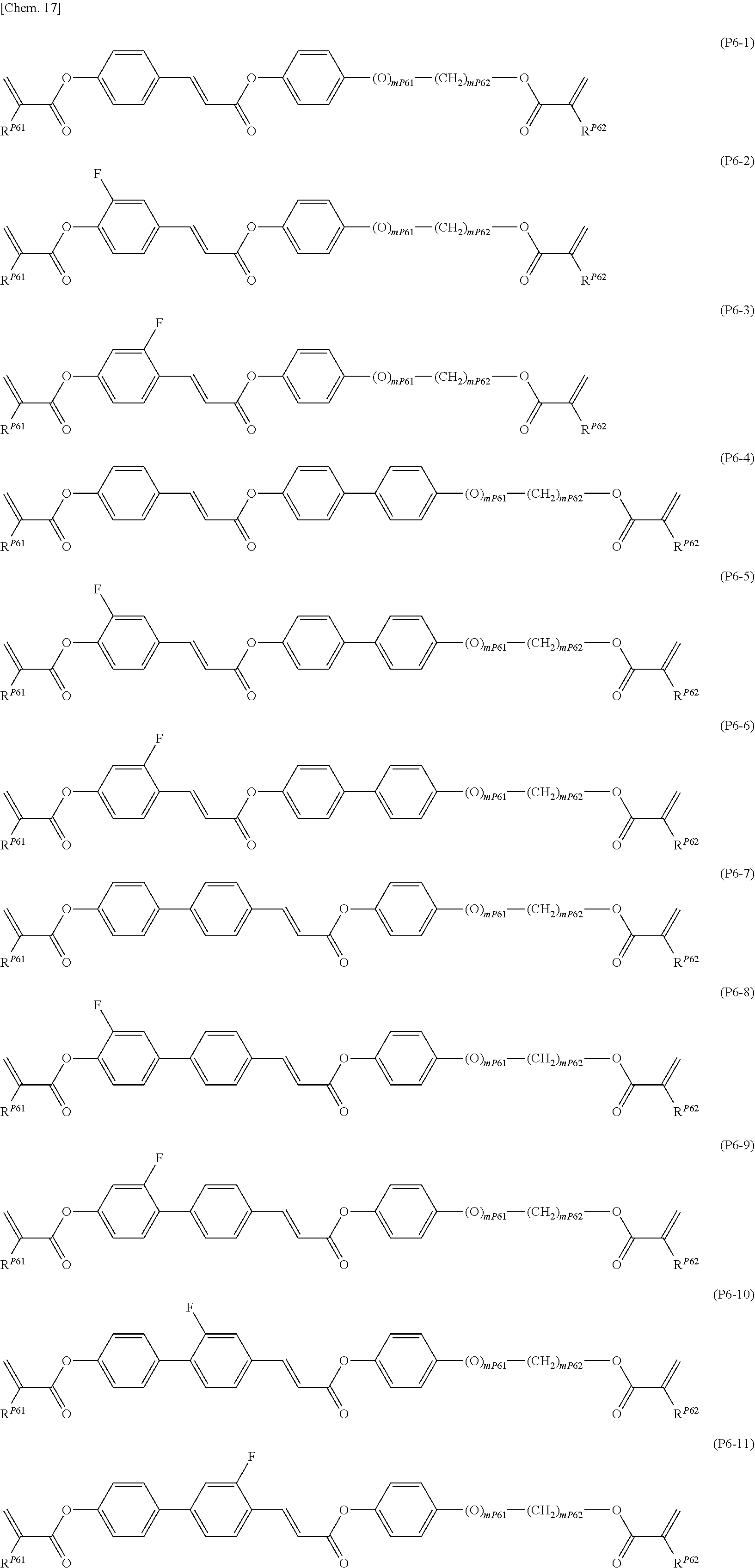

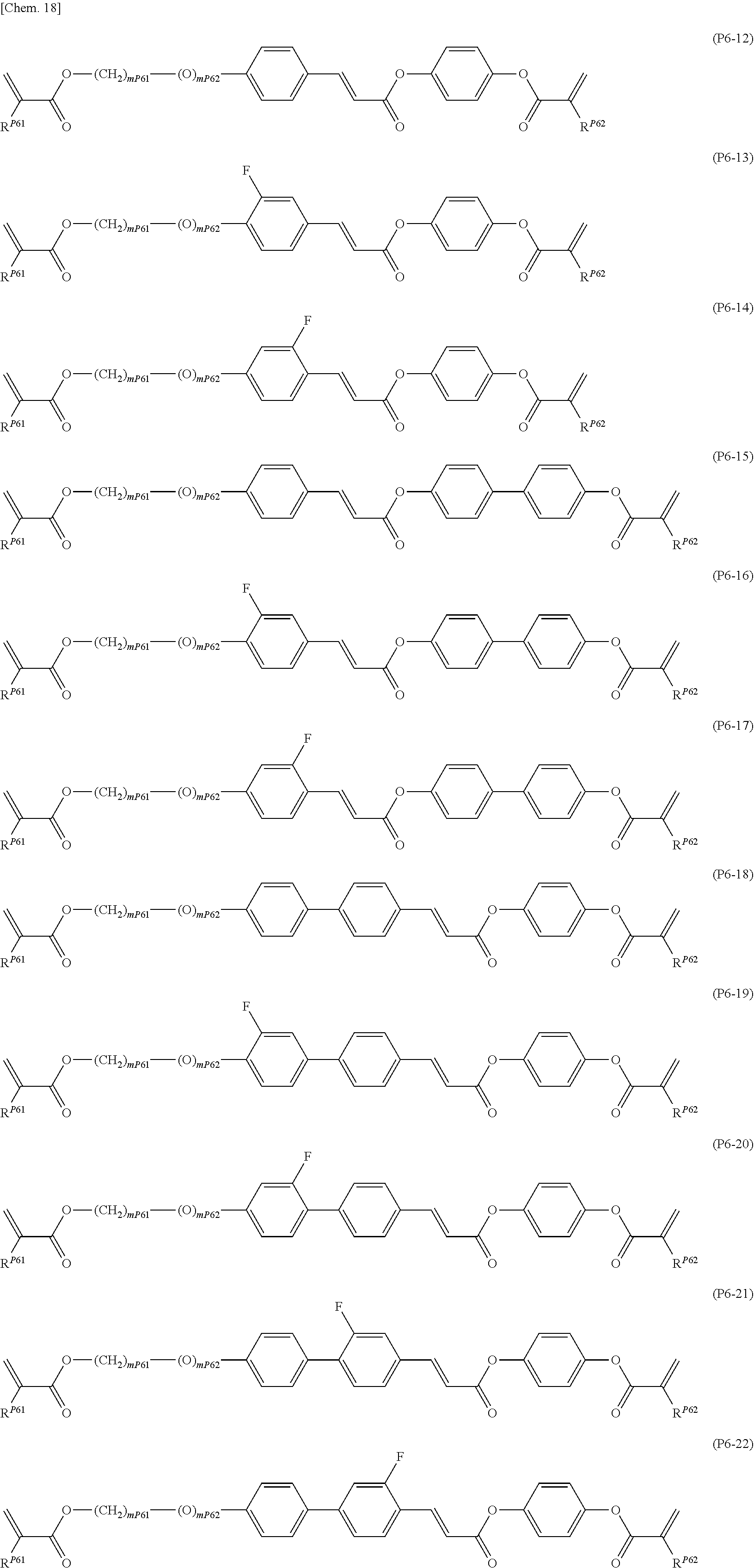

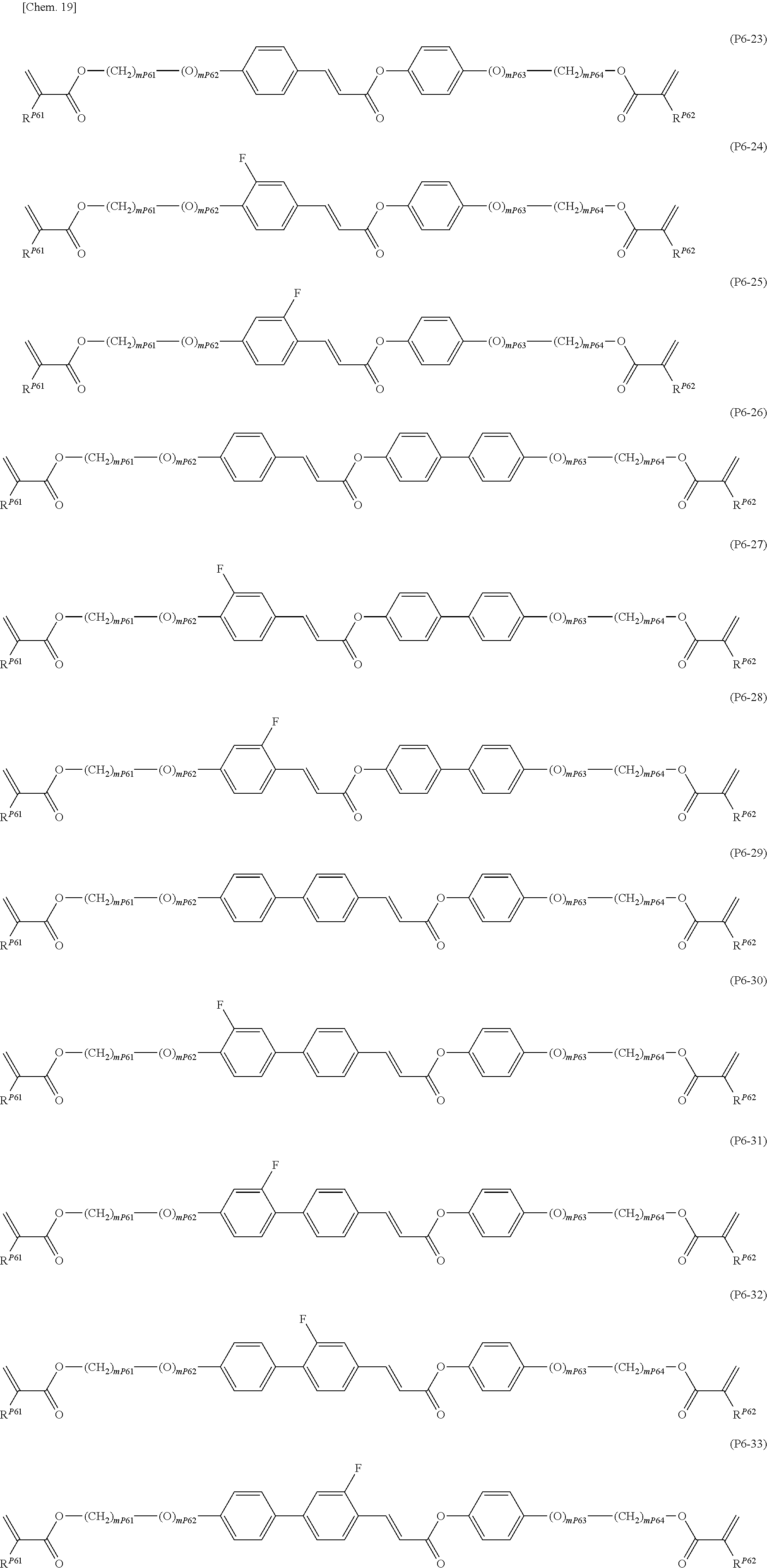

(where R^{P6} and R^{P62} each independently represent a hydrogen atom or methyl group, and mP62 and mP63 each independently represent an integer of 0 or 1. If mP62 is 0, mP61 represents an integer of 1 to 6. If mp62 is 1, mP61 represents an integer of 2 to 6. If mP63 is 0, mP64 represents an integer of 1 to 6. If mP63 is 1, mp64 represents an integer of 2 to 6.)

Among formula (P1), those compounds having condensed rings as represented by formulae (P7-1) to (P7-5) below are particularly preferred in light of the adjustment of the sensitivity of monomers because they help shift the ultraviolet absorbing band toward the visible light side more than monocyclic compounds.

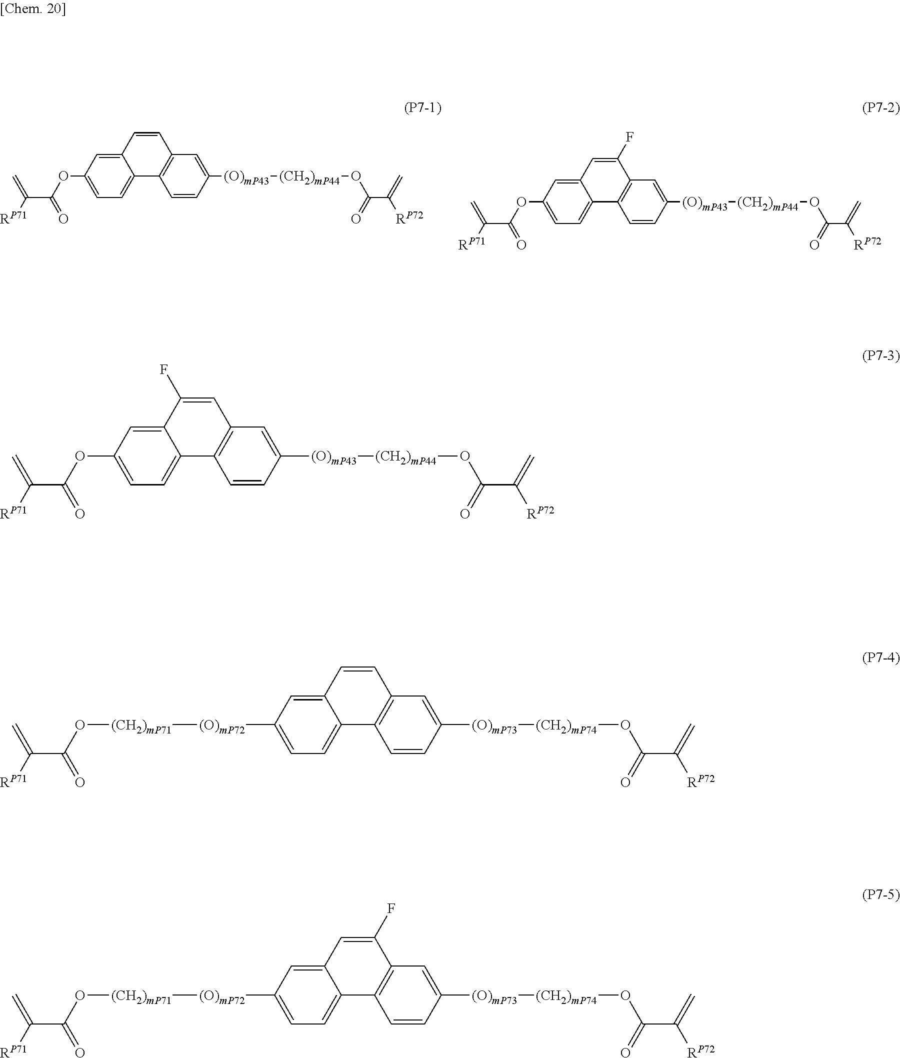

(where R and R^{P72} each independently represent a hydrogen atom or methyl group, and mP72 and mP73 each independently represent an integer of 0 or 1. If mP72 is 0, mP71 represents an integer of 1 to 6. If mp72 is 1, mP71 represents an integer of 2 to 6. If mP73 is 0, mP74 represents an integer of 1 to 6. If mP73 is 1, mp74 represents an integer of 2 to 6.)

The monomers listed above as examples of preferred compounds are bifunctional, but among formula (P1), it is also particularly preferred to use a trifunctional monomer like those compounds represented by formulae (P5-1) to (P5-11). It helps improve the mechanical strength of the polymer or copolymer. Those having an ester bond in the mesogen are more preferred because they help reduce the amount of polymerization initiator added by virtue of their ability to start polymerization in response to ultraviolet irradiation.

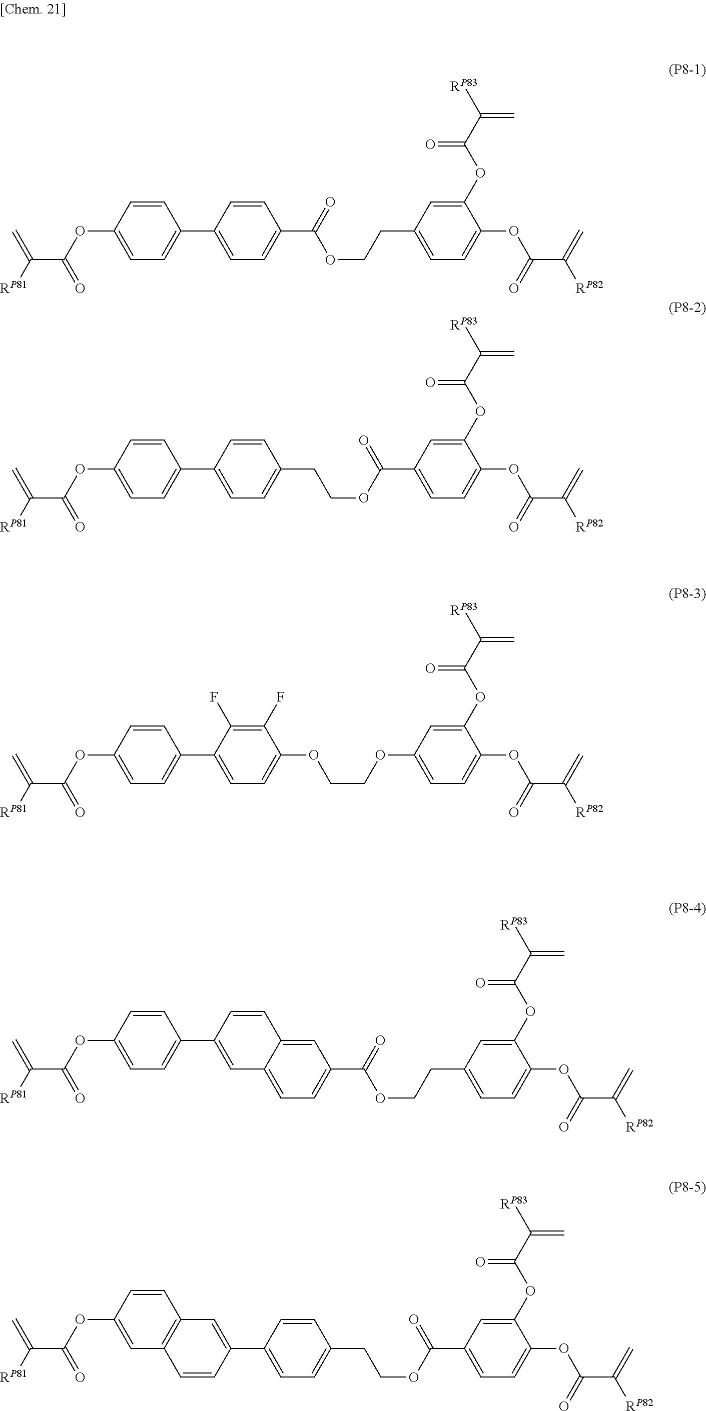

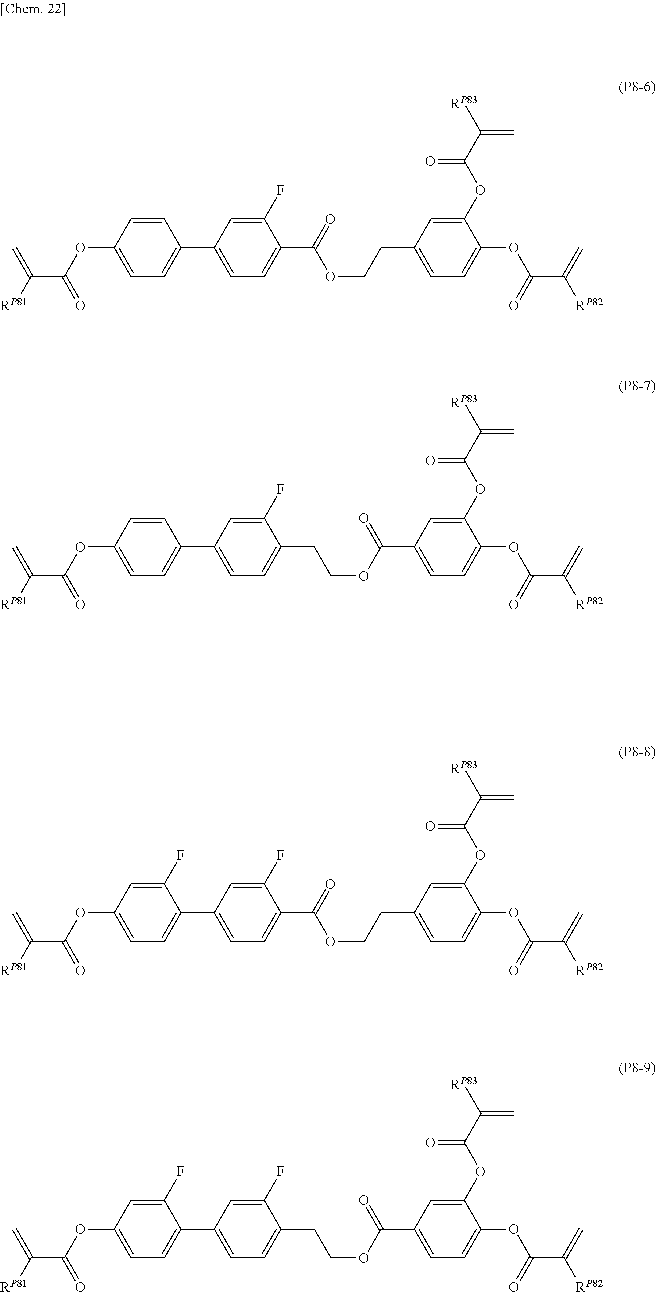

(where R^{P81} and R^{P83} each independently represent a hydrogen atom or methyl group, and mP72 and mP73 each independently represent an integer of 0 or 1. If mP72 is 0, mP71 represents an integer of 1 to 6. If mp72 is 1, mP71 represents an integer of 2 to 6. If mP73 is 0, mP74 represents an integer of 1 to 6. If mP73 is 1, mp74 represents an integer of 2 to 6)

Among formula (P1), it is also preferred to use a monofunctional monomer like those compounds represented by formulae (P9-1) to (P9-11) below for the purpose of adjusting the drive voltage of the liquid crystal display element.

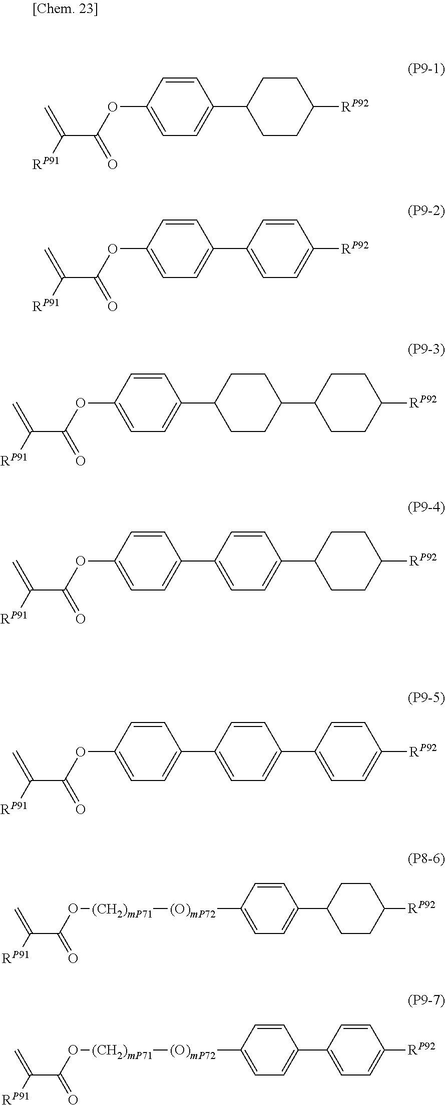

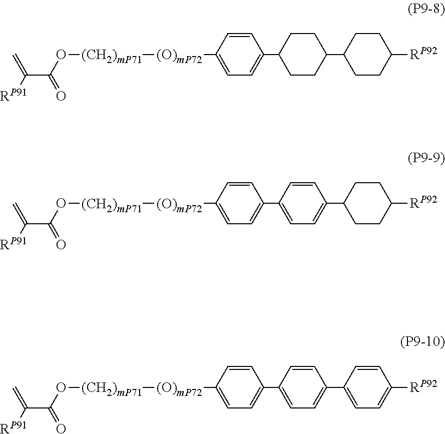

(where R^{P91} represents a hydrogen atom or methyl group, and RP92 represents a hydrogen atom or C1-18 alkyl group)

Among formula (P1), moreover, imparting the capability of photoisomerizing as a monomer is preferred because it makes available the photoalignment capability, or light-induced alignment with the use of the Weigert effect. In this light, the compounds represented by (P10-1) to (P10-11) are preferred.

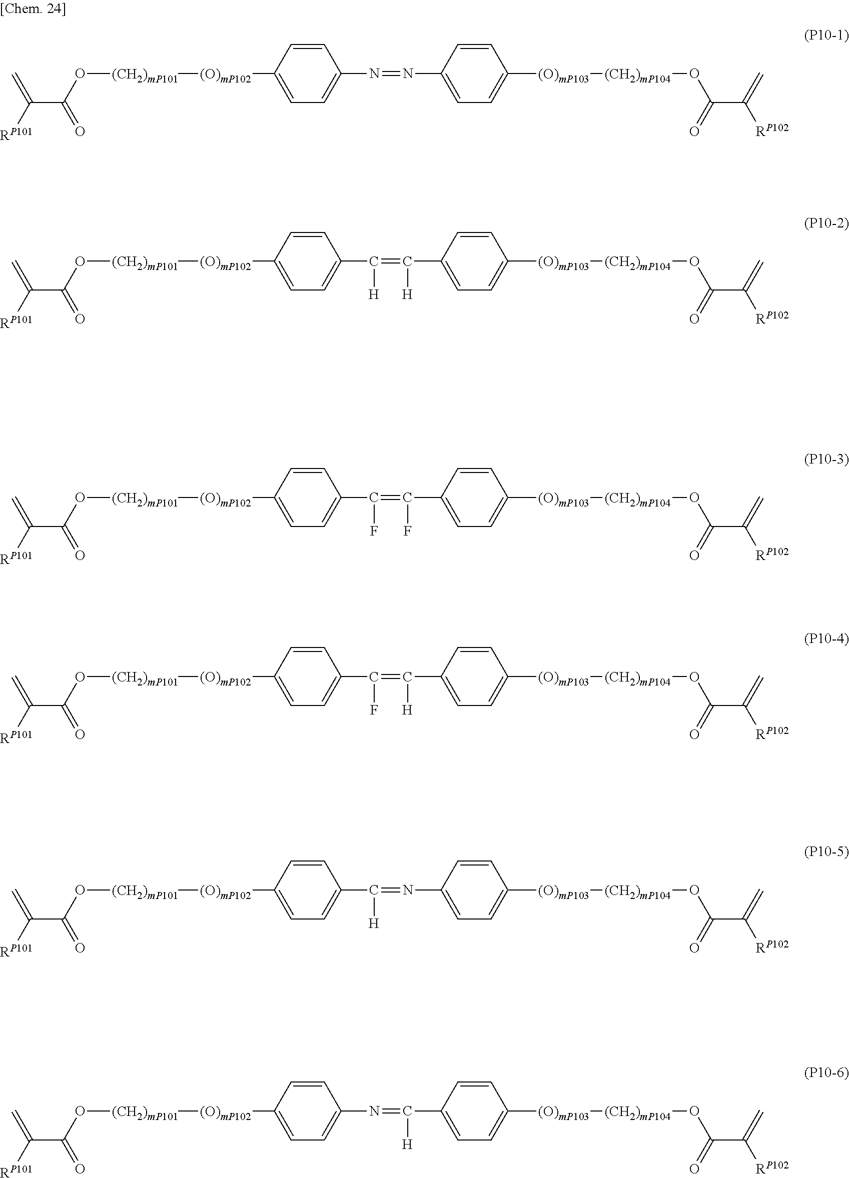

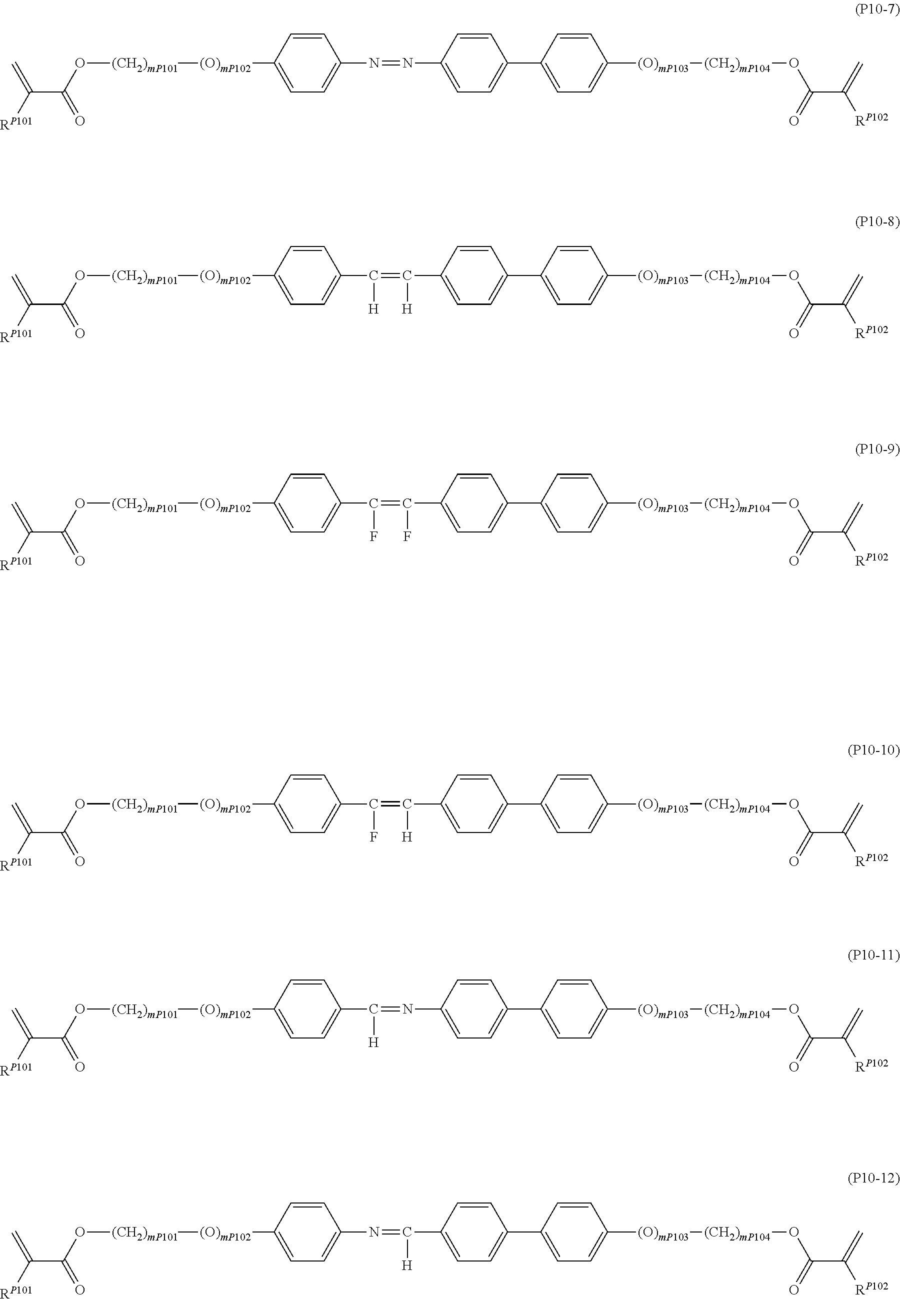

(where R^{P101} and R^{P102} each independently represent a hydrogen atom or methyl group, and mP102 and mP103 each independently represent an integer of 0 or 1. If mP102 is 0, mP101 represents an integer of 1 to 6. If mp102 is 1, mP101 represents an integer of 2 to 6. If mP103 is 0, mP104 represents an integer of 1 to 6. If mP103 is 1, mp104 represents an integer of 2 to 6)

For the radically polymerizable monomer component (A) specified above, the compounds represented by the above specific examples can be expressed with general formula (V) below

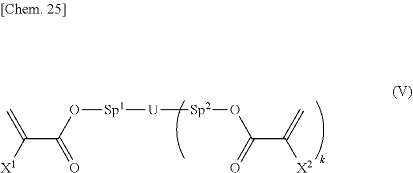

(where X¹ and X² each independently represent a hydrogen atom or methyl group, Sp¹ and Sp² each independently represent a single bond, a C1-12 alkylene group, or —O—(CH₂)ₛ— (where s represents an integer of 1 to 11, and the oxygen atom binds to an aromatic ring), and U represents a C2-20 linear or branched polyvalent aliphatic hydrocarbon group or C5-30 polyvalent cyclic substituent. The polyvalent aliphatic hydrocarbon group may be substituted with oxygen atom(s) with no oxygen atoms at adjacent positions, with C5-20 alkyl group(s) (Alkylene group(s) therein may be substituted with oxygen atom(s) with no oxygen atoms at adjacent positions.), or cyclic substituent(s). k represents an integer of 1 to 5. All 1,4-phenylene groups in the formula may have any of their hydrogen atoms substituted with —CH₃, —OCH₃, a fluorine atom, or a cyano group.) or general formula (VI) below

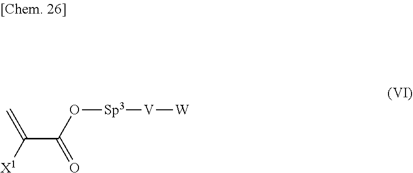

(where X³ represents a hydrogen atom or methyl group, Sp³ represents a single bond, a C1-12 alkylene group, or —O—(CH₂)ₜ— (where t represents an integer of 2 to 11, and the oxygen atom binds to an aromatic ring.), and V represents a C2-20 linear or branched polyvalent aliphatic hydrocarbon group or C5-30 polyvalent cyclic substituent or a structural unit resulting from substituting oxygen atom(s) in a C2-20 linear or branched alkylene structure with an oxygen atom except at adjacent positions, with the proviso that these chemical structures may have hydrogen atom(s) on their carbon atom(s) substituted with a C5-20 alkyl group (Alkylene group(s) therein may be substituted with an oxygen atom with no oxygen atoms at adjacent positions.), or a cyclic substituent. W represents a hydrogen atom, a halogen atom, or a C1-15 alkyl group. All 1,4-phenylene groups in the formula may have any of their hydrogen atoms substituted with —CH₃, —OCH₃, a fluorine atom, or a cyano group.).

Here, it is preferred that the compound be one in which Sp¹ and Sp² in general formula (V) above are the same because this facilitates the synthesis of the compound if they are, for example, C1-12 linear or branched alkylene groups, and because the physical properties of such a compound can be easily controlled by using multiple compounds with different alkylene chain lengths in appropriate proportions.

Next, the liquid crystal material (B) used in the polymerizable liquid crystal composition according to the present invention (hereinafter simply referred to as “the liquid crystal composition (B)”) may have a positive or negative dielectric constant anisotropy. A liquid crystal composition (B) having a negative anisotropy preferably contains a liquid crystal composition with a negative dielectric constant anisotropy (Δε smaller than −2) and a liquid crystal composition with substantially no dielectric constant anisotropy (the value of Δε between −2 to 2). A liquid crystal composition (B) having a positive anisotropy preferably contains a liquid crystal composition with a positive dielectric constant anisotropy (Δε larger than 2) and a liquid crystal composition with substantially no dielectric constant anisotropy (the value of Δε between −2 to 2).

If the liquid crystal composition (B) has a negative dielectric constant anisotropy, the value of dielectric constant anisotropy Δε is preferably in the range of −1.0 to −7.0, more preferably −1.5 to −6.5, eve more preferably −2.0 to −6.0, in particular −2.5 to −5.5. If low-voltage driving is a high priority, however, Δε is preferably in the range of −3.0 to −6.0, and if fast response time is a high priority, Δε is preferably in the range of −2.0 to −3.5.

The value of refractive index anisotropy Δn is preferably in the range of 0.100 to 0.140 if the cell gap is thin for fast response time, and in the range of 0.080 to 0.100 if the cell gap is thick for an improved yield in the production of displays. If reflective displays are fabricated, these preferred ranges are preferably between 50% and 80% of the values given above.

The value of the nematic-isotropic transition temperature T_{NI} is preferably in the range of 65° C. to 150° C., but preferably between 70° C. and 130° C. However, if fast response time is a high priority or if the produced displays are used primarily indoors, T_{NI} is preferably in the range of 70° C. to 90° C., and if the produced displays are used primarily outdoors, T_{NI} is preferably in the range of 80° C. to 120° C.

The value of rotational viscosity is preferably 200 mPa·s or less, more preferably 180 mPa·s or less, even more preferably 150 mPa·s or less, in particular 130 mPa·s or less, the most preferably 100 mPa·s or less.

If the liquid crystal composition (B) has a positive dielectric constant anisotropy, the value of dielectric constant anisotropy Δε is preferably in the range of 1.0 to 20.0, more preferably 1.5 to 15.0, even more preferably 2.0 to 10.0, in particular 3.0 to 8.5. If low-voltage driving is a high priority, however, Δε is preferably in the range of 5.0 to 12.0, and if fast response time is a high priority, Δε is preferably in the range of 1.5 to 5.0.

The value of Δn is preferably in the range of 0.110 to 0.160 if the cell gap is thin for fast response time, and in the range of 0.090 to 0.110 if the cell gap is thick for an improved yield in the production of displays. If reflective displays are fabricated, these preferred ranges are preferably between 50% and 80% of the values given above.

As for preferred ranges of the nematic-isotropic transition temperature T_{NI} range, T_{NI} is preferably in the range of 65° C. to 150° C., but preferably between 70° C. and 130° C. However, if fast response time is a high priority or if the produced displays are used primarily indoors, T_{NI} is preferably in the range of 70° C. to 90° C., and if the produced displays are used primarily outdoors, T_{NI} is preferably in the range of 80° C. to 120° C. The value of rotational viscosity is preferably 130 mPa·s or less, more preferably 100 mPa·s or less, even more preferably 90 mPa·s or less, in particular 75 mPa·s or less, the most preferably 60 mPa·s or less.

Specifically, a liquid crystal composition (B) having a negative dielectric constant anisotropy preferably contains one or two or more compounds selected from the compounds represented by general formulae (N-1), (N-2), (N-3), and (N-4). These compounds are dielectrically negative compounds (The sign of Δε is negative, with the absolute value larger than 2.).

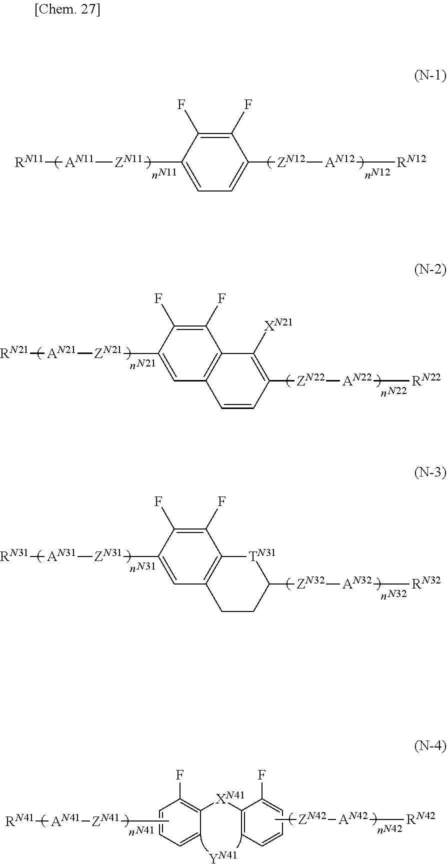

[In general formulae (N-1), (N-2), (N-3), and (N-4) above, R^{N11}, R^{N12}, R^{N21}, R^{N22}, R^{N31}, R^{N32}, R^{N41}, and R^{N42} each independently represent a C1-8 alkyl group or a structural unit having a chemical structure resulting from substituting one —CH₂— in a C2-8 alkyl chain, or each of nonadjacent two or more independently, with —CH═CH—, —C═C—, —O—, —CO—, —COO—, or —OCO—, and

A^{N11}, A^{N12}, A^{N21}, A^{N22}, A^{N31}, A^{N32}, A^{N41}, and A^{N42} each independently represent a group selected from the group consisting of:

(a) a 1,4-cyclohexylene group (One —CH₂— or two or more nonadjacent —CH₂— present in this group may be substituted with —O—.);

(b) a 1,4-phenylene group (One —CH═ or two or more nonadjacent —CH=present in this group may be substituted with —N═.);

(c) a naphthalen-2,6-diyl, 1,2,3,4-tetrahydronaphthalen-2,6-diyl, or decahydronaphthalen-2,6-diyl group (One —CH═ or two or more nonadjacent —CH=present in the naphthalen-2,6-diyl or 1,2,3,4-tetrahydronaphthalen-2,6-diyl group may be substituted with —N═.); and

(d) a 1,4-cyclohexenylene group, and

the hydrogen atoms in the structure of the groups (a), (b), (c), and (d) may each independently be substituted with a cyano group, a fluorine atom, or a chlorine atom.

Z^{N11}, Z^{N12} Z^{N21} Z^{N22} Z^{N31}, Z^{N32} Z^{N41} and Z^{N42} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C═C—. X^{N21} represents a hydrogen or fluorine atom, T^{N31} represents —CH₂— or an oxygen atom, X^{N41} represents an oxygen atom, a nitrogen atom, or —CH₂—, and Y^{N41} represents a single bond or —CH₂—. n^{N11}, n^{N12} n^{N21}, n^{N22}, n^{N31}, n^{N32}, n^{N41}, and n^{N42} each independently represent an integer of 0 to 3, with the proviso that each of n^{N11}+n^{N12}n^{N21}+n^{N22}, and n^{N31}+n^{N32} is independently 1, 2, or 3. For A^{N11} to A^{N32} and Z^{N11} to Z^{N32}, multiple groups may be the same or different. n^{N41}+n^{N42} represents an integer of 0 to 3, with the proviso that for A^{N41} and A^{N42} and for Z^{N41} and Z^{N42}, multiple groups may be the same or different.]

The compound(s) represented by general formulae (N-1), (N-2), (N-3), and (N-4) are preferably compound(s) having a negative Δε with the absolute value larger than 2.

In general formulae (N-1), (N-2), (N-3), and (N-4), each of R^{N11}, R^{N12}, R^{N21}, R^{N22}, R^{N31}, R^{N32}, R^{N41}, and R^{N32} is preferably independently a C1-8 alkyl, C1-8 alkoxy, C2-8 alkenyl, or C2-8 alkenyloxy group, preferably a C1-5 alkyl, C1-5 alkoxy, C2-5 alkenyl, or C2-5 alkenyloxy group, more preferably a C1-5 alkyl or C2-5 alkenyl group, more preferably a C2-5 alkyl or C2-3 alkenyl group, in particular a C3 alkenyl group (propenyl group).

If the ring structure to which the group is bound is a phenyl group (aromatic), linear C1-5 alkyl, linear C1-4 alkoxy, and C4-5 alkenyl groups are preferred. If the ring structure to which the group is bound is a saturated ring structure, such as cyclohexane, pyran, or dioxane, linear C1-5 alkyl, linear C1-4 alkoxy, and linear C2-5 alkenyl groups are preferred. To stabilize the nematic phase, it is preferred that the total number of carbon and oxygen, if present, atoms be 5 or less, preferably with the group being linear.

An alkenyl group is preferably selected from the groups represented by any of formulae (R1) to (R5). (The black dot in the formulae represents a carbon atom in a ring structure.)

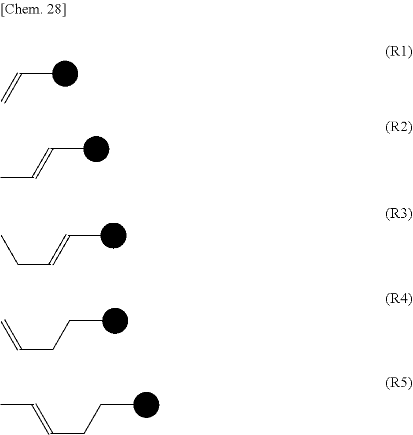

If Δn needs to be large, each of A^{N11}, A^{N12}, A^{N21}, A^{N22}, A^{N31}, A^{N32}, A^{N41}, and A^{N42} is preferably independently an aromatic structural unit. To improve the response rate, it is preferred that each of these groups be independently an aliphatic structural unit, preferably a trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidin-1,4-diyl, naphthalen-2,6-diyl, decahydronaphthalen-2,6-diyl, or 1,2,3,4-tetrahydronaphthalen-2,6-diyl or a group having a structure represented by the structural formulae below.

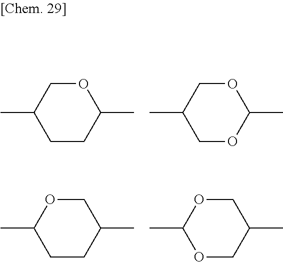

i.e., a tetrahydrofuran or dioxane structure.

Among these, it is more preferred that the group represent a structure given below.

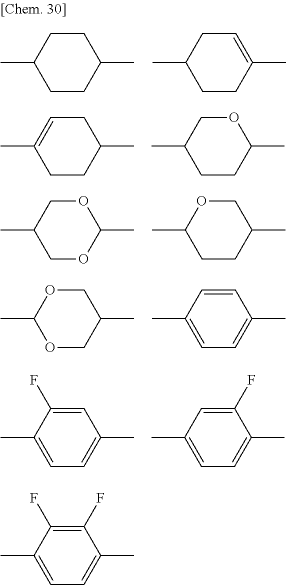

In particular, the trans-1,4-cyclohexylene and 1,4-cyclohexenylene groups are preferred because they are useful if the manufacturer wants to reduce Δn and helps lower viscosity, and the 1,4-phenylene group is more preferred because it is useful if the manufacturer wants to increase Δn.

Z^{N11} Z^{N12}, Z^{N21}, Z^{N22}, Z^{N31}, Z^{N32}, Z^{N41}, and Z^{N42} each preferably independently represent —CH₂O—, —CF₂O—, —CH₂CH₂—, —CF₂CF₂—, or a single bond, more preferably —CH₂—, —CH₂CH₂—, or a single bond, in particular —CH₂O— or a single bond.

X^{N21} is preferably a fluorine atom.

T^{N31} is preferably an oxygen atom.

n^{N11}+n^{N12}, n^{N21}+n^{N22}, n^{N31}+n^{N32}, and n^{N41}+n^{N42} are preferably 0, 1, or 2. The combinations are preferred in which n^{N11} is 1 with n^{N12} being 0, n^{N11} is 2 with n^{N12} being 0, n^{N11} is 1 with n^{N12} being 1, n^{N11} is 2 with n^{N12} being 1, n^{N21} is 1 with n^{N22} being 0, n^{N21} is 2 with n^{N22} being 0, n^{N31} is 1 with n^{N32} being 0, and n^{N31} is 2 with n^{N32} being 0, but for n^{N41}+n^{N42}, the combination in which both n^{N41} and n^{N42} are 0 is also preferred.

The lower limit of preferred percentages of compound(s) represented by formula (N-1) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is 95% by mass, 85% by mass, 75% by mass, 65% by mass, 55% by mass, 45% by mass, 35% by mass, 25% by mass, or 20% by mass.

The lower limit of preferred percentages of compound(s) represented by formula (N-2) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is 95% by mass, 85% by mass, 75% by mass, 65% by mass, 55% by mass, 45% by mass, 35% by mass, 25% by mass, or 20% by mass.

The lower limit of preferred percentages of compound(s) represented by formula (N-3) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is 95% by mass, 85% by mass, 75% by mass, 65% by mass, 55% by mass, 45% by mass, 35% by mass, 25% by mass, or 20% by mass.

The lower limit of preferred percentages of compound(s) represented by formula (N-4) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is 95% by mass, 85% by mass, 75% by mass, 65% by mass, 55% by mass, 45% by mass, 35% by mass, 25% by mass, or 20% by mass.

If the manufacturer needs to keep the viscosity of the liquid crystal composition (B) low and thereby make the composition fast in response time, it is preferred that the above lower limit be low with the upper limit low. If the manufacturer needs to keep the Tni of the liquid crystal composition (B) high and thereby make the composition good in temperature stability, it is preferred that the above lower limit be low with the upper limit low. If the manufacturer wants a large dielectric constant anisotropy to keep the drive voltage low, it is preferred that the above lower limit be high with the upper limit high.

Examples of compounds represented by general formula (N-1) are the group of compounds represented by general formulae (N-1a) to (N-1g) below.

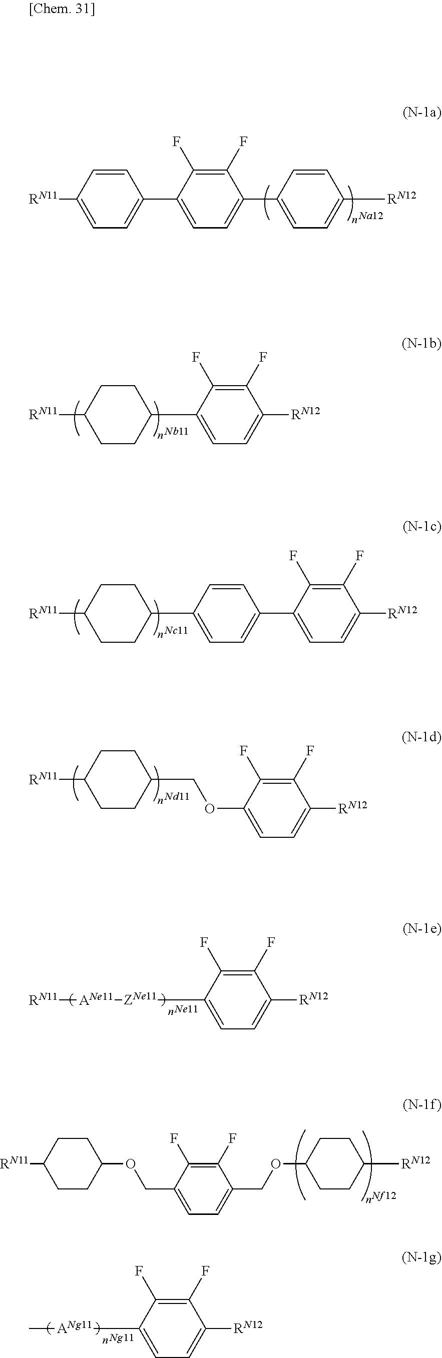

(where R^{N11} and R^{N12} represent the same meaning as R^{N11} and R^{N12} in general formula (N-1), n^{Na11} represents 0 or 1, n^{Nb11} represents 0 or 1, n^{Nc11} represents 0 or 1, n^{Nd11} represents 0 or 1, n^{Ne11} represents 1 or 2, n^{f} represents 1 or 2, n^{Ng11} represents 1 or 2, A^{Ne11} represents a trans-1,4-cyclohexylene or 1,4-phenylene group, A^{Ng11} represents a trans-1,4-cyclohexylene, 1,4-cyclohexenylene, or 1,4-phenylene group with the proviso that at least one represents a 1,4-cyclohexenylene group, and Z^{Ne 11} represents a single bond or ethylene with the proviso that at least one represents ethylene.)

To be more specific, the compound(s) represented by general formula (N-1) is preferably compound(s) selected from the group of compounds represented by general formulae (N-1-1) to (N-1-21).

The compounds represented by general formula (N-1-1) are the following compounds.

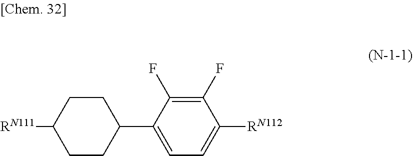

(where R^{N111} and R^{N112} each independently represent the same meaning as R^{N11} and R^{N12} in general formula (N-1).)

R^{N111} is preferably a C1-5 alkyl or C2-5 alkenyl group, preferably a propyl, pentyl, or vinyl group. R^{N112} is preferably a C1-5 alkyl, C4-5 alkenyl, or C1-4 alkoxy group, preferably an ethoxy or butoxy group.

The compounds represented by general formula (N-1-1) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively small is highly effective. To improve drop marks or image-sticking properties, it is preferred to set the range of percentages to a medium range.

The lower limit of preferred percentages of the compound(s) represented by formula (N-1-1) to the total amount of the liquid crystal composition (B) is 5% by mass, 10% by mass, 13% by mass, 15% by mass, 17% by mass, 20% by mass, 23% by mass, 25% by mass, 27% by mass, 30% by mass, 33% by mass, or 35% by mass. The upper limit of preferred percentages is 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass of the total amount of the liquid crystal composition (B).

The compound(s) represented by general formula (N-1-1), moreover, is preferably compound(s) selected from the group of compounds represented by formulae (N-1-1.1) to (N-1-1.23), preferably is compound(s) represented by formulae (N-1-1.1) to (N-1-1.4), preferably compound(s) represented by formulae (N-1-1.1) and (N-1-1.3).

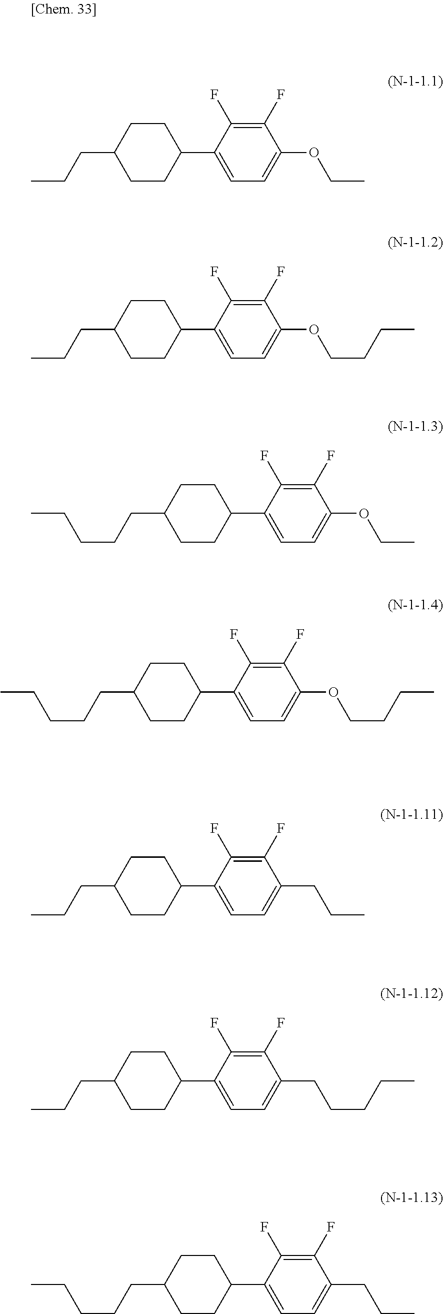

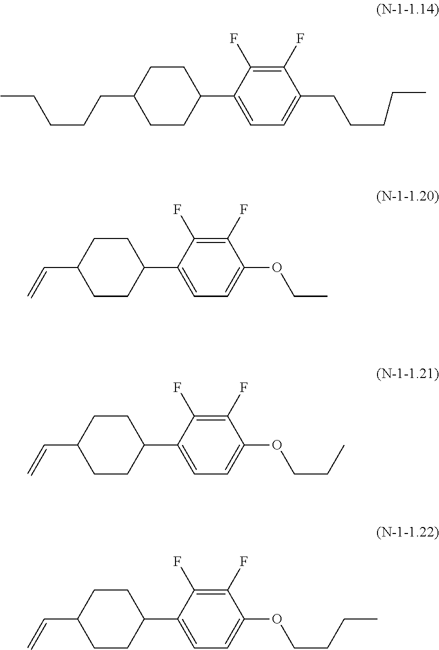

The compounds represented by formulae (N-1-1.1) to (N-1-1.22) can be used alone or can be used in combination, but the lower limit of preferred percentages of the compound or these compounds to the total amount of the liquid crystal composition (B) is 5% by mass, 10% by mass, 13% by mass, 15% by mass, 17% by mass, 20% by mass, 23% by mass, 25% by mass, 27% by mass, 30% by mass, 33% by mass, or 35% by mass. The upper limit of preferred percentages is 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass of the total amount of the nonpolymerizable composition.

The compounds represented by general formula (N-1-2) are the following compounds.

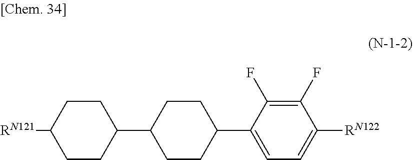

(where R^{N121} and R^{N122} each independently represent the same meaning as R^{N11} and R^{N12} in general formula (N-1).)

R^{N121} is preferably a C1-5 alkyl or C2-5 alkenyl group, preferably an ethyl, propyl, butyl, or pentyl group. R^{N122} is preferably a C1-5 alkyl, C4-5 alkenyl, or C1-4 alkoxy group, preferably a methyl, methoxy, ethoxy, or propoxy group.

The compounds represented by general formula (N-1-2) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively small is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-2) to the total amount of the liquid crystal composition (B) is 5% by mass, 7% by mass, 10% by mass, 13% by mass, 15% by mass, 17% by mass, 20% by mass, 23% by mass, 25% by mass, 27% by mass, 30% by mass, 33% by mass, 35% by mass, 37% by mass, 40% by mass, or 42% by mass. The upper limit of preferred percentages is 50% by mass, 48% by mass, 45% by mass, 43% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, or 5% by mass of the total amount of the liquid crystal composition (B).

The compound(s) represented by general formula (N-1-2), moreover, is preferably compound(s) selected from the group of compounds represented by formulae (N-1-2.1) to (N-1-2.22), preferably is compound(s) represented by formulae (N-1-2.3) to (N-1-2.7), (N-1-2.10), (N-1-2.11), (N-1-2.13), and (N-1-2.20). If improving Δε is a high priority, the compounds represented by formulae (N-1-2.3) to (N-1-2.7) are preferred. If improving T_{NI} is a high priority, the compound(s) is preferably compound(s) represented by formulae (N-1-2.10), (N-1-2.11), and (N-1-2.13). If improving the response rate is a high priority, the compound is preferably the compound represented by formula (N-1-2.20).

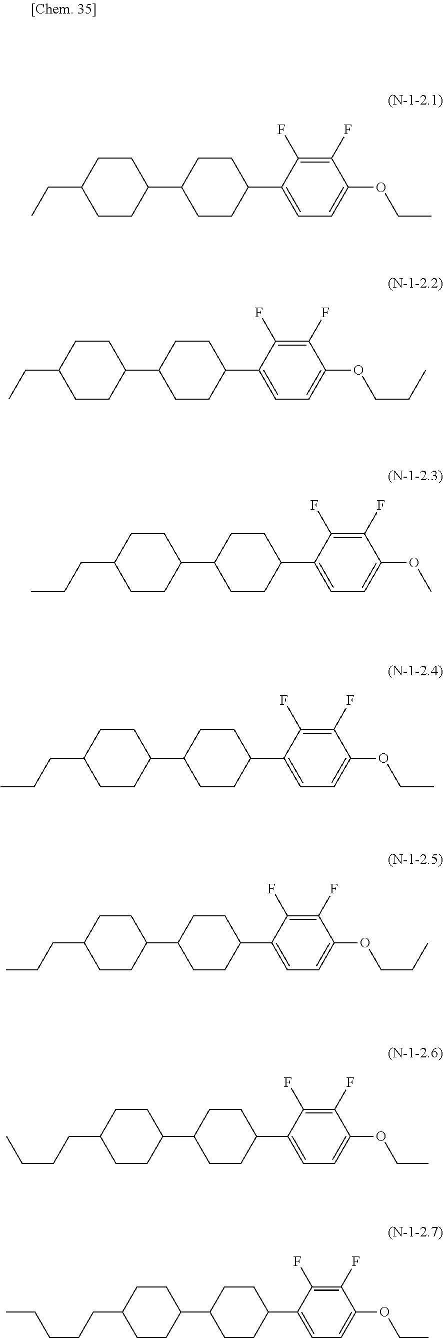

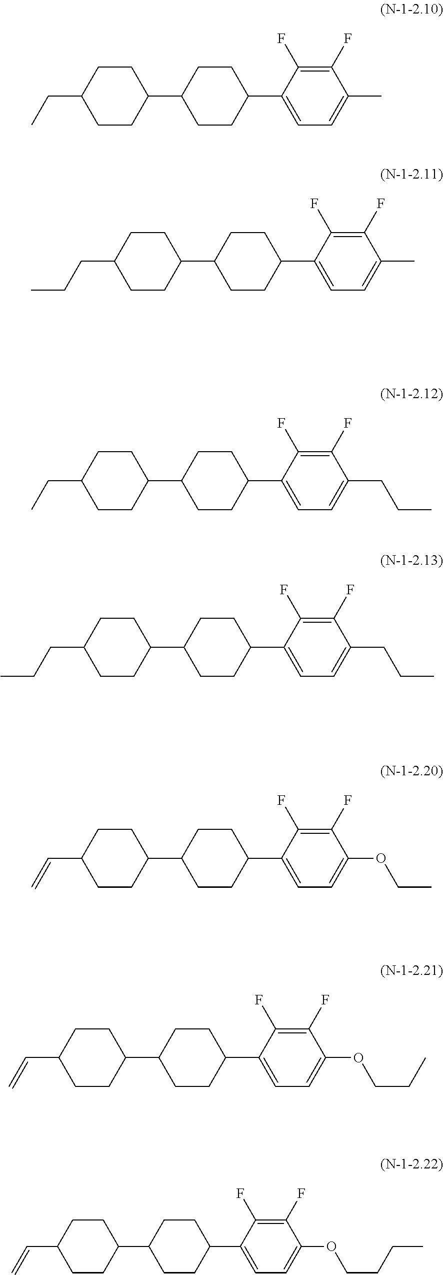

The compounds represented by formulae (N-1-2.1) to (N-1-2.22) can be used alone or can be used in combination, but the lower limit of preferred percentages of the compound or these compounds to the total amount of the liquid crystal composition (B) is 5% by mass, 10% by mass, 13% by mass, 15% by mass, 17% by mass, 20% by mass, 23% by mass, 25% by mass, 27% by mass, 30% by mass, 33% by mass, or 35% by mass. The upper limit of preferred percentages is 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass of the total amount of the liquid crystal composition (B).

The compounds represented by general formula (N-1-3) are the following compounds.

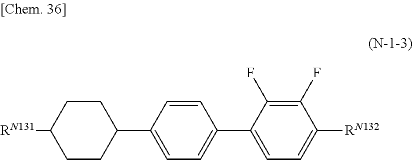

(where R^{N131} and R^{N132} each independently represent the same meaning as R^{N11} and R^{N12} in general formula (N-1).)

R^{N131} is preferably a C1-5 alkyl or C2-5 alkenyl group, preferably an ethyl, propyl, or butyl group. R^{N132} is preferably a C1-5 alkyl, C3-5 alkenyl, or C1-4 alkoxy group, preferably a 1-propenyl, ethoxy, propoxy, or butoxy group.

The compounds represented by general formula (N-1-3) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-3) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compound(s) represented by general formula (N-1-3), moreover, is preferably compound(s) selected from the group of compounds represented by formulae (N-1-3.1) to (N-1-3.21), preferably is compound(s) represented by formulae (N-1-3.1) to (N-1-3.7) and (N-1-3.21), preferably compound(s) represented by formulae (N-1-3.1), (N-1-3.2), (N-1-3.3), (N-1-3.4), and (N-1-3.6).

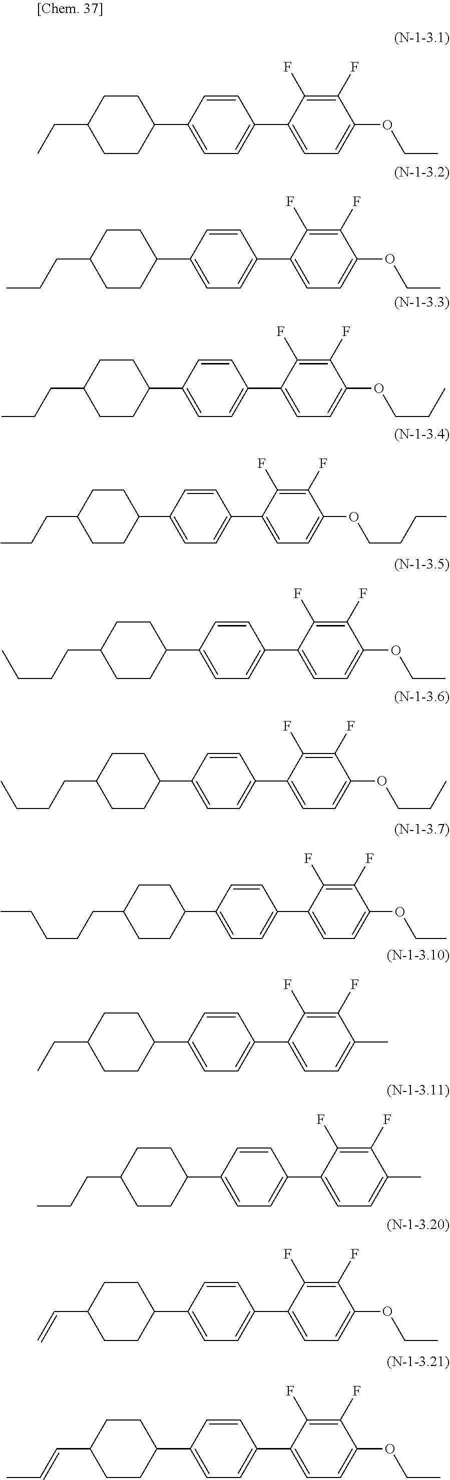

The compounds represented by formulae (N-1-3.1) to (N-1-3.4), (N-1-3.6), and (N-1-3.21) can be used alone or can be used in combination, but the combination of formulae (N-1-3.1) and (N-1-3.2) and the combinations of two selected from formulae (N-1-3.3), (N-1-3.4), and (N-1-3.6) or of these three are preferred. The lower limit of preferred percentages of the compound or these compounds to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-4) are the following compounds.

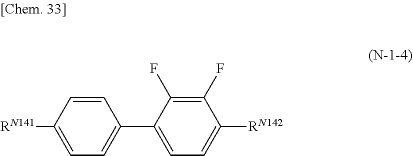

(where R^{N141} and R^{N142} each independently represent the same meaning as R^{N11} and R^{N12} in general formula (N-1).)

Each of R^{N141} and R^{N142} is preferably independently a C1-5 alkyl, C4-5 alkenyl, or C1-4 alkoxy group, preferably a methyl, propyl, ethoxy, or butoxy group.

The compounds represented by general formula (N-1-4) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively small is highly effective. To improve drop marks or image-sticking properties, it is preferred to set the range of percentages to a medium range.

The lower limit of preferred percentages of the compound(s) represented by formula (N-1-4) to the total amount of the liquid crystal composition (B) is 3% by mass, 5% by mass, 7% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, 13% by mass, 11% by mass, 10% by mass, or 8% by mass of the total amount of the liquid crystal composition (B).

The compound(s) represented by general formula (N-1-4), moreover, is preferably compound(s) selected from the group of compounds represented by formulae (N-1-4.1) to (N-1-4.14), preferably is compound(s) represented by formulae (N-1-4.1) to (N-1-4.4), preferably compound(s) represented by formulae (N-1-4.1), (N-1-4.2), and (N-1-4.4).

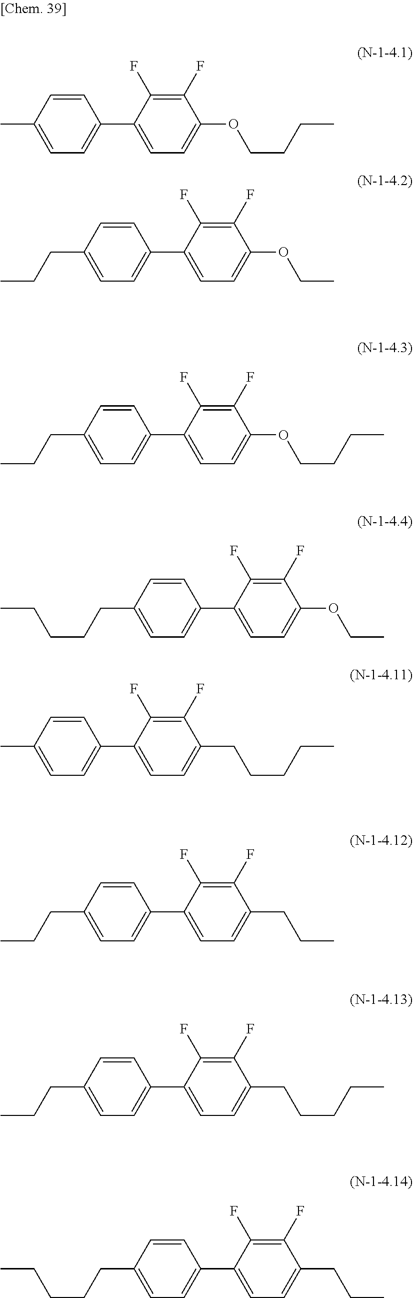

The compounds represented by formulae (N-1-4.1) to (N-1-4.14) can be used alone or can be used in combination, but the lower limit of preferred percentages of the compound or these compounds to the total amount of the liquid crystal composition (B) is 3% by mass, 5% by mass, 7% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, 13% by mass, 11% by mass, 10% by mass, or 8% by mass of the total amount of the liquid crystal composition (B).

The compounds represented by general formula (N-1-5) are the following compounds.

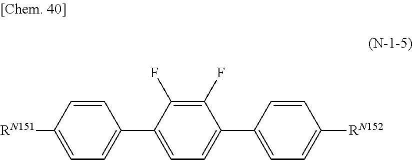

(where R^{N151} and R^{N152} each independently represent the same meaning as R^{N11} and R^{N12} in general formula (N-1).) Each of R^{N151} and R^{N152} is preferably independently a C1-5 alkyl, C4-5 alkenyl, or C1-4 alkoxy group, preferably an ethyl, propyl, or butyl group.

The compounds represented by general formula (N-1-5) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively small is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-5) to the total amount of the liquid crystal composition (B) is 5% by mass, 8% by mass, 10% by mass, 13% by mass, 15% by mass, 17% by mass, or 20% by mass. The upper limit of preferred percentages is 35% by mass, 33% by mass, 30% by mass, 28% by mass, 25% by mass, 23% by mass, 20% by mass, 18% by mass, 15% by mass, or 13% by mass of the total amount of the liquid crystal composition (B).

The compound(s) represented by general formula (N-1-5), moreover, is preferably compound(s) selected from the group of compounds represented by formulae (N-1-5.1) to (N-1-5.6), preferably is compound(s) represented by formulae (N-1-5.1), (N-1-5.2), and (N-1-5.4).

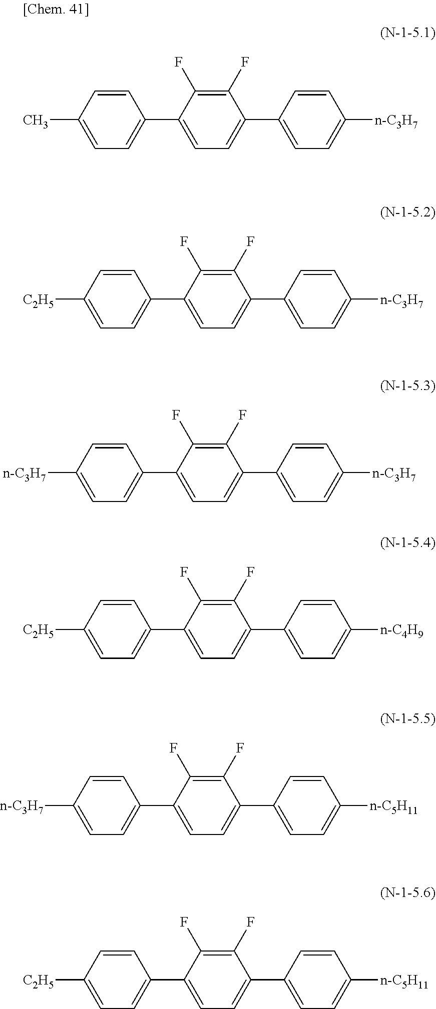

The compounds represented by formulae (N-1-5.1), (N-1-5.2), and (N-1-5.4) can be used alone or can be used in combination, but the lower limit of preferred percentages of the compound or these compounds to the total amount of the liquid crystal composition (B) is 5% by mass, 8% by mass, 10% by mass, 13% by mass, 15% by mass, 17% by mass, or 20% by mass. The upper limit of preferred percentages is 35% by mass, 33% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-10) are the following compounds.

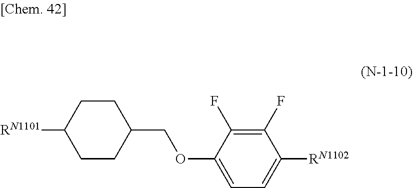

(where R^{N1101} and R^{N1102} each independently represent the same meaning as R^{N11} and R^{N12} in general formula (N-1).)

R^{N1101} is preferably a C1-5 alkyl or C2-5 alkenyl group, preferably an ethyl, propyl, butyl, vinyl, or 1-propenyl group. R^{N1102} is preferably a C1-5 alkyl, C4-5 alkenyl, or C1-4 alkoxy group, preferably an ethoxy, propoxy, or butoxy group.

The compounds represented by general formula (N-1-10) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively high is highly effective. If T_{NI} is a high priority, setting the percentage relatively high is highly effective. To improve drop marks or image-sticking properties, it is preferred to set the range of percentages to a medium range.

The lower limit of preferred percentages of the compound(s) represented by formula (N-1-10) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compound(s) represented by general formula (N-1-10), moreover, is preferably compound(s) selected from the group of compounds represented by formulae (N-1-10.1) to (N-1-10.21), preferably is compound(s) represented by formulae (N-1-10.1) to (N-1-10.5), (N-1-10.20), and (N-1-10.21), preferably compound(s) represented by formulae (N-1-10.1), (N-1-10.2), (N-1-10.20), and (N-1-10.21).

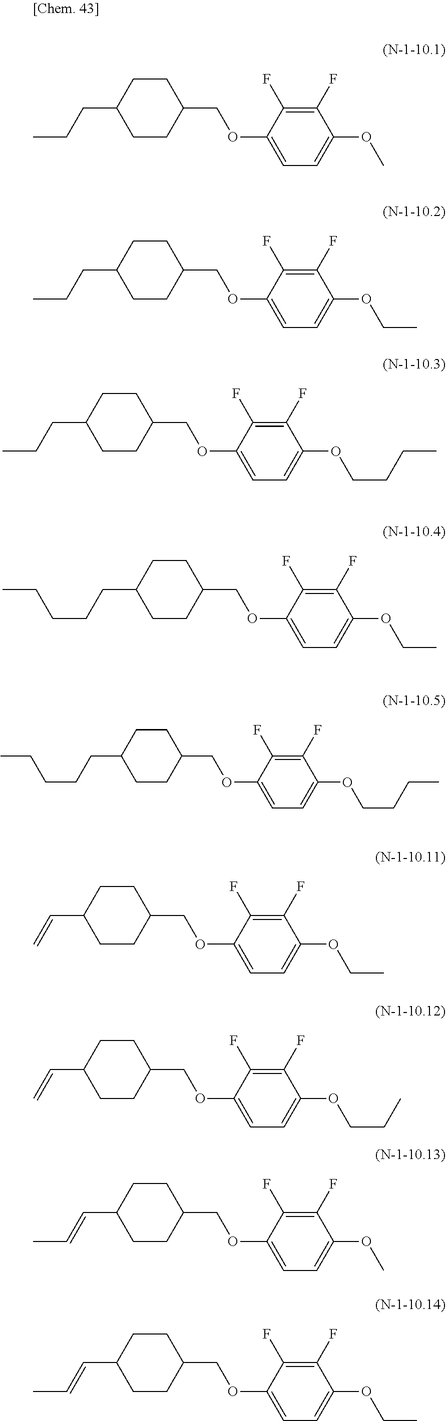

The compounds represented by formulae (N-1-10.1), (N-1-10.2), (N-1-10.20), and (N-1-10.21) can be used alone or can be used in combination, but the lower limit of preferred percentages of the compound or these compounds to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-11) are the following compounds.

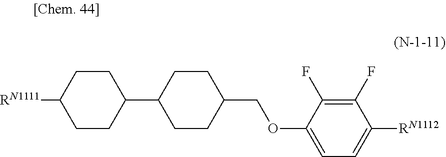

(where R^{N1111} and R^{N1112} each independently represent the same meaning as R^{N11} and R^{N12} in general formula (N-1).)

R^{N1111} is preferably a C1-5 alkyl or C2-5 alkenyl group, preferably an ethyl, propyl, butyl, vinyl, or 1-propenyl group. R^{N1112} is preferably a C1-5 alkyl, C4-5 alkenyl, or C1-4 alkoxy group, preferably an ethoxy, propoxy, or butoxy group.

The compounds represented by general formula (N-1-11) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively low is highly effective. If T_{NI} is a high priority, setting the percentage relatively high is highly effective. To improve drop marks or image-sticking properties, it is preferred to set the range of percentages to a medium range.

The lower limit of preferred percentages of the compound(s) represented by formula (N-1-11) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compound(s) represented by general formula (N-1-11), moreover, is preferably compound(s) selected from the group of compounds represented by formulae (N-1-11.1) to (N-1-11.15), preferably is compound(s) represented by formulae (N-1-11.1) to (N-1-11.15), preferably compound(s) represented by formulae (N-1-11.2 and (N-1-11.4).

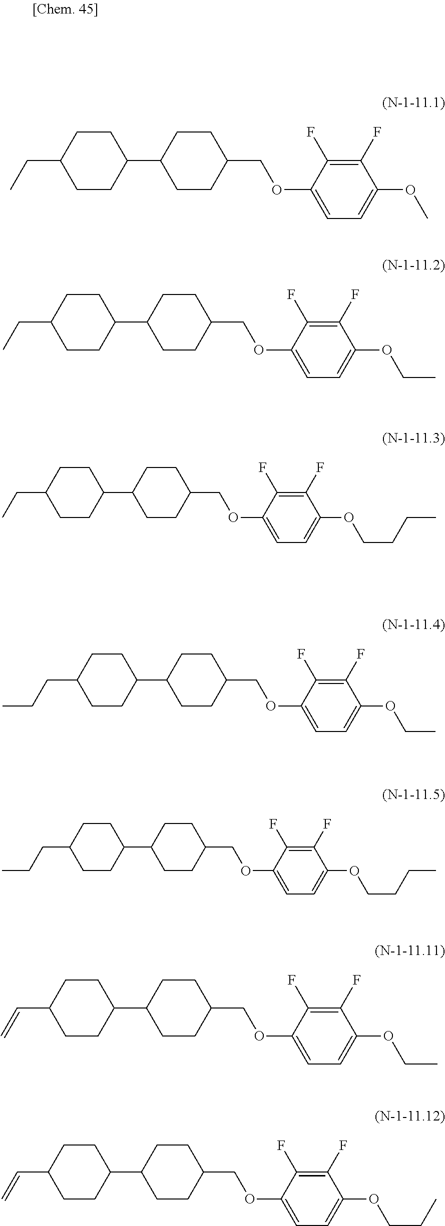

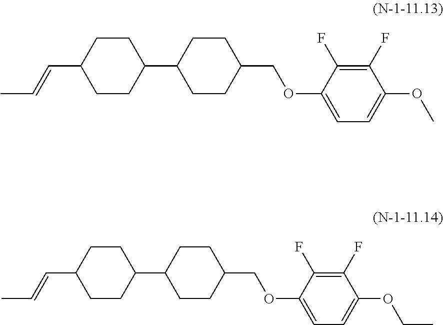

The compounds represented by formulae (N-1-11.2) and (N-1-11.4) can be used alone or can be used in combination, but the lower limit of preferred percentages of the compound or these compounds to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-12) are the following compounds.

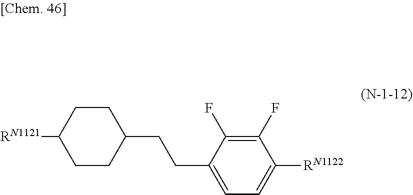

(where R^{N1121} and R^{N1122} each independently represent the same meaning as R^{N11} and R^{N12} in general formula (N-1).)

R^{N1121} is preferably a C1-5 alkyl or C2-5 alkenyl group, preferably an ethyl, propyl, or butyl group. R^{N1122} is preferably a C1-5 alkyl, C4-5 alkenyl, or C1-4 alkoxy group, preferably an ethoxy, propoxy, or butoxy group.

The compounds represented by general formula (N-1-12) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-12) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-13) are the following compounds.

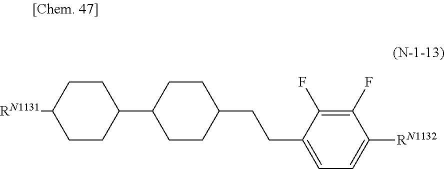

(where R^{N1131} and R^{N1132} each independently represent the same meaning as R^{N11} and R^{N12} in general formula (N-1).) R^{N1131} is preferably a C1-5 alkyl or C2-5 alkenyl group, preferably an ethyl, propyl, or butyl group. R^{N1132} is preferably a C1-5 alkyl, C4-5 alkenyl, or C1-4 alkoxy group, preferably an ethoxy, propoxy, or butoxy group.

The compounds represented by general formula (N-1-13) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-13) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-14) are the following compounds.

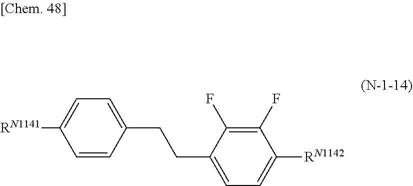

(where R^{N1141} and R^{N1142} each independently represent the same meaning as R^{N11} and R^{N12} in general formula (N-1).) R^{N1141} is preferably a C1-5 alkyl or C2-5 alkenyl group, preferably an ethyl, propyl, or butyl group. R^{N1142} is preferably a C1-5 alkyl, C4-5 alkenyl, or C1-4 alkoxy group, preferably an ethoxy, propoxy, or butoxy group.

The compounds represented by general formula (N-1-14) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-14) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-15) are the following compounds.

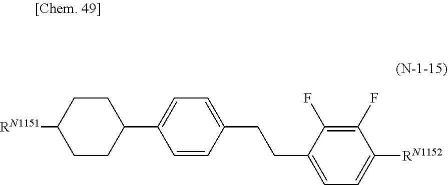

(where R^{N1151} and R^{N1152} each independently represent the same meaning as R^{N1} and R^{N12} in general formula (N-1).)

R^{N1151} is preferably a C1-5 alkyl or C2-5 alkenyl group, preferably an ethyl, propyl, or butyl group. R^{N1152} is preferably a C1-5 alkyl, C4-5 alkenyl, or C1-4 alkoxy group, preferably an ethoxy, propoxy, or butoxy group.

The compounds represented by general formula (N-1-15) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-15) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-16) are the following compounds.

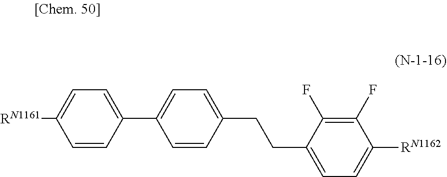

(where R^{N1161} and R^{N1162} each independently represent the same meaning as R^{N1} and R^{N12} in general formula (N-1).)

R^{N1161} is preferably a C1-5 alkyl or C2-5 alkenyl group, preferably an ethyl, propyl, or butyl group. R^{N1162} is preferably a C1-5 alkyl, C4-5 alkenyl, or C1-4 alkoxy group, preferably an ethoxy, propoxy, or butoxy group.

The compounds represented by general formula (N-1-16) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-16) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-17) are the following compounds.

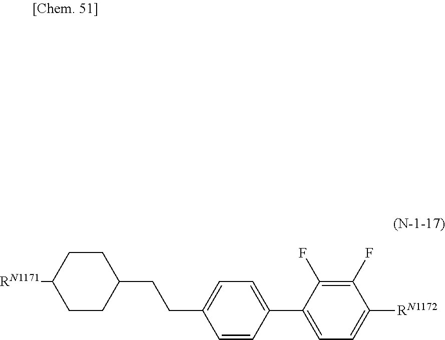

(where R^{N1171} and R^{N1172} each independently represent the same meaning as R^{N11} and R^{N12} in general formula (N-1).)

R^{N1171} is preferably a C1-5 alkyl or C2-5 alkenyl group, preferably an ethyl, propyl, or butyl group. R^{N1172} is preferably a C1-5 alkyl, C4-5 alkenyl, or C1-4 alkoxy group, preferably an ethoxy, propoxy, or butoxy group.

The compounds represented by general formula (N-1-17) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-17) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-18) are the following compounds.

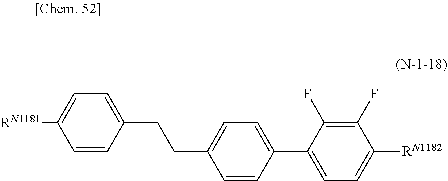

(where R^{N1181} and R^{N1182} each independently represent the same meaning as R^{N11} and R^{N12} in general formula (N-1).) R^{N1181} is preferably a C1-5 alkyl or C2-5 alkenyl group, preferably a methyl, ethyl, propyl, or butyl group. R^{N1182} is preferably a C1-5 alkyl, C4-5 alkenyl, or C1-4 alkoxy group, preferably an ethoxy, propoxy, or butoxy group.

The compounds represented by general formula (N-1-18) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-18) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compound(s) represented by general formula (N-1-18), moreover, is preferably compound(s) selected from the group of compounds represented by formulae (N-1-18.1) to (N-1-18.5), preferably is compound(s) represented by formulae (N-1-18.1) to (N-1-11.3), preferably compound(s) represented by formulae (N-1-18.2 and (N-1-18.3).

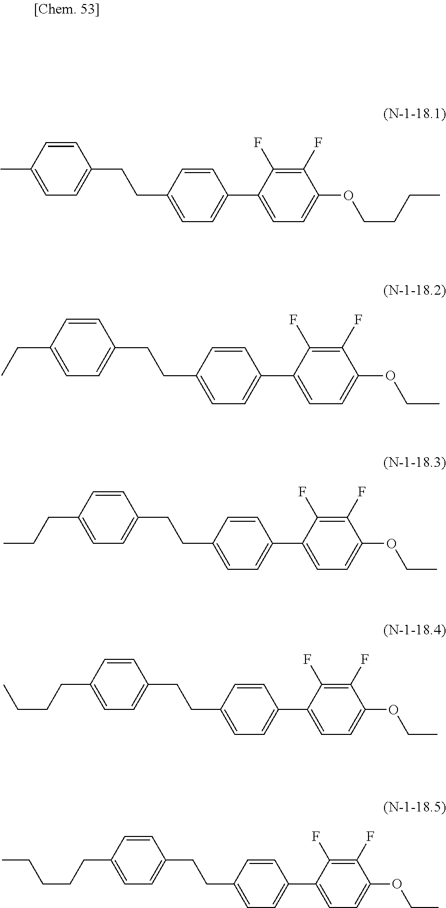

The compounds represented by general formula (N-1-20) are the following compounds.

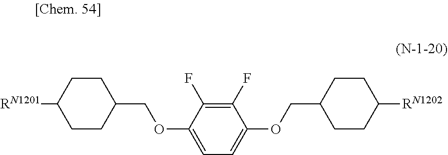

(where R^{N1201} and R^{N1202} each independently represent the same meaning as R^{N11} and R^{N12} in general formula (N-1).)

Each of R^{N1201} and R^{N1202} is preferably independently a C1-5 alkyl or C2-5 alkenyl group, preferably an ethyl, propyl, or butyl group.

The compounds represented by general formula (N-1-20) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-20) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-21) are the following compounds.

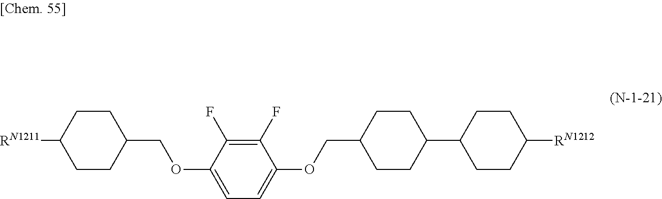

(where R^{N1211} and R^{N1212} each independently represent the same meaning as R^{N1} and R^{N12} in general formula (N-1).)

Each of R^{N12}11 and R^{N1212} is preferably independently a C1-5 alkyl or C2-5 alkenyl group, preferably an ethyl, propyl, or butyl group.

The compounds represented by general formula (N-1-21) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-21) to the total amount of the liquid crystal composition (B) is 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, or 13% by mass of the total amount of the liquid crystal composition (B).

The compounds represented by general formula (N-1-22) are the following compounds.

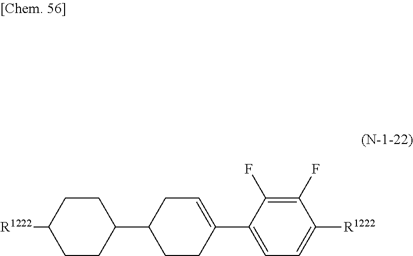

(where R^{N1221} and R^{N1222} each independently represent the same meaning as R^{N11} and R^{N12} in general formula (N-1).)

Each of R^{N1221} and R^{N1222} is preferably independently a C1-5 alkyl or C2-5 alkenyl group, preferably an ethyl, propyl, or butyl group.

The compounds represented by general formula (N-1-22) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively large is highly effective. To improve drop marks or image-sticking properties, it is preferred to set the range of percentages to a medium range.

The lower limit of preferred percentages of the compound(s) represented by formula (N-1-21) to the total amount of the liquid crystal composition (B) is 1% by mass, 5% by mass, 10% by mass, 13% by mass, 15% by mass, 17% by mass, or 20% by mass. The upper limit of preferred percentages is 35% by mass, 30% by mass, 28% by mass, 25% by mass, 23% by mass, 20% by mass, 18% by mass, 15% by mass, 13% by mass, 10% by mass, or 5% by mass of the total amount of the liquid crystal composition (B).

The compound(s) represented by general formula (N-1-22), moreover, is preferably compound(s) selected from the group of compounds represented by formulae (N-1-22.1) to (N-1-22.12), preferably is compound(s) represented by formulae (N-1-22.1) to (N-1-22.5), preferably compound(s) represented by formulae (N-1-22.1) to (N-1-22.4).

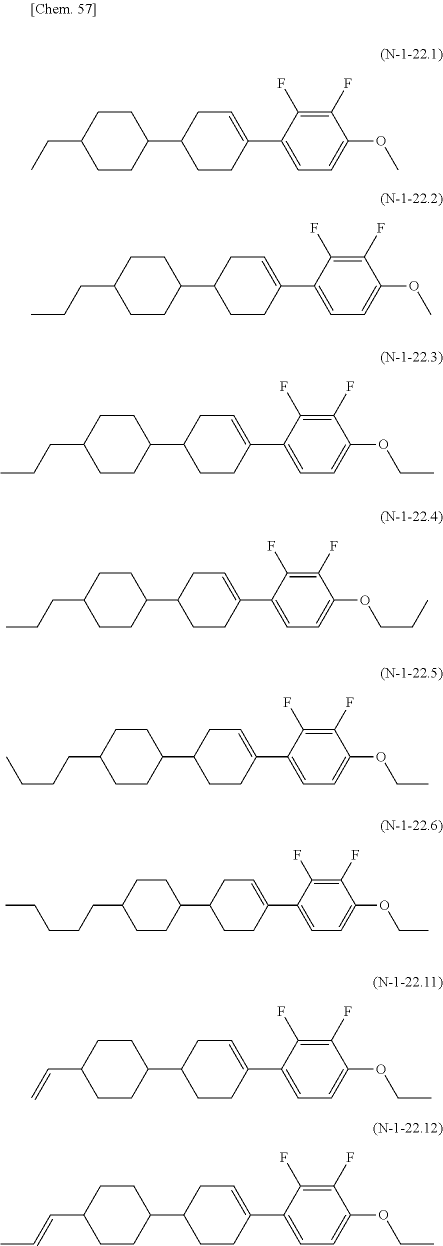

Next, the compound(s) represented by general formula (N-2) above is more preferably one or two or more compounds selected from the group consisting of the compounds represented by general formulae (N-2-a) to (N-2-c) below

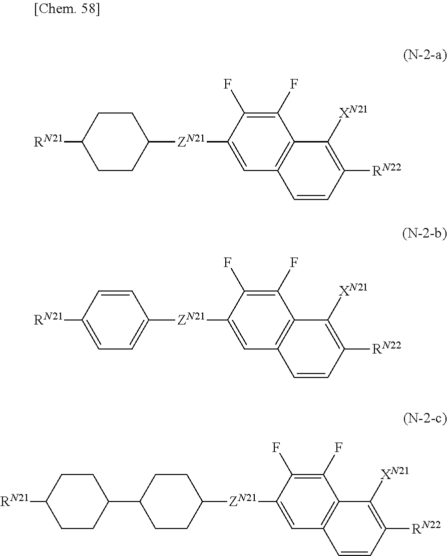

(where R^{N21}, R^{N22}, and X^{N21} each independently represent the same meaning as R^{N21}, R^{N22}, and X^{N21} in general formula (N-2) above, and Z^{N21} represents a single bond, —CH═CH—, —C═C—, —CH₂CH₂—, —(CH₂)₄—, —COO—, —OCH₂—, —CH₂O—, —OCF₂—, or —CF₂O—.)

The compound(s) represented by general formula (N-3) is preferably compound(s) selected from the group of compounds represented by general formula (N-3-1).

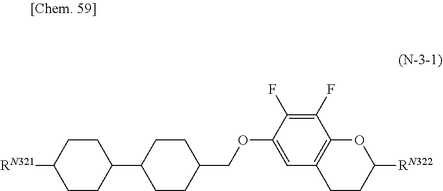

(where R^{N321} and R^{N322} each independently represent the same meaning as R^{N11} and R^{N12} in general formula (N-3).)

R^{N321} and R^{N322} are preferably C1-5 alkyl or C2-5 alkenyl groups, preferably propyl or pentyl groups.

The compounds represented by general formula (N-3-2) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively small is highly effective. To improve drop marks or image-sticking properties, it is preferred to set the range of percentages to a medium range.

The lower limit of preferred percentages of the compound(s) represented by formula (N-3-2) to the total amount of the liquid crystal composition (B) is 3% by mass, 5% by mass, 10% by mass, 13% by mass, 15% by mass, 17% by mass, 20% by mass, 23% by mass, 25% by mass, 27% by mass, 30% by mass, 33% by mass, or 35% by mass. The upper limit of preferred percentages is 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, or 5% by mass of the total amount of the liquid crystal composition (B).

The compound(s) represented by general formula (N-3-1), moreover, is preferably compound(s) selected from the group of compounds represented by formulae (N-3-1.1) to (N-3-1.3).

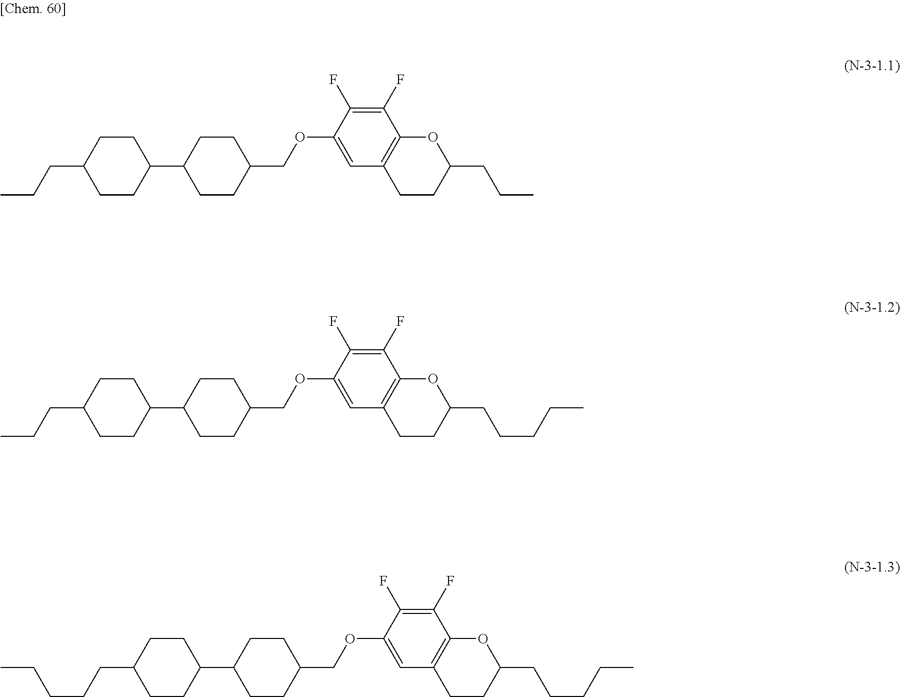

Examples of compounds represented by general formula (N-4) are the group of compounds represented by general formula (N-4-1) below.

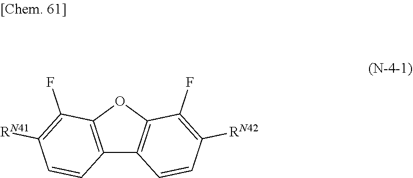

(where R^{N41} and R^{N42} each independently represent the same meaning as R^{N41} and R^{N42} in general formula (N-4).)

R^{N321} and R^{N322} are preferably C1-5 alkyl or C2-5 alkoxy groups, preferably propyl, pentyl, ethoxy, propoxy, or butoxy groups.

The compounds represented by general formula (N-4-1) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If improving Δε is a high priority, it is preferred to set the percentage of the compound(s) relatively high. If solubility at low temperatures is a high priority, setting the percentage relatively large is highly effective. If T_{NI} is a high priority, setting the percentage relatively small is highly effective. To improve drop marks or image-sticking properties, it is preferred to set the range of percentages to a medium range.

The lower limit of preferred percentages of the compound(s) represented by formula (N-4-1) to the total amount of the liquid crystal composition (B) is 1% by mass, 3% by mass, 5% by mass, 10% by mass, 13% by mass, 15% by mass, 17% by mass, 20% by mass, 23% by mass, 25% by mass, 27% by mass, 30% by mass, 33% by mass, or 35% by mass. The upper limit of preferred percentages is 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, or 5% by mass of the total amount of the liquid crystal composition (B).

The compound(s) represented by general formula (N-4-1), moreover, is preferably compound(s) selected from the group of compounds represented by formulae (N-4-1.1) to (N-4-1.6)

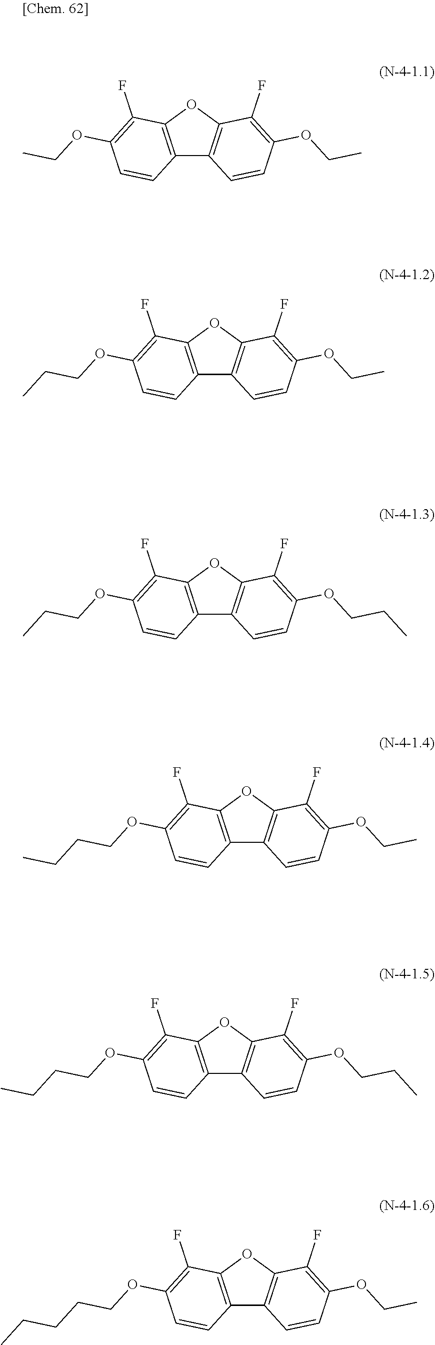

Among general formulae (N-1) to (N-4) specified above, the compounds represented by general formula (N-1) are particularly preferred because when irradiated with active energy radiation to form polymer networks and a liquid crystal phase, they are highly resistant to the active energy radiation.

Next, a liquid crystal composition (B) having a positive dielectric constant anisotropy preferably contains one or two or more compounds represented by general formula (J). These compounds are dielectrically positive compounds (Δε is larger than 2.)

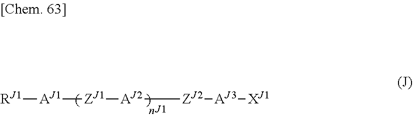

(where R^{J1} represents a C1-8 alkyl group, and one —CH₂— in the alkyl group, or each of nonadjacent two or more independently, may be substituted with —CH═CH—, —C═C—, —O—, —CO—, —COO—, or —OCO—,

n^{J1} represents 0, 1, 2, 3, or 4,

A^{J1}, A^{J2}, and A^{J3} each independently represent a group selected from the group consisting of:

(a) a 1,4-cyclohexylene group (One —CH₂— or two or more nonadjacent —CH₂— present in this group may be substituted with —O—.);

(b) a 1,4-phenylene group (One —CH═ or two or more nonadjacent —CH=present in this group may be substituted with —N═.); and

(c) a naphthalen-2,6-diyl, 1,2,3,4-tetrahydronaphthalen-2,6-diyl, or decahydronaphthalen-2,6-diyl group (One —CH═ or two or more nonadjacent —CH=present in the naphthalen-2,6-diyl or 1,2,3,4-tetrahydronaphthalen-2,6-diyl group may be substituted with —N═.),

the groups (a), (b), and (c) may each independently be substituted with a cyano group, a fluorine atom, a chlorine atom, a methyl group, a trifluoromethyl group, or a trifluoromethoxy group,

Z^{J1} and Z^{J2} each independently represent a single bond, —CH₂CH₂—, —(CH₂)₄—, —OCH₂—, —CH₂O—, —OCF₂—, —CF₂O—, —COO—, —OCO—, or —C═C—,

if n^{J1} is 2, 3, or 4 and there are multiple A^{J2}s, they may be the same or different, and if n^{J1} is 2, 3, or 4 and there are multiple Z^{J1}s, they may be the same or different, and

X^{J1} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.)

In general formula (J), R^{J1} is preferably a C1-8 alkyl, C1-8 alkoxy, C2-8 alkenyl, or C2-8 alkenyloxy group, preferably a C1-5 alkyl, C1-5 alkoxy, C2-5 alkenyl, or C2-5 alkenyloxy group, more preferably a C1-5 alkyl or C2-5 alkenyl group, more preferably a C2-5 alkyl or C2-3 alkenyl group, in particular a C3 alkenyl group (propenyl group).

If reliability is a high priority, R^{J1} is preferably an alkyl group. If reducing viscosity is a high priority, R^{J1} is preferably an alkenyl group.

If the ring structure to which the group is bound is a phenyl group (aromatic), linear C1-5 alkyl, linear C1-4 alkoxy, and C4-5 alkenyl groups are preferred. If the ring structure to which the group is bound is a saturated ring structure, such as cyclohexane, pyran, or dioxane, linear C1-5 alkyl, linear C1-4 alkoxy, and linear C2-5 alkenyl groups are preferred. To stabilize the nematic phase, it is preferred that the total number of carbon and oxygen, if present, atoms be 5 or less, preferably with the group being linear.

An alkenyl group is preferably selected from the groups represented by any of formulae (R1) to (R5). (The black dot in the formulae represents a carbon atom in the ring structure to which the alkenyl group is bound.)

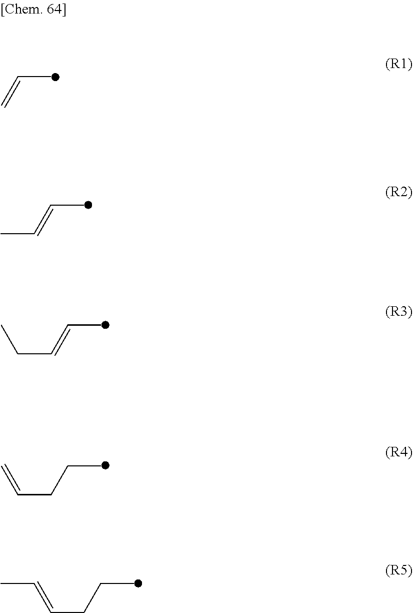

If Δn needs to be large, each of A^{J1}, A^{J2}, and A^{J3} is preferably independently an aromatic structural unit. To improve the response rate, it is preferred that each of these groups be independently an aliphatic structural unit, preferably a trans-1,4-cyclohexylene, 1,4-phenylene, 1,4-cyclohexenylene, 1,4-bicyclo[2.2.2]octylene, piperidin-1,4-diyl, naphthalen-2,6-diyl, decahydronaphthalen-2,6-diyl, or 1,2,3,4-tetrahydronaphthalen-2,6-diyl, other group having a tetrahydrofuran or dioxane structure represented by the structural formulae below,

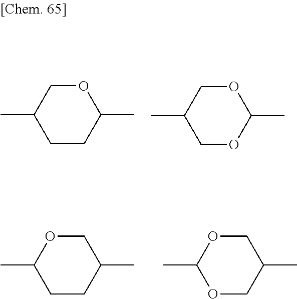

or structure resulting from substituting hydrogen atom(s) in these structures with a fluorine atom.

Among these, the groups having an alicyclic structure are particularly preferred because they are useful if the manufacturer wants to reduce Δn and helps lower viscosity, and the aromatic ones are useful if the manufacturer wants to increase Δn. In this light, the groups that are represented by the following structures

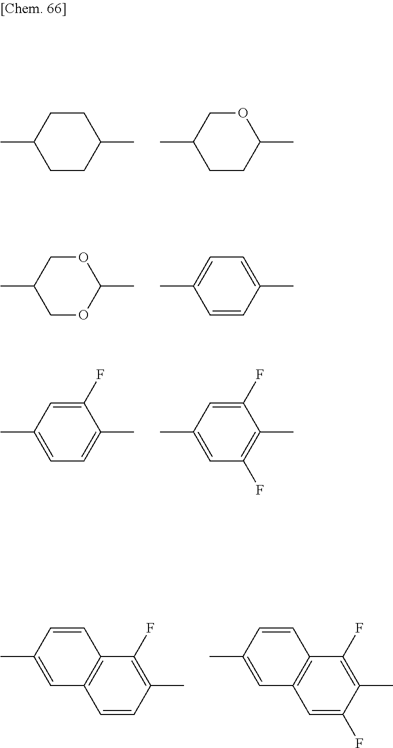

are particularly preferred.

Z^{J1} and Z^{J2} each preferably independently represent —CH₂O—, —OCH₂—, —CF₂O—, —CH₂CH₂—, —CF₂CF₂—, or a single bond, more preferably —OCH₂—, —CF₂O—, —CH₂CH₂—, or a single bond, in particular —OCH₂—, —CF₂O—, or a single bond.

X^{J1} is preferably a fluorine atom or trifluoromethoxy group, preferably a fluorine atom.

n^{J1} is preferably 0, 1, 2, or 3, preferably 0, 1, or 2. If emphasis is on improving Δε, n^{J1} is preferably 0 or 1. If Tni is a high priority, n^{J1} is preferably 1 or 2.

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three as an embodiment according to the present invention by way of example, or is four, five, six, or seven or more in another embodiment according to the present invention.

In the liquid crystal composition (B), the percentage of the compound(s) represented by general formula (J) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (J) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is, in an embodiment according to the present invention by way of example, 95% by mass, 85% by mass, 75% by mass, 65% by mass, 55% by mass, 45% by mass, 35% by mass, or 25% by mass of the total amount of the liquid crystal composition (B).

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

If reliability is a high priority, R^{J1} is preferably an alkyl group. If reducing viscosity is a high priority, R^{J1} is preferably an alkenyl group.

Preferred compounds represented by general formula (J) are the compounds represented by general formula (M) and the compounds represented by general formula (K).

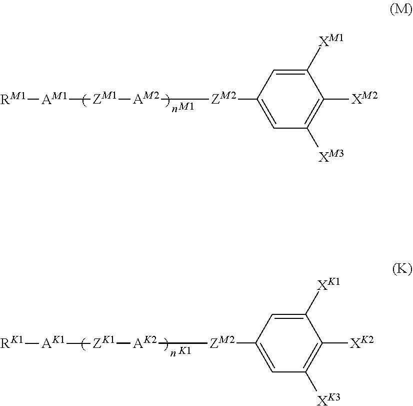

A liquid crystal composition having a positive dielectric constant anisotropy preferably contains one or two or more compounds represented by general formula (M). These compounds are dielectrically positive compounds (Δε is larger than 2.)

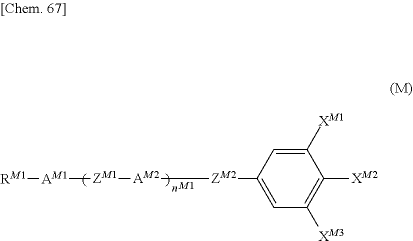

(where R^{M1} represents a C1-8 alkyl group, and one —CH₂— in the alkyl group, or each of two or more nonadjacent —CH₂— independently, may be substituted with —CH═CH—, —C═C—, —O—, —CO—, —COO—, or —OCO—,

n^{M1} represents 0, 1, 2, 3, or 4,

A^{M1} and A^{M2} each independently represent a group selected from the group consisting of:

(a) a 1,4-cyclohexylene group (One —CH₂— or two or more nonadjacent —CH₂— present in this group may be substituted with —O— or —S—.); and

(b) a 1,4-phenylene group (One —CH═ or two or more nonadjacent —CH=present in this group may be substituted with —N═.),

the hydrogen atoms on the groups (a) and (b) may each independently be substituted with a cyano group, a fluorine atom, or a chlorine atom,

Z^{M1} and Z^{M2} each independently represent a single bond, —CH₂CH₂—, —(CH₂)₄—, —OCH₂—, —CH₂O—, —OCF₂—, —CF₂O—, —COO—, —OCO—, or —C═C—,

if n^{M1} is 2, 3, or 4 and there are multiple A^{M2}s, they may be the same or different, and if n^{M1} is 2, 3, or 4 and there are multiple Z^{M1}s, they may be the same or different,

X^{M1} and X^{M3} each independently represent a hydrogen, chlorine, or fluorine atom, and

X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.)

In general formula (M), R^{M1} is preferably a C1-8 alkyl, C1-8 alkoxy, C2-8 alkenyl, or C2-8 alkenyloxy group, preferably a C1-5 alkyl, C1-5 alkoxy, C2-5 alkenyl, or C2-5 alkenyloxy group, more preferably a C1-5 alkyl or C2-5 alkenyl group, more preferably a C2-5 alkyl or C2-3 alkenyl group, in particular a C3 alkenyl group (propenyl group).

If reliability is a high priority, R^{M1} is preferably an alkyl group. If reducing viscosity is a high priority, R^{M1} is preferably an alkenyl group.

If the ring structure to which the group is bound is a phenyl group (aromatic), linear C1-5 alkyl, linear C1-4 alkoxy, and C4-5 alkenyl groups are preferred. If the ring structure to which the group is bound is a saturated ring structure, such as cyclohexane, pyran, or dioxane, linear C1-5 alkyl, linear C1-4 alkoxy, and linear C2-5 alkenyl groups are preferred. To stabilize the nematic phase, it is preferred that the total number of carbon and oxygen, if present, atoms be 5 or less, preferably with the group being linear.

An alkenyl group is preferably selected from the groups represented by any of formulae (R1) to (R5). (The black dot in the formulae represents a carbon atom in the ring structure to which the alkenyl group is bound.)

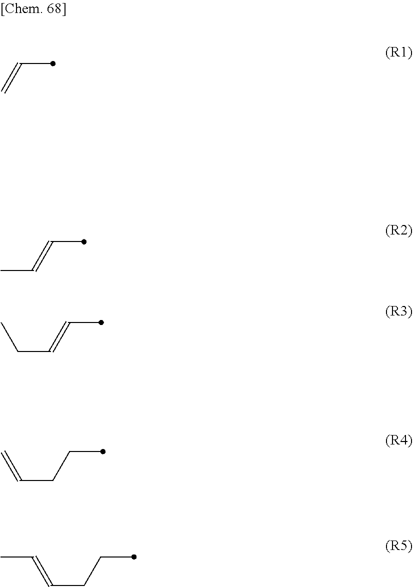

If Δn needs to be large, each of A^{M1} and A^{M2} is preferably independently an aromatic moiety. To improve the response rate, it is preferred that each of these groups be independently an aliphatic structural unit, preferably a trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidin-1,4-diyl, naphthalen-2,6-diyl, decahydronaphthalen-2,6-diyl, or 1,2,3,4-tetrahydronaphthalen-2,6-diyl, more preferably represent a structure given below,

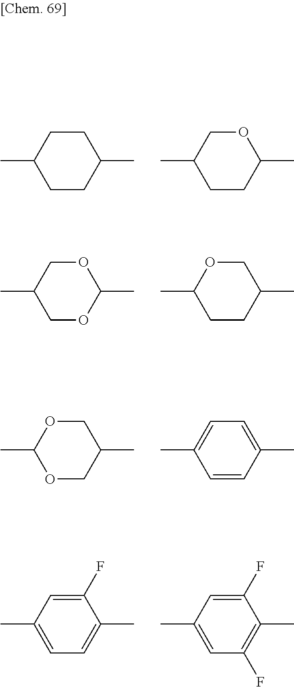

and more preferably represent a structure given below.

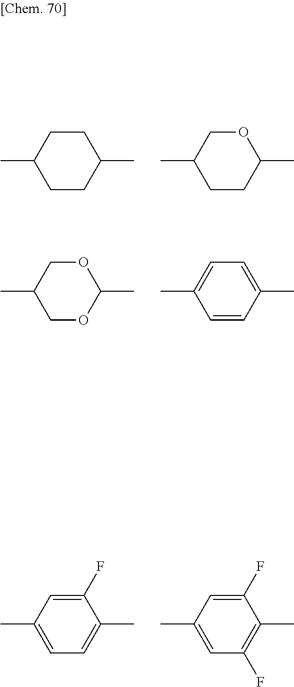

Z^{M1} and Z^{M2} each preferably independently represent —CH₂O—, —CF₂O—, —CH₂CH₂—, —CF₂CF₂—, or a single bond, more preferably —CF₂O—, —CH₂CH₂—, or a single bond, in particular —CF₂O— or a single bond.

n^{M1} is preferably 0, 1, 2, or 3, preferably 0, 1, or 2. If emphasis is on improving Δε, n^{M1} is preferably 0 or 1. If Tni is a high priority, n^{M1} is preferably 1 or 2.

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three as an embodiment according to the present invention by way of example, or is four, five, six, or seven or more in another embodiment according to the present invention.

In the liquid crystal composition (B), the percentage of the compound(s) represented by general formula (M) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (M) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is, in an embodiment according to the present invention by way of example, 95% by mass, 85% by mass, 75% by mass, 65% by mass, 55% by mass, 45% by mass, 35% by mass, or 25% by mass of the total amount of the liquid crystal composition (B).

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (M) is preferably compound(s) selected from, for example, the group of compounds represented by general formula (M-1).

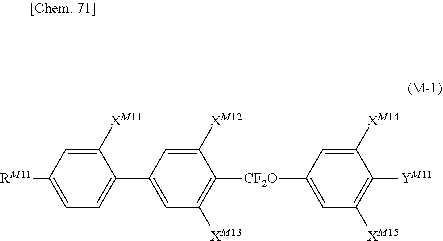

(where R^{M11} represents a C1-5 alkyl, C2-5 alkenyl, or C1-4 alkoxy group, X^{M11} to X^{M15} each independently represent a hydrogen or fluorine atom, and Y^{M11} represents a fluorine atom or OCF₃.)

Any two or more such compounds can be combined, but compounds selected in accordance with the desired performance attributes, such as solubility at low temperatures, transition temperature, electrical reliability, and birefringence, are used. The number of kinds of compounds used is one, two, or three or more as an embodiment according to the present invention by way of example.

The lower limit of preferred percentages of the compound(s) represented by formula (M-1) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (M-1), moreover, is preferably compound(s) represented by formulae (M-1.1) to (M-1.4), preferably the compound represented by formula (M-1.1) or (M-1.2), more preferably the compound represented by formula (M-1.2), to be specific. It is also preferred to use the compounds represented by formula (M-1.1) or (M-1.2) together.

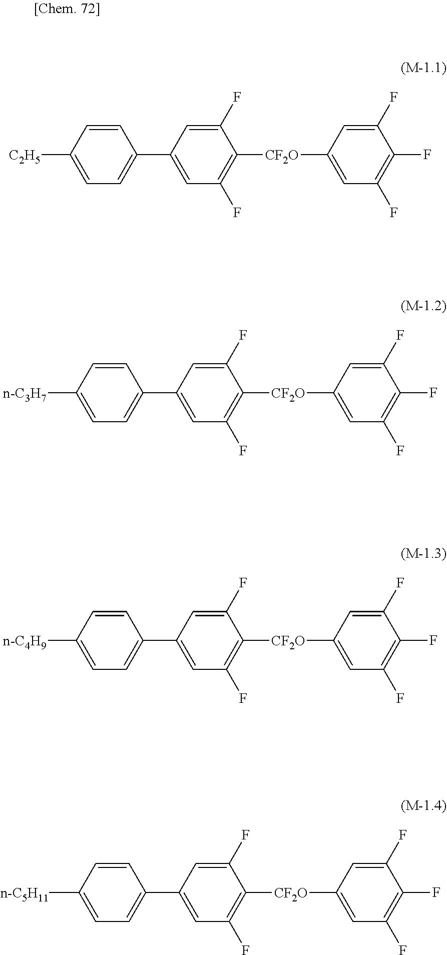

The lower limit of preferred percentages of the compound represented by formula (M-1.1) to the total amount of the liquid crystal composition (B) is 1% by mass, 2% by mass, 5% by mass, or 6% by mass. The upper limit of preferred percentages is 15% by mass, 13% by mass, 10% by mass, 8% by mass, or 5% by mass.

The lower limit of preferred percentages of the compound represented by formula (M-1.2) to the total amount of the liquid crystal composition (B) is 1% by mass, 2% by mass, 5% by mass, or 6% by mass. The upper limit of preferred percentages is 30% by mass, 25% by mass, 23% by mass, 20% by mass, 18% by mass, 15% by mass, 13% by mass, 10% by mass, or 8% by mass.

The lower limit of preferred total percentages of the compounds represented by formulae (M-1.1) and (M-1.2) to the total amount of the liquid crystal composition (B) is 1% by mass, 2% by mass, 5% by mass, or 6% by mass. The upper limit of preferred percentages is 30% by mass, 25% by mass, 23% by mass, 20% by mass, 18% by mass, 15% by mass, 13% by mass, 10% by mass, or 8% by mass.

The compound(s) represented by general formula (M), moreover, is preferably compound(s) selected from, for example, the group of compounds represented by general formula (M-2).

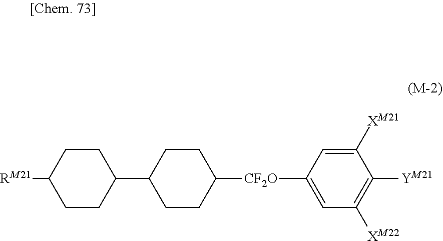

(where R^{M21} represents a C1-5 alkyl, C2-5 alkenyl, or C1-4 alkoxy group, X^{M21} and X^{M22} each independently represent a hydrogen or fluorine atom, and Y^{M21} represents a fluorine atom, a chlorine atom, or OCF₃.)

The lower limit of preferred percentages of the compound(s) represented by formula (M-1) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs a composition with less image sticking by keeping the Tni of the liquid crystal composition (B), it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (M-2), moreover, is preferably compound(s) represented by formulae (M-2.1) to (M-2.5), preferably the compound(s) represented by formula (M-2.3) and/or formula (M-2.5).

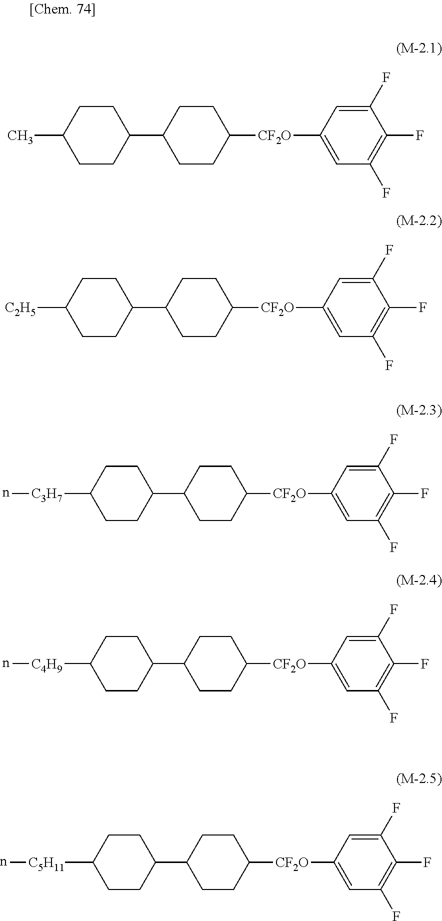

The lower limit of preferred percentages of the compound represented by formula (M-2.2) to the total amount of the liquid crystal composition (B) is 1% by mass, 2% by mass, 5% by mass, or 6% by mass. The upper limit of preferred percentages is 15% by mass, 13% by mass, 10% by mass, 8% by mass, or 5% by mass.

The lower limit of preferred percentages of the compound represented by formula (M-2.3) to the total amount of the liquid crystal composition (B) is 1% by mass, 2% by mass, 5% by mass, or 6% by mass. The upper limit of preferred percentages is 30% by mass, 25% by mass, 23% by mass, 20% by mass, 18% by mass, 15% by mass, 13% by mass, 10% by mass, or 8% by mass.

The lower limit of preferred percentages of the compound represented by formula (M-2.5) to the total amount of the liquid crystal composition (B) is 1% by mass, 2% by mass, 5% by mass, or 6% by mass. The upper limit of preferred percentages is 30% by mass, 25% by mass, 23% by mass, 20% by mass, 18% by mass, 15% by mass, 13% by mass, 10% by mass, or 8% by mass.

The lower limit of preferred total percentages of the compounds represented by formulae (M-2.2), (M-2.3), and (M-2.5) to the total amount of the liquid crystal composition (B) is 1% by mass, 2% by mass, 5% by mass, or 6% by mass. The upper limit of preferred percentages is 30% by mass, 25% by mass, 23% by mass, 20% by mass, 18% by mass, 15% by mass, 13% by mass, 10% by mass, or 8% by mass.

The percentage is preferably 1% by mass or more, more preferably 5% by mass or more, even more preferably 8% by mass or more, more preferably 10% by mass or more, more preferably 14% by mass or more, in particular 16% by mass or more of the total amount of the liquid crystal composition (B). It is preferred to limit the maximum proportion to 30% by mass or less, more preferably 25% by mass or less, even more preferably 22% by mass or less, in particular less than 20% by mass considering, for example, solubility at low temperatures, transition temperature, and electrical reliability.

The compound(s) of general formula (M) used in the liquid crystal composition (B) is preferably compound(s) represented by general formula (M-3).

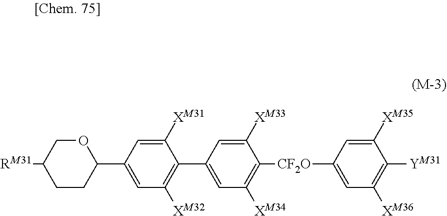

(where R^{M31} represents a C1-5 alkyl, C2-5 alkenyl, or C1-4 alkoxy group, X^{M31} to X^{M36} each independently represent a hydrogen or fluorine atom, and Y^{M31} represents a fluorine atom, a chlorine atom, or OCF₃.)

Any two or more such compounds can be combined, but it is preferred to combine one to two or more considering, for example, solubility at low temperatures, transition temperature, electrical reliability, and birefringence.

The percentage of the compound(s) represented by general formula (M-3) has upper and lower limits that vary from embodiment to embodiment in accordance with desired solubility at low temperatures, transition temperature, electrical reliability, birefringence, and other characteristics.

The lower limit of preferred percentages of the compound(s) represented by formula (M-3) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 20% by mass, 18% by mass, 15% by mass, 13% by mass, 10% by mass, 8% by mass, or 5% by mass.

The compound(s) of general formula (M-3) used in the liquid crystal composition (B), moreover, is preferably compound(s) represented by formulae (M-3.1) to (M-3.8), to be specific. In particular, it is preferred that the liquid crystal composition (B) contain the compound(s) represented by formula (M-3.1) and/or formula (M-3.2).

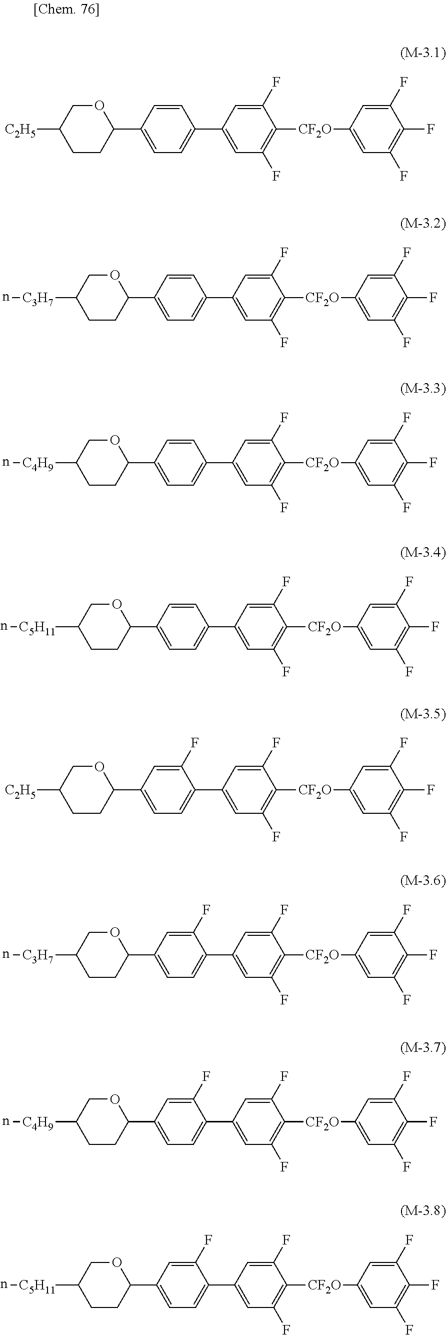

The lower limit of preferred percentages of the compound represented by formula (M-3.1) to the total amount of the liquid crystal composition (B) is 1% by mass, 2% by of the liquid crystal composition (B) is 1% by mass, 20 by mass, 4% by mass, 5% by mass, 8% by mass, 10% by mass, 13% by mass, 15% by mass, 18% by mass, or 20% by mass. The upper limit of preferred percentages is 20% by mass, 18% by mass, 15% by mass, 13% by mass, 10% by mass, 8% by mass, or 5% by mass.

The lower limit of preferred percentages of the compound represented by formula (M-3.2) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 20% by mass, 18% by mass, 15% by mass, 13% by mass, 10% by mass, 8% by mass, or 5% by mass.

The lower limit of preferred total percentages of the compounds represented by formulae (M-3.1) and (M-3.2) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 20% by mass, 18% by mass, 15% by mass, 13% by mass, 10% by mass, 8% by mass, or 5% by mass.

The compound(s) represented by general formula (M), moreover, is preferably compound(s) selected from the group of compounds represented by general formula (M-4).

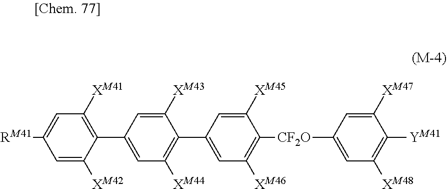

(where R^{M41} represents a C1-5 alkyl, C2-5 alkenyl, or C1-4 alkoxy group, X^{M41} to X^{M48} each independently represent a fluorine or hydrogen atom, and Y^{M41} represents a fluorine atom, a chlorine atom, or OCF₃.)

Any two or more such compounds can be combined, but it is preferred to combine one, two, or three or more considering, for example, solubility at low temperatures, transition temperature, electrical reliability, and birefringence.

The percentage of the compound(s) represented by general formula (M-4) has upper and lower limits that vary from embodiment to embodiment in accordance with desired solubility at low temperatures, transition temperature, electrical reliability, birefringence, and other characteristics.

The lower limit of preferred percentages of the compound(s) represented by formula (M-4) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the liquid crystal composition (B) is used for liquid crystal display elements with a small cell gap, it is appropriate to set the percentage of the compound(s) represented by general formula (M-4) relatively large. If the liquid crystal composition (B) is used for liquid crystal display elements with a small drive voltage, it is appropriate to set the percentage of the compound(s) represented by general formula (M-4) relatively large. If the liquid crystal composition (B) is used for liquid crystal display elements that will be used in cold environments, it is appropriate to set the percentage of the compound(s) represented by general formula (M-4) relatively small. If the liquid crystal composition (B) is a composition for fast response liquid crystal display elements, it is appropriate to set the percentage of the compound(s) represented by general formula (M-4) relatively small.

The compound(s) of general formula (M-4) used in the liquid crystal composition (B), moreover, is preferably compound(s) represented by formulae (M-4.1) to (M-4.4), to be specific. In particular, it is preferred that the liquid crystal composition (B) contain compound(s) represented by formulae (M-4.2) to (M-4.4), more preferably the compound represented by formula (M-4.2).

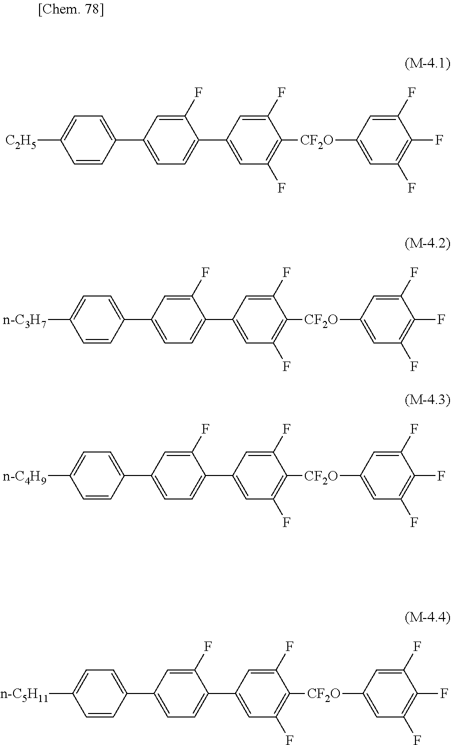

The compound(s) represented by general formula (M), moreover, is preferably compound(s) selected from the group of compounds represented by general formula (M-5).

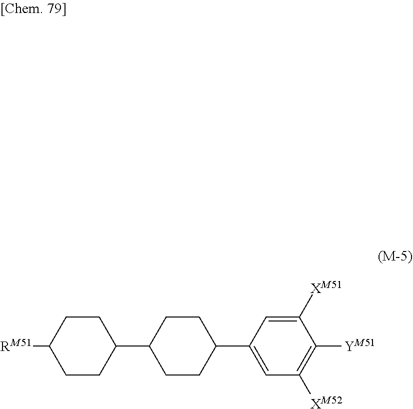

(where R^{M51} represents a C1-5 alkyl, C2-5 alkenyl, or C1-4 alkoxy group, X^{M51} and X^{M52} each independently represent a hydrogen or fluorine atom, and Y^{M51} represents a fluorine atom, a chlorine atom, or OCF₃.)

Any two or more such compounds can be combined, but compounds that are needed in the particular embodiment are combined considering, for example, solubility at low temperatures, transition temperature, electrical reliability, and birefringence. For example, in an embodiment according to the present invention, one compound is used. Two are combined in another embodiment, three in yet another embodiment, four in still another embodiment, five in still another embodiment, and six or more in still another embodiment.

The lower limit of preferred percentages of the compound(s) represented by formula (M-5) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 50% by mass, 45% by mass, 40% by mass, 35% by mass, 33% by mass, 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs a composition with less image sticking by keeping the Tni of the liquid crystal composition (B), it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (M-5), moreover, is preferably compound(s) represented by formulae (M-5.1) to (M-5.4), preferably compound(s) represented by formulae (M-5.1) to (M-5.4).

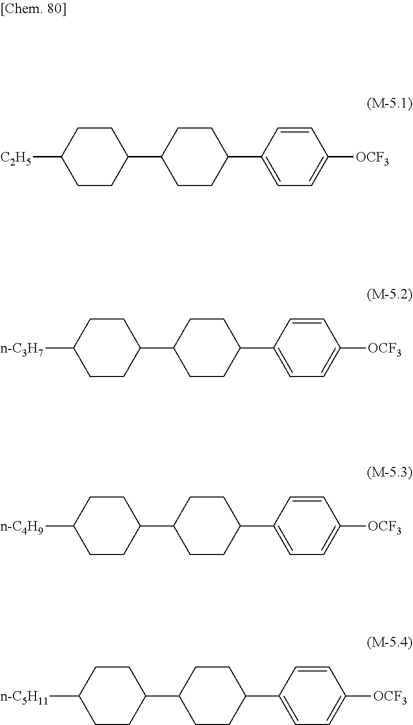

The lower limit of preferred percentages of these compounds to the total amount of the liquid crystal composition (B) is 1% by mass, 2% by mass, 5% by mass, 8% by mass, 10% by mass, 13% by mass, or 15% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-5), moreover, is preferably compound(s) represented by formulae (M-5.11) to (M-5.17), preferably compound(s) represented by formulae (M-5.11), (M-5.13), and (M-5.17).

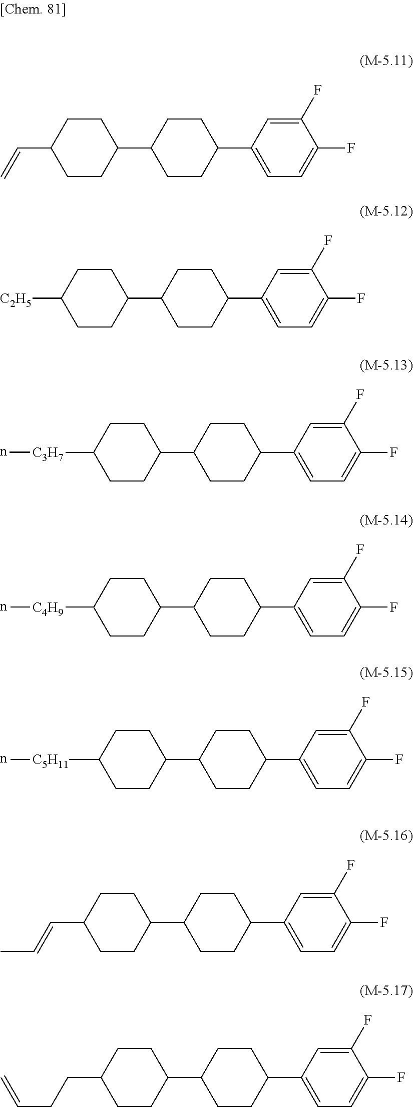

The lower limit of preferred percentages of these compounds to the total amount of the liquid crystal composition (B) is 1% by mass, 2% by mass, 5% by mass, 8% by mass, 10% by mass, 13% by mass, or 15% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-5), moreover, is preferably compound(s) represented by formulae (M-5.21) to (M-5.28), preferably compound(s) represented by formulae (M-5.21), (M-5.22), (M-5.23), and (M-5.25).

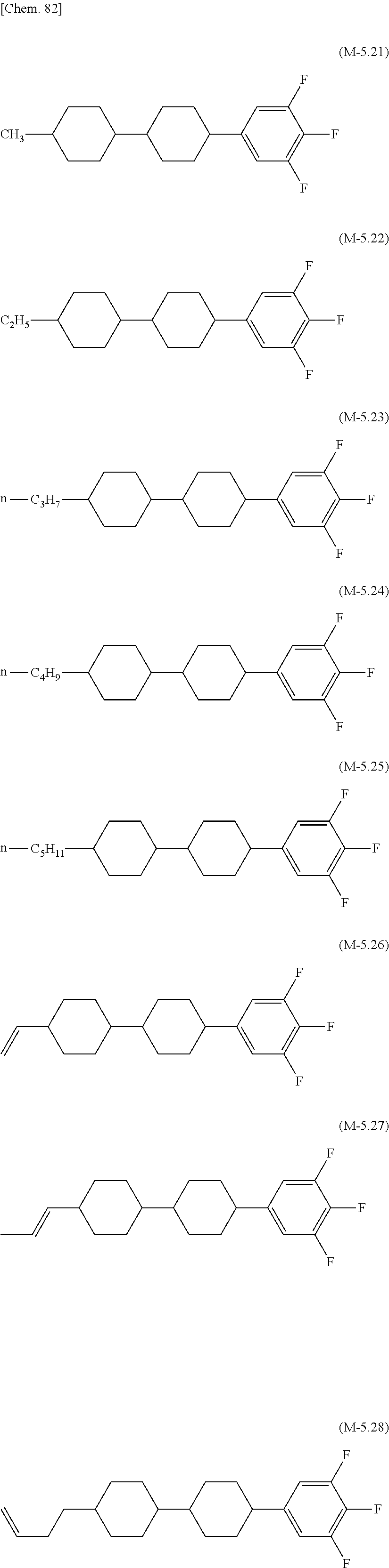

The lower limit of preferred percentages of these compounds to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 40% by mass, 35% by mass, 33% by mass, 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M), moreover, is preferably compound(s) selected from the group of compounds represented by general formula (M-6).

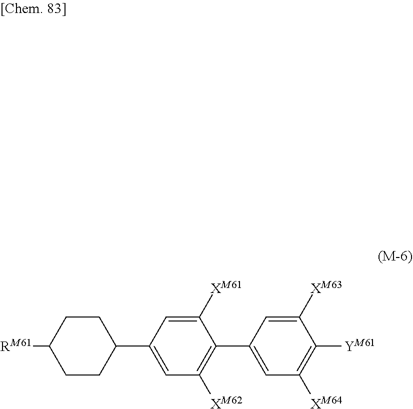

(where R^{M61} represents a C1-5 alkyl, C2-5 alkenyl, or C1-4 alkoxy group, X⁶¹ to X^{M64} each independently represent a fluorine or hydrogen atom, and Y^{M61} represents a fluorine atom, a chlorine atom, or OCF₃.)

Any two or more such compounds can be combined, but compounds that are needed in the particular embodiment are combined considering, for example, solubility at low temperatures, transition temperature, electrical reliability, and birefringence.

The lower limit of preferred percentages of the compound(s) represented by formula (M-6) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the liquid crystal composition (B) is used for liquid crystal display elements with a small drive voltage, it is appropriate to set the percentage of the compound(s) represented by general formula (M-6) relatively large. If the liquid crystal composition (B) is a composition for fast response liquid crystal display elements, it is appropriate to set the percentage of the compound(s) represented by general formula (M-6) relatively small.

The compound(s) represented by general formula (M-6), moreover, is preferably compound(s) represented by formulae (M-6.1) to (M-6.4), to be specific. In particular, it is preferred that the liquid crystal composition (B) contain compound(s) represented by formulae (M-6.2) and (M-6.4).

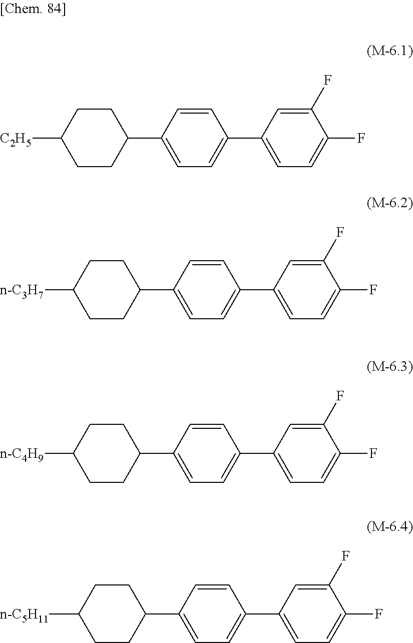

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-6), moreover, is preferably compound(s) represented by formulae (M-6.11) to (M-6.14), to be specific. In particular, it is preferred that the liquid crystal composition (B) contain compound(s) represented by formulae (M-6.12) and (M-6.14).

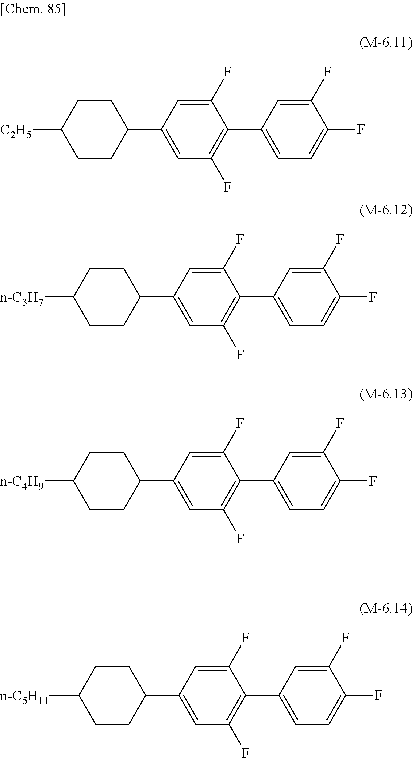

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-6), moreover, is preferably compound(s) represented by formulae (M-6.21) to (M-6.24), to be specific. In particular, it is preferred that the liquid crystal composition (B) contain compound(s) represented by formulae (M-6.21), (M-6.22), and (M-6.24).

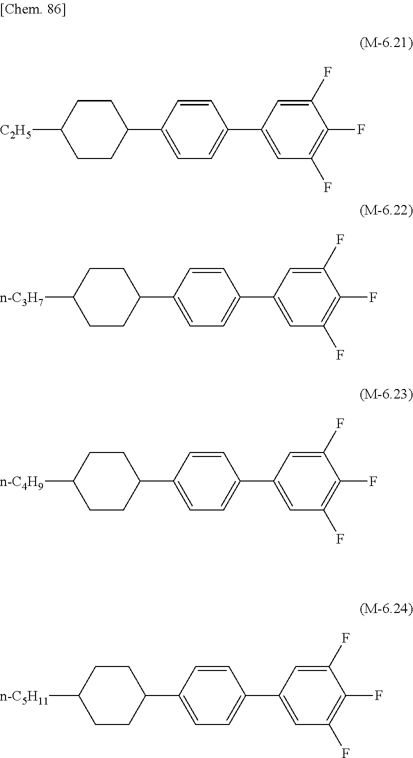

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-6), moreover, is preferably compound(s) represented by formulae (M-6.31) to (M-6.34), to be specific. In particular, it is preferred that the liquid crystal composition (B) contain compound(s) represented by formulae (M-6.31) and (M-6.32).

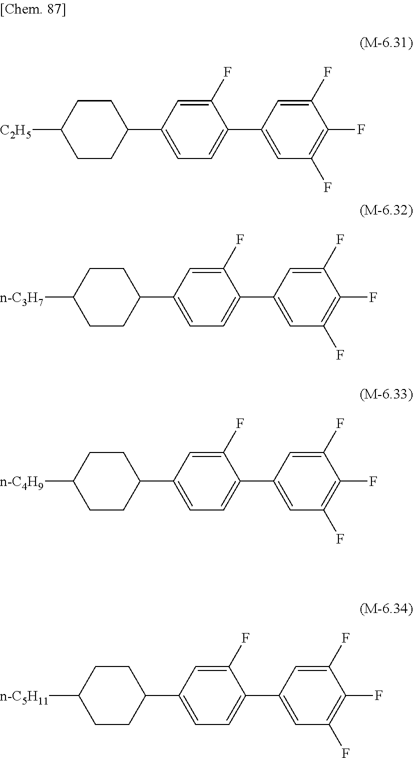

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-6), moreover, is preferably compound(s) represented by formulae (M-6.41) to (M-6.44), to be specific. In particular, it is preferred that the liquid crystal composition (B) contain the compound represented by formulae (M-6.42).

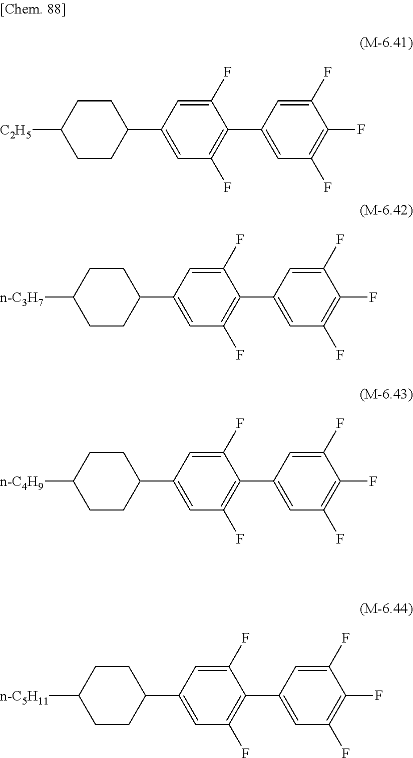

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M), moreover, is preferably compound(s) selected from the group of compounds represented by general formula (M-7).

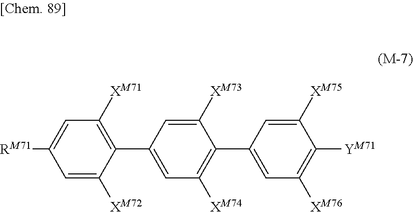

(where X^{M71} to X^{M76} each independently represent a fluorine or hydrogen atom, R^{M71} represents a C1-5 alkyl, C2-5 alkenyl, or C1-4 alkoxy group, and Y^{M71} represents a fluorine atom or OCF₃.)

Any two or more such compounds can be combined, but it is preferred that the liquid crystal composition (B) contain one or two of such compounds, more preferably one to three, even more preferably one to four.

The percentage of the compound(s) represented by general formula (M-7) has upper and lower limits that vary from embodiment to embodiment in accordance with desired solubility at low temperatures, transition temperature, electrical reliability, birefringence, and other characteristics.

The lower limit of preferred percentages of the compound(s) represented by formula (M-7) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the liquid crystal composition (B) is used for liquid crystal display elements with a small cell gap, it is appropriate to set the percentage of the compound(s) represented by general formula (M-7) relatively large. If the liquid crystal composition (B) is used for liquid crystal display elements with a small drive voltage, it is appropriate to set the percentage of the compound(s) represented by general formula (M-7) relatively large. If the liquid crystal composition (B) is used for liquid crystal display elements that will be used in cold environments, it is appropriate to set the percentage of the compound(s) represented by general formula (M-7) relatively small. If the liquid crystal composition (B) is a composition for fast response liquid crystal display elements, it is appropriate to set the percentage of the compound(s) represented by general formula (M-7) relatively small.

The compound(s) represented by general formula (M-7), moreover, is preferably compound(s) represented by formulae (M-7.1) to (M-7.4), preferably the compound represented by formulae (M-7.2).

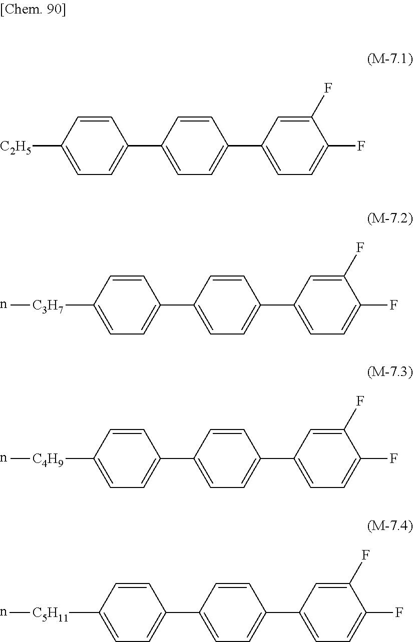

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-7), moreover, is preferably compound(s) represented by formulae (M-7.11) to (M-7.14), preferably compound(s) represented by formulae (M-7.11) and (M-7.12).

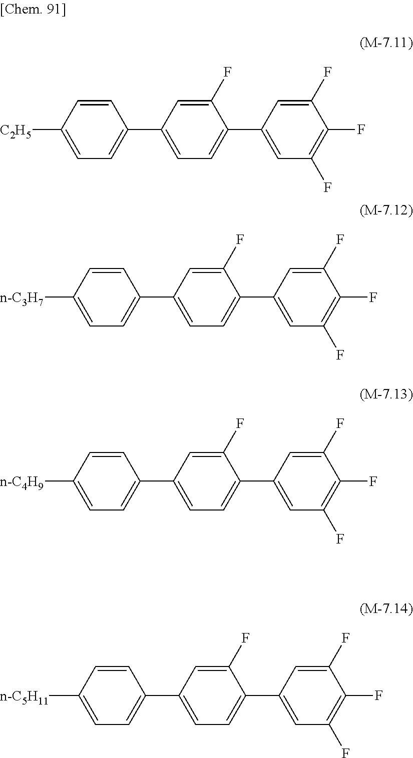

For these compounds, the lower limit of preferred percentages to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M-7), moreover, is preferably compound(s) represented by formulae (M-7.21) to (M-7.24), preferably compound(s) represented by formulae (M-7.21) and (M-7.22).

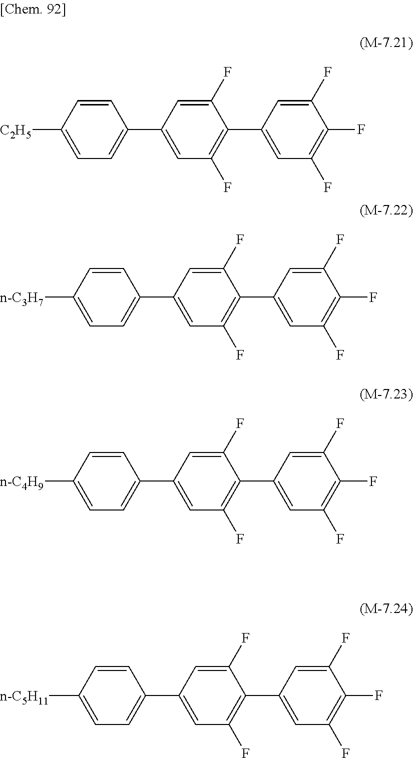

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M), moreover, is preferably compound(s) selected from the group of compounds represented by general formula (M-8)

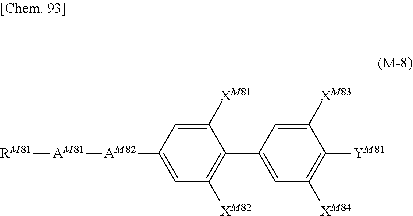

(where X^{M81} to X^{M84} each independently represent a fluorine or hydrogen atom, Y^{M81} represents a fluorine atom, a chlorine atom, or —OCF₃, R represents a C1-5 alkyl, C2-5 alkenyl, or C1-4 alkoxy group, and A^{M81} and A^{M82} each independently represent a 1,4-cyclohexylene group, 1,4-phenylene group, or the following,

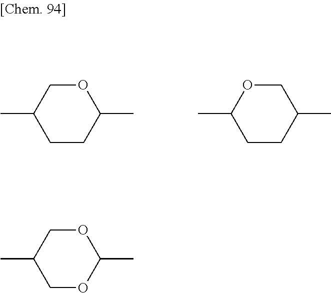

with the proviso that hydrogen atom(s) on a 1,4-phenylene group may be substituted with a fluorine atom.)

The lower limit of preferred percentages of the compound(s) represented by general formula (M-8) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-8) used in the liquid crystal composition (B), moreover, is preferably compound(s) represented by formulae (M-8.1) to (M-8.4), to be specific. In particular, it is preferred that the liquid crystal composition (B) contain compound(s) represented by formulae (M-8.1) and (M-8.2).

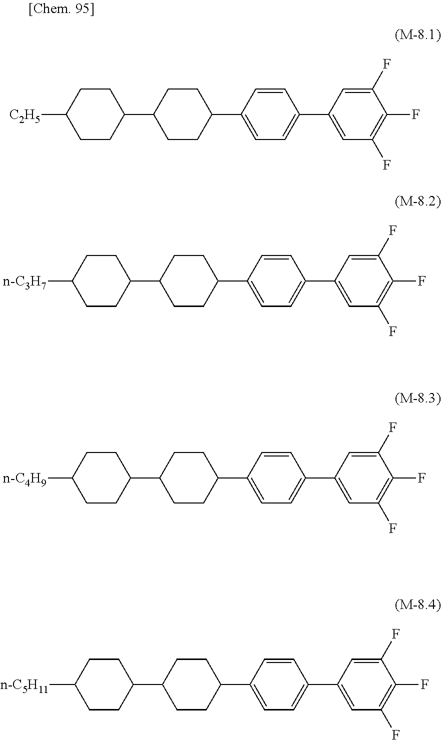

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) of general formula (M-8) used in the liquid crystal composition (B), moreover, is preferably compound(s) represented by formulae (M-8.11) to (M-8.14), to be specific. In particular, it is preferred that the liquid crystal composition (B) contain the compound represented by formula (M-8.12).

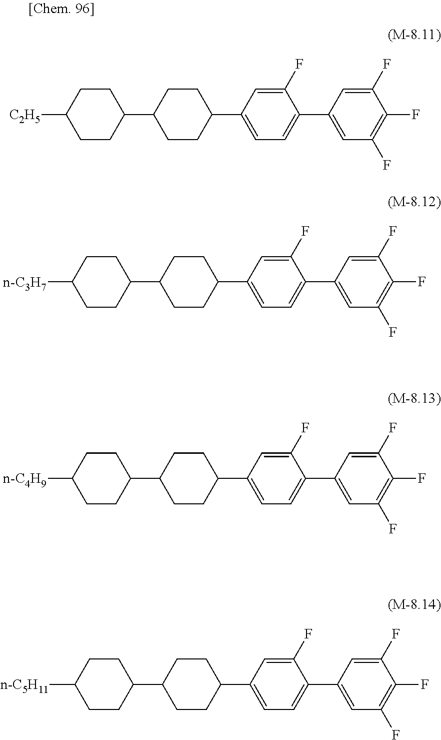

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) of general formula (M-8) used in the liquid crystal composition (B), moreover, is preferably compound(s) represented by formulae (M-8.21) to (M-8.24), to be specific. In particular, it is preferred that the liquid crystal composition (B) contain the compound represented by formula (M-8.22).

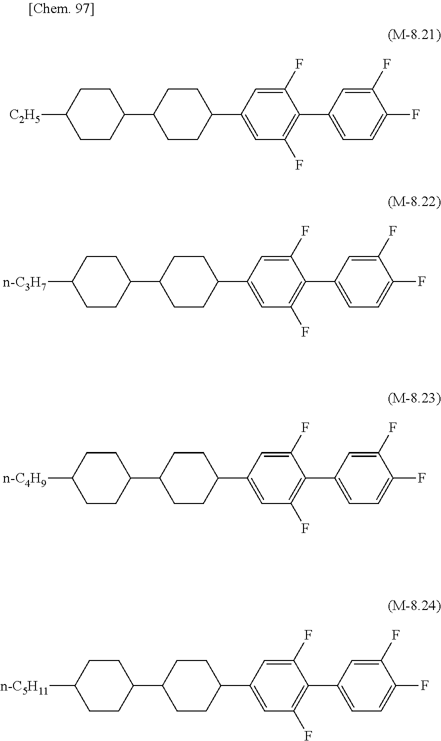

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) of general formula (M-8) used in the liquid crystal composition (B), moreover, is preferably compound(s) represented by formulae (M-8.31) to (M-8.34), to be specific. In particular, it is preferred that the liquid crystal composition (B) contain the compound represented by formula (M-8.32).

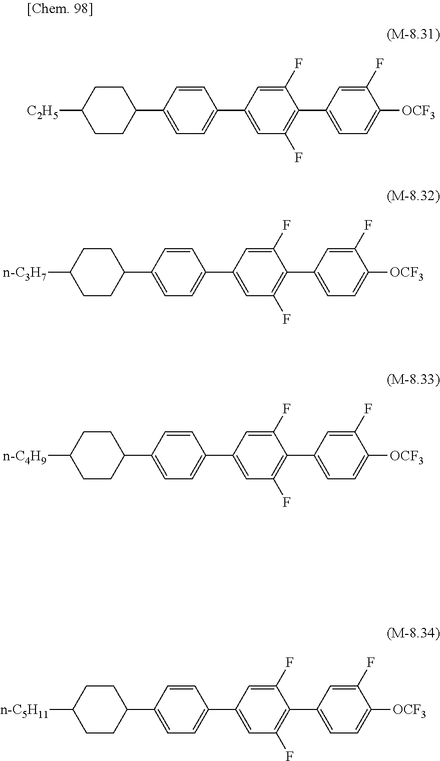

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) of general formula (M-8) used in the liquid crystal composition (B), moreover, is preferably compound(s) represented by formulae (M-8.41) to (M-8.44), to be specific. In particular, it is preferred that the liquid crystal composition (B) contain the compound represented by formula (M-8.42).

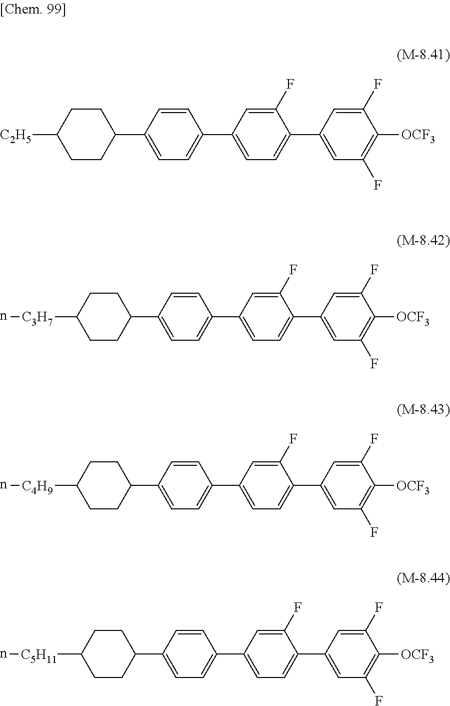

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) of general formula (M-8) used in the liquid crystal composition (B), moreover, is preferably compound(s) represented by formulae (M-8.51) to (M-8.54), to be specific. In particular, it is preferred that the liquid crystal composition (B) contain the compound represented by formula (M-8.52).

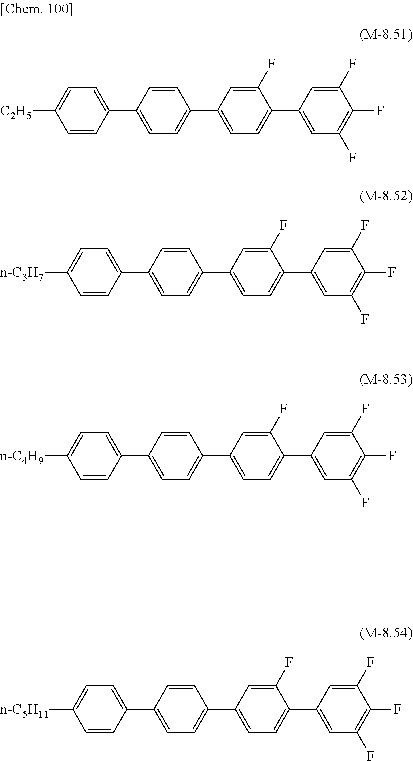

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (M), moreover, may have the following substructure in the structure thereof.

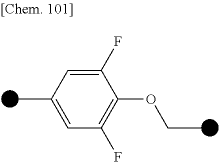

(The black dots in the formula represent carbon atoms in the ring structures to which the substructure is bound.)

Preferred compounds having this substructure are the compounds represented by general formulae (M-10) to (M-18).

The compounds represented by general formula (M-10) are as follows.

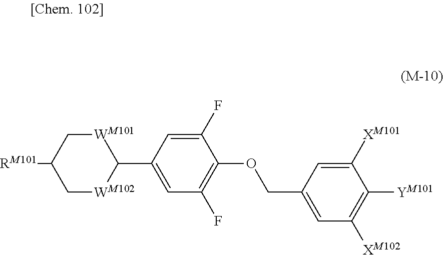

(where X^{M101} and X^{M102} each independently represent a fluorine or hydrogen atom, Y^{M101} represents a fluorine atom, a chlorine atom, or —OCF₃, R^{M101} represents a C1-5 alkyl, C2-5 alkenyl, or C1-4 alkoxy group, and W^{M101} and W^{M102} each independently represent —CH₂— or —O—.)

The lower limit of preferred percentages of the compound(s) represented by general formula (M-10) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-10) used in the liquid crystal composition (B), moreover, is preferably compound(s) represented by formulae (M-10.1) to (M-10.12), to be specific. In particular, it is preferred that the liquid crystal composition (B) contain compound(s) represented by formulae (M-10.5) and (M-10.12).

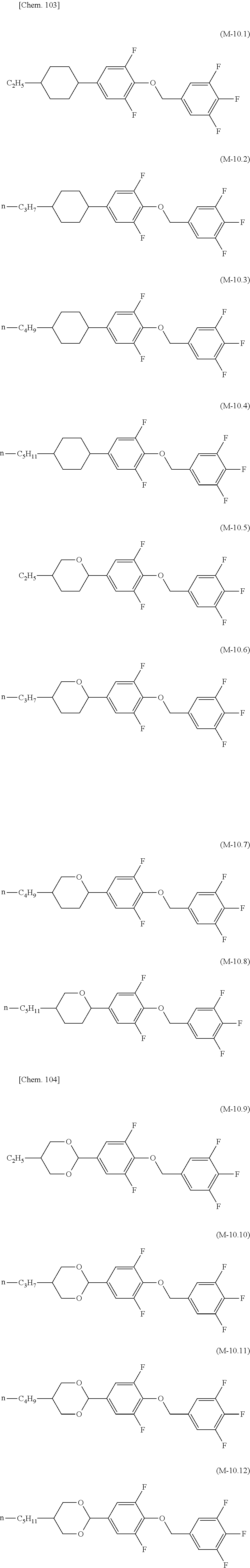

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-11) are as follows.

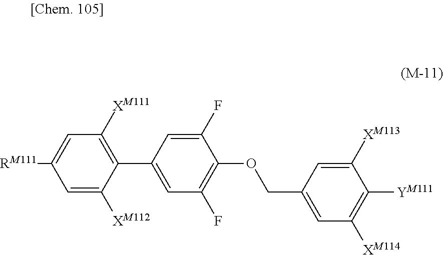

(where X^{M111} to X^{M114} each independently represent a fluorine or hydrogen atom, Y represents a fluorine atom, a chlorine atom, or —OCF₃, R^{M111} represents a C1-5 alkyl, C2-5 alkenyl, or C1-4 alkoxy group.)

The lower limit of preferred percentages of the compound(s) represented by formula (M-11) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-11) used in the liquid crystal composition (B), moreover, is preferably compound(s) represented by formulae (M-11.1) to (M-11.8), to be specific. In particular, it is preferred that the liquid crystal composition (B) contain compound(s) represented by formulae (M-11.1) to (M-11.4).

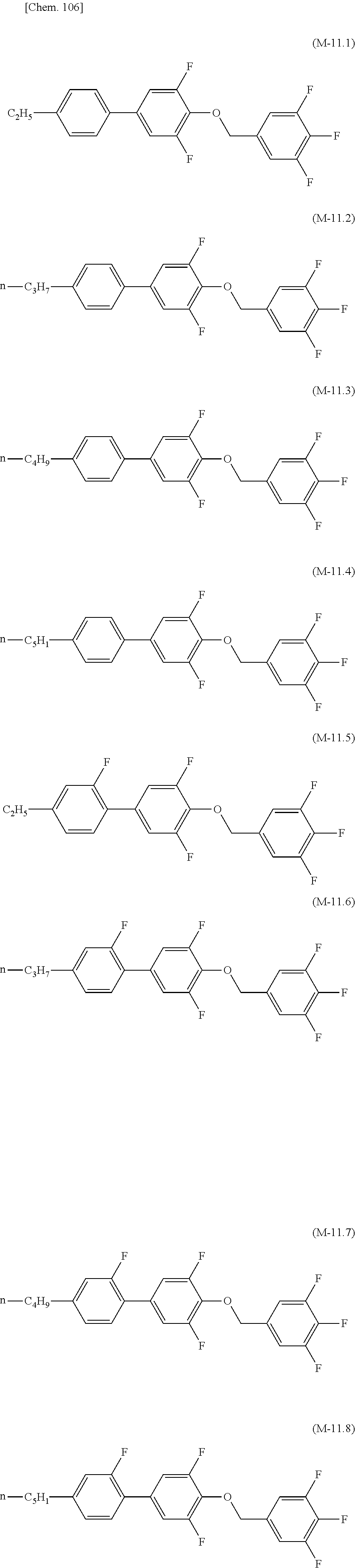

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-12) are as follows.

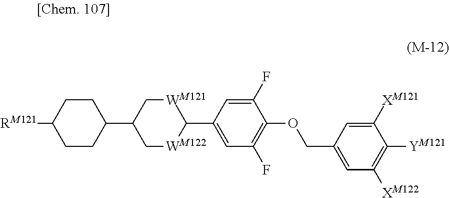

(where X^{M121} and X^{M122} each independently represent a fluorine or hydrogen atom, Y^{M121} represents a fluorine atom, a chlorine atom, or —OCF₃, R^{M121} represents a C1-5 alkyl, C2-5 alkenyl, or C1-4 alkoxy group, and W^{M121} and W^{M122} each independently represent —CH₂— or —O—.)

The lower limit of preferred percentages of the compound(s) represented by formula (M-12) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-12) used in the liquid crystal composition (B), moreover, is preferably compound(s) represented by formulae (M-12.1) to (M-12.12), to be specific. In particular, it is preferred that the liquid crystal composition (B) contain compound(s) represented by formulae (M-12.5) to (M-12.8).

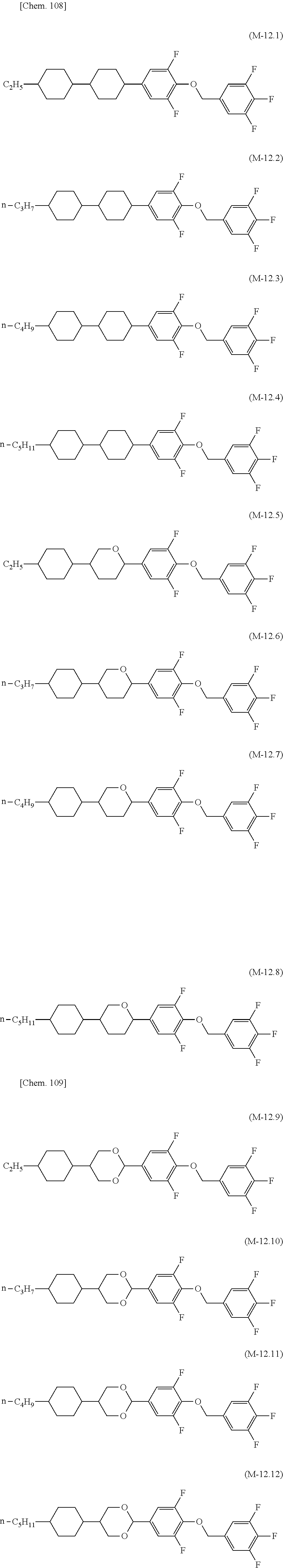

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-13) are as follows.

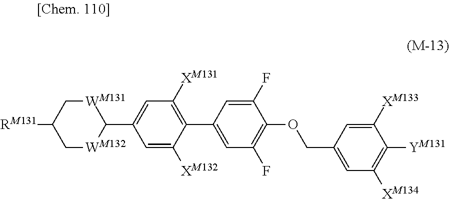

(where X^{M131} to X^{M134} each independently represent a fluorine or hydrogen atom, Y represents a fluorine atom, a chlorine atom, or —OCF₃, R^{M131} represents a C1-5 alkyl, C2-5 alkenyl, or C1-4 alkoxy group, and W^{M131} and W^{M132} each independently represent —CH₂— or —O—.)

The lower limit of preferred percentages of the compound(s) represented by formula (M-13) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-13) used in the liquid crystal composition (B), moreover, is preferably compound(s) represented by formulae (M-13.1) to (M-13.28), to be specific. In particular, it is preferred that the liquid crystal composition (B) contain compound(s) represented by formulae (M-13.1) to (M-13.4), (M-13.11) to (M-13.14), and (M-13.25) to (M-13.28)

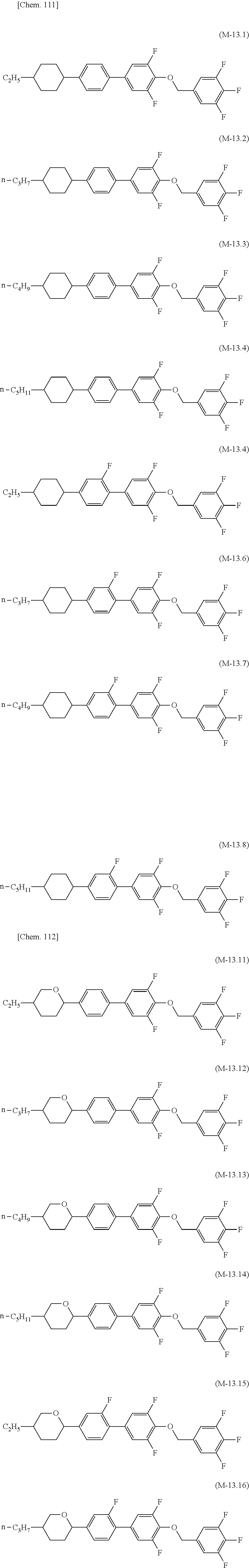

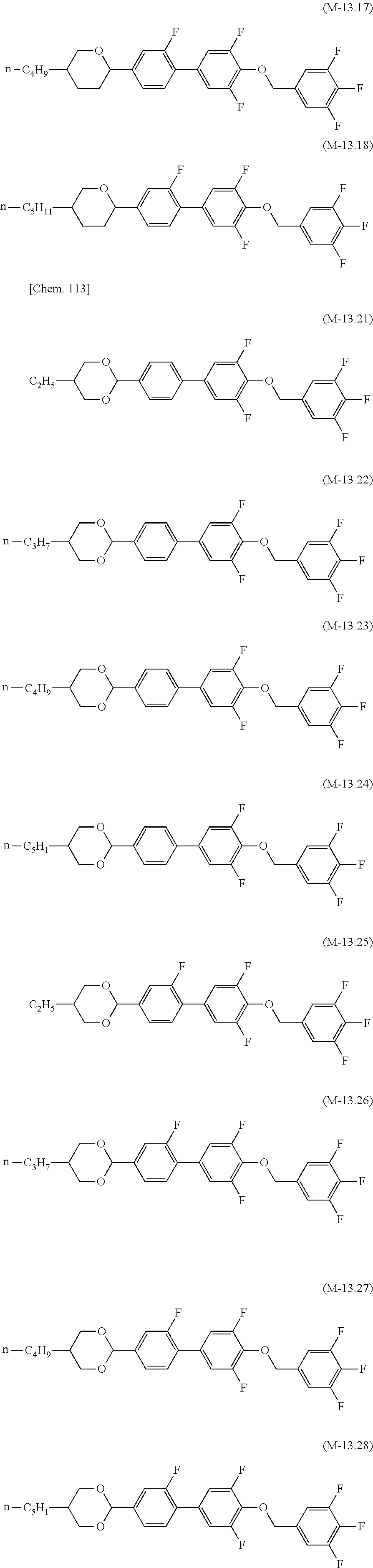

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-14) are as follows.

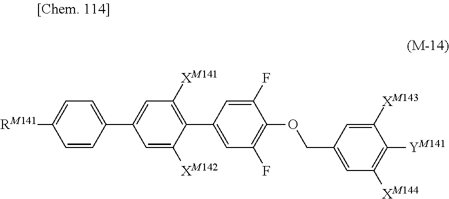

(where X^{M141} to X^{M144} each independently represent a fluorine or hydrogen atom, Y^{M141} represents a fluorine atom, a chlorine atom, or —OCF₃, R^{M141} represents a C1-5 alkyl, C2-5 alkenyl, or C1-4 alkoxy group, and W^{M141} and W^{M142} each independently represent —CH₂— or —O—.)

The lower limit of preferred percentages of the compound(s) represented by formula (M-14) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-14) used in the liquid crystal composition (B), moreover, is preferably compound(s) represented by formulae (M-14.1) to (M-14.8), to be specific. In particular, it is preferred that the liquid crystal composition (B) contain compound(s) represented by formulae (M-14.5) and (M-14.8).

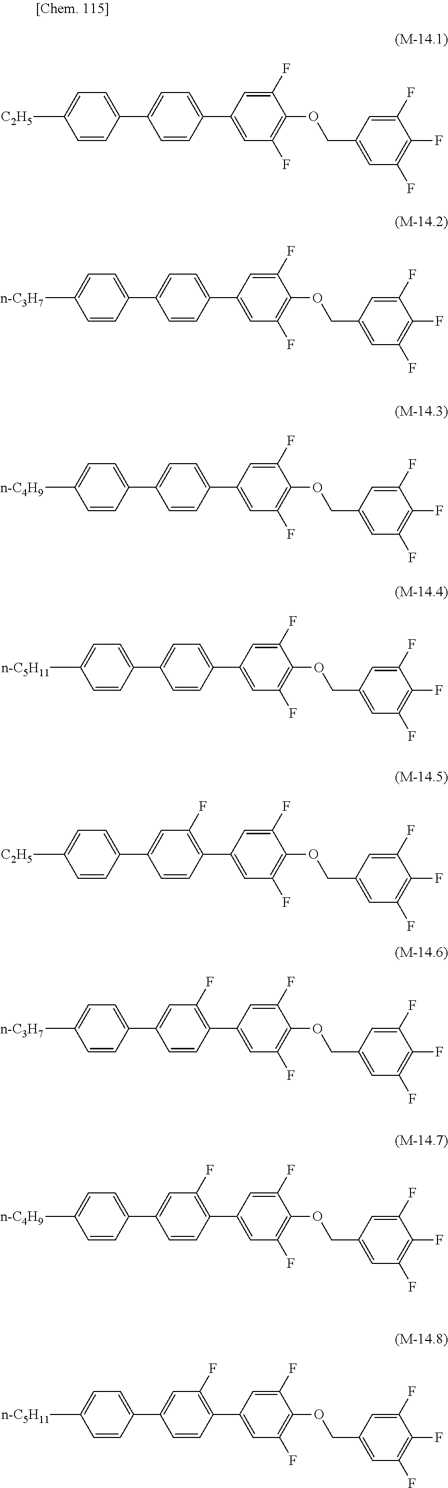

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-15) are as follows.

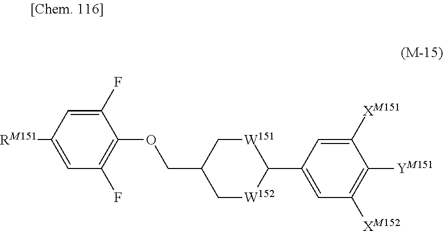

(where X^{M151} and X^{M152} each independently represent a fluorine or hydrogen atom, M⁵¹ represents a fluorine atom, a chlorine atom, or —OCF₃, R represents a C1-5 alkyl, C2-5 alkenyl, or C1-4 alkoxy group, and W^{M151} and W^{M152} each independently represent —CH₂— or —O—.)

The lower limit of preferred percentages of the compound(s) represented by formula (M-15) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-15) used in the liquid crystal composition (B), moreover, is preferably compound(s) represented by formulae (M-15.1) to (M-15.14), to be specific. In particular, it is preferred that the liquid crystal composition (B) contain compound(s) represented by formulae (M-15.5) to (M-15.8) and (M-15.11) to (M-15.14).

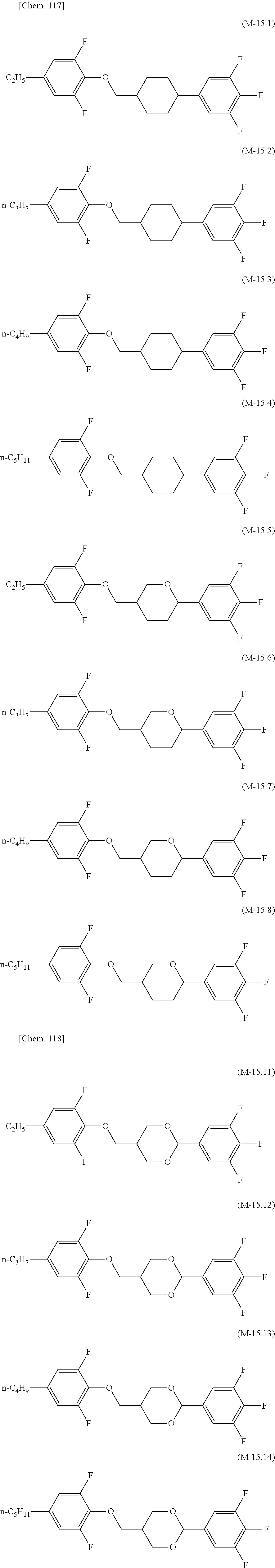

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-16) are as follows.

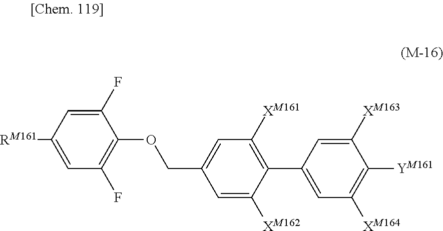

(where X^{M161} to X^{M164} each independently represent a fluorine or hydrogen atom, Y represents a fluorine atom, a chlorine atom, or —OCF₃, and R^{M161} represents a C1-5 alkyl, C2-5 alkenyl, or C1-4 alkoxy group.)

The lower limit of preferred percentages of the compound(s) represented by formula (M-16) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-16) used in the liquid crystal composition (B), moreover, is preferably compound(s) represented by formulae (M-16.1) to (M-16.8), to be specific. In particular, it is preferred that the liquid crystal composition (B) contain compound(s) represented by formulae (M-16.1) to (M-16.4).

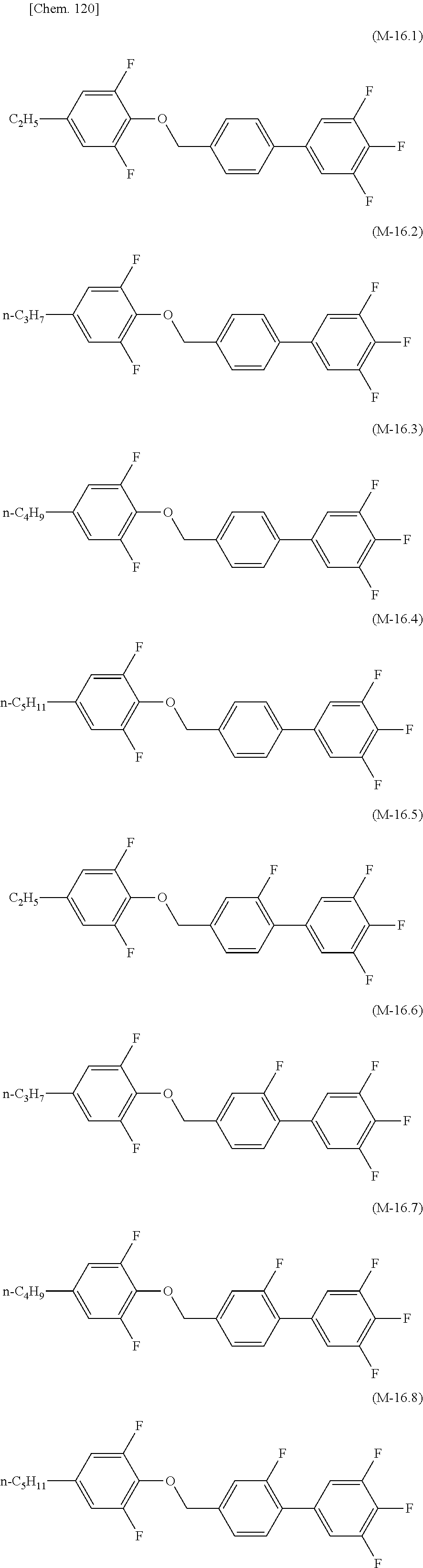

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-17) are as follows.

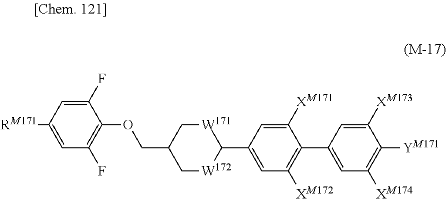

(where X^{M171} to X^{M174} each independently represent a fluorine or hydrogen atom, Y 171 represents a fluorine atom, a chlorine atom, or —OCF₃, R^{M17} represents a C1-5 alkyl, C2-5 alkenyl, or C1-4 alkoxy group, and W^{M171} and W^{M172} each independently represent —CH₂— or —O—.)

The lower limit of preferred percentages of the compound(s) represented by formula (M-17) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-17) used in the liquid crystal composition (B), moreover, is preferably compound(s) represented by formulae (M-17.1) to (M-17.52), to be specific. In particular, it is preferred that the liquid crystal composition (B) contain compound(s) represented by formulae (M-17.9) to (M-17.12), (M-17.21) to (M-17.28), and (M-17.45) to (M-17.48)

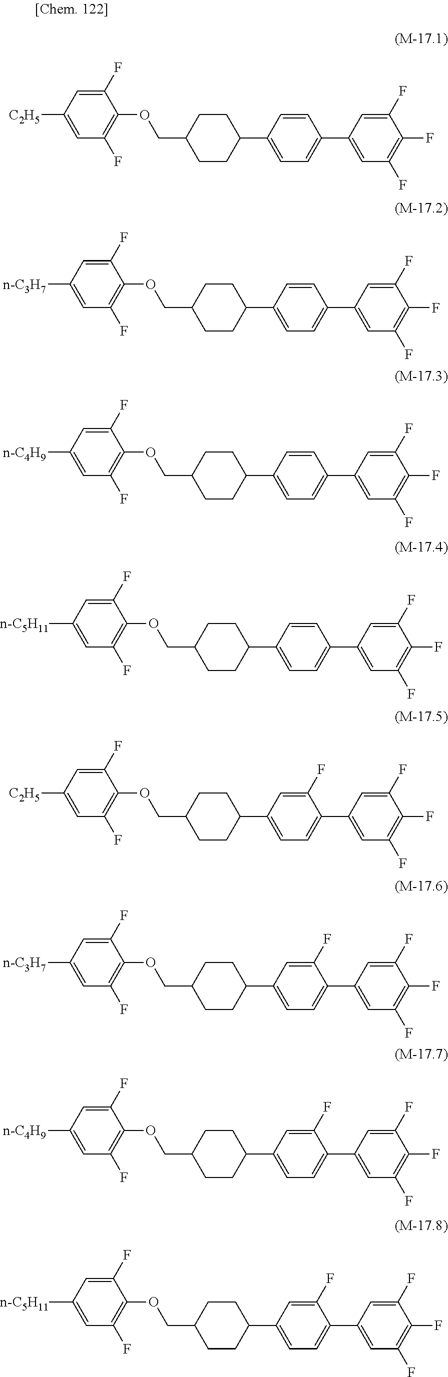

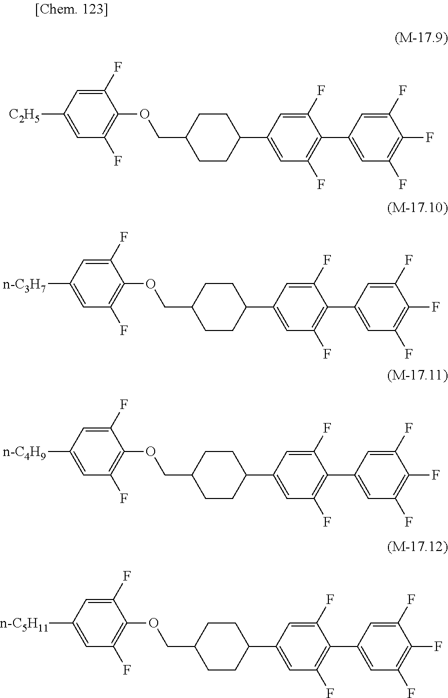

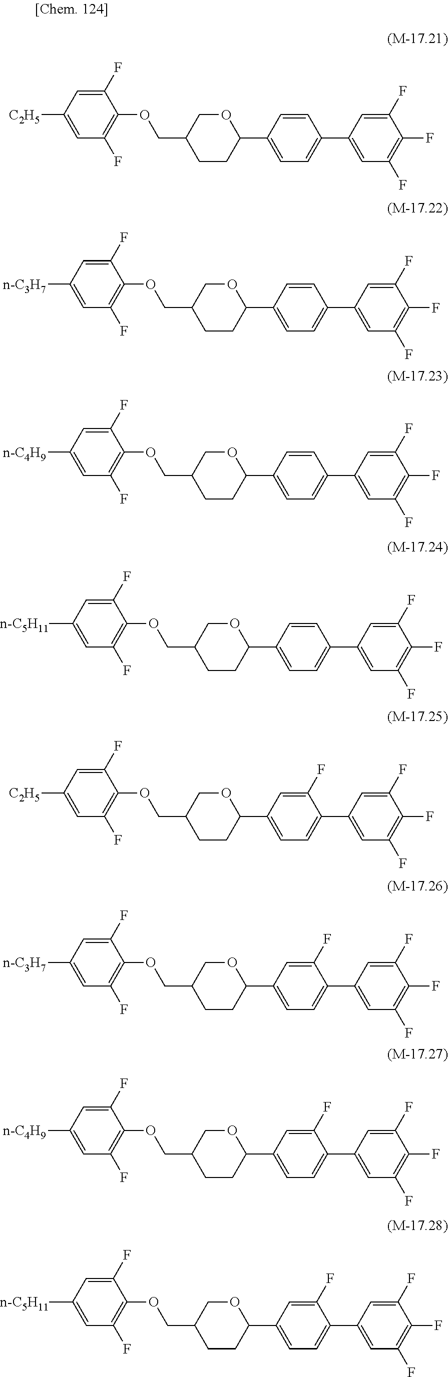

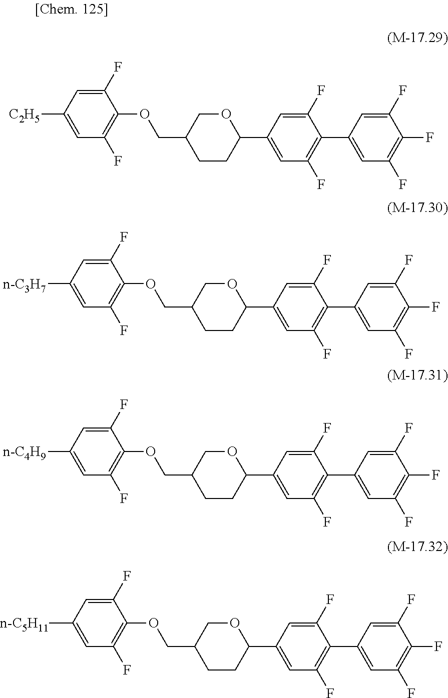

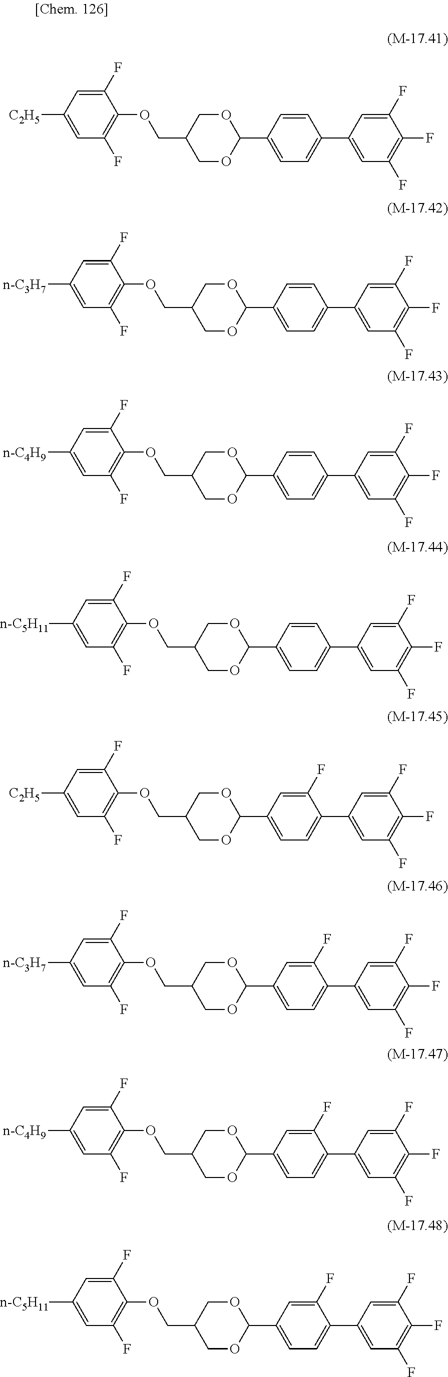

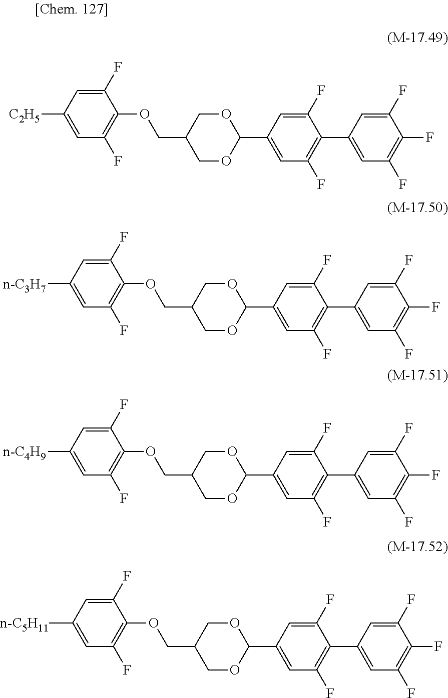

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compounds represented by general formula (M-18) are as follows.

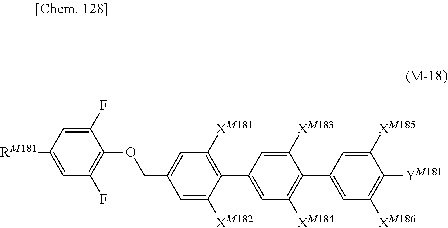

(where X^{M181} to X^{M186} each independently represent a fluorine or hydrogen atom, Y^{M181} represents a fluorine atom, a chlorine atom, or —OCF₃, and R^{M181} represents a C1-5 alkyl, C2-5 alkenyl, or C1-4 alkoxy group.)

The lower limit of preferred percentages of the compound(s) represented by formula (M-18) to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If a composition with less image-sticking is needed, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) of general formula (M-18) used in the liquid crystal composition (B), moreover, is preferably compound(s) represented by formulae (M-18.1) to (M-18.12), to be specific. In particular, it is preferred that the liquid crystal composition (B) contain compound(s) represented by formulae (M-18.5) to (M-18.8).

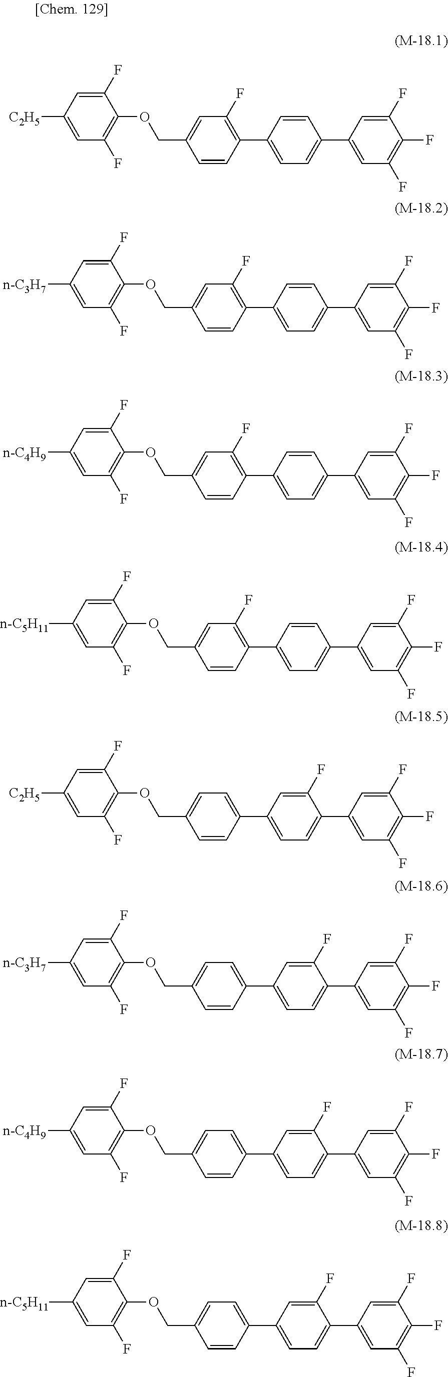

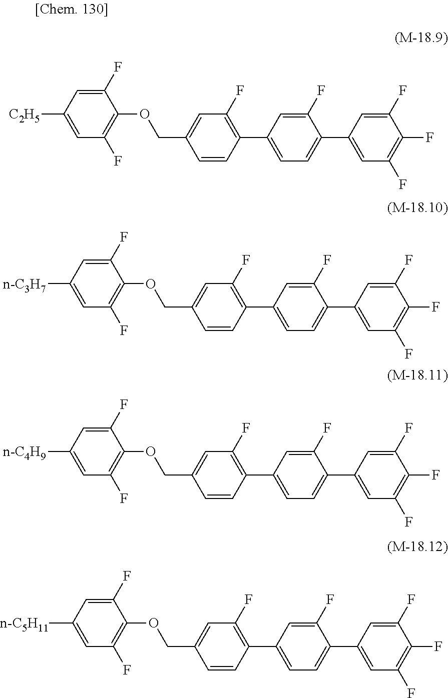

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The liquid crystal composition (B) preferably contains one or two or more compounds represented by general formula (K). These compounds are dielectrically positive compounds (Δε is larger than 2.).

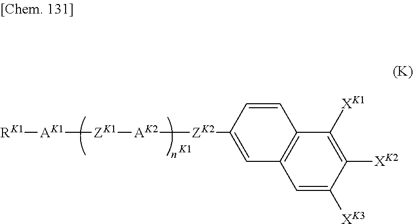

(where R^{K1} represents a C1-8 alkyl group, and one —CH₂— in the alkyl group, or each of nonadjacent two or more independently, may be substituted with —CH═CH—, —C═C—, —O—, —CO—, —COO—, or —OCO—,

n^{K1} represents 0, 1, 2, 3, or 4,

A^{K1} and A^{K2} each independently represent a group selected from the group consisting of:

(a) a 1,4-cyclohexylene group (One —CH₂— or two or more nonadjacent —CH₂— present in this group may be substituted with —O— or —S—.); and

(b) a 1,4-phenylene group (One —CH═ or two or more nonadjacent —CH=present in this group may be substituted with —N═.),

the hydrogen atoms on the groups (a) and (b) may each independently be substituted with a cyano group, a fluorine atom, or a chlorine atom,

Z^{K1} and Z^{K2} each independently represent a single bond, —CH₂CH₂—, —(CH₂)₄—, —OCH₂—, —CH₂O—, —OCF₂—, —CF₂O—, —COO—, —OCO—, or —C═C—,

if n^{K1} is 2, 3, or 4 and there are multiple A^{K2}s, they may be the same or different, and if n^{K1} is 2, 3, or 4 and there are multiple Z^{K1}s, they may be the same or different,

X^{K1} and X^{K3} each independently represent a hydrogen, chlorine, or fluorine atom, and

X^{K2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.)

In general formula (K), R^{K1} is preferably a C1-8 alkyl, C1-8 alkoxy, C2-8 alkenyl, or C2-8 alkenyloxy group, preferably a C1-5 alkyl, C1-5 alkoxy, C2-5 alkenyl, or C2-5 alkenyloxy group, more preferably a C1-5 alkyl or C2-5 alkenyl group, more preferably a C2-5 alkyl or C2-3 alkenyl group, in particular a C3 alkenyl group (propenyl group).

If reliability is a high priority, R^{K1} is preferably an alkyl group. If reducing viscosity is a high priority, R^{K1} is preferably an alkenyl group.

If the ring structure to which the group is bound is a phenyl group (aromatic), linear C1-5 alkyl, linear C1-4 alkoxy, and C4-5 alkenyl groups are preferred. If the ring structure to which the group is bound is a saturated ring structure, such as cyclohexane, pyran, or dioxane, linear C1-5 alkyl, linear C1-4 alkoxy, and linear C2-5 alkenyl groups are preferred. To stabilize the nematic phase, it is preferred that the total number of carbon and oxygen, if present, atoms be 5 or less with the group being linear.

An alkenyl group is preferably selected from the groups represented by any of formulae (R1) to (R5). (The black dot in the formulae represents a carbon atom in the ring structure to which the alkenyl group is bound.)

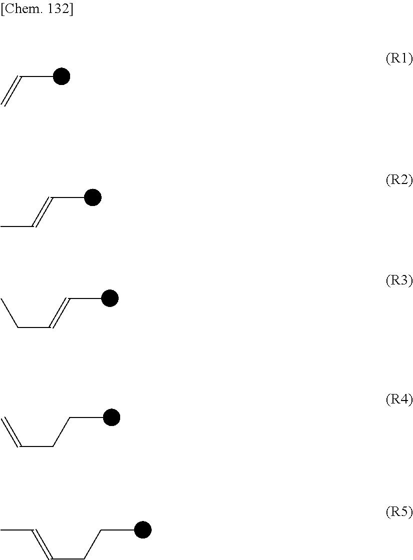

If Δn needs to be large, each of A^{K1} and A^{K2} is preferably independently aromatic. To improve the response rate, it is preferred that each of these groups be independently aliphatic, preferably representing a trans-1,4-cyclohexylene, 1,4-phenylene, 2-fluoro-1,4-phenylene, 3-fluoro-1,4-phenylene, 3,5-difluoro-1,4-phenylene, 2,3-difluoro-1,4-phenylene, 1,4-cyclohexenylene, 1,4-bicyclo[2.2.2]octylene, piperidin-1,4-diyl, naphthalen-2,6-diyl, decahydronaphthalen-2,6-diyl, or 1,2,3,4-tetrahydronaphthalen-2,6-diyl, more preferably representing a structure given below,

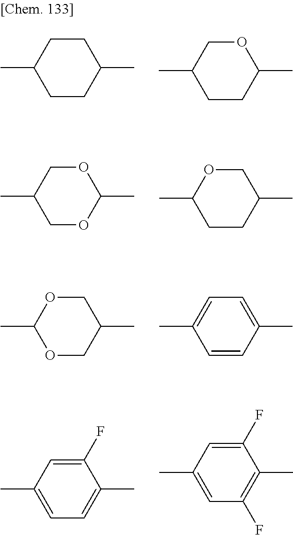

more preferably representing a structure given below.

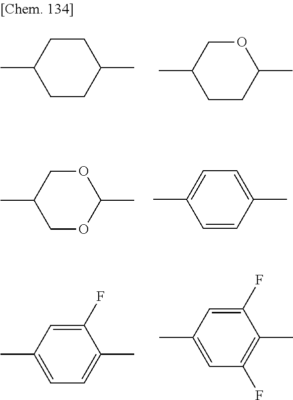

Z^{K1} and Z^{K2} each preferably independently represent —CH₂O—, —CF₂O—, —CH₂CH₂—, —CF₂CF₂—, or a single bond, more preferably —CF₂O—, —CH₂CH₂—, or a single bond, in particular —CF₂O— or a single bond.

n^{K1} is preferably 0, 1, 2, or 3, preferably 0, 1, or 2. If emphasis is on improving Δε, n^{K1} is preferably 0 or 1. If Tni is a high priority, n^{K1} is preferably 1 or 2.

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three as an embodiment according to the present invention by way of example, or is four, five, six, or seven or more in another embodiment according to the present invention.

In the liquid crystal composition (B), the percentage of the compound(s) represented by general formula (K) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (K) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is, in an embodiment according to the present invention by way of example, 95% by mass, 85% by mass, 75% by mass, 65% by mass, 55% by mass, 45% by mass, 35% by mass, or 25% by mass of the total amount of the liquid crystal composition (B).

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K) is preferably compound(s) selected from, for example, the group of compounds represented by general formula (K-1).

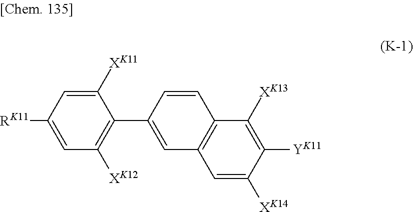

(where R^{K11} represents a C1-5 alkyl, C2-5 alkenyl, or C1-4 alkoxy group, X^{K11} to X^{K14} each independently represent a hydrogen or fluorine atom, and Y^{K11} represents a fluorine atom or OCF₃.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-1) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-1), moreover, is preferably compound(s) represented by formulae (K-1.1) to (K-1.4), preferably the compound represented by formula (K-1.1) or (K-1.2), more preferably the compound represented by formula (K-1.2), to be specific. It is also preferred to use the compounds represented by formula (K-1.1) or (K-1.2) together.

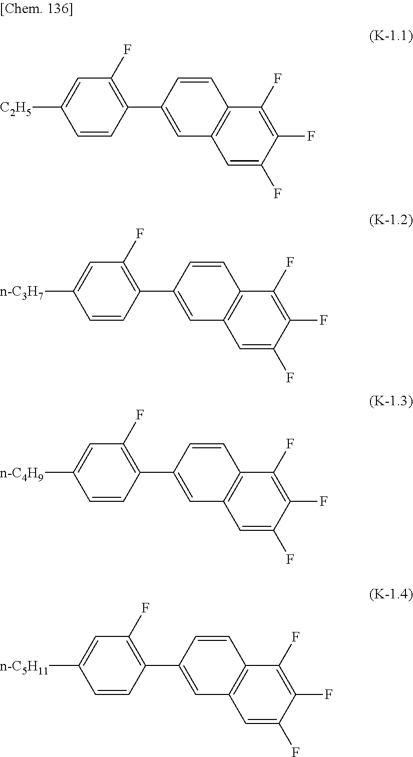

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (K) is preferably compound(s) selected from, for example, the group of compounds represented by general formula (K-2).

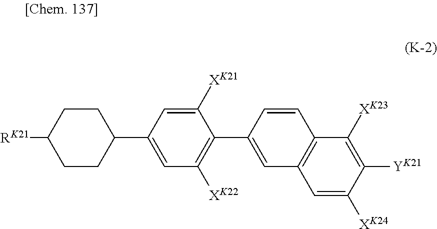

(where R^{K21} represents a C1-5 alkyl, C2-5 alkenyl, or C1-4 alkoxy group, X^{K21} to X^{K24} each independently represent a hydrogen or fluorine atom, and Y^{K21} represents a fluorine atom or OCF₃.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-2) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-2), moreover, is preferably compound(s) represented by formulae (K-2.1) to (K-2.6), preferably the compound represented by formula (K-2.5) or (K-2.6), more preferably the compound represented by formula (K-2.6), to be specific. It is also preferred to use the compounds represented by formula (K-2.5) or (K-2.6) together.

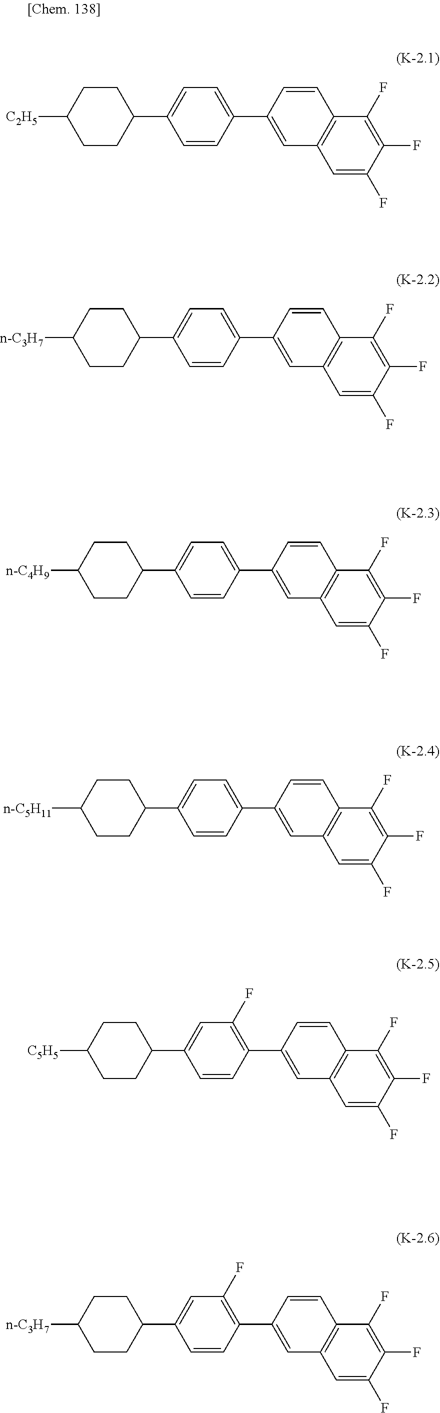

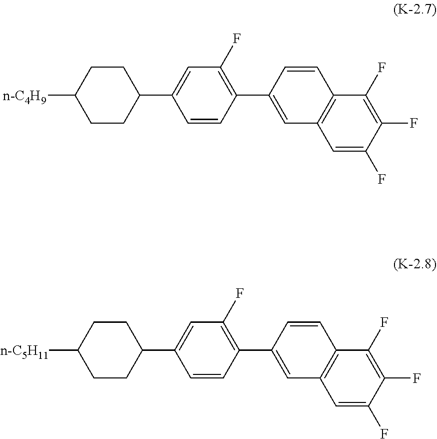

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (K) is preferably compound(s) selected from, for example, the group of compounds represented by general formula (K-3).

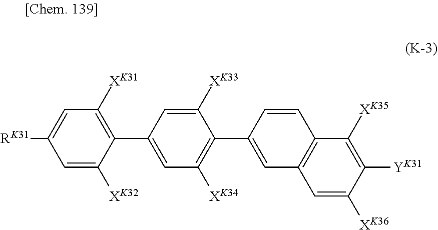

(where R^{K31} represents a C1-5 alkyl, C2-5 alkenyl, or C1-4 alkoxy group, X^{K1} to X^{K36} each independently represent a hydrogen or fluorine atom, and Y^{K31} represents a fluorine atom or OCF₃.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-3) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-3), moreover, is preferably compound(s) represented by formulae (K-3.1) to (K-3.4), more preferably the compound represented by formula (K-3.1) or (K-3.2), to be specific. It is also preferred to use the compounds represented by formulae (K-3.1) and (K-3.2) together.

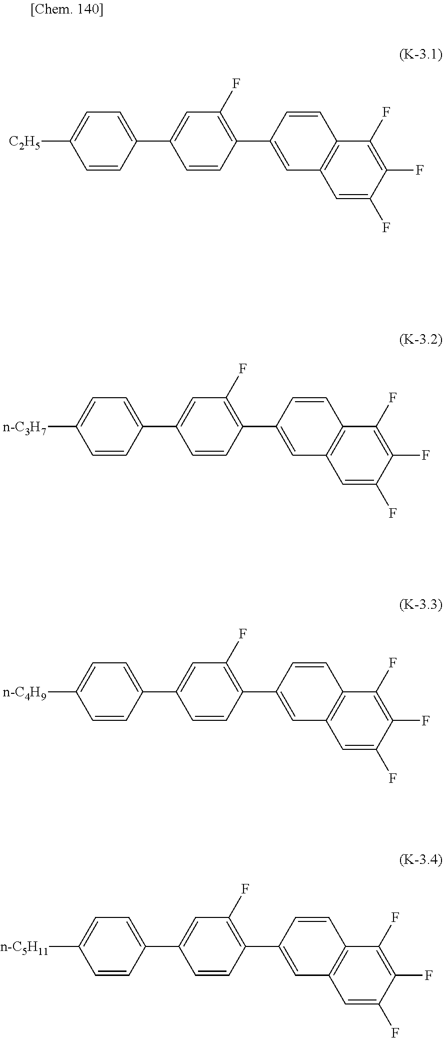

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (K) is preferably compound(s) selected from, for example, the group of compounds represented by general formula (K-4).

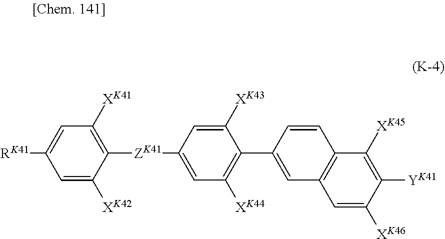

(where R^{K41} represents a C1-5 alkyl, C2-5 alkenyl, or C1-4 alkoxy group, X^{K41} to X^{K46} each independently represent a hydrogen or fluorine atom, Y^{K41} represents a fluorine atom or OCF₃, and Z^{K41} represents —OCH₂—, —CH₂O—, —OCF₂—, or —CF₂O—.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-4) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-4), moreover, is preferably compound(s) represented by formulae (K-4.1) to (K-4.18), more preferably compound(s) represented by formulae (K-4.1), (K-4.2), (K-4.11), and (K-4.12), to be specific. It is also preferred to use the compounds represented by formulae (K-4.1), (K-4.2), (K-4.11), and (K-4.12) together.

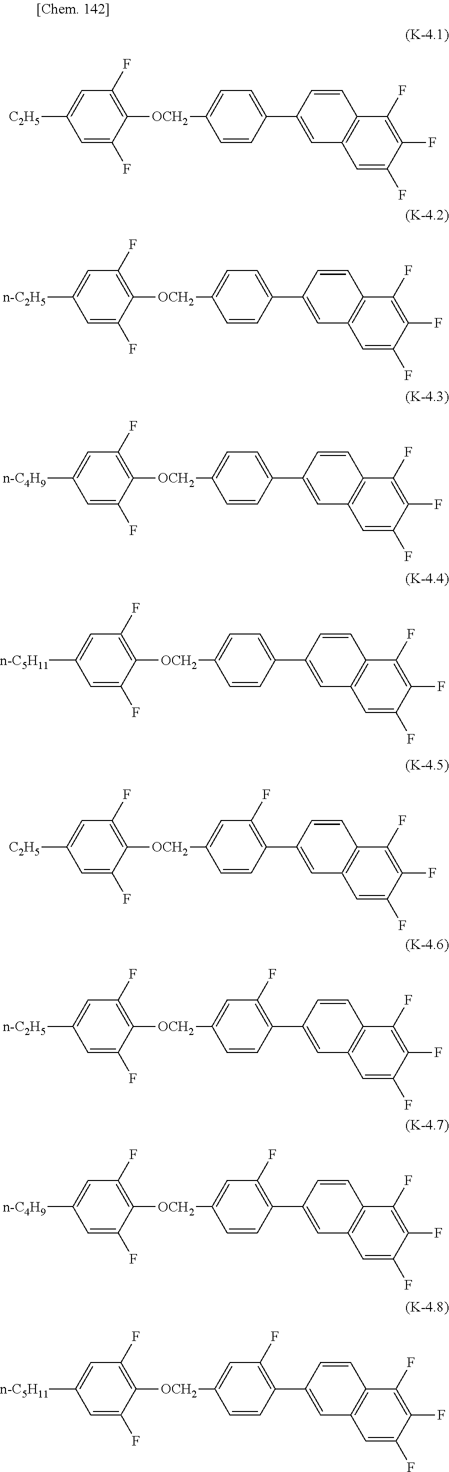

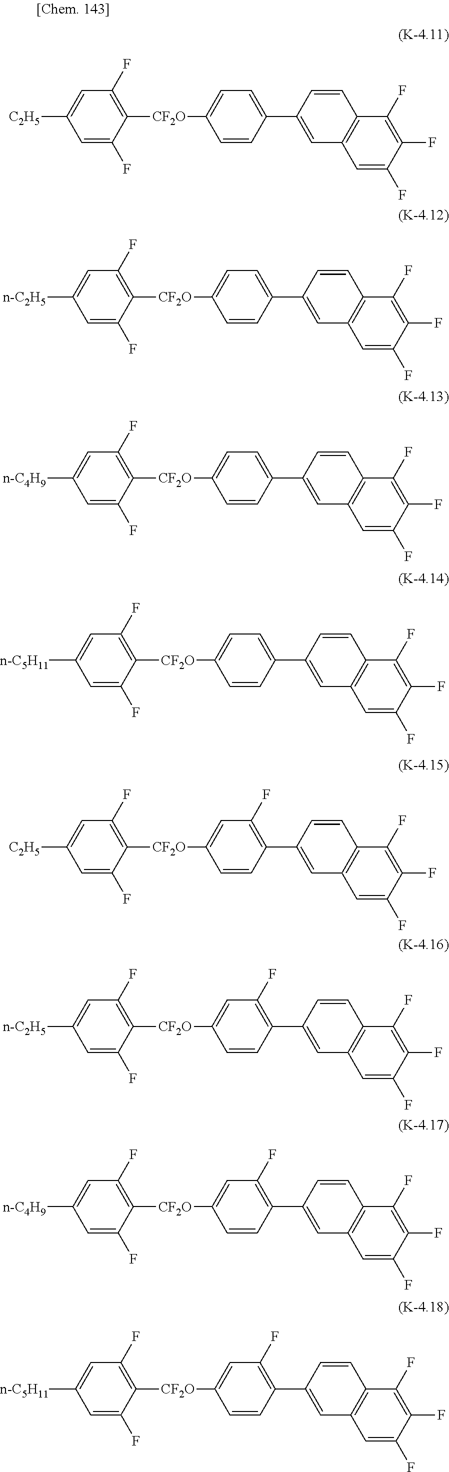

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (K) is preferably compound(s) selected from, for example, the group of compounds represented by general formula (K-5).

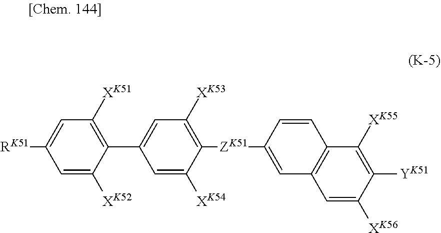

(where R^{K51} represents a C1-5 alkyl, C2-5 alkenyl, or C1-4 alkoxy group, X^{K51} to X^{K56} each independently represent a hydrogen or fluorine atom, Y^{K51} represents a fluorine atom or OCF₃, and Z^{K51} represents —OCH₂—, —CH₂O—, —OCF₂—, or —CF₂O—.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-5) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-5), moreover, is preferably compound(s) represented by formulae (K-5.1) to (K-5.18), preferably compound(s) represented by formulae (K-5.11) to (K-5.14), more preferably the compound represented by formula (K-5.12), to be specific.

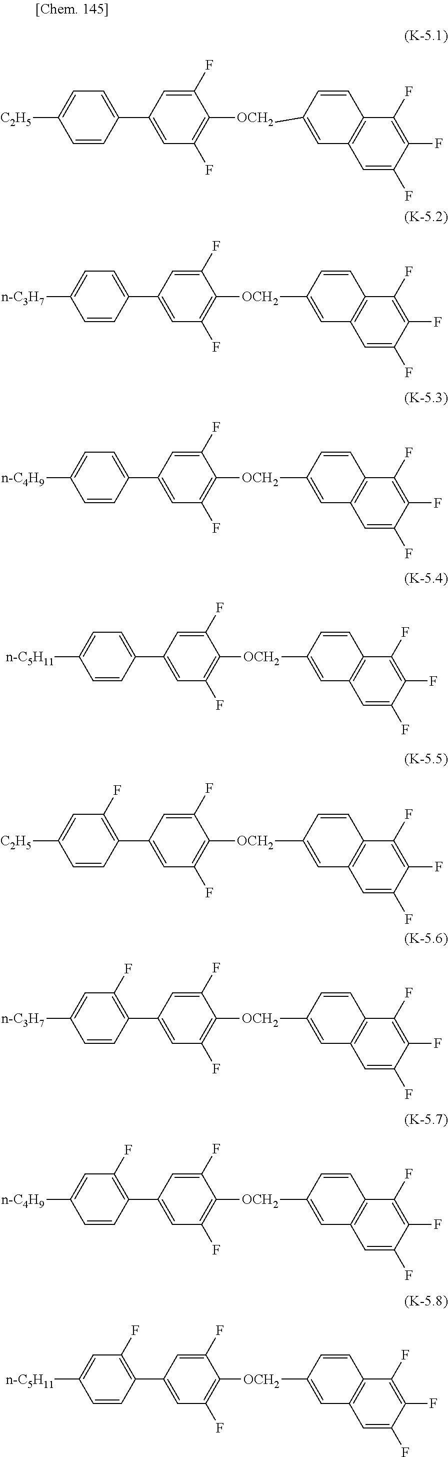

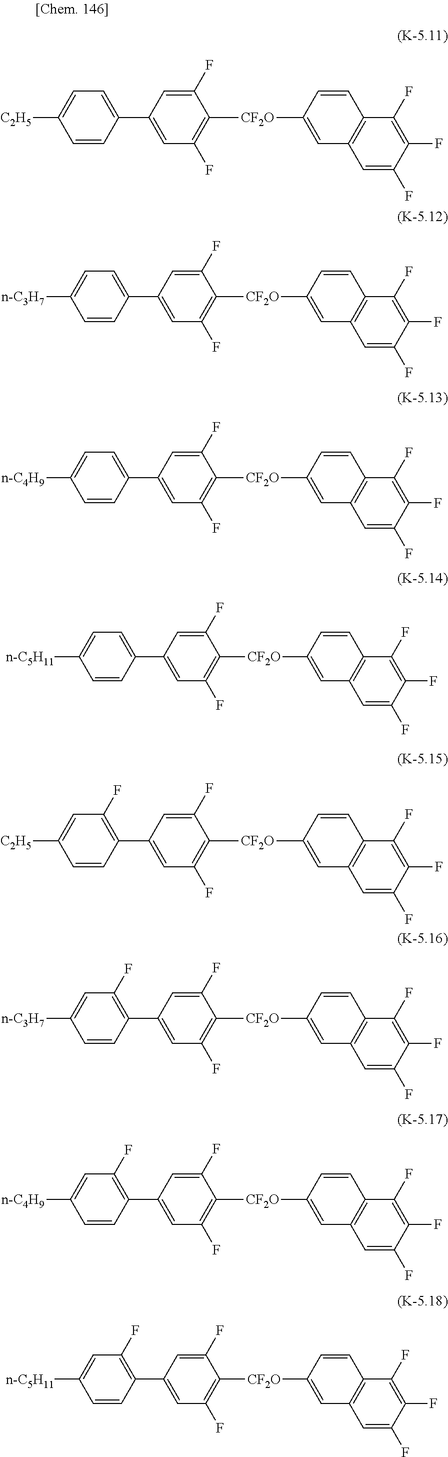

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

The compound(s) represented by general formula (K) is preferably compound(s) selected from, for example, the group of compounds represented by general formula (K-6).

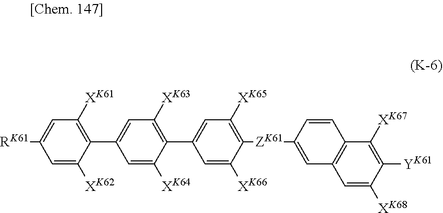

(where R^{K61} represents a C1-5 alkyl, C2-5 alkenyl, or C1-4 alkoxy group, X^{K61} to X^{K68} each independently represent a hydrogen or fluorine atom, Y^{K61} represents a fluorine atom or OCF₃, and Z^{K61} represents —OCH₂—, —CH₂O—, —OCF₂—, or —CF₂O—.)

Any two or more such compounds can be combined, but compounds selected in accordance with the desired performance attributes, such as solubility at low temperatures, transition temperature, electrical reliability, and birefringence, are used in combination. The number of kinds of compounds used is one, two, or three or more as an embodiment according to the present invention by way of example.

The lower limit of preferred percentages of the compound(s) represented by formula (K-6) to the total amount of the liquid crystal composition (B) is 1% by mass, 2% by mass, 5% by mass, 8% by mass, 10% by mass, 13% by mass, 15% by mass, 18% by mass, 20% by mass, 22% by mass, 25% by mass, or 30% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

If the manufacturer needs to keep the viscosity of the liquid crystal composition (B) low and thereby make the composition fast in response time, it is preferred to set the above lower limit relatively low with the upper limit relatively low. If the manufacturer needs to keep the Tni of the liquid crystal composition (B) high and thereby make the composition good in temperature stability, it is preferred to set the above lower limit relatively low with the upper limit relatively low. If the manufacturer wants a large dielectric constant anisotropy to keep the drive voltage low, it is preferred to set the above lower limit relatively high with the upper limit relatively high.

The compound(s) represented by general formula (K-6), moreover, is preferably compound(s) represented by formulae (K-6.1) to (K-6.18), preferably compound(s) represented by formula (K-6.15) to (K-6.18), more preferably compound(s) represented by formulae (K-6.16) and (K-6.17), to be specific. It is also preferred to use the compounds represented by formulae (K-6.16) and (K-6.17) together.

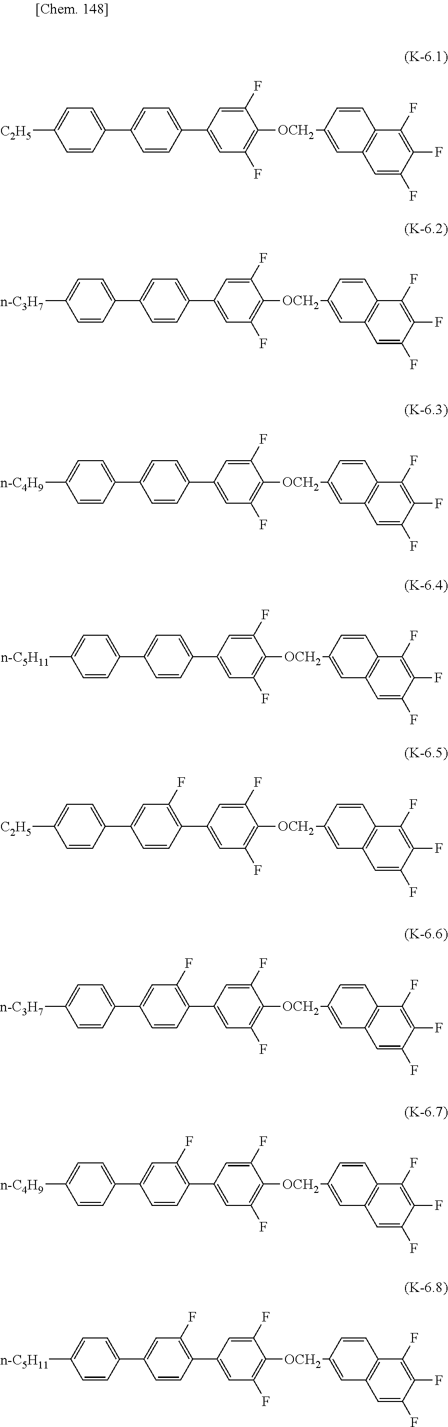

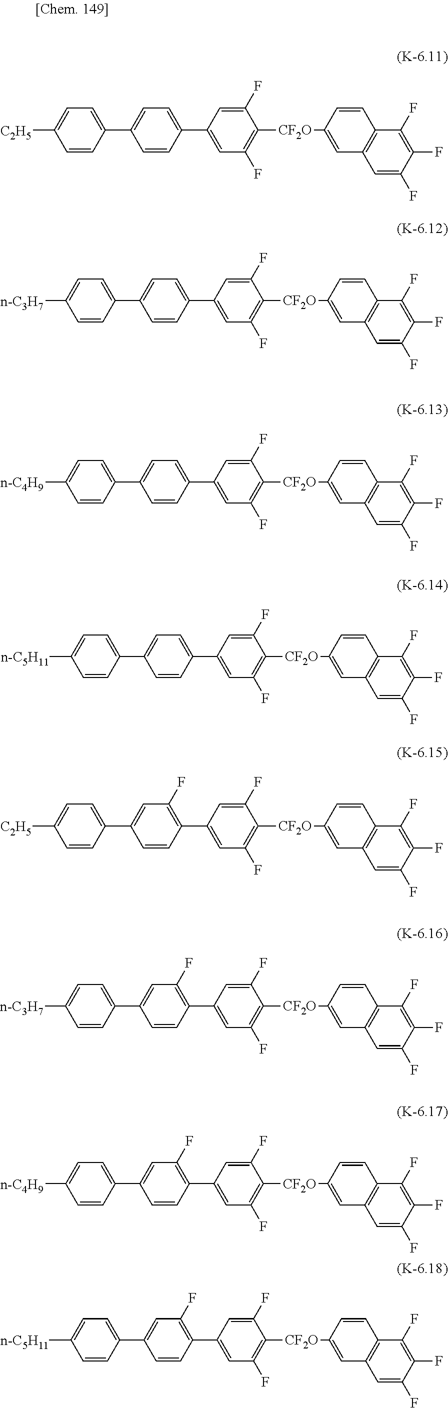

The lower limit of preferred percentages of these compounds to the total amount of the liquid crystal composition (B) is 1% by mass, 2% by mass, 4% by mass, 5% by mass, 8% by mass, 10% by mass, 13% by mass, 15% by mass, 18% by mass, or 20% by mass. The upper limit of preferred percentages is 30% by mass, 28% by mass, 25% by mass, 23% by mass, 20% by mass, 18% by mass, 15% by mass, 13% by mass, 10% by mass, 8% by mass, or 5% by mass.

A liquid crystal composition having substantially no dielectric constant anisotropy preferably contains one or two or more compounds represented by general formula (L) below. The compounds represented by general formula (L) are dielectrically substantially neutral compounds (Δε is between −2 and 2).

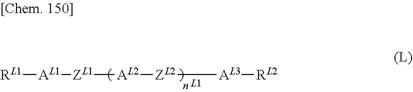

(where R^{L1} and R^{L2} each independently represent a C1-8 alkyl group or an organic group having a chemical structure resulting from substituting one —CH₂— present in a C2-8 alkyl chain, or each of nonadjacent two or more independently, with —CH═CH—, —C═C—, —O—, —CO—, —COO—, or —OCO—,

n^{L1} represents 0, 1, 2, or 3,

A^{L1}, A^{L2}, and A^{L3} each independently represent a group selected from the group consisting of:

(a) a 1,4-cyclohexylene group (One —CH₂— or two or more nonadjacent —CH₂— present in this group may be substituted with —O—.);

(b) a 1,4-phenylene group (One —CH═ or two or more nonadjacent —CH=present in this group may be substituted with —N═.); and

(c) a naphthalen-2,6-diyl, 1,2,3,4-tetrahydronaphthalen-2,6-diyl, or decahydronaphthalen-2,6-diyl group (One —CH═ or two or more nonadjacent —CH=present in the naphthalen-2,6-diyl or 1,2,3,4-tetrahydronaphthalen-2,6-diyl group may be substituted with —N═.),

the groups (a), (b), and (c) may each independently be substituted with a cyano group, a fluorine atom, or a chlorine atom,

Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C═C—,

if n^{L1} is 2 or 3 and there are multiple A^{L2}s, they may be the same or different, and if n^{L1} is 2 or 3 and there are multiple Z^{L2}s, they may be the same or different, with the proviso that the compounds represented by general formulae (N-1), (N-2), (N-3), (N-4), and (J) are excluded.)

The compounds represented by general formula (L) can be used alone but can also be used in combination. Any two or more of the compounds can be combined, but compounds needed for the performance attributes required, such as solubility at low temperatures, transition temperature, electrical reliability, and birefringence, are used in combination. The number of kinds of compounds used is one as an embodiment according to the present invention by way of example or two, three, four, five, six, seven, eight, nine, or ten or more in another embodiment according to the present invention.

In the liquid crystal composition (B), the percentage of the compound(s) represented by general formula (L) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (L) to the total amount of the liquid crystal composition (B) is 1% by mass, 10% by mass, 20% by mass, 30% by mass, 40% by mass, 50% by mass, 55% by mass, 60% by mass, 65% by mass, 70% by mass, 75% by mass, or 80% by mass. The upper limit of preferred percentages is 95% by mass, 85% by mass, 75% by mass, 65% by mass, 55% by mass, 45% by mass, 35% by mass, or 25% by mass.

If the manufacturer needs to keep the viscosity of the liquid crystal composition (B) low and thereby make the composition fast in response time, it is preferred that the above lower limit be high with the upper limit high. If the manufacturer needs to keep the Tni of the liquid crystal composition (B) high and thereby make the composition good in temperature stability, it is preferred that the above lower limit be high with the upper limit high. If the manufacturer wants a large dielectric constant anisotropy to keep the drive voltage low, it is preferred that the above lower limit be low with the upper limit low.

If reliability is a high priority, it is preferred that both R^{L1} and R^{L2} be alkyl groups. If making the compound less volatile is a high priority, it is preferred that both R^{L1} and R^{L2} be alkoxy groups. If reducing viscosity is a high priority, it is preferred that at least one of them be an alkenyl group.

The number of halogen atoms present in the molecule is preferably 0, 1, 2, or 3, preferably 0 or 1. If compatibility with other liquid crystal molecule(s) is a high priority, this number of halogen atoms is preferably 1.

For R^{L1} and R^{L2}, if the ring structure to which the group is bound is a phenyl group (aromatic), linear C1-5 alkyl, linear C1-4 alkoxy, and C4-5 alkenyl groups are preferred. If the ring structure to which the group is bound is a saturated ring structure, such as cyclohexane, pyran, or dioxane, linear C1-5 alkyl, linear C1-4 alkoxy, and linear C2-5 alkenyl groups are preferred. To stabilize the nematic phase, it is preferred that the total number of carbon and oxygen, if present, atoms be 5 or less, preferably with the group being linear.

An alkenyl group is preferably selected from the groups represented by any of formulae (R1) to (R5). (The black dot in the formulae represents a carbon atom in a ring structure.)

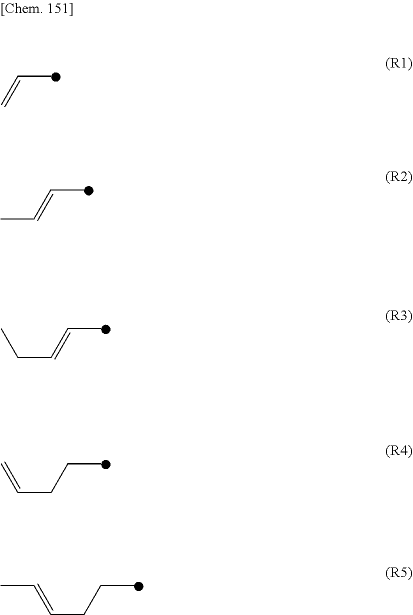

If the response rate is a high priority, nL¹ is preferably 0. To improve the highest possible temperature of the nematic phase, it is preferred that nL¹ be 2 or 3. To achieve a balance therebetween, it is preferred that nL¹ be 1. For the composition to have characteristics expected of it, it is preferred to combine compounds with different values for n^{L1}

If Δn needs to be large, A^{L1}, A^{L2}, and A^{L3} are preferably aromatic. To improve the response rate, it is preferred that these groups be aliphatic, preferably each independently being a trans-1,4-cyclohexylene, 1,4-phenylene, 2-fluoro-1,4-phenylene, 3-fluoro-1,4-phenylene, 3,5-difluoro-1,4-phenylene, 1,4-cyclohexenylene, 1,4-bicyclo[2.2.2]octylene, piperidin-1,4-diyl, naphthalen-2,6-diyl, decahydronaphthalen-2,6-diyl, or 1,2,3,4-tetrahydronaphthalen-2,6-diyl or a group having a structure represented by the structural formulae below,

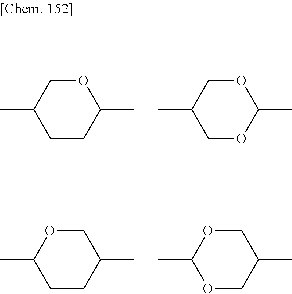

i.e., a tetrahydrofuran or dioxane structure.

Among these, it is more preferred that the group represent a structure given below.

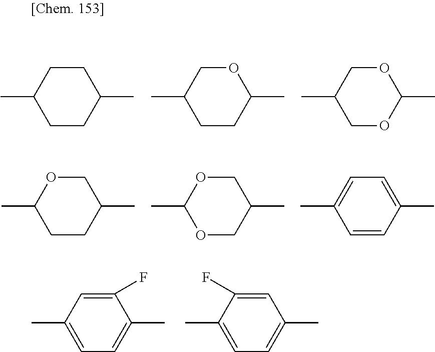

In particular, the trans-1,4-cyclohexylene group is preferred because it is useful if the manufacturer wants to reduce Δn and helps lower viscosity, and the 1,4-phenylene group is more preferred because it is useful if the manufacturer wants to increase Δn.

If the response rate is a high priority, Z^{L1} and Z^{L2} are preferably single bonds.

The compound(s) represented by general formula (L) preferably has no or one halogen atom in the molecule.

The compound(s) represented by general formula (L) is preferably compound(s) selected from the group of compounds represented by general formulae (L-1) to (L-8).

The compounds represented by general formula (L-1) are the following compounds.

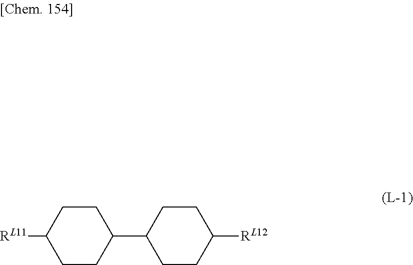

(where R and R^{L12} each independently represent the same meaning as R^{L1} and R^{L2} in general formula (L).)

R^{L11} and R^{L12} are preferably linear C1-5 alkyl, linear C1-4 alkoxy, or linear C2-5 alkenyl groups.

The compounds represented by general formula (L-1) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

The lower limit of preferred percentages is 1% by mass, 2% by mass, 3% by mass, 5% by mass, 7% by mass, 10% by mass, 15% by mass, 20% by mass, 25% by mass, 30% by mass, 35% by mass, 40% by mass, 45% by mass, 50% by mass, or 55% by mass of the total amount of the liquid crystal composition (B). The upper limit of preferred percentages is 95% by mass, 90% by mass, 85% by mass, 80% by mass, 75% by mass, 70% by mass, 65% by mass, 60% by mass, 55% by mass, 50% by mass, 45% by mass, 40% by mass, 35% by mass, 30% by mass, or 25% by mass of the total amount of the liquid crystal composition (B).

If the manufacturer needs to keep the viscosity of the liquid crystal composition (B) low and thereby make the composition fast in response time, it is preferred that the above lower limit be high with the upper limit high. If the manufacturer needs to keep the Tni of the liquid crystal composition (B) high and thereby make the composition good in temperature stability, it is preferred that the above lower limit be moderate with the upper limit moderate. If the manufacturer wants a large dielectric constant anisotropy to keep the drive voltage low, it is preferred that the above lower limit be low with the upper limit low.

The compound(s) represented by general formula (L-1) is preferably compound(s) selected from the group of compounds represented by general formula (L-1-1).

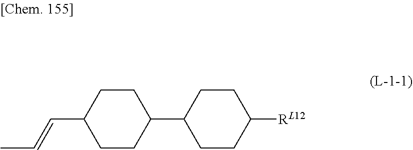

(wherein R^{L12} represents the same meaning as in general formula (L-1).)

The compound(s) represented by general formula (L-1-1) is preferably compound(s) selected from the group of compounds represented by formulae (L-1-1.1) to (L-1-1.3), preferably the compound represented by formula (L-1-1.2) or (L-1-1.3), in particular the compound represented by formula (L-1-1.3).

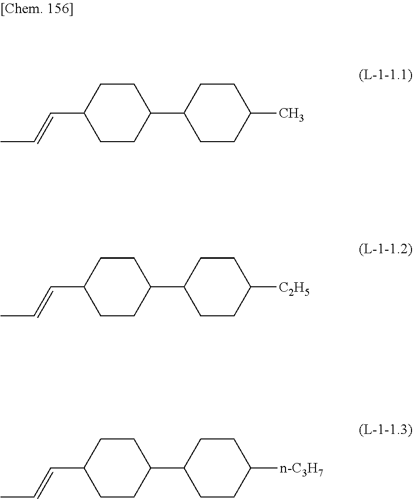

The lower limit of preferred percentages of the compound represented by formula (L-1-1.3) to the total amount of the liquid crystal composition (B) is 1% by mass, 2% by mass, 3% by mass, 5% by mass, 7% by mass, or 10% by mass. The upper limit of preferred percentages is 20% by mass, 15% by mass, 13% by mass, 10% by mass, 8% by mass, 7% by mass, 6% by mass, 5% by mass, or 3% by mass of the total amount of the liquid crystal composition (B).

The compound(s) represented by general formula (L-1) is preferably compound(s) selected from the group of compounds represented by general formula (L-1-2).

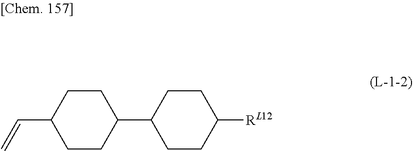

(wherein R^{L12} represents the same meaning as in general formula (L-1).)

The lower limit of preferred percentages of the compound(s) represented by general formula (L-1-2) to the total amount of the liquid crystal composition (B) is 1% by mass, 5% by mass, 10% by mass, 15% by mass, 17% by mass, 20% by mass, 23% by mass, 25% by mass, 27% by mass, 30% by mass, or 35% by mass. The upper limit of preferred percentages is 60% by mass, 55% by mass, 50% by mass, 45% by mass, 42% by mass, 40% by mass, 38% by mass, 35% by mass, 33% by mass, or 30% by mass of the total amount of the liquid crystal composition (B).

The compound(s) represented by general formula (L-1-2) is, moreover, preferably compound(s) selected from the group of compounds represented by formulae (L-1-2.1) to (L-1-2.4), preferably compound(s) represented by formulae (L-1-2.2) to (L-1-2.4). In particular, the compound represented by formula (L-1-2.2) is preferred because it improves the response rate of the liquid crystal composition (B) markedly. If a high Tni is wanted more than the response rate, it is preferred to use the compound represented by formula (L-1-2.3) or (L-1-2.4). It is not preferred to set the percentage of the compounds represented by formulae (L-1-2.3) and (L-1-2.4) to 30% by mass or more for the solubility at low temperatures to be good.

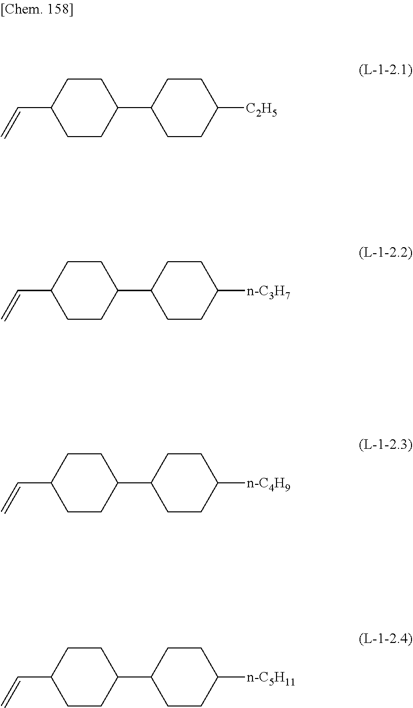

The lower limit of preferred percentages of the compound represented by formula (L-1-2.2) to the total amount of the liquid crystal composition (B) is 10% by mass, 15% by mass, 18% by mass, 20% by mass, 23% by mass, 25% by mass, 27% by mass, 30% by mass, 33% by mass, 35% by mass, 38% by mass, or 40% by mass. The upper limit of preferred percentages is 60% by mass, 55% by mass, 50% by mass, 45% by mass, 43% by mass, 40% by mass, 38% by mass, 35% by mass, 32% by mass, 30% by mass, 27% by mass, 25% by mass, or 22% by mass of the total amount of the liquid crystal composition (B).

The lower limit of preferred total percentages of the compounds represented by formulae (L-1-1.3) and (L-1-2.2) to the total amount of the liquid crystal composition (B) is 10% by mass, 15% by mass, 20% by mass, 25% by mass, 27% by mass, 30% by mass, 35% by mass, or 40% by mass. The upper limit of preferred percentages is 60% by mass, 55% by mass, 50% by mass, 45% by mass, 43% by mass, 40% by mass, 38% by mass, 35% by mass, 32% by mass, 30% by mass, 27% by mass, 25% by mass, or 22% by mass of the total amount of the liquid crystal composition (B).

The compound(s) represented by general formula (L-1) is preferably compound(s) selected from the group of compounds represented by general formula (L-1-3).

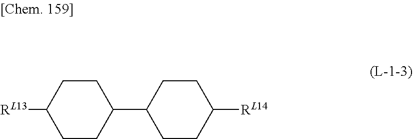

(wherein R^{L13} and R^{L14} each independently represent a C1-8 alkyl or C1-8 alkoxy group.)

R^{L13} and R^{L14} are preferably linear C1-5 alkyl, linear C1-4 alkoxy, or linear C2-5 alkenyl groups.

The lower limit of preferred percentages of the compound(s) represented by formula (L-1-3) to the total amount of the liquid crystal composition (B) is 1% by mass, 5% by mass, 10% by mass, 13% by mass, 15% by mass, 17% by mass, 20% by mass, 23% by mass, 25% by mass, or 30% by mass. The upper limit of preferred percentages is 60% by mass, 55% by mass, 50% by mass, 45% by mass, 40% by mass, 37% by mass, 35% by mass, 33% by mass, 30% by mass, 27% by mass, 25% by mass, 23% by mass, 20% by mass, 17% by mass, 15% by mass, 13% by mass, or 10% by mass of the total amount of the liquid crystal composition (B).

The compound(s) represented by general formula (L-1-3) is, moreover, preferably compound(s) selected from the group of compounds represented by formulae (L-1-3.1) to (L-1-3.12), preferably the compound represented by formula (L-1-3.1), (L-1-3.3), or (L-1-3.4). In particular, the compound represented by formula (L-1-3.1) is preferred because it improves the response rate of the liquid crystal composition (B) markedly. If a high Tni is wanted more than the response rate, it is preferred to use the compounds represented by formulae (L-1-3.3), (L-1-3.4), (L-1-3.11), and (L-1-3.12). It is not preferred to set the total percentage of the compounds represented by formulae (L-1-3.3), (L-1-3.4), (L-1-3.11), and (L-1-3.12) to 20% by mass or more for the solubility at low temperatures to be good.

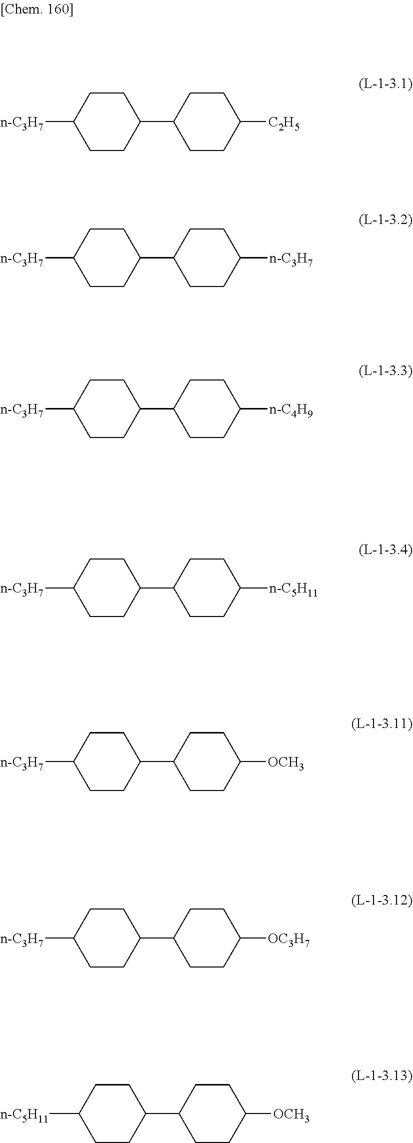

The lower limit of preferred percentages of the compound represented by formula (L-1-3.1) to the total amount of the liquid crystal composition (B) is 1% by mass, 2% by mass, 3% by mass, 5% by mass, 7% by mass, 10% by mass, 13% by mass, 15% by mass, 18% by mass, or 20% by mass. The upper limit of preferred percentages is 20% by mass, 17% by mass, 15% by mass, 13% by mass, 10% by mass, 8% by mass, 7% by mass, or 6% by mass of the total amount of the liquid crystal composition (B).

The compound(s) represented by general formula (L-1) is preferably compound(s) selected from the group of compounds represented by general formula (L-1-4) and/or general formula (L-1-5).

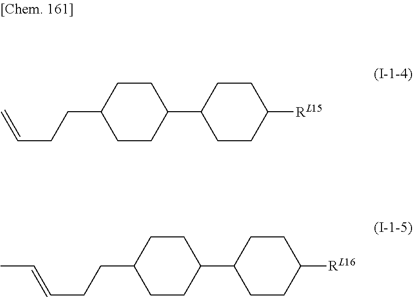

(wherein R^{L15} and R^{L16} each independently represent a C1-8 alkyl or C1-8 alkoxy group.)

R^{L15} and R^{L16} are preferably linear C1-5 alkyl, linear C1-4 alkoxy, or linear C2-5 alkenyl groups.

The lower limit of preferred percentages of compound(s) represented by formula (L-1-4) to the total amount of the liquid crystal composition (B) is 1% by mass, 5% by mass, 10% by mass, 13% by mass, 15% by mass, 17% by mass, or 20% by mass. The upper limit of preferred percentages is 25% by mass, 23% by mass, 20% by mass, 17% by mass, 15% by mass, 13% by mass, or 10% by mass of the total amount of the liquid crystal composition (B).

The lower limit of preferred percentages of compound(s) represented by formula (L-1-5) to the total amount of the liquid crystal composition (B) is 1% by mass, 5% by mass, 10% by mass, 13% by mass, 15% by mass, 17% by mass, or 20% by mass. The upper limit of preferred percentages is 25% by mass, 23% by mass, 20% by mass, 17% by mass, 15% by mass, 13% by mass, or 10% by mass of the total amount of the liquid crystal composition (B).

The compound(s) represented by general formulae (L-1-4) and (L-1-5) is, moreover, preferably compound(s) selected from the group of compounds represented by formulae (L-1-4.1) to (L-1-5.3), preferably the compound represented by formula (L-1-4.2) or (L-1-5.2).

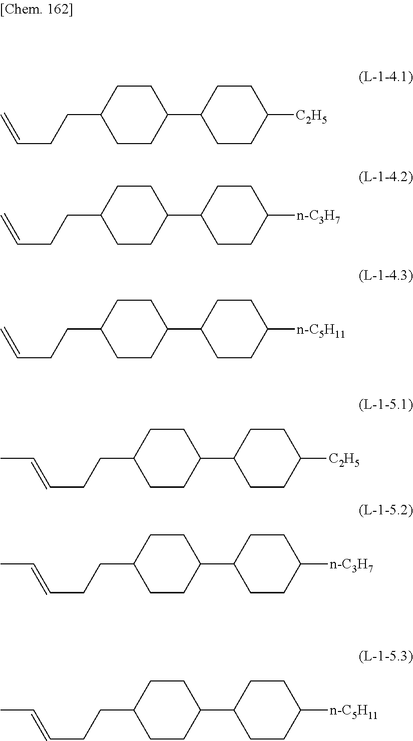

The lower limit of preferred percentages of the compound represented by formula (L-1-4.2) to the total amount of the liquid crystal composition (B) is 1% by mass, 2% by mass, 3% by mass, 5% by mass, 7% by mass, 10% by mass, 13% by mass, 15% by mass, 18% by mass, or 20% by mass. The upper limit of preferred percentages is 20% by mass, 17% by mass, 15% by mass, 13% by mass, 10% by mass, 8% by mass, 7% by mass, or 6% by mass of the total amount of the liquid crystal composition (B).

It is preferred to combine two or more compounds selected from the compounds represented by formulae (L-1-1.3), (L-1-2.2), (L-1-3.1), (L-1-3.3), (L-1-3.4), (L-1-3.11), and (L-1-3.12), preferably two or more compounds selected from the compounds represented by formulae (L-1-1.3), (L-1-2.2), (L-1-3.1), (L-1-3.3), (L-1-3.4), and (L-1-4.2). The lower limit of preferred percentages of the total percentage of these compounds is 1% by mass, 2% by mass, 3% by mass, 5% by mass, 7% by mass, 10% by mass, 13% by mass, 15% by mass, 18% by mass, 20% by mass, 23% by mass, 25% by mass, 27% by mass, 30% by mass, 33% by mass, or 35% by mass of the total amount of the liquid crystal composition (B). The upper limit is 80% by mass, 70% by mass, 60% by mass, 50% by mass, 45% by mass, 40% by mass, 37% by mass, 35% by mass, 33% by mass, 30% by mass, 28% by mass, 25% by mass, 23% by mass, or 20% by mass of the total amount of the liquid crystal composition (B). If the reliability of the composition is a high priority, it is preferred to combine two or more compounds selected from the compounds represented by formulae (L-1-3.1), (L-1-3.3), and (L-1-3.4)). If the response rate of the composition is a high priority, it is preferred to combine two or more compounds selected from the compounds represented by formulae (L-1-1.3) and (L-1-2.2).

The compound(s) represented by general formula (L-1) is preferably compound(s) selected from the group of compounds represented by general formula (L-1-6).

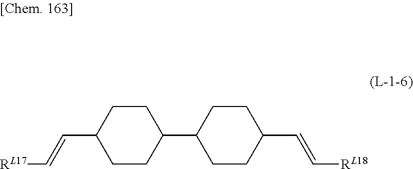

(wherein R^{L17} and R^{L18} each independently represent a methyl group or hydrogen atom.)

The lower limit of preferred percentages of the compound(s) represented by formula (L-1-6) to the total amount of the liquid crystal composition (B) is 1% by mass, 5% by mass, 10% by mass, 15% by mass, 17% by mass, 20% by mass, 23% by mass, 25% by mass, 27% by mass, 30% by mass, or 35% by mass. The upper limit of preferred percentages is 60% by mass, 55% by mass, 50% by mass, 45% by mass, 42% by mass, 40% by mass, 38% by mass, 35% by mass, 33% by mass, or 30% by mass of the total amount of the liquid crystal composition (B).

The compound(s) represented by general formula (L-1-6) is, moreover, preferably compound(s) selected from the group of compounds represented by formulae (L-1-6.1) to (L-1-6.3).

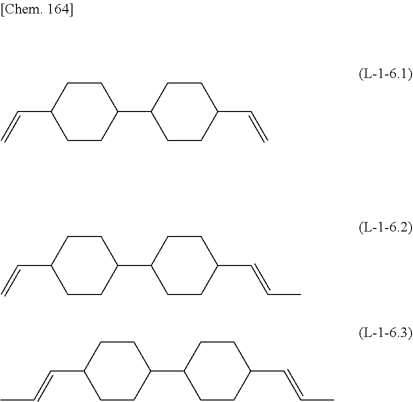

The compounds represented by general formula (L-2) are the following compounds.

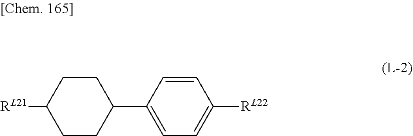

(where R^{L21} and R^{L22} each independently represent the same meaning as R^{L1} and R^{L2} in general formula (L).)

R^{L21} is preferably a C1-5 alkyl or C2-5 alkenyl group, and R^{L22} is preferably a C1-5 alkyl, C4-5 alkenyl, or C1-4 alkoxy group.

The compounds represented by general formula (L-1) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

If solubility at low temperatures is a high priority, setting the percentage relatively large is highly effective. If the response rate is a high priority, by contrast, setting the percentage relatively small is highly effective. To improve drop marks or image-sticking properties, it is preferred to set the range of percentages to a medium range.

The lower limit of preferred percentages of the compound(s) represented by general formula (L-2) to the total amount of the liquid crystal composition (B) is 1% by mass, 2% by mass, 3% by mass, 5% by mass, 7% by mass, or 10% by mass. The upper limit of preferred percentages is 20% by mass, 15% by mass, 13% by mass, 10% by mass, 8% by mass, 7% by mass, 6% by mass, 5% by mass, or 3% by mass of the total amount of the liquid crystal composition (B).

The compound(s) represented by general formula (L-2) is, moreover, preferably compound(s) selected from the group of compounds represented by formulae (L-2.1) to (L-2.6), preferably compound(s) represented by formulae (L-2.1), (L-2.3), (L-2.4), and (L-2.6).

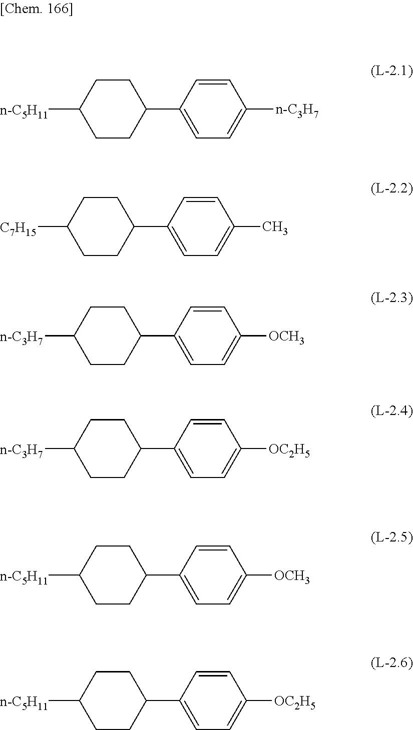

The compounds represented by general formula (L-3) are the following compounds.

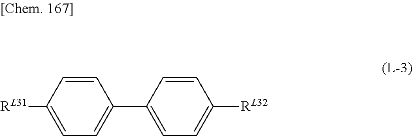

(where R^{L31} and R^{L32} each independently represent the same meaning as R^{L1} and R^{L2} in general formula (L).) Each of R^{L31} and R^{L32} is preferably independently a C1-5 alkyl, C4-5 alkenyl, or C1-4 alkoxy group.

The compounds represented by general formula (L-3) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

The lower limit of preferred percentages of the compound(s) represented by general formula (L-3) to the total amount of the liquid crystal composition (B) is 1% by mass, 2% by mass, 3% by mass, 5% by mass, 7% by mass, or 10% by mass. The upper limit of preferred percentages is 20% by mass, 15% by mass, 13% by mass, 10% by mass, 8% by mass, 7% by mass, 6% by mass, 5% by mass, or 3% by mass of the total amount of the liquid crystal composition (B).

To achieve a high birefringence, setting the percentage relatively large is highly effective. If a high Tni is a high priority, by contrast, setting the percentage relatively small is highly effective. To improve drop marks or image-sticking properties, it is preferred to set the range of percentages to a medium range.

The compound(s) represented by general formula (L-3) is, moreover, preferably compound(s) selected from the group of compounds represented by formulae (L-3.1) to (L-3.4), preferably compound(s) represented by formulae (L-3.2) to (L-3.7).

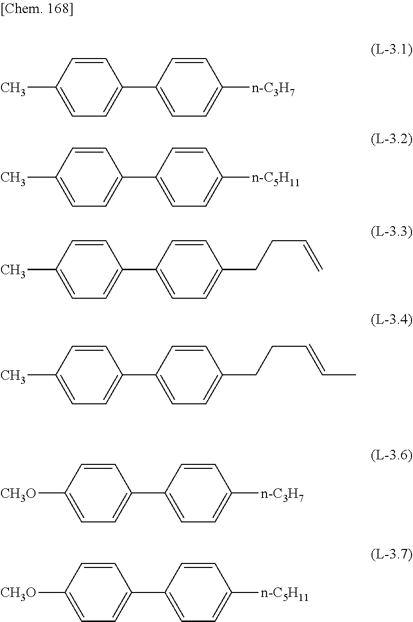

The compounds represented by general formula (L-4) are the following compounds.

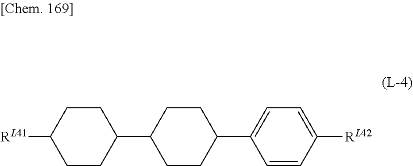

(where R^{L41} and R^{L42} each independently represent the same meaning as R^{L1} and R^{L2} in general formula (L).)

R^{L41} is preferably a C1-5 alkyl or C2-5 alkenyl group, and R^{L42} is preferably a C1-5 alkyl, C4-5 alkenyl, or C1-4 alkoxy group.)

The compounds represented by general formula (L-4) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

In the liquid crystal composition (B), the percentage of the compound(s) represented by general formula (L-4) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (L-4) to the total amount of the liquid crystal composition (B) is 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass. The upper limit of preferred percentages of the compound(s) represented by formula (L-4) to the total amount of the liquid crystal composition (B) is 50% by mass, 40% by mass, 35% by mass, 30% by mass, 20% by mass, 15% by mass, 10% by mass, or 5% by mass.

The compound(s) represented by general formula (L-4) is preferably, for example, compound(s) represented by formulae (L-4.1) to (L-4.3)

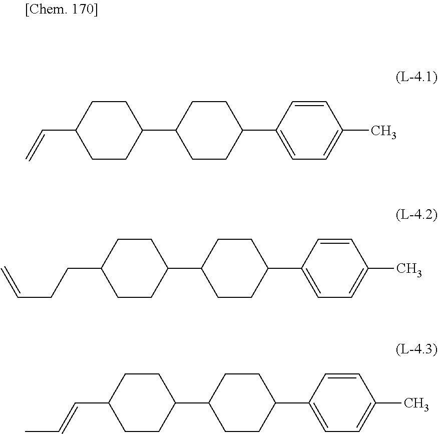

The liquid crystal composition (B) may contain the compound represented by formula (L-4.1), the compound represented by formula (L-4.2), or both compounds represented by formulae (L-4.1) and (L-4.2) or may even contain all compounds represented by formulae (L-4.1) to (L-4.3), depending on the performance attributes required, such as solubility at low temperatures, transition temperature, electrical reliability, and birefringence. The lower limit of preferred percentages of the compound represented by formula (L-4.1) or (L-4.2) to the total amount of the liquid crystal composition (B) is 3% by mass, 5% by mass, 7% by mass, 9% by mass, 11% by mass, 12% by mass, 13% by mass, 18% by mass, or 21% by mass. Preferred upper limits are 45% by mass, 40% by mass, 35% by mass, 30% by mass, 25% by mass, 23% by mass, 20% by mass, 18% by mass, 15% by mass, 13% by mass, 10% by mass, and 8% by mass.

If both compounds represented by formulae (L-4.1) and (L-4.2) are contained, the lower limit of preferred percentages of the two compounds to the total amount of the liquid crystal composition (B) is 15% by mass, 19% by mass, 24% by mass, or 30% by mass. Preferred upper limits are 45% by mass, 40% by mass, 35% by mass, 30% by mass, 25% by mass, 23% by mass, 20% by mass, 18% by mass, 15% by mass, and 13% by mass.

The compound(s) represented by general formula (L-4) is preferably, for example, compound(s) represented by formulae (L-4.4) to (L-4.6), preferably the compound represented by formula (L-4.4).

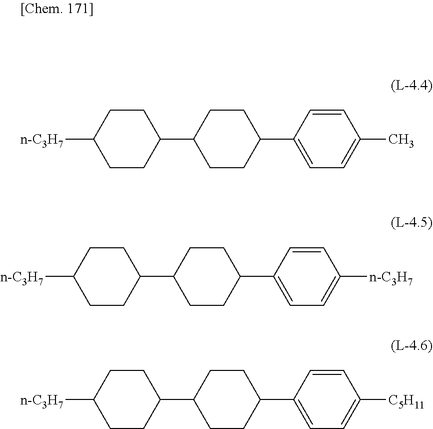

The liquid crystal composition (B) may contain the compound represented by formula (L-4.4), the compound represented by formula (L-4.5), or both compounds represented by formulae (L-4.4) and (L-4.5), depending on the performance attributes required, such as solubility at low temperatures, transition temperature, electrical reliability, and birefringence.

The lower limit of preferred percentages of the compound represented by formula (L-4.4) or (L-4.5) to the total amount of the liquid crystal composition (B) is 3% by mass, 5% by mass, 7% by mass, 9% by mass, 11% by mass, 12% by mass, 13% by mass, 18% by mass, or 21% by mass. Preferred upper limits are 45% by mass, 40% by mass, 35% by mass, 30% by mass, 25% by mass, 23% by mass, 20% by mass, 18% by mass, 15% by mass, 13% by mass, 10% by mass, and 8% by mass.

If both compounds represented by formulae (L-4.4) and (L-4.5) are contained, the lower limit of preferred percentages of the two compounds to the total amount of the liquid crystal composition (B) is 15% by mass, 19% by mass, 24% by mass, or 30% by mass. Preferred upper limits are 45% by mass, 40% by mass, 35% by mass, 30% by mass, 25% by mass, 23% by mass, 20% by mass, 18% by mass, 15% by mass, and 13% by mass.

The compound(s) represented by general formula (L-4) is preferably compound(s) represented by formulae (L-4.7) to (L-4.10), in particular the compound represented by formula (L-4.9).

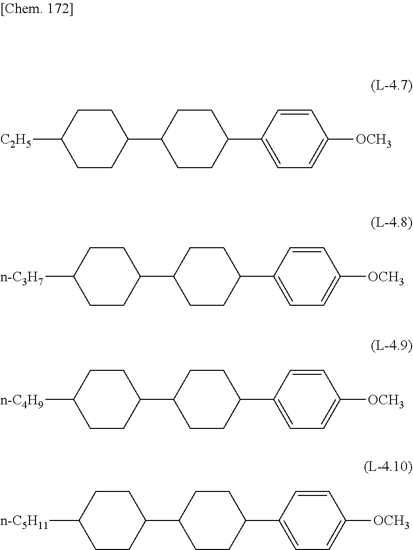

The compounds represented by general formula (L-5) are the following compounds.

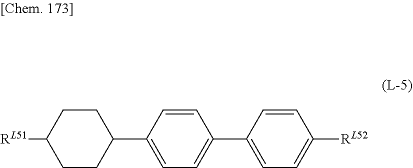

(where R^{L51} and R^{L52} each independently represent the same meaning as R^{L1} and R^{L2} in general formula (L).)

R^{L51} is preferably a C1-5 alkyl or C2-5 alkenyl group, and R^{L52} is preferably a C1-5 alkyl, C4-5 alkenyl, or C1-4 alkoxy group.

The compounds represented by general formula (L-5) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

In the liquid crystal composition (B), the percentage of the compound(s) represented by general formula (L-5) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (L-5) to the total amount of the liquid crystal composition (B) is 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass. The upper limit of preferred percentages of the compound(s) represented by formula (L-5) to the total amount of the liquid crystal composition (B) is 50% by mass, 40% by mass, 35% by mass, 30% by mass, 20% by mass, 15% by mass, 10% by mass, or 5% by mass

The compound(s) represented by general formula (L-5) is preferably the compound represented by formula (L-5.1) or (L-5.2), in particular the compound represented by general formula (L-5.1).

The lower limit of preferred percentages of these compounds to the total amount of the liquid crystal composition (B) is 1% by mass, 2% by mass, 3% by mass, 5% by mass, or 7% by mass. The upper limit of preferred percentages of these compounds is 20% by mass, 15% by mass, 13% by mass, 10% by mass, or 9% by mass.

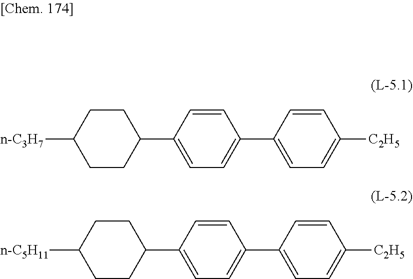

The compound(s) represented by general formula (L-5) is preferably the compound represented by formula (L-5.3) or (L-5.4).

The lower limit of preferred percentages of these compounds to the total amount of the liquid crystal composition (B) is 1% by mass, 2% by mass, 3% by mass, 5% by mass, or 7% by mass. The upper limit of preferred percentages of these compounds is 20% by mass, 15% by mass, 13% by mass, 10% by mass, or 9% by mass.

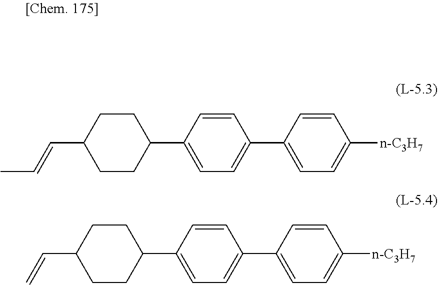

The compound(s) represented by general formula (L-5) is preferably compound(s) selected from the group of compounds represented by formulae (L-5.5) to (L-5.7), in particular the compound represented by formula (L-5.7).

The lower limit of preferred percentages of these compounds to the total amount of the liquid crystal composition (B) is 1% by mass, 2% by mass, 3% by mass, 5% by mass, or 7% by mass. The upper limit of preferred percentages of these compounds is 20% by mass, 15% by mass, 13% by mass, 10% by mass, or 9% by mass.

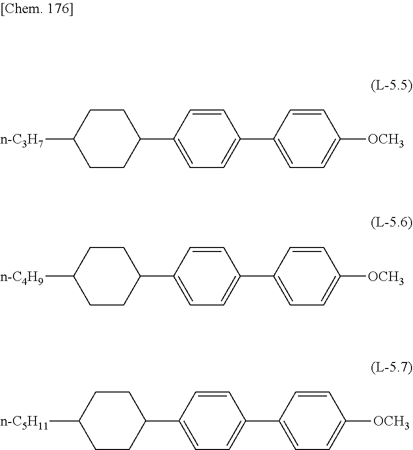

The compounds represented by general formula (L-6) are the following compounds.

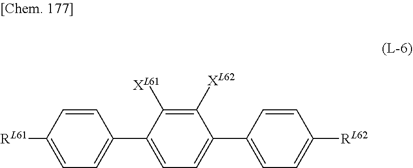

(where R^{L61} and R^{L62} each independently represent the same meaning as R^{L1} and R^{L2} in general formula (L), and X^{L61} and X^{L62} each independently represent a hydrogen or fluorine atom.)

Each of R^{L61} and R^{L62} is preferably independently a C1-5 alkyl or C2-5 alkenyl group. It is preferred that one of X^{L61} and X^{L62} be a fluorine atom with the other being a hydrogen atom.

The compounds represented by general formula (L-6) can be used alone but can also be used in a combination of two or more compounds. Any two or more of the compounds can be combined, but compounds needed for the performance attributes required, such as solubility at low temperatures, transition temperature, electrical reliability, and birefringence, are used in combination. The number of kinds of compounds used is one, two, three, four, or five or more as an embodiment according to the present invention by way of example.

The lower limit of preferred percentages of the compound(s) represented by general formula (L-6) to the total amount of the liquid crystal composition (B) is 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass. The upper limit of preferred percentages of the compound(s) represented by formula (L-6) to the total amount of the liquid crystal composition (B) is 50% by mass, 40% by mass, 35% by mass, 30% by mass, 20% by mass, 15% by mass, 10% by mass, or 5% by mass. If emphasis is on increasing Δn, it is preferred to set the percentage large. If emphasis is on separation at low temperatures, it is preferred that the percentage be small.

The compound(s) represented by general formula (L-6) is preferably compound(s) represented by formulae (L-6.1) to (L-6.9).

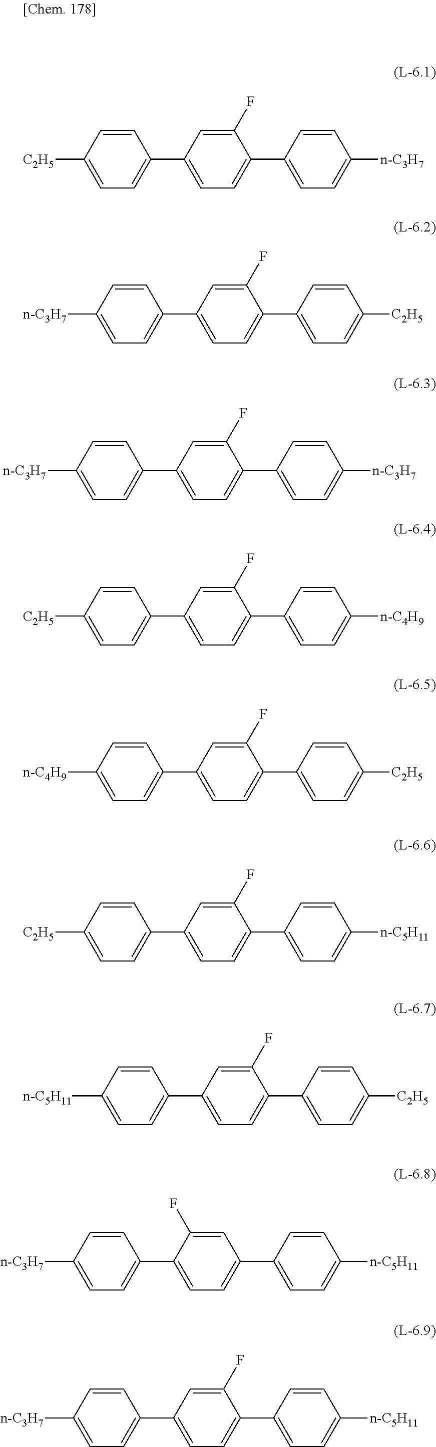

Any two or more of these compounds can be combined, but it is preferred that the liquid crystal composition (B) contain one to three of these compounds, more preferably one to four. It would also be advantageous for solubility that the selected compounds have a broad molecular weight distribution. Thus, it is preferred to select one compound from those represented by formula (L-6.1) or (L-6.2), one from those represented by formula (L-6.4) or (L-6.5), one from those represented by formula (L-6.6) or (L-6.7), and one from those represented by formula (L-6.8) or (L-6.9) and combine them as needed. In particular, it is preferred that the liquid crystal composition (B) contain the compounds represented by formulae (L-6.1), (L-6.3), (L-6.4), (L-6.6), and (L-6.9).

The compound(s) represented by general formula (L-6), moreover, is preferably, for example, compound(s) represented by formulae (L-6.10) to (L-6.17), in particular the compound represented by formula (L-6.11).

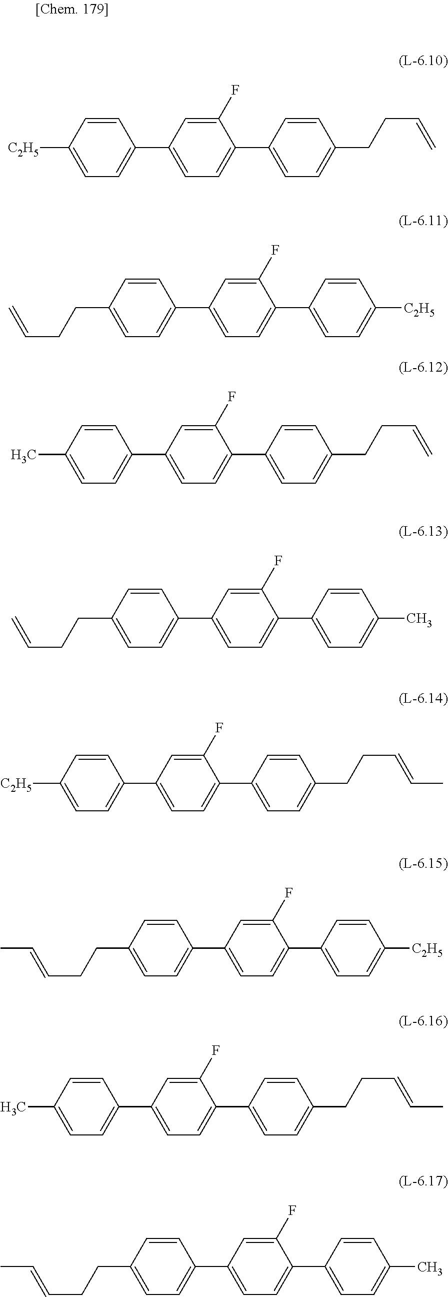

The lower limit of preferred percentages of these compounds to the total amount of the liquid crystal composition (B) is 1% by mass, 2% by mass, 3% by mass, 5% by mass, or 7% by mass. The upper limit of preferred percentages of these compounds is 20% by mass, 15% by mass, 13% by mass, 10% by mass, or 9% by mass.

The compounds represented by general formula (L-7) are the following compounds.

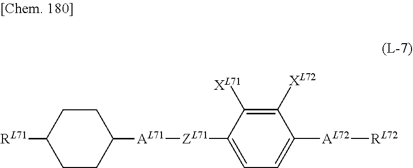

(where R^{L71} and R^{L72} each independently represent the same meaning as R^{L1} and R^{L2} in general formula (L), and A^{L71} and A^{L72} each independently represent the same meaning as A^{L2} and A^{L3} in general formula (L). The hydrogen atoms on A^{L71} and A^{L72} may each independently be substituted with a fluorine atom. Z^{L71} represents the same meaning as Z^{L2} in general formula (L), and X^{L71} and X^{L72} each independently represent a fluorine or hydrogen atom.)

In the formula, each of R^{L71} and R^{L72} is preferably independently a C1-5 alkyl, C2-5 alkenyl, or C1-4 alkoxy, and each of A^{L71} and A^{L72} is preferably independently a 1,4-cyclohexylene or 1,4-phenylene group. The hydrogen atoms on A^{L71} and A^{L72} may each independently be substituted with a fluorine atom. Z^{L71} is preferably a single bond or COO—, preferably a single bond. X^{L71} and X^{L72} are preferably hydrogen bonds.

Any two or more such compounds can be combined, but compounds are combined in accordance with the performance attributes required, such as solubility at low temperatures, transition temperature, electrical reliability, and birefringence. The number of kinds of compounds used is one, two, three, or four as an embodiment according to the present invention by way of example.

In the liquid crystal composition (B), the percentage of the compound(s) represented by general formula (L-7) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (L-7) to the total amount of the liquid crystal composition (B) is 1% by mass, 2% by mass, 3% by mass, 5% by mass, 7% by mass, 10% by mass, 14% by mass, 16% by mass, or 20% by mass. The upper limit of preferred percentages of the compound(s) represented by formula (L-7) to the total amount of the liquid crystal composition (B) is 30% by mass, 25% by mass, 23% by mass, 20% by mass, 18% by mass, 15% by mass, 10% by mass, or 5% by mass.

If an embodiment with a high-Tni liquid crystal composition (B) is desired, it is preferred to set the percentage of the compound(s) represented by formula (L-7) relatively large. If an embodiment with a low-viscosity liquid crystal composition (B) is desired, it is preferred to set the percentage relatively small.

The compound(s) represented by general formula (L-7), moreover, is preferably compound(s) represented by formulae (L-7.1) to (L-7.4), preferably the compound represented by formula (L-7.2).

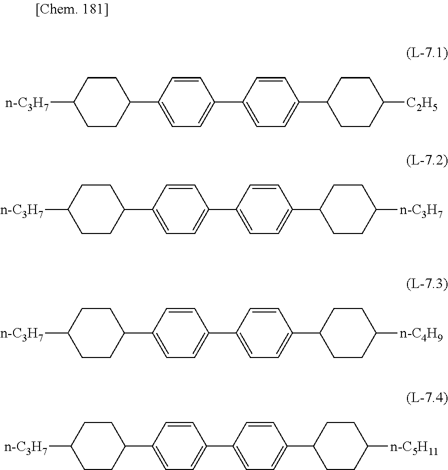

The compound(s) represented by general formula (L-7), moreover, is preferably compound(s) represented by formulae (L-7.11) to (L-7.13), preferably the compound represented by formula (L-7.11).

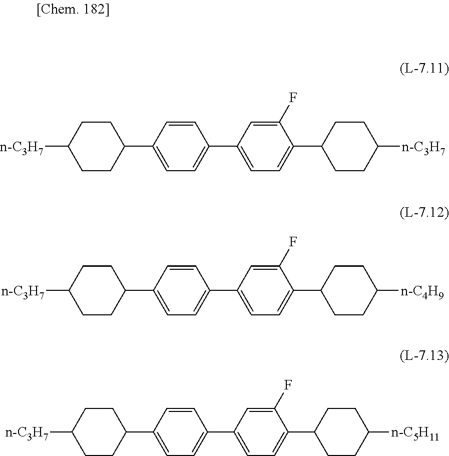

The compound(s) represented by general formula (L-7), moreover, is preferably compound(s) represented by formulae (L-7.21) to (L-7.23), preferably the compound represented by formula (L-7.21).

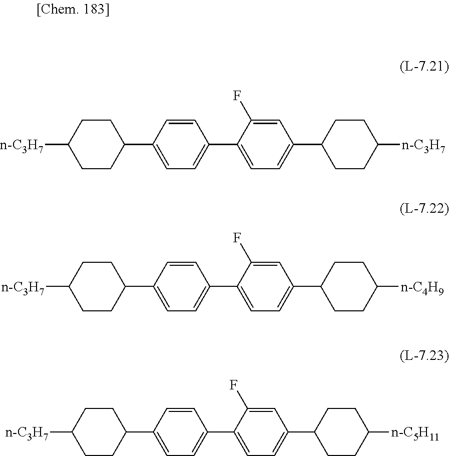

The compound(s) represented by general formula (L-7), moreover, is preferably compound(s) represented by formulae (L-7.31) to (L-7.34), preferably the compound(s) represented by formula (L-7.31) and/or formula (L-7.32).

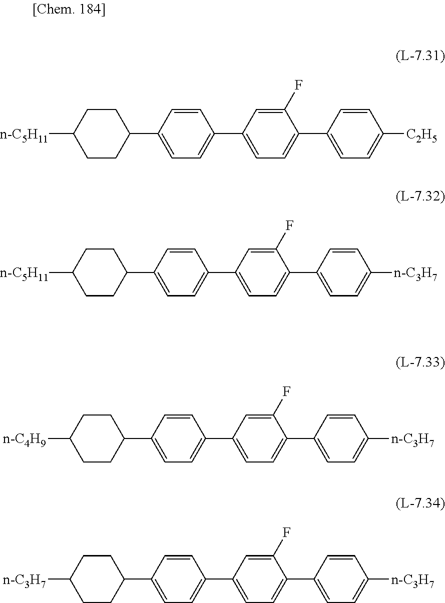

The compound(s) represented by general formula (L-7), moreover, is preferably compound(s) represented by formulae (L-7.41) to (L-7.44), preferably the compound(s) represented by formula (L-7.41) and/or formula (L-7.42).

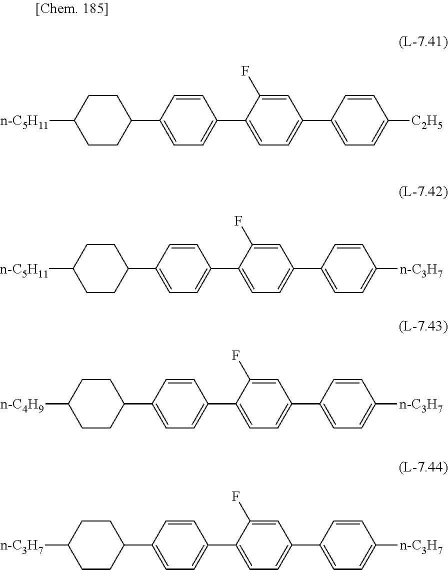

The compound(s) represented by general formula (L-7), moreover, is preferably compound(s) represented by formulae (L-7.51) to (L-7.53).

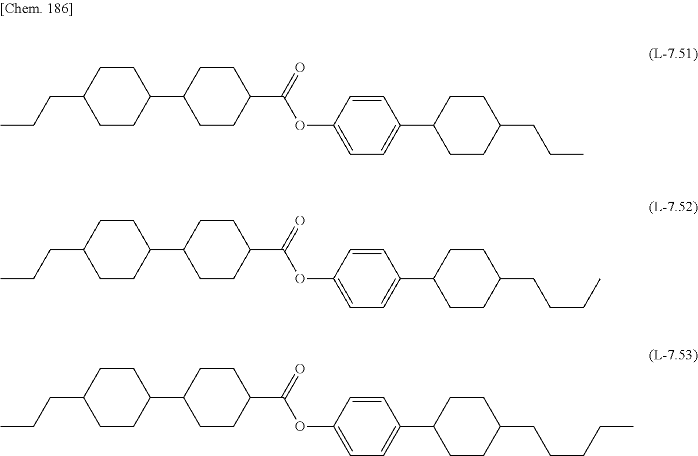

The compounds represented by general formula (L-8) are the following compounds.

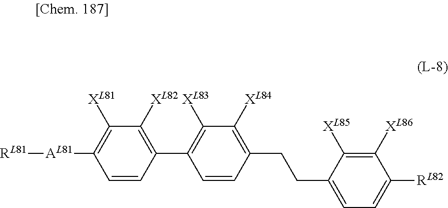

(where R^{L81} and R^{L82} each independently represent the same meaning as R^{L1} and R^{L2} in general formula (L), and A^{L81} represents the same meaning as A^{L1} in general formula (L) or a single bond. The hydrogen atoms on A^{L81} may each independently substituted with a fluorine atom. X^{L81} to X^{L86} each independently represent a fluorine or hydrogen atom.)

In the formula, each of R^{L81} and R^{L82} is preferably independently a C1-5 alkyl, C2-5 alkenyl, or C1-4 alkoxy, and A^{L81} is preferably a 1,4-cyclohexylene or 1,4-phenylene group. The hydrogen atoms on A^{L71} and A^{L72} may each independently be substituted with a fluorine atom. The number of fluorine atoms on each single ring structure in general formula (L-8) is preferably 0 or 1. The number of fluorine atoms in the molecule is preferably 0 or 1.

Any two or more such compounds can be combined, but compounds are combined in accordance with the performance attributes required, such as solubility at low temperatures, transition temperature, electrical reliability, and birefringence. The number of kinds of compounds used is one, two, three, or four as an embodiment according to the present invention by way of example.

In the liquid crystal composition (B), the percentage of the compound(s) represented by general formula (L-8) needs to be adjusted as needed for the performance attributes required, such as solubility at low temperatures, transition temperature, electrical reliability, birefringence, process suitability, drop marks, image-sticking, and dielectric constant anisotropy.

The lower limit of preferred percentages of the compound(s) represented by general formula (L-8) to the total amount of the liquid crystal composition (B) is 1% by mass, 2% by mass, 3% by mass, 5% by mass, 7% by mass, 10% by mass, 14% by mass, 16% by mass, or 20% by mass. The upper limit of preferred percentages of the compound(s) represented by formula (L-8) to the total amount of the liquid crystal composition (B) is 30% by mass, 25% by mass, 23% by mass, 20% by mass, 18% by mass, 15% by mass, 10% by mass, or 5% by mass.

If an embodiment with a high-Tni liquid crystal composition (B) is desired, it is preferred to set the percentage of the compound(s) represented by formula (L-8) relatively large. If an embodiment with a low-viscosity liquid crystal composition (B) is desired, it is preferred to set the percentage relatively small.

The compound(s) represented by general formula (L-8), moreover, is preferably compound(s) represented by formulae (L-8.1) to (L-8.4), more preferably compound(s) represented by formulae (L-8.3), (L-8.5), (L-8.6), (L-8.13), (L-8.16) to (L-8.18), and (L-8.23) to (L-8.28)

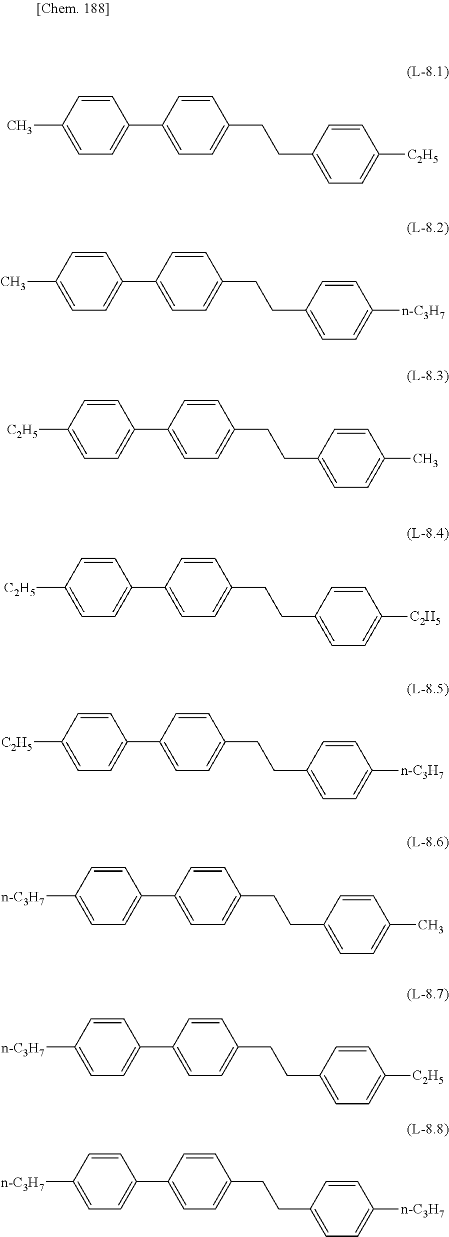

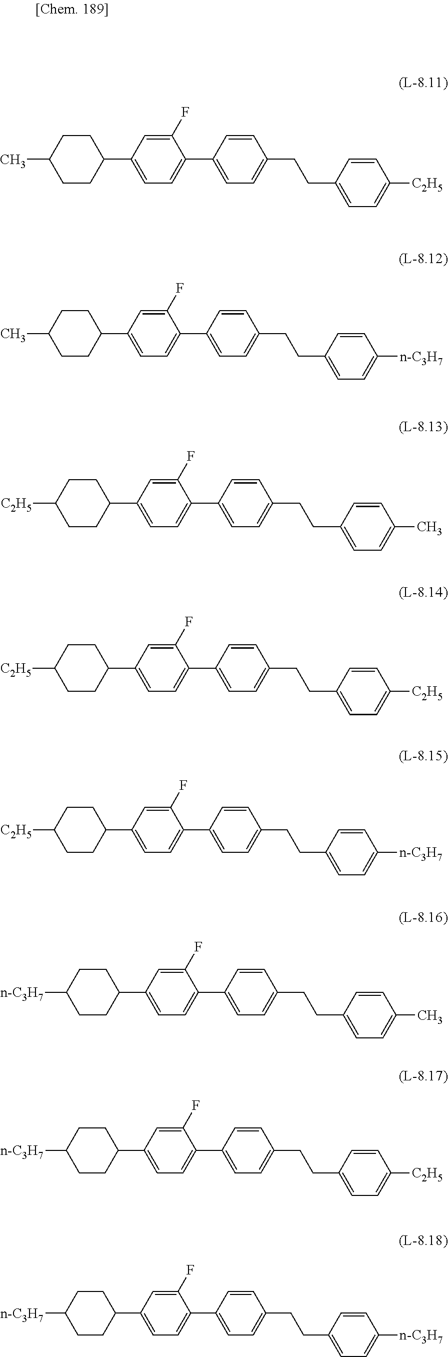

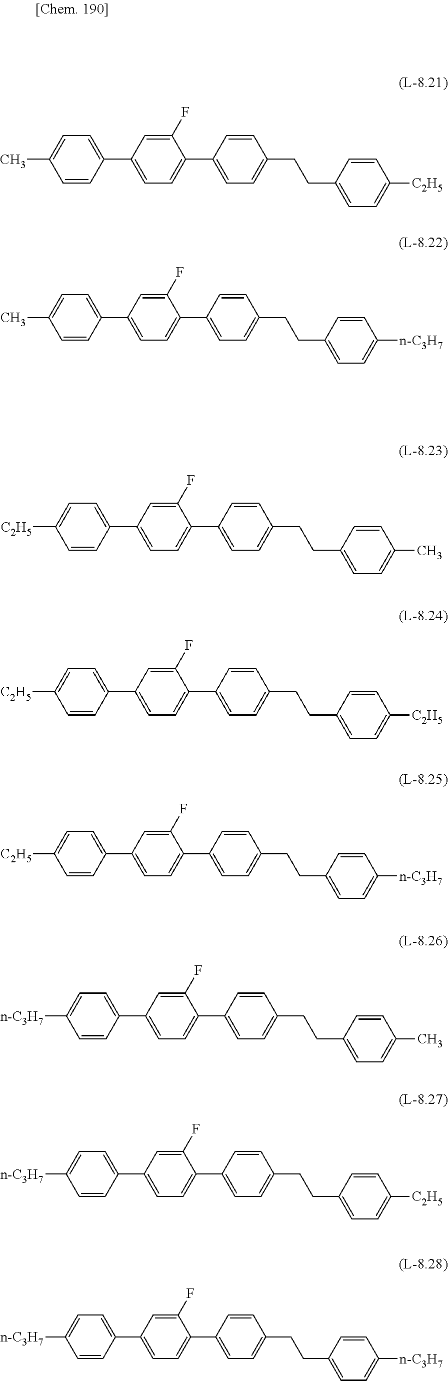

The lower limit of preferred total percentages of the compounds represented by general formula (L), (N-1), (N-2), (N-3), (N-4), and (J) to the total amount of the liquid crystal composition (B) is 80% by mass, 85% by mass, 88% by mass, 90% by mass, 92% by mass, 93% by mass, 94% by mass, 95% by mass, 96% by mass, 97% by mass, 98% by mass, 99% by mass, or 100% by mass. The upper limit of preferred percentages is 100% by mass, 99% by mass, 98% by mass, or 95% by mass. To give the composition a large absolute A, however, it is preferred that the percentage of at least one of the compounds represented by general formulae (N-1), (N-2), (N-3), (N-4), and (J) be 0% by mass.

The liquid crystal composition (B) preferably contains no compound that has a structure in which oxygen atoms are bound to each other, such as the peracid (—CO—OO—) structure, in the molecule.

If the reliability and long-term stability of the composition are high priorities, it is preferred that the percentage of compounds having a carbonyl group be 5% by mass or less, more preferably 3% by mass or less, even more preferably 1% by mass or less of the total mass of the composition. It is the most preferred that the composition contain substantially no such compounds.

If stability by UV irradiation is a high priority, it is preferred that the percentage of compounds substituted with chlorine atom(s) be 15% by mass or less, preferably 10% by mass or less, preferably 8% by mass or less, more preferably 5% by mass or less, preferably 3% by mass or less of the total mass of the composition. It is more preferred that the composition contain substantially no such compounds.

Preferably, the percentage of compounds whose ring structures in the molecule are all six-membered rings is large. It is preferred that the percentage of compounds whose ring structures in the molecule are all six-membered rings be 80% by mass or more, more preferably 90% by mass or more, even more preferably 95% by mass or more of the total mass of the composition. It is the most preferred that the composition be formed substantially only by compound(s) whose ring structures in the molecule are all six-membered rings.

To prevent oxidative deterioration of the composition, it is preferred that the percentage of compounds having a cyclohexenylene group as a ring structure be small. It is preferred that the percentage of compounds having a cyclohexenylene group be 10% by mass or less, preferably 8% by mass or less, more preferably 5% by mass or less, preferably 3% by mass or less of the total mass of the composition. It is even more preferred that the composition contain substantially no such compounds.

If improving viscosity and improving Tni are high priorities, it is preferred that the percentage of compounds having a 2-methylbenzen-1,4-diyl group, with or without hydrogen atom(s) substituted with a halogen, in the molecule be small. It is preferred that the percentage of compounds having such a 2-methylbenzen-1,4-diyl group in the molecule be 10% by mass or less, preferably 8% by mass or less, more preferably 5% by mass or less, preferably 3% by mass or less of the total mass of the composition. It is even more preferred that the composition contain substantially no such compounds.

Containing substantially no something herein means that the composition is free from it except for unintended contaminants.

If a compound contained in the liquid crystal composition (B) has a pendant alkenyl group and if the alkenyl group is bound to cyclohexane, the number of carbon atoms in the alkenyl group is preferably between 2 and 5. If the alkenyl group is bound to benzene, the number of carbon atoms in the alkenyl group is preferably 4 or 5, and it is preferred that the unsaturated bond of the alkenyl group be not directly bound to the benzene.

The average elastic constant (K_{AVG}) of liquid crystal compositions used in the liquid crystal composition (B) is preferably between 10 and 25. The lower limit is preferably 10, preferably 10.5, preferably 11, preferably 11.5, preferably 12, preferably 12.3, preferably 12.5, preferably 12.8, preferably 13, preferably 13.3, preferably 13.5, preferably 13.8, preferably 14, preferably 14.3, preferably 14.5, preferably 14.8, preferably 15, preferably 15.3, preferably 15.5, preferably 15.8, preferably 16, preferably 16.3, preferably 16.5, preferably 16.8, preferably 17, preferably 17.3, preferably 17.5, preferably 17.8, preferably 18. The upper limit is preferably 25, preferably 24.5, preferably 24, preferably 23.5, preferably 23, preferably 22.8, preferably 22.5, preferably 22.3, preferably 22, preferably 21.8, preferably 21.5, preferably 21.3, preferably 21, preferably 20.8, preferably 20.5, preferably 20.3, preferably 20, preferably 19.8, preferably 19.5, preferably 19.3, preferably 19, preferably 18.8, preferably 18.5, preferably 18.3, preferably 18, preferably 17.8, preferably 17.5, preferably 17.3, preferably 17. If cutting power consumption is a high priority, reducing the intensity of the backlight is effective, and, when it comes to the liquid crystal display element, it is preferred to improve its optical transmittance. For this to be possible, it is preferred to set the value of K_{AVG} relatively low. If improving the response rate is a high priority, it is preferred to set the value of K_{AVG} relatively high.

The liquid crystal composition (B) preferably exhibits a particular value of Z, a function of rotational viscosity and refractive index anisotropy.

Z=γ1/Δn₂ [Math. 1]

(where γ₁ represents rotational viscosity, and Δn represents refractive index anisotropy.)

Z is preferably 13000 or less, more preferably 12000 or less, in particular 11000 or less.

If used in an active-matrix display element, the liquid crystal composition (B) needs to have a resistivity of 10¹² (Ω·m) or more, preferably 10¹³ (Ω·m), more preferably 10¹⁴ (Ω·m) or more.

When it comes to how to polymerize the polymerizable compound(s) used in the present invention, it can be polymerized by radical polymerization using the aforementioned polymerization initiator (C).

An element-production liquid crystal composition can contain, as essential ingredients, a radically polymerizable monomer component (A), a liquid crystal composition (B), and a polymerization initiator (C). The proportion of the radically polymerizable monomer component (A) can be between 0.5% and 20% by mass, preferably between 1% and 10% by mass, of the polymerizable liquid crystal composition.

The element-production liquid crystal composition used in the present invention is preferably one that forms polymer networks having a uniaxial optical anisotropy or uniaxial refractive index anisotropy or easy axis of orientation by virtue of containing 0.5% by mass to 20% by mass radically polymerizable monomer component (A), more preferably formed so that the optical axis or easy axis of orientation of the polymer networks will substantially coincide with the easy axis of orientation of the low-molecular liquid crystal. The polymer networks include polymer binders, which are thin films of polymer resulting from the gathering of multiple polymer networks. The polymer binders have a refractive index anisotropy that exhibits uniaxial orientation, and the low-molecular liquid crystal is dispersed in the thin films with the uniaxial optical axis of the thin films substantially aligned with the optical axis of the low-molecular liquid crystal.

Owing to these, the liquid crystal composition gives a polarized-light liquid crystal element the capability of high-contrast display by preventing light scattering, which would occur with a light-scattering polymer-dispersed or polymer-network liquid crystal, and improves the response of the liquid crystal element by reducing the decay time. Moreover, the element-production liquid crystal composition used in the present invention, if it forms polymer network layers throughout the liquid crystal element, is distinguishable from a PSA (Polymer Sustained Alignment) liquid crystal composition, which induces a pretilt by forming a thin film layer of polymer on the substrates of a liquid crystal element.

It is preferred to use at least two or more radically polymerizable monomer components (A) with different Tgs, whatever their concentration is, to adjust the Tg as needed. A radically polymerizable monomer component (A) that is a precursor to a high-Tg polymer is preferably a radically polymerizable monomer component (A) having a molecular structure that will give a high crosslink density and possessing two or more functional groups. A precursor to a low-Tg polymer preferably has one functional group or two or more functional groups with a spacer, for example an alkylene group, between the functional groups to extend the molecular length. If the Tg of the polymer networks is adjusted for the purpose of addressing the need for thermal stability and improved impact resistance of the polymer networks, it is preferred to control the proportion between multifunctional and monofunctional monomers as needed. Tg is also relevant to the thermal mobility of the backbone and side chains of the polymer networks at the molecular level, thereby influencing electrooptical characteristics. For example, increasing the crosslink density will reduce the molecular mobility of the backbone and thereby increase the strength of anchoring to the low-molecular liquid crystal. The drive voltage is increased, and the decay time is shortened. By contrast, reducing the crosslink density to lower Tg tends to increase the thermal mobility of the polymer backbone and reduce the strength of anchoring to the low-molecular liquid crystal, thereby lowering the drive voltage and extending the decay time. The interfacial anchoring strength of the polymer networks is influenced not only by the Tg but also by the molecular mobility of the side chains of the polymers, and using an acrylate or methacrylate of a monohydric or dihydric C8-18 alcohol compound as a radically polymerizable monomer component (A) helps reduce the interfacial anchoring strength of the polymers. Such a radically polymerizable monomer component (A) is effective in inducing a pretilt angle at the interfaces with the substrates and acts to reduce the polar anchoring strength.

When the radically polymerizable monomer components (A) in the element-production liquid crystal composition are polymerized with the element-production liquid crystal composition in the liquid crystal phase, the molecular weight increases, causing a phase separation between the liquid crystal composition (B) and polymers (or copolymers) The form of biphasic separation varies greatly depending on the kinds of liquid crystal composition and monomers contained. The phase separation structure may be formed by binodal decomposition, in which the monomer phase emerges and grows as countless islet cores in the liquid crystal material, or may be formed by spinodal decomposition, in which the phase separation occurs as a result of concentration fluctuations in the liquid crystal material with the monomer phase. Forming the polymer networks by binodal decomposition is preferred because when using monomer compounds with a fast reaction rate, binodal decomposition gives a phase separation structure on the order of nanometers as a result of countless monomer cores smaller than the visible spectrum being formed and linked into linear chains. With the progress of polymerization in the monomer phase, as a result, polymer networks are formed with a void spacing shorter than the visible spectrum depending on the phase separation structure. The voids in the polymer networks are produced by the separation of the liquid crystal composition (B) phase, and it is particularly preferred that these voids be smaller than the visible spectrum because this makes the liquid crystal display element high-contrast by virtue of having no light-scattering properties, and fast response time owing to a shortened decay time as a result of increased influence of the anchoring strength of the polymer networks. The formation of cores in the monomer phase in binodal decomposition is influenced by a difference in compatibility according the kinds and combination of compounds and by parameters such as reaction rate and temperature and is preferably controlled as needed. In ultraviolet polymerization, the reaction rate is determined by the functional group(s) of the monomers, the kind and amount of polymerization initiator, and the intensity of ultraviolet radiation. The manufacturer only needs to customize the conditions of ultraviolet irradiation as needed to promote reactivity, preferably so that the intensity of ultraviolet radiation is at least 2 mW/cm² or more. Spinodal decomposition is preferred because a microscopic phase separation structure produced as a result of periodic concentration fluctuations between the two phases facilitates creating void spacings that are uniform and smaller than the visible spectrum. At an increased percentage of the radically polymerizable monomer components (A), there is a phase transition temperature, or a temperature at which the liquid crystal composition is separated into two phases, liquid crystal composition (B)-rich and monomer-rich phases, by the effects of temperature. At temperatures higher than the phase transition temperature for biphasic separation, the liquid crystal composition is in the isotropic phase, but at lower temperatures, separation unfavorably prevents the formation of a uniform phase separation structure. If the biphasic separation is induced by a temperature change, it is preferred to form the phase separation structure at a temperature higher than the biphasic separation temperature. In all of the above cases, polymer networks are formed having the same alignment as the liquid crystal composition (B). During this, the polymerization-induced phase separation structure relates closely to the spacing and density of the polymer networks. In the process of the formation of the polymerization-induced phase separation structure, as stated, the two phases of monomer-rich and liquid-crystal-rich phases are formed. The photopolymerization initiator tends to concentrate around the monomers or in the liquid crystal, whichever the initiator is more compatible with, causing a localization of concentration. Localized presence of the photopolymerization initiator in the monomer-rich phase promotes the polymerization of monomers, but on the other hand it inhibits the polymerization of monomers remaining in the liquid-crystal-rich phase. The monomers remaining in the liquid-crystal-rich phase, in which the concentration of the photopolymerization initiator is low, crosslink by gathering in the monomer-rich phase, for example by the action of cohesion. The opposite, which can be the cases in which promoted polymerization of the monomers remaining in the liquid-crystal-rich phase increases the molecular weight of the monomers remaining in the liquid crystal and results in the formation of a new, polymerization-induced phase separation structure or the monomers aggregate in the monomer-rich phase, is preferred because the monomers remaining in the liquid-crystal-rich phase easily polymerize owing to the effects of the photopolymerization initiator dissolved in the liquid crystal phase. Additional phase separation induced by the polymerization of the monomers remaining in the liquid-crystal-rich phase and subsequent formation of extra polymer networks by virtue of the effect of the photopolymerization initiator are also preferred.

The resulting polymer networks exhibit optical anisotropy in line with the alignment of the liquid crystal composition (B). Possible forms of the liquid crystal layer in the polymer networks include the structure in which the liquid crystal composition (B) forms a continuous layer in the three-dimensional polymer network structure, the structure in which droplets of the liquid crystal composition (B) are dispersed between the polymers, the structure in which both are in the mix, and the structure in which there is a polymer network layer on the surface of each substrate, and the space near the middle between it and the opposite substrate is totally occupied by the liquid crystal layer. In any of these structures, it is preferred that a pretilt angle of 00 to 900 have been induced to the interfaces with the substrates of the liquid crystal display element by the action of the polymer networks. The polymer networks to be formed are preferably capable of orienting the coexisting liquid crystal composition (B) in the direction of alignment determined by the alignment films of the liquid crystal cell, and it is also preferred that the polymer networks be capable of pretilting the low-molecular liquid crystal with regard to the interfaces with the polymers. Introducing a monomer that pretilts the low-molecular liquid crystal with respect to the interfaces with the polymers is preferred because it is beneficial in improving transmittance and reducing the drive voltage of the liquid crystal element. The polymer networks may have refractive index anisotropy, and the capability of orienting the liquid crystal in the direction of alignment is preferably achieved using a monomer having a mesogenic group. The pretilt may alternatively be created by forming polymer networks, for example through ultraviolet irradiation, while applying a voltage.

If a vertical alignment cell, such as a VA-mode one, is used, a monomer can be an acrylate or methacrylate of a monohydric or dihydric C8-18 alcohol compound having no mesogenic groups that induce vertical orientation, and it is also preferred to use it in combination with a monomer having a mesogenic group. Polymer networks formed by phase separation polymerization using the element-production liquid crystal composition in a vertical alignment cell are preferably fibrous or columnar polymer networks formed substantially in the same direction as the vertical of the liquid crystal composition (B) to the substrates of the liquid crystal cell. If the vertical alignment films on the surface of the cell substrates have been treated to give the liquid crystal a tilted alignment, for example by rubbing, to induce a pretilt angle, it is preferred that the fibrous or columnar polymer networks have been formed tilted in the same direction as the liquid crystal composition (B) is in a pretilted alignment. The selection of monomers may be such that the polymer networks will tilt spontaneously at the interfaces with the substrates. It is also possible to form the polymer networks through irradiation, for example with ultraviolet radiation, while applying a voltage to bring the liquid crystal into a tilted alignment.

An alternative method for inducing a pretilt angle while applying a voltage is to initiate the polymerization while applying a voltage between about 0.9 V lower and about 2 V higher than the threshold voltage of the element-production liquid crystal composition, and another is to apply a voltage equal to or higher than the threshold voltage for a short time, seconds to tens of seconds, during the formation of polymer networks and then form polymer networks at a voltage lower than the threshold voltage. This is more preferred because fibrous or columnar polymer networks are formed tilted to induce a pretilt angle of 900 to 800 to the plane of the transparent substrates. The pretilt angle is preferably between 900 and 85°, preferably between 89.90 to 850, preferably between 89.90 and 87°, preferably between 89.90 and 88°. The fibrous or columnar polymer networks formed by any of these methods connect the two cell substrates together. This improves the thermal stability of the pretilt angle, thereby helping increase the reliability of the liquid crystal display element.

An alternative method for inducing a pretilt angle of the liquid crystal composition (B) by forming fibrous or columnar polymer networks in a tilted alignment is to use a bifunctional acrylate that has a C6 or larger alkylene group between its functional group and mesogen group and induces a smaller pretilt angle in combination with a bifunctional acrylate that has a C5 or less alkylene group between its functional group and mesogen group and induces a larger pretilt angle. By adjusting the proportions of these compounds, the desired pretilt angle can be induced near the interfaces.

Another is to form fibrous or columnar polymer networks by adding at least 0.01% by mass or more and 1% by mass or less monomer having the capability of reversible photoalignment. In this case, the trans isomer influences the alignment of the low-molecular liquid crystal by forming rods similar to the low-molecular liquid crystal. When irradiated with parallel beams of ultraviolet radiation through the top surface of the cell, the trans isomer in the element-production liquid crystal composition is aligned to make their longitudinal axis of rods parallel to the path of the ultraviolet radiation. At the same time, the low-molecular liquid crystal is also oriented to be aligned with the longitudinal axis of the trans isomer. Irradiating the cell with ultraviolet radiation obliquely will result in the longitudinal axis of the trans isomer facing the oblique direction, which makes the liquid crystal aligned in the direction in which the radiation is tilted. The monomer therefore becomes an inducer of a pretilt angle and expresses the capability of photoalignment. Crosslinking the monomer at this stage will cause the induced pretilt angle to be fixed by the fibrous or columnar polymer networks formed by polymerization-induced phase separation. Overall, when it comes to the induction of a pretilt angle, important in the VA mode, the liquid crystal element according to the present invention can be fabricated using one of the following methods as needed: a method in which polymerization-induced phase separation is initiated while a voltage is applied; a method in which polymerization-induced phase separation is initiated in the presence of multiple monomers that induce different pretilt angles; and a method in which polymerization-induced phase separation is initiated in the presence of a monomer capable of reversible photoalignment and with the liquid crystal composition (B) and the monomer aligned in the path of ultraviolet radiation using the monomer's capability of photoalignment.

The monomer having the photoalignment capability may be a photoisomeric compound that forms its trans isomer by absorbing ultraviolet radiation, or may be a photoisomeric compound that forms its cis isomer by absorbing ultraviolet radiation. It is preferred that the reaction rate of the monomer having the photoalignment capability be slower than the monomer(s) other than that having the photoalignment capability. When irradiated with ultraviolet radiation, the monomer having the photoalignment capability immediately forms its trans isomer and is aligned in the direction of travel of the radiation. This causes the nearby monomer(s) and nonpolymerizable liquid crystal composition(s) to be aligned in the same direction. During this, polymerization-induced phase separation proceeds, making the easy axis of orientation of the liquid crystal composition (B) and polymer networks aligned with the easy axis of orientation of the monomer having the photoalignment capability. As a result, a pretilt angle is induced in the direction of travel of the ultraviolet radiation.

If a planar alignment cell, such as an IPS- or FFS-mode one, is used, the fibrous or columnar polymer networks resulting from a phase separation polymerization using the element-production liquid crystal composition make the liquid crystal composition (B) aligned parallel to the direction of alignment of the alignment films lying on the surface of the substrates of the liquid crystal cell. Preferably, the fibrous or columnar polymer networks have been formed to have its refractive index anisotropy or easy axis of orientation substantially in the same direction as the direction of alignment of the liquid crystal composition (B). It is more preferred that the fibrous or columnar polymer networks extend substantially throughout the cell except for the voids in which the liquid crystal composition (B) is dispersed. It is preferred to use, as a monomer for the purpose of inducing the pretilt angle with respect to the interfaces with the polymers, an acrylate or methacrylate of a monohydric or dihydric C8-18 alcohol compound in combination with a monomer having a mesogen group.

Electrooptical characteristics are influenced by the interfacial surface area of the polymer networks and the void spacing of the polymer networks. What is important is to prevent light scattering, and it is preferred that the average void spacing be smaller than the visible spectrum. To expand the interfacial surface area and reduce the void spacing, for example, a possible method is to increase the percentage of the monomer composition. This will change the polymerization-induced phase separation structure and narrow the void spacing. The polymer networks will therefore be formed with an increased interfacial surface area, and, as a result, the drive voltage and decay time will be shortened. The polymerization-induced phase separation structure is also influenced by the polymerization temperature.

In the present invention, it is preferred that the polymerization be performed with accelerated phase separation to give a phase separation structure with microscopic voids. The rate of phase separation is greatly influenced by the compatibility between the low-molecular liquid crystal and the monomers and the rate of polymerization. The molecular structure and percentages of the compounds matter greatly, so it is preferred to adjust the makeup as needed before use. If the compatibility is high, it is preferred to use monomers high in the rate of polymerization. If ultraviolet polymerization is performed, it is preferred to increase the intensity of ultraviolet radiation. It is also preferred to increase the monomer content of the element-production liquid crystal composition. Low compatibility is preferred for the fabrication of a liquid crystal element according to the present invention because it ensures a sufficiently quick phase separation. A possible method for reducing the compatibility is polymerization at low temperatures. At low temperatures, the orientational order of the liquid crystal increases, and the compatibility between the liquid crystal composition (B) and the monomers decreases, helping accelerate the polymerization-induced phase separation. Another method is to perform the polymerization with the element-production liquid crystal composition at a temperature at which the composition is in an overcooled state. This is preferred because the temperature only needs to be slightly lower than the melting point of the element-production liquid crystal composition, and therefore the phase separation can be accelerated only with a decrease of a few degrees in temperature. These ensure that the liquid crystal composition will form a polymerization-induced phase separation structure equivalent to what it would be if tens percent by mass monomers were added to the liquid crystal, i.e., a polymer network structure in which the polymer networks have a large interfacial surface area and are narrow in the void spacing, a structure that acts to shorten the decay time. The element-production liquid crystal composition is therefore, preferably, customized in terms of its makeup considering the alignment capability, crosslink density, anchoring strength, and void spacing as needed to shorten the decay time.

To achieve high-contrast display with a liquid crystal element, it is needed to prevent light scattering. For this, it is important to consider the methods described above and to control the phase separation structure and form an appropriate polymer network layer structure to achieve the intended voltage-transmittance characteristics and switching properties. A specific description of the polymer network layer structure is as follows.

The polymer network layer structure is preferably a structure in which polymer network layers have been formed in the liquid crystal phase throughout the liquid crystal display element, and the liquid crystal phase is continuous; and in which the easy axis of orientation or uniaxial optical axis of the polymer networks is substantially in the same direction as the easy axis of orientation of the low-molecular liquid crystal. Preferably, the polymer networks are formed to induce a pretilt angle of the low-molecular liquid crystal. The average void spacing of the polymer networks is preferably smaller than the visible spectrum, at least smaller than 450 nm, because this will prevent light scattering. To shorten the decay time by the effects of the interactions between the polymer networks and the low-molecular liquid crystal (anchoring strength) to make it shorter than the decay time of the low-molecular liquid crystal alone, it is preferred that the average void spacing be in the range of 50 nm to 450 nm. To make the decay time less sensitive to the thickness of the liquid crystal cell and ensure that even a decay time with a large cell thickness is as it would be with a small thickness, at least it is preferred that the average void spacing be near 200 nm at its lower limit and near 450 nm at its upper limit. Reducing the average void spacing will cause the problem of increased drive voltage, but reducing it to fall within the range of near 250 nm to 450 nm will shorten the decay time while limiting the increase in drive voltage to 25 V or less and is preferred because the decay time will be improved to be within the range of about 5 msec to about 1 msec. To limit the increase in drive voltage to approximately 5 V or less, it is preferred that the average void spacing be in the range of near 300 nm to 450 nm. It is also possible to achieve fast response time with a decay time of 1 msec or less by controlling the average void spacing of the polymer networks. This can be done by making the average void spacing between near 50 nm and near 250 nm, although this occasionally causes the drive voltage to increase to 30 V or more. To make the decay time 0.5 msec or less, it is preferred that the average void spacing be between near 50 nm and near 200 nm. The average diameter of the polymer networks with mutually opposite relation to the average void spacing, is preferably in the range of 20 nm to 700 nm. The average diameter tends to increase with increasing monomer content. Since increasing reactivity to accelerate the polymerization-induced phase separation rate will increase the density of the polymer networks and thereby reduce the average diameter of the polymer networks, the manufacturer can customize the conditions for phase separation as needed. If the monomer content is 10% by mass or less, it is preferred that the average diameter be from 20 nm to 160 nm. If the average void spacing is in the range of 200 nm to 450 nm, it is preferred that the average diameter be in the range of 40 nm to 160 nm. If the monomer content is larger than 10% by mass, the average diameter is preferably in the range of 50 nm to 700 nm, more preferably in the range of 50 nm to 400 nm.

In contrast to the structure in which polymer network layers have been formed throughout the liquid crystal display element and the liquid crystal phase is continuous, a monomer content too low for the polymer network layers to cover the entire cell results in discontinuous formation of the polymer network layers. If the surface of the substrates, for example polyimide alignment films, has high polarity, the monomers tend to gather near the interfaces with the substrates of the liquid crystal cell, and the polymer networks grow from the surface of the substrates to form polymer network layers adhering to the interfaces with the substrates. The polymer network layers are therefore formed in such a manner that from the surface of a cell substrate, a polymer network layer, the liquid crystal layer, a polymer network layer, and the opposite substrate are stacked in this order. A multilayer structure of polymer network/liquid crystal/polymer network layers with the thickness of the polymer network layers, along a cross-section of the cell, being at least 0.5% or more, preferably 1% or more, more preferably 5% or more of the cell thickness tends to be preferred because it ensures the action of the anchoring strength between the polymer networks and the low-molecular liquid crystal produces the effect of shortening the decay time. This, however, increases the impact of the cell thickness, so if an increased cell thickness causes an extended decay time, the thickness of the polymer network layers only needs to be increased as required. As for the structure of polymer networks in the polymer network layers, they only need to have their easy axis of orientation or uniaxial optical axis aligned substantially in the same direction as the low-molecular liquid crystal, and only need to be formed so that the low-molecular liquid crystal will induce a pretilt angle. The average void spacing is preferably in the range of 90 nm to 450 nm.

If the monomer content is less than 6% by mass, for example, it is preferred to use a bifunctional monomer having a mesogen group with high anchoring strength, preferably a bifunctional monomer that polymerizes quickly with its structure in which the distance between the functional groups is short, and it is preferred to form the polymerization-induced phase separation structure at a low temperature of 0° C. or lower. If the monomer content is between 6% by mass and less than 10% by mass, a combination of such a bifunctional monomer and a monofunctional monomer with low anchoring strength is preferred, and it is preferred to form the polymerization-induced phase separation structure at a temperature in the range of 25° C. and −20° C. according to the need. If the aforementioned melting point is equal to or higher than room temperature, a temperature approximately 5° C. lower than the melting point is preferred because it offers an advantage similar to that of low-temperature polymerization. With increasing monomer concentration of the element-production liquid crystal composition, the anchoring strength between the liquid crystal composition (B) and its interfaces with the polymer increases, and, therefore, td is accelerated. The increased anchoring strength between the liquid crystal composition (B) and its interfaces with the polymer, however, causes τr to be delayed. To make the sum of td and τr less than 1.5 ms, the concentration of monomers in the element-production liquid crystal composition is 1% by mass or more and less than 10% by mass, preferably 1.5% by mass or more and 8% by mass or less, more preferably 1.8% by mass or more and 5% by mass or less.

The liquid crystal composition, if used in a TFT-driven liquid crystal display element, needs to be improved in reliability, for example in flicker reduction and motion blur caused by image-sticking, and the voltage holding ratio is an important characteristic. A possible cause of low voltage holding ratio is ionic impurities contained in the element-production liquid crystal composition. In particular, mobile ions affect the voltage holding ratio greatly. It is therefore preferred to eliminate mobile ions, for example by purification, to achieve at least a resistivity of 10¹⁴ Ω·cm or more. Forming the polymer networks by radical polymerization can affect the voltage holding ratio because of ionic impurities resulting from the photopolymerization initiator and other sources. Thus, it is preferred to select a polymerization initiator that produces only small amounts of organic acid or low-molecular by-products.

A liquid crystal display element according to the present invention includes two transparent substrates at least one of which has electrodes and a liquid crystal composition sandwiched therebetween. The liquid crystal composition contains a polymer or copolymer, with the polymer or copolymer content being 0.5% by mass or more and less than 10% by mass of the total mass of the liquid crystal composition and the polymer or copolymer. The polymer or copolymer forms polymer networks, and the polymer networks have a uniaxial refractive index anisotropy or easy axis of orientation and have two or more different states of alignment. The liquid crystal display element according to the present invention preferably has, on at least one of the transparent substrates, an alignment film for aligning the liquid crystal composition. A voltage is applied to this alignment film on substrate(s) and to the electrodes on the substrate(s) to control the orientation of liquid crystal molecules. It is preferred that the polymer networks or polymer binders have a uniaxial refractive index anisotropy or easy axis of orientation with the optical axis or easy axis of orientation of the polymer networks or polymer binders in the same direction as the easy axis of orientation of the low-molecular liquid crystal. In this regard, the liquid crystal in this liquid crystal display element is different from light-scattering polymer-network or polymer-dispersed liquid crystals, in which the polymers have no uniaxial refractive index anisotropy or easy axis of orientation.

Moreover, it is preferred that the easy axis of orientation of the alignment film(s) and that of the polymer networks or polymer binders be the same. Fitted with other components, such as polarizers and a retardation film, the liquid crystal display element creates a display using the states of alignment. The liquid crystal display element can be applied to operation modes such as TN, STN, ECB, VA, VA-TN, IPS, FFS, t-cell, OCB, and cholesteric liquid crystal. VA, IPS, FFS, VA-TN, TN, and ECB are particularly preferred. Note that the liquid crystal display element according to the present invention, which contains a polymer or copolymer in a liquid crystal composition, is different from a PSA (Polymer Sustained Alignment) liquid crystal display element, which has a polymer or copolymer on alignment film(s).

The polymer or copolymer content of the liquid crystal composition is 0.5% by mass or more and less than 10% by mass of the total mass of the liquid crystal composition and the polymer or copolymer. As for the lower limit, the percentage is preferably 0.7% by mass or more, preferably 0.9% by mass or more. As for the upper limit, the percentage is preferably less than 9% by mass, preferably less than 7% by mass.

For PSA liquid crystal display elements, rubbing can be omitted by replacing it with cutting multiple 3- to 5-μm-wide slits in the electrodes and aligning the liquid crystal, with a tilt, in the direction of the slits. In the mass-production technology, ultraviolet irradiation with the application of a voltage of tens of volts stabilizes the alignment of the liquid crystal by polymerization, producing a pretilt angle (oblique angle to the normal of the substrates) at the interfaces with the substrates and forming thin films of polymer. This induction of a pretilt angle by the action of polymer thin films is used to produce PSVA (polymer-stabilized vertical alignment) LCDs or PSA LCDs. The pretilt angle, moreover, is made in multiple directions within each pixel using patterned electrodes designed to make the liquid crystal multidomain for the purpose of improving the viewing angle. However, when this method is applied to a liquid crystal display element whose response relaxation time can be improved by forming polymer networks, for example, throughout the cell, the polymer networks stabilize the liquid crystal in planar alignment because the liquid crystal composition is exposed to a voltage of tens of volts, equal to or higher than the saturation voltage, while being irradiated with ultraviolet radiation. This makes it impossible to achieve vertical alignment because the refraction anisotropy or easy axis of orientation of the polymer networks is formed to keep the liquid crystal molecules in planar alignment.

For vertical alignment LCDs, the industry has sought to improve their electrooptical characteristics, such as transmittance and response rate, by imparting a pretilt angle of 20 or less to the normal of the cell for the purpose of restricting a tilted alignment to a particular direction by applying a voltage. To form polymer networks to induce the pretilt angle, however, a possible method is to form them while applying a voltage slightly higher than the threshold voltage of the liquid crystal and thereby making the liquid crystal aligned tilted at 20 or less. For liquid crystal display elements that achieve a unidirectional tilted alignment by using electrode geometry, such as a PVA (Ptterned vertical alignment) one, however, forming the refraction anisotropy or easy axis of orientation of the polymer networks while applying a low voltage near the threshold voltage affects transmittance because it causes the tilted alignment of the liquid crystal to vary in direction. The cause is that with the application of a voltage near the threshold voltage, the liquid crystal near the interfaces with the substrates remains vertical because of strong influence of the vertical alignment films, and, as a result, the tilted alignment cannot be restricted to a particular direction, but rather becomes instable in direction, near the interfaces with the substrates. Applying a high voltage equal to or higher than the saturation voltage for electrooptical characteristics, by contrast, contributes to improving transmittance because it brings the liquid crystal near the interfaces with the substrates into a tilted alignment and because the tilted alignment is unidirectional by virtue of enhanced influence of the field distribution by the patterned electrodes owing to the strong electric field. The polymer networks, however, are formed in planar alignment throughout the cell, making it impossible to achieve vertical alignment as in the case described above.

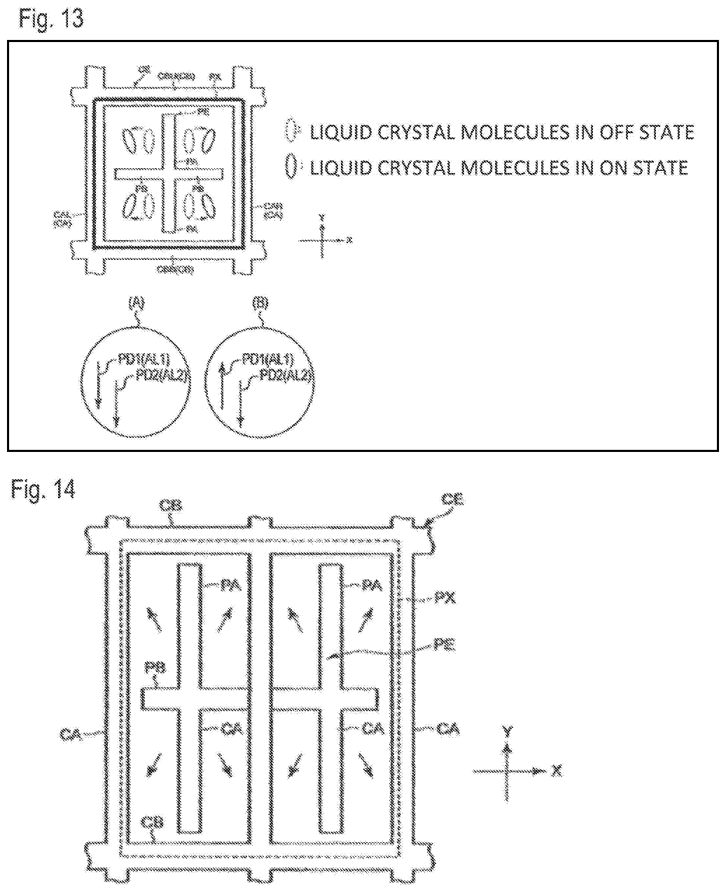

The direction of a tilted alignment depends greatly on the type of electrode pattern. For example, a fishbone electrode, illustrated in FIG. 13, includes multiple thin electrode lines approximately 3 to 5 μm wide alternating with multiple linear slits having a similar width. On this patterned electrode, the direction of the tilted alignment of the liquid crystal is such that the liquid crystal on the electrode lines is oriented to be substantially parallel to the direction of the slits. It is therefore needed to give the liquid crystal an orientational memory, as a refraction anisotropy or easy axis of orientation of the polymer networks, that restricts its tilted alignment to the direction of the slits. An Axially Symmetric Vertical Alignment patterned electrode has a subpixel structure formed by a point electrode and a substantially square counter electrode. When a voltage is applied, the central axis remains oriented vertically, but the liquid crystal director reaches a radial tilted alignment with the point electrode on the central axis as the origin. When the element is viewed from the top, the direction of the tilted alignment is such that the liquid crystal director is oriented radially from the central axis, rotating by 3600 continuously. Stabilizing the alignment by polymerization, with a subset of polymer networks, by applying a high voltage results in the subset of the polymer networks being formed to stabilize the radial tilted alignment. Reducing the voltage below the threshold voltage during the ultraviolet irradiation returns the liquid crystal to a substantially vertical alignment, and if the ultraviolet irradiation is continued in this state, the refraction anisotropy or easy axis of orientation of the polymer networks is formed to be substantially vertical, allowing the radial tilted alignment to be left as tracks in the polymer networks. In this way, alignment control in the voltage-on state and vertical alignment in the voltage-off state can be combined.

That is, for PVA liquid crystal display elements, allowing two types of polymer networks to coexist for stabilizing two different states of alignment of the liquid crystal makes the polymer networks vary in power to influence the alignment of the liquid crystal from type to type: One is formed to match the refractive index anisotropy or easy axis of orientation of polymer networks to the alignment of the liquid crystal at a voltage equal to or higher than the threshold voltage, and thereby to stabilize this state of alignment by polymerization, and the other is formed to match the refractive index anisotropy or easy axis of orientation of polymer networks to the alignment of the liquid crystal at a voltage lower than the threshold voltage is applied, and thereby to stabilize this state of alignment by polymerization. For example, with the polymer networks for stabilizing the sub-threshold-voltage alignment of the liquid crystal alone, switching the voltage to change the alignment of the liquid crystal would cause a strain on the resulting alignment because the alignment of the liquid crystal under the influence of the polymer networks is different from that of the liquid crystal the liquid crystal display element really needs. The failure to achieve the desired alignment would affect electrooptical effects, thereby reducing, for example, contrast and transmittance. Allowing two states of alignment to coexist in the polymer networks, one achieved by applying a voltage equal to or higher than the threshold voltage and the other by applying a voltage lower than the threshold voltage, therefore makes it easier for the liquid crystal to transform between the two states of alignment, thereby making display characteristics better. To stabilize the alignment of the liquid crystal at the threshold voltage or higher and that at sub-threshold voltages by polymerization and to form a mixture of the two states of alignment with polymer networks, therefore, it is preferred to use a subset of the monomers contained in the element-production liquid crystal composition for the purpose of stabilizing the alignment of the liquid crystal at the threshold voltage or higher, and to use the rest for the polymer networks to be formed to stabilize the alignment of the liquid crystal at sub-threshold voltages.

Moreover, since two types of polymer networks that act to stabilize these two different states of alignment are in the mix, the alignment of the liquid crystal in the voltage-off state of the element in which the polymer networks have been formed is influenced by the polymer networks acting to support the two different states of alignment, and the alignment of the liquid crystal in the voltage-off state is determined by the power balance between each type of polymer networks. For example, for vertical-alignment-mode liquid crystal display elements, increasing the power of the polymer networks that stabilize the alignment of the liquid crystal at sub-threshold voltages is preferred because this increases the contrast of the liquid crystal display by ensuring that the liquid crystal display element reaches the vertical alignment it really needs. On the other hand, too great a power of the polymer networks that stabilize the alignment of the liquid crystal at the threshold voltage or higher tends to affect contrast by increasing the pretilt angle of the liquid crystal. To increase the transmittance and contrast of the liquid crystal display element and thereby to enhance the display quality, it is important to adjust the power balance between the two individual types of polymer networks that stabilize two different states of alignment of the liquid crystal. For example, for PVA cells, too great a power of the polymer networks that act to stabilize the alignment of the liquid crystal at the threshold voltage or higher causes a decrease in contrast by increasing the black level, although it improves the maximum transmittance. Too great a power of the polymer networks that act to stabilize the alignment of the liquid crystal at sub-threshold voltages unfavorably causes a decrease in maximum transmittance and thereby affects contrast, although it provides a good black level.

Applying a tilting voltage to restrict the tilted alignment of the liquid crystal to a particular direction improves the maximum transmittance. Thus, the polymer networks for stabilizing the alignment of the liquid crystal at the threshold voltage or higher and thereby achieving a unidirectional tilted alignment are formed only to have a small influence, and during the ultraviolet irradiation, a sub-threshold voltage is applied to form the polymer networks for stabilizing a substantially vertical alignment that gives a good black level. By virtue of a high contrast resulting from the good black level and the increased maximum transmittance owing to a unidirectional tilted alignment, the display quality is advantageously improved.

A method according to the present invention for producing a liquid crystal display element is a method that includes a step of irradiating, with ultraviolet radiation, an element-production liquid crystal composition sandwiched between two transparent substrates, at least one of them having electrodes, while applying a voltage equal to or higher than the threshold voltage of the element-production liquid crystal composition to initiate polymerization-induced phase separation; and a step of further irradiating the liquid crystal composition with ultraviolet radiation after reducing the voltage below the threshold voltage with continued ultraviolet irradiation. Through these, two types of polymer networks are formed that respectively stabilize the alignment of the liquid crystal at the threshold voltage or higher and that at sub-threshold voltages; two types of polymer networks that stabilize two different states of alignment of the liquid crystal are formed in the mix. If the liquid crystal display element is a vertical-alignment-mode one that includes, for example, a patterned-electrode cell, it is preferred that in the step of irradiating with ultraviolet radiation an element-production liquid crystal composition while applying a voltage equal to or higher than the threshold voltage of the liquid crystal composition, the liquid crystal molecules in the element-production liquid crystal composition be aligned tilted at an angle in the range of 0° to 30° with respect to the plane of the transparent substrates, and in the step of further irradiating the liquid crystal composition with ultraviolet radiation after reducing the voltage below the threshold voltage with continued ultraviolet irradiation, the liquid crystal molecules be aligned tilted at 80° to 90° to the plane of the transparent substrates. In the state of the liquid crystal molecules being aligned tilted at an angle in the range of 0° to 30° to the plane of the transparent substrates, the liquid crystal exhibits an increased birefringence as a result of voltage application. Although it is preferred that the orientation of the liquid crystal be 0° to the plane of the transparent substrates because this maximizes the birefringence, but the orientation of being tilted at 30° to the substrate plane is also preferred. PVA cells particularly benefit because unidirectional tilting is achieved. In any case, it is preferred to form polymer networks that stabilize the tilted alignment of the liquid crystal to restrict the alignment to a particular direction.

As for the state of the liquid crystal molecules being aligned tilted at 80° to 90° to the plane of the transparent substrates, it is preferred that the liquid crystal in the voltage-off state be oriented at 90° to the plane of the transparent substrates because this minimizes the birefringence and therefore is beneficial in making the liquid crystal display element high-contrast. To ensure that the liquid crystal reaches a unidirectional tilted alignment when a voltage is applied, however, it is more preferred that the liquid crystal be tilted at within 89.9° to 85° to the substrate plane. A tilt exceeding 80V to the substrate plane would unfavorably affect the display contrast because it would increase the birefringence and the amount of light transmitted. A tilt of 85° or more to the substrate plane is preferred because it ensures a good display black level, thereby enabling a high contrast. For IPS (In-plane switching)- or FFS-mode liquid crystal display elements, it is also preferred that in the step of irradiating with ultraviolet radiation an element-production liquid crystal composition while applying a voltage equal to or higher than the threshold voltage of the liquid crystal composition, the liquid crystal molecules in the element-production liquid crystal composition be aligned tilted at an angle in the range of 0° to 90° to the plane of the transparent substrates, and in the step of further irradiating the liquid crystal composition with ultraviolet radiation after reducing the voltage below the threshold voltage with continued ultraviolet irradiation, the liquid crystal molecules be aligned tilted at 0° to 30° to the plane of the transparent substrates.

A tilted alignment of the liquid crystal molecules at an angle in the range of 0° to 90° to the plane of the transparent substrates forms polymer networks to stabilize the alignment of the liquid crystal to which a voltage is applied. In the IPS mode, the tilt angle as a characteristic of the alignment film(s) used in the element greatly matters. It may be in the range of approximately 1° to 2°, and for liquid crystal molecules with a pretilt angle including twisted alignment, the tilt angle is preferably from 0.5° to 3°, preferably within 0° to 2°. In the FFS mode, the alignment of the liquid crystal when a voltage equal to or higher than the threshold voltage is applied can be splay, bend, or twisted alignment depending on the field distribution in the element, but primarily splay or twisted alignment. The tilt angle of the alignment of the liquid crystal molecules in this state preferably falls within the range of 0° to 45°, and it is preferred that stabilizing the alignment with polymer networks stabilize a similar range. In the TN mode, it is preferred that the tilt angle be in the range of 45° to 90°.

Separately, polymer networks are formed to stabilize the alignment of the liquid crystal while a voltage lower than the threshold voltage is applied. In the IPS, FFS, and TN modes, there is a pretilt angle of approximately 10 to 30 at the interfaces with the substrates as a result of rubbing, and for this reason it is preferred to form polymer networks to stabilize the alignment of the liquid crystal to which a voltage lower than the threshold voltage is applied. The angle of alignment of the liquid crystal may be tilted in this range, and it is preferred that liquid crystal molecules given a pretilt angle including twisted alignment by another aligning process, such as a photoalignment film, be tilted at an angle of 0.5° to 3°, more preferably within 0° to 2° because it is beneficial in achieving a wide viewing angle.

Furthermore, it is preferred that the voltage applied be an alternating waveform and have a frequency at which the element-production liquid crystal composition exhibits dielectric anisotropy. The waveform is preferably rectangular waves, with which the effective voltage is high when the peak voltage is constant. Regarding the upper frequency limit, the frequency only needs to be such that the signal transmitted by the driver used in the liquid crystal display element to the pixel is not dampened. It is preferred that at least the frequency be 2 kHz or less. In the frequency dependence of the dielectric constant of the element-production liquid crystal composition before ultraviolet irradiation, the frequency only needs to be such that dielectric anisotropy is exhibited and be 10 kHz or less. As for the lower limit, a flicker can occur when the element is driven, so the frequency only needs to be such that the flicker in this case is minimized, and preferably is at least 20 Hz or more.

As stated above, the method according to the present invention for producing a liquid crystal display element is characterized in that polymer networks are formed to support two states of alignment of the liquid crystal. Each type of polymer networks formed to support a state of alignment of the liquid crystal is formed in such a manner that its refractive index anisotropy or easy axis of orientation will coincide with the orientation of the liquid crystal at a voltage equal to or higher than the threshold voltage or with that at sub-threshold voltages. This creates a state of coexistence between polymer networks that stabilize the alignment of the liquid crystal in the voltage-on state and polymer networks that stabilize the alignment of the liquid crystal in the voltage-off state. As a result, display characteristics can be improved, for example the contrast can be enhanced, by reducing the orientational strain that occurs when a voltage is applied to transform the alignment from that in the voltage-off state. With the polymer networks formed to support the alignment of the liquid crystal in the voltage-off state alone, the polymer networks formed to support the alignment of the liquid crystal at sub-threshold voltages would predominate when the liquid crystal changes its alignment to that in the voltage-on state. When the liquid crystal changes its alignment to that at the threshold voltage or higher, therefore, an orientational strain would be imparted, causing low transmittance. By forming polymer networks that stabilize the alignment of the liquid crystal in the voltage-on state as a subset of the polymer networks, the orientational change strain that occurs with switching can be reduced. The intended change in the alignment of the liquid crystal is ensured, improving the transmittance. Note that the two types of polymer networks formed to stabilize the respective states of alignment of the liquid crystal in the voltage-on and voltage-off states are characterized in that their refractive index anisotropy or easy axis of orientation is formed to be along the two different orientations of the liquid crystal.

Moreover, the power of the polymer networks formed to stabilize the condition of the liquid crystal at the threshold voltage or higher changes with the duration of the application of a voltage equal to or higher than the threshold voltage during ultraviolet irradiation, and this can be used to modify electrooptical characteristics. For example, if the polymer networks are formed with the alignment of the liquid crystal in the voltage-on state being a planar alignment that includes a tilted alignment at 0° to 30° to the substrate plane, applying a voltage equal to or higher than the threshold voltage only for a short period of time during ultraviolet irradiation will cause the liquid crystal to be aligned to follow the effect of the polymer networks to support vertical alignment because the effect to support planar alignment is minor. Moreover, the powers of the two different states of alignment stemming from the two types of polymer networks supporting the two states of alignment are balanced, inducing a small pretilt angle, 1° or less, with respect to the normal of the transparent substrates. With extended application of a voltage equal to or higher than the threshold voltage during ultraviolet irradiation, the polymer networks that act to support planar alignment become more predominant. The pretilt angle increases owing to the balance between the force that supports vertical alignment and the force that supports planar alignment. The pretilt angle can increase to 10° or more with respect to the normal of the transparent substrates. The duration of the application of a voltage equal to or higher than the threshold voltage during ultraviolet irradiation depends greatly on the reactivity of the element-production liquid crystal composition used, so it is preferred to adjust the reactivity as necessary for the desired pretilt angle to be achieved. It is particularly preferred to ensure that a pretilt angle in the range of 80° to 90° to the substrate plane is achieved. The pretilt angle is more preferably between 85° and 89.9°, even more preferably between 87° and 89.9°.

For a vertical-alignment-mode liquid crystal display element that uses a negative dielectric anisotropy, the polymer networks formed to support the alignment of the liquid crystal obtained by applying a voltage equal to or higher than the threshold voltage are desirably in planar or a unidirectional tilted alignment. The alignment obtained at sub-threshold voltages is preferably a substantially vertical alignment, in particular a substantially vertical alignment at 80° to 90° with respect to the substrate plane, preferably an alignment that exhibits a black level good enough that a high contrast is achieved. In the IPS display mode, driven by a transverse electric field and using a negative or positive dielectric anisotropy, the alignment of the liquid crystal obtained by applying a voltage equal to or higher than the threshold voltage during ultraviolet irradiation is preferably twisted alignment. The alignment obtained at sub-threshold voltages is preferably a unidirectional planar alignment. In the FFS mode, it is preferred that at least one of bend, splay, and tilted alignment or a mixture of two or more be obtained when a voltage equal to or higher than the threshold voltage is applied during ultraviolet irradiation. At sub-threshold voltages, the alignment is preferably a substantially planar alignment. After polymer networks are formed to support the alignment of the liquid crystal in the voltage-on state, the alignment of the liquid crystal at sub-threshold voltages is stabilized by polymerization. Once the formation of polymer networks is complete, the alignment of the liquid crystal can be easily changed to that in the voltage-on state. As a result, high transmittance and fast response time can be combined.

The voltages applied during ultraviolet irradiation are preferably adjusted as necessary for the liquid crystal display element in which the polymer networks have been formed to achieve a high-contrast display. The voltages depend greatly on the characteristics of the electrooptical effects of the element-production liquid crystal composition before ultraviolet radiation, and therefore needs to be matched to the voltage-transmittance properties of the element-production liquid crystal composition. The voltage equal to or higher than the threshold voltage is preferably equal to or higher than the voltage V10 in the voltage-transmittance characteristics voltage of the element-production liquid crystal composition, at which the change in transmittance is 10% or more of the total change, more preferably equal to or higher than the voltage V20 at which the total change in transmittance is 20% or more, more preferably equal to or higher than the voltage V50 at which the total change in transmittance is 50% or more. It is, however, preferred that the voltage be six times the threshold voltage or lower. The voltage equal to or higher than the threshold voltage applied during ultraviolet irradiation is preferably an alternating voltage, preferably rectangular waves. The frequency is preferably such that no flicker is visible to the eye. If there are electronic circuits on a glass substrate as in the case of a TFT substrate, the frequency only needs to be such that the polymerization voltage is not dampened, preferably approximately 30 Hz to 5 kHz.

In the course of ultraviolet irradiation, the voltage applied is changed from a voltage equal to or higher than the threshold voltage to a sub-threshold voltage. The voltage lower than the threshold voltage only needs to be such that no change in the alignment of the liquid crystal is caused, and preferably is 0 V or more and less than 90% of the threshold voltage, preferably a voltage less than 80% of the threshold voltage. It is more preferred that the voltage be 70% or less of the threshold voltage. This change in applied voltage to the threshold voltage or lower during ultraviolet irradiation, moreover, preferably returns the liquid crystal to the alignment it has when the liquid crystal display element is off. For example, as mentioned above, the liquid crystal can be returned to vertical alignment in the vertical alignment mode, or brought into planar alignment in the FFS or IPS mode. To return the liquid crystal to the alignment it has when the liquid crystal display element is off, it is preferred to reduce the voltage to a sub-threshold voltage with the power of the polymer networks that stabilize the alignment of the liquid crystal in the voltage-on state being minor.

After the application of a voltage equal to or higher than the threshold voltage, the liquid crystal composition is irradiated with ultraviolet radiation. If prolonged, however, the voltage application during the ultraviolet irradiation is no longer preferred. In such a case, the power of the polymer networks that stabilize the alignment of the liquid crystal in the voltage-on state during the ultraviolet irradiation increases, preventing the liquid crystal from returning to the alignment it has when the liquid crystal display element is off. It is therefore preferred to produce the liquid crystal display element according to the present invention while optimizing the optimum voltage during the ultraviolet irradiation as needed. When the voltage during the ultraviolet irradiation is reduced below the threshold voltage, the voltage may be lowered gradually during the ultraviolet irradiation. This is for the purpose of adjusting the relaxation time in the response of the element-production liquid crystal composition in liquid crystal state, and minimizes the effects of the backflow that occurs during the process of response relaxation by making the fall time of the applied voltage longer than the response relaxation time of the liquid crystal during the ultraviolet irradiation. The fall time of the applied voltage is preferably 10 ms or more and 1000 ms or less. The opposite, or to reduce the voltage quickly, is also preferred. It is preferred to at least make the fall time shorter than the relaxation time exhibited by the element-production liquid crystal composition, preferably 100 ms or less.

The liquid crystal composition is irradiated with ultraviolet radiation with the application of a voltage equal to or higher than the threshold voltage for spotty formation of a planar alignment component of polymer networks, and then the voltage is reduced below the threshold voltage with continued ultraviolet irradiation to return the liquid crystal to vertical alignment, completing polymerization-induced phase separation. For fishbone-electrode liquid crystal cells, the pretilt angle can be changed using the proportion between the aforementioned planar alignment component and a vertical alignment component. Turning off the voltage early in the process of the formation of polymer networks determines the direction of tilted alignment, and vertical alignment is created with remaining monomers. This helps combine vertical alignment with the direction of a tilted alignment, providing a technology for controlling the alignment of a nano-phase-separated liquid crystal.

It should be noted that planar alignment means that a liquid crystal with a negative dielectric anisotropy goes into a substantially planar alignment in response to a voltage applied, preferably at an angle in the range of 0.10 to 300 with respect to the substrate surfaces. Preferably, the liquid crystal is in a tilted alignment at an angle in the range of 0.10 to 100. Vertical alignment, which occurs in the voltage-off state, represents being brought into a substantially vertical alignment by the action of a vertical alignment film. It is preferred that the liquid crystal be aligned with its orientation tilted at 800 to 89.90 with respect to the substrate plane, more preferably at 850 to 89.90

A liquid crystal with a positive dielectric anisotropy reaches vertical alignment when a voltage is applied. The vertical alignment in this case includes the liquid crystal being aligned with its orientation tilted at an angle of 45° to 89.9° with respect to the substrate plane.

Planar alignment, which occurs in the voltage-off state, represents being brought into a substantially planar alignment by the action of a planar alignment film and includes the liquid crystal be aligned with its orientation tilted at 0.1° to 30° with respect to the substrate plane.

The substrate-to-substrate distance (d) of the liquid crystal display element according to the present invention is preferably in the range of 2 to 5 μm, more preferably 3.5 μm or less. In general, the birefringence of a liquid crystal composition is adjusted to make the product of the birefringence and the cell thickness near 0.275. With the element-production liquid crystal composition used in the present invention, however, polymer networks are formed after polymerization-induced phase separation. By the action of the anchoring strength of the polymer networks and because of the optical characteristics of the polymer networks, the birefringence of the liquid crystal display element in the electric field-on state is low. If the increase in drive voltage caused by the formation of polymer networks is approximately 5 V or less, therefore, the product of the birefringence (Δn) of the liquid crystal composition and polymeric composition or the liquid crystal composition contained in the element-production liquid crystal composition and the substrate-to-substrate distance (d) is preferably in the range of 0.3 to 0.4 μm in particular. If the increase is approximately 3 V or less, it is more preferred that the product be in the range of 0.30 to 0.35 μm. If the increase in drive voltage is 1 V or less, it is particularly preferred that the product be in the range of 0.29 to 0.33 μm. By ensuring that the substrate-to-substrate distance (d) of the liquid crystal display element and the product of the birefringence (Δn) of the liquid crystal composition and the substrate-to-substrate distance (d) fall within the above ranges, a display fast in response time and favorable in color reproduction can be achieved with a transmittance as high as it would be with the low-molecular liquid crystal alone. It is preferred to set the birefringence of the liquid crystal composition used in the element-production liquid crystal composition to make the product of the cell thickness (d) and the birefringence (Δn) 1 to 1.9 times 0.275.

The drive voltage of the liquid crystal display element according to the present invention is not simply determined by the dielectric anisotropy and elastic constant of the liquid crystal composition. It is also greatly influenced by the anchoring strength that acts between the liquid crystal composition and its interfaces with the polymer.

For example, the following mathematical relation is presented in Japanese Unexamined Patent Application Publication No. 6-222320 as a description of the drive voltage of a polymer-dispersed liquid crystal display element.

$$Vth ∝ \frac{d}{〈 r 〉 + {}^{1} Kii / A} {( \frac{{}^{2} Kii}{Δ ɛ} )}^{\frac{1}{2}} \qquad [ Math . 2 ]$$

(Vth represents the threshold voltage, 1Kii and 2Kii represent elastic constant, i represents 1, 2, or 3, Δε represents dielectric constant anisotropy, <r> represents the average void spacing at the interfaces of a transparent polymer substance, A represents the anchoring strength of the transparent polymer substance to the liquid crystal composition, and d represents a gap between pair of transparent electrode on the substrate.

According to this, the drive voltage of a light-scattering liquid crystal display element is determined by the average void spacing at the interfaces of a transparent polymer substance, the substrate-to-substrate distance, the elastic constant and dielectric constant anisotropy of the liquid crystal composition, and the anchoring energy between the liquid crystal composition and the transparent polymer substance.

Of these, the parameters that can be controlled in the liquid crystal display element according to the present invention are liquid crystal characteristics and the anchoring strength between polymers. The anchoring strength depends greatly on the molecular structure of the polymer and that of the low-molecular liquid crystal. Thus the response time can be accelerated to 1.5 ms or less by selecting a monomer whose anchoring strength is large, but at the same time, the drive voltage is increased to 30 V or more. It is therefore preferred to select liquid crystal compound(s) and monomer(s) and to adjust the makeup as necessary for the drive voltage to be 30 V or less and the response rate to be 1.5 ms or less. It is preferred to adjust the makeup by blending monomeric precursor(s) with a large anchoring strength and monomeric precursors(s) with a small anchoring strength as needed so that the drive voltage and the response rate will be in good balance. As for the characteristics required of the liquid crystal composition for reducing the drive voltage, it is particularly preferred that the dielectric anisotropy be 6 or more for P-type liquid crystals, or −3 or less for N-type liquid crystals. Furthermore, it is preferred that the birefringence be 0.09 or more. It is more preferred to make the birefringence of the liquid crystal composition and that of fibrous or columnar polymer networks as close as possible and thereby eliminate light scattering. The retardation of the liquid crystal element, however, is influenced by the concentration of the polymer precursor(s). Thus, it is preferred to increase or reduce the birefringence of the liquid crystal composition as needed to achieve the retardation required.

The liquid crystal display element according to the present invention is preferably one obtained by irradiating the liquid crystal composition described above with energy radiation with the composition at −50° C. to 30° C. to polymerize the monomer(s) to form, in the liquid crystal composition, polymer networks having refractive index anisotropy or an easy axis of orientation. The upper limit of the polymerization temperature is 30° C., preferably between 20° C. to −10° C. As stated in Examples hereinafter, the inventor found that τd is further accelerated by low-temperature polymerization or room-temperature polymerization depending on the monomer makeup. An example of possible reasons is: 1) the polymerization is performed with an increased degree of alignment of liquid crystal molecules by virtue of a low temperature; 2) low-temperature polymerization facilitates phase separation by reducing the compatibility between the resulting polymer and the liquid crystal composition, accelerating the polymerization-induced phase separation and narrowing the void spacing between polymer networks; and 3) since the void spacing is small even with a monomer having a relatively low anchoring strength, the resulting polymer networks with refractive index anisotropy are of a kind that increases the power of the anchoring strength.

The liquid crystal display element according to the present invention is preferably, moreover, one in which the optical axis or easy axis of orientation of the polymer networks or polymer binders having a uniaxial refractive index anisotropy or easy axis of orientation has been formed to make a pretilt angle with the transparent substrates, preferably the display element configured such that the strength of an electric field is adjusted to control the alignment of a low-molecular liquid crystal to tilt the liquid crystal with respect to the substrate surfaces, and thus by irradiating it with energy radiation while applying a voltage to the aforementioned liquid crystal layer, the monomer(s) can be polymerized to form a polymer, in the liquid crystal composition, having refractive index anisotropy or an easy axis of orientation. In the VA, or vertical alignment, mode, polymerization with the application of a voltage to make the pretilt angle 20° or less to the normal of the substrates is particularly preferred because not only it produces an effect corresponding to that of protrusions or such used for the existing VA-mode cells or microscopic polymer bumps for PSA liquid crystals, but also the resulting liquid crystal exhibits a fast response time that cannot be achieved by PSA. Furthermore, polymerization with the application of an electric field in multiple directions is more preferred as it helps improve the viewing angle by making the liquid crystal multidomain. Subjecting the vertical alignment film(s) at the interfaces with the substrates to, for example, photoaligning or rubbing in such a manner that the low-molecular liquid crystal will induce the pretilt angle at the interfaces with the alignment films is also preferred as it will reduce the formation of alignment defects upon switching by restricting the tilting of the low-molecular liquid crystal to a particular direction, and it is also preferred to use a patterned electrode that tilts the liquid crystal in multiple directions or performed the above aligning process. By irradiating the monomer-containing liquid crystal composition with ultraviolet radiation or electron beams while applying an alternating electric field, optionally within a temperature range of −50° C. to 30° C., the liquid crystal layer is formed in such a manner that the optical axis of the polymer networks having refractive index anisotropy will make a pretilt angle with the substrate surfaces. Polymerization-induced phase separation performed in this alignment, in which a pretilt angle has been induced, owing to the dielectric anisotropy of the low-molecular liquid crystal, by the application of an electric field, gives a liquid crystal element in which the optical axis of the polymer networks resulting from polymerization is tilted with respect to the substrate surfaces, more preferably in a configuration in which the monomer(s) has been polymerized. It is also preferred to induce the pretilt angle by combining the polymer networks obtained by stabilizing the alignment in the voltage-on state and those obtained by stabilizing the alignment in the voltage-off state.

The two substrates used in the liquid crystal display element according to the present invention can be made with a flexible transparent material like glass or plastic. Transparent substrates having a transparent electrode layer can be obtained by, for example, sputtering indium tin oxide (ITO) on a transparent substrate, such as a glass plate.

The color filter can be prepared by, for example, pigment dispersion, printing, electrodeposition, or dyeing. To take an example, a method for preparing a color filter by pigment dispersion is described. That is, a curable colored composition for color filters is applied to a transparent substrate, patterned, and cured by heating or irradiation with light. Performing this process for the three colors of red, green, and blue will give pixel sections for the color filter. Alternatively, there may be a pixel electrode provided with active elements, such as TFTs or thin-film diodes, on the same substrate.

The substrates are placed facing each other, with the transparent electrode layer inside. The spacing between the substrates may be adjusted using a spacer, preferably to make the thickness of the resulting light-modulating layer between 1 and 100 μm. A spacing between 1.5 and 10 μm is more preferred, and if a polarizer is used, it is preferred to adjust the product of the refractive index anisotropy Δn and the cell thickness d to make it ½ or ¼ of 550 nm, depending on the display mode, to maximize the contrast. If there are two polarizers, the polarization axis of each polarizer may be adjusted to achieve a good viewing angle and contrast. A retardation film for expanding the viewing angle can also be used. The spacer can be, for example, glass particles, plastic particles, alumina particles, or a columnar spacer, for example made of a photoresist material. Then a sealant, such as an epoxy-based thermosetting composition, is applied to the substrates by screen printing, with an opening saved for the filling with the liquid crystal. The substrates are attached together and heated to thermally set the sealant.

As for the method for putting the element-production liquid crystal composition between the two substrates, the ordinary vacuum filling or ODF, for example, can be used. In an ODF-based production process for a liquid crystal display element, the liquid crystal display element can be produced by drawing a closed-loop bank on one of the backplane and frontplane substrates with a sealant, such as an epoxy-based light- and heat-curable one, using a dispenser; adding dropwise a predetermined amount of the element-production liquid crystal composition to the inside of the bank with degassing; and then joining the frontplane and backplane. The element-production liquid crystal composition used in the present invention is suitable for use because it allows a liquid-crystalline monomer composite material to be added dropwise stably in an ODF process.

As for the method for the polymerization of the monomer(s), a method in which the monomer(s) is polymerized by irradiating it with one of ultraviolet radiation and electron beams, which are forms of active energy radiation, with both together, or with one after another because to achieve a good alignment of the liquid crystal, an appropriate polymerization rate is desired. If ultraviolet radiation is used, a polarized light source may be used, or an unpolarized light source may be used. If the polymerization is performed with the element-production liquid crystal composition sandwiched between the two substrates, at least the substrate on the side to be irradiated has to be given a transparency appropriate for the active energy radiation. It is, moreover, preferred to irradiate the monomer-containing liquid crystal composition

with ultraviolet radiation or electron beams while applying an alternating electric field with the element-production liquid crystal composition at a temperature in the range of −50° C. to 20° C. The alternating electric field applied is preferably alternating with a frequency of 10 Hz to 10 kHz, more preferably with a frequency of 100 Hz to 5 kHz, and the voltage is selected depending on the desired pretilt angle of the liquid crystal display element. That is, the pretilt angle of the liquid crystal display element can be controlled by the voltage applied. For transverse-field MVA liquid crystal display elements, it is preferred to control the pretilt angle to make it between 800 and 89.9° in light of alignment stability and contrast.

As for the temperature during the irradiation, it is preferred that the element-production liquid crystal composition be at a temperature in the range of −50° C. to 30° C., more preferably 20° C. to −10° C. τd tends to be further accelerated by low-temperature polymerization or room-temperature polymerization, depending on the makeup of the element-production liquid crystal composition. An example of possible reasons is: 1) the polymerization is performed with an increased degree of alignment of liquid crystal molecules by virtue of a low temperature; 2) low-temperature polymerization facilitates phase separation by reducing the compatibility between the resulting polymer and the liquid crystal composition, accelerating the polymerization-induced phase separation and narrowing the void spacing between polymer networks; and 3) since the void spacing is small even with a polymerizable compound with a relatively low anchoring strength, the resulting polymer networks with refractive index anisotropy are of a kind that increases the power of the anchoring strength.

The lamp with which ultraviolet radiation is generated can be, for example, a metal halide lamp, a high-pressure mercury lamp, or an ultrahigh-pressure mercury lamp. As for the wavelength of the ultraviolet radiation for irradiation, it is preferred to irradiate the liquid crystal composition with ultraviolet radiation in a wavelength region that is out of the absorption wavelength band of the liquid crystal composition, preferably using it after optional cutting of ultraviolet radiation shorter than 365 nm. The intensity of the ultraviolet radiation for irradiation is preferably between 0.1 mW/cm² and 100 W/cm², more preferably between 2 mW/cm² and 50 W/cm². The energy of the ultraviolet radiation for irradiation can be adjusted as needed, but preferably is between 10 mJ/cm² and 500 J/cm², more preferably between 100 mJ/cm² and 200 J/cm². The intensity may be changed during the ultraviolet irradiation. The duration of ultraviolet irradiation is selected in accordance with the intensity of the ultraviolet radiation for irradiation, but preferably is between 10 seconds and 3600 seconds, more preferably between 10 seconds and 600 seconds.

(Transverse-Field Type)

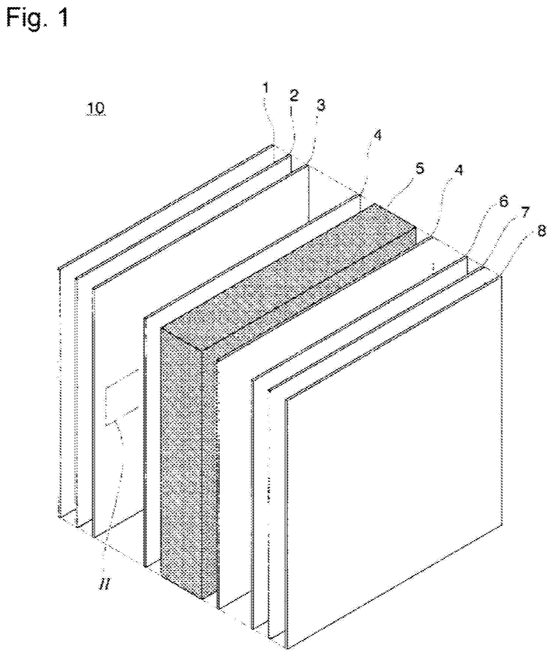

First, a liquid crystal display element according to an embodiment of the present invention is described with reference to drawings. FIG. 1 is a schematic diagram illustrating an example of a liquid crystal display element according to the present invention. The liquid crystal display element 10 according to an embodiment of the present invention includes a first substrate 2 with an alignment layer 4 formed on its surface, a second substrate 7 spaced apart from the first substrate and having a photoalignment layer formed on its surface, and a liquid crystal layer 5 filling the space between the first and second substrates 2 and 7 and touching the pair of alignment layers. Between the alignment layers 4 (4a and 4b) and the first substrate 2 is an electrode layer 3 that has thin-film transistors as active elements, a common electrode 22, and a pixel electrode.

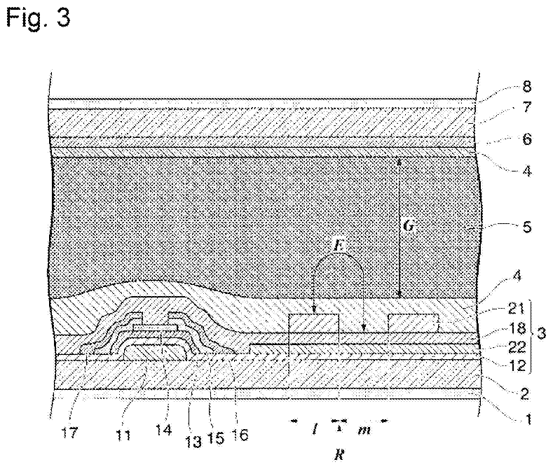

In FIG. 1, the components are illustrated spaced apart for the sake of convenience in explanation. The configuration of the liquid crystal display element 10 according to an embodiment of the present invention is, as depicted in FIG. 1, a transverse-field liquid crystal display element (illustrated is the FFS mode as a form of IPS) having an element-production liquid crystal composition (or liquid crystal layer 5) sandwiched between a first transparent insulating substrate 2 and a second transparent insulating substrate 7 placed facing each other. The first transparent insulating substrate 2 has an electrode layer 3 on its surface on the liquid crystal layer 5 side. Between the liquid crystal layer 5 and the first and second transparent insulating substrates 2 and 7 are a pair of alignment films 4 (4a and 4b) that are in direct contact with the element-production liquid crystal composition forming the liquid crystal layer 5 to induce homogeneous alignment, and the liquid crystal molecules in the element-production liquid crystal composition are oriented substantially parallel to the substrates 2 and 7 in the voltage-off state. As illustrated in FIGS. 1 and 3, the second and first substrates 7 and 2 may be sandwiched between a pair of polarizers 1 and 8. In FIG. 1, moreover, there is a color filter 6 between the second substrate 7 and an alignment film 4. The form of a liquid crystal display element according to the present invention may be a so-called color filter on array (COA). There may be a color filter between an electrode layer including thin-film transistors and a liquid crystal layer, or there may be a color filter between the electrode layer including thin-film transistors and a second substrate.

That is, the liquid crystal display element 10 according to an embodiment of the present invention has a structure in which a first polarizer 1, a first substrate 2, an electrode layer 3 including thin-film transistors, an alignment film 4, a liquid crystal layer 5 containing an element-production liquid crystal composition, an alignment film 4, a color filter 6, a second substrate 7, and a second polarizer 8 are stacked one after another.

The first and second substrates 2 and 7 can be made with a flexible transparent material like glass or plastic. One of them may be made of a nontransparent material, such as silicon. The two substrates 2 and 7 have been attached together using a sealant, such as an epoxy-based thermosetting composition, and an encapsulant placed in the periphery. Between them, for example, a particulate spacer, such as glass particles, plastic particles, or alumina particles, or resin spacer columns formed by photolithography may be placed to maintain the substrate-to-substrate distance.

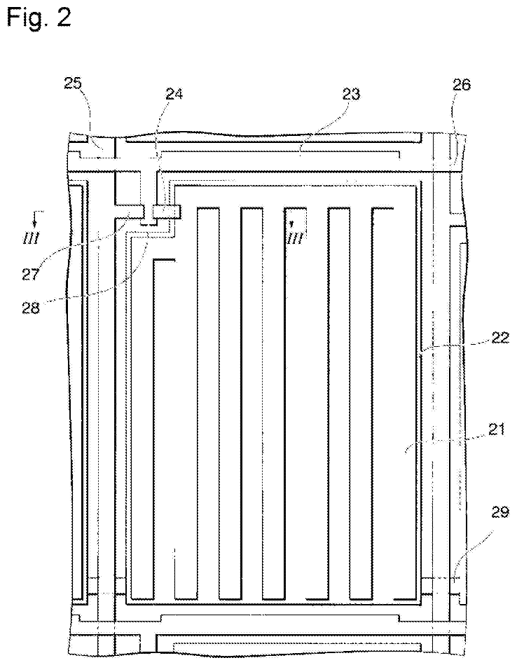

FIG. 2 is an enlarged plan view of the electrode layer 3 formed on a substrate 2 in FIG. 1 in its region surrounded by line II. FIG. 3 is a cross-sectional view of the liquid crystal display element illustrated in FIG. 1 cut along line III-III in FIG. 2. As illustrated in FIG. 2, the electrode layer 3 including thin-film transistors, formed on the surface of the first substrate 2, has multiple gate wires 26 for supplying a scanning signal and multiple data wires 26 for supplying a display signal crossing each other or arranged in a matrix. It should be noted that FIG. 2 illustrates only a pair of gate wires 26 and a pair of data wires 25.

The regions surrounded by the multiple gate wires 26 and multiple data wires 25 form unit pixels of a liquid crystal display device, and in a unit pixel, a pixel electrode 21 and a common electrode 22 have been formed. Near the intersection of a gate wire 26 and a data wire 25 is a thin-film transistor including a source electrode 27, a drain electrode 24, and a gate electrode 28. As a switch element that supplies a display signal to the pixel electrode 21, this thin-film transistor is connected to the pixel electrode 21. Along the gate wires 26, there are common lines (not illustrated). The common lines are connected to the common electrode 22 to supply a common signal to the common electrode 22.

A preferred form of the thin-film transistor has, for example, as illustrated in FIG. 3, a gate electrode 11 formed on the surface of the substrate 2, a gate insulating layer 12 covering the gate electrode 11 and also covering substantially the entire surface the substrate 2, a semiconductor layer 13 formed on the surface of the gate insulating layer 12 to face the gate electrode 11, a protective layer 14 covering part of the surface of the semiconductor layer 13, a drain electrode 16 covering one lateral edge of the protective and semiconductor layers 14 and 13 and touching the gate insulating layer 12 formed on the surface of the substrate 2, a source electrode 17 covering the other lateral edge of the protective and semiconductor layers 14 and 13 and touching the gate insulating layer 12 formed on the surface of the substrate 2, and an insulating protective layer 18 covering the drain and source electrodes 16 and 17. An anodized coating (not illustrated) may be formed on the surface of the gate electrode 11, for example for the reason of eliminating the difference in height from the gate electrode.

The semiconductor layer 13 can be made with, for example, amorphous silicone or polycrystalline polysilicon, but the use of a transparent semiconductor film, for example of ZnO, IGZO (In—Ga—Zn—O), or ITO, is preferred because it helps reduce the bad effects of photocarriers, resulting from the absorption of light, and also to increase the aperture ratio of the element.

Moreover, there may be an ohmic contact layer 15 between the semiconductor layer 13 and the drain or source electrode 16 or 17 for the purpose of reducing the width and height of the Schottky barrier. The ohmic contact layer can be made with a material highly doped with phosphorus or other impurities, such as n-type amorphous silicon or n-type polycrystalline polysilicon.

The gate wires 26, data wires 25, and common lines 29 are preferably metal films, more preferably of Al, Cu, Au, Ag, Cr, Ta, Ti, Mo, W, Ni, or an alloy thereof. The use of wires of Al or its alloy is particularly preferred. The insulating protective layer 18 is a layer having the insulating capability and is formed of, for example, silicon nitride, silicon dioxide, or silicon oxynitride film.

In the embodiment illustrated in FIGS. 2 and 3, the common electrode 22 is a flat-plate electrode formed substantially over the entire gate insulating layer 12, whereas the pixel electrode 21 is a comb-shaped electrode formed on the insulating protective layer 18 covering the common electrode 22. That is, the common electrode 22 is closer to the first substrate 2 than the pixel electrode 21 is, and these electrodes overlap with the insulating protective layer 18 therebetween. The pixel and common electrodes 21 and 22 are formed of a transparent electrically conductive material, such as ITO (Indium Tin Oxide), IZO (Indium Zinc Oxide), or IZTO (Indium Zinc Tin Oxide). By virtue of the pixel and common electrodes 21 and 22 being formed of a transparent electrically conductive material, the aperture area in the area of the unit pixel is large. As a result, the aperture ratio and the transmittance are increased.

To form a fringe electrode therebetween, the pixel and common electrodes 21 and 22 are formed in such a manner that the electrode-to-electrode distance (also referred to as the minimum clearance): R, between the pixel and common electrodes 21 and 22, is smaller than the distance between the first and second substrates 2 and 7: G. Here, the electrode-to-electrode distance: R represents the distance between the electrodes in the horizontal direction with respect to the substrate. FIG. 3, in which a flat-plate common electrode 22 and a comb-shaped pixel electrode 21 overlap, illustrates an example in which the electrode-to-electrode distance: R=0, and in this drawing, a fringe electric field E is created because the minimum clearance: R is smaller than the distance between the first and second substrates 2 and 7 (i.e., the cell gap): G. An FFS liquid crystal display element can therefore use a horizontal electric field, created perpendicular to the lines that form the comb-like shape of the pixel electrode 21, and a parabolic electric field. The electrode width in the comb-shaped section of the pixel electrode 21:1 and the width of the spaces in the comb-shaped section of the pixel electrode 21: m are preferably formed to be appropriate for all liquid crystal molecules in the liquid crystal layer 5 to be driven by the electric fields produced. The minimum clearance R between the pixel and common electrodes can be adjusted as the (average) thickness of the gate insulating layer 12. A liquid crystal display element according to the present invention may alternatively be formed in such a manner the electrode-to-electrode distance (also referred to as the minimum clearance): R, between the pixel and common electrodes 21 and 22, is larger than the distance between the first and second substrates 2 and 7: G (IPS method) unlike that in FIG. 3. In this case, an example of a possible configuration is one in which a comb-shaped pixel electrode and a comb-shaped common electrode alternate substantially in the same plane.

As for preferred forms of a liquid crystal display element according to the present invention, it is preferably an FFS liquid crystal display element, which uses a fringe electric field. When the adjacent minimum clearance d between the common and pixel electrodes 22 and 21 is shorter than the minimum clearance D between the alignment films 4 (substrate-to-substrate distance), a fringe electric field is created between the common and pixel electrodes, allowing for effective use of horizontal and vertical alignment of liquid crystal molecules. For an FFS liquid crystal display element according to the present invention, a voltage is applied to liquid crystal molecules positioned with their major axis parallel to the direction of alignment of the alignment layers. Equipotential lines of a parabolic electric field are created between the pixel and common electrodes 21 and 22 to reach above the pixel and common electrodes 21 and 22, and, as a result, the major axis of the liquid crystal molecules in the liquid crystal layer 5 is aligned along the electric field created. The liquid crystal molecules are therefore driven even with a low dielectric anisotropy.

The color filter 6 according to the present invention preferably has, to prevent the leakage of light, a black matrix (not illustrated) formed in the portions corresponding to the thin-film transistors and storage capacitors 23. The color filter 6 usually consists of the three filter pixels of R (red), G (green), and B (blue) of one dot of a video or image, and these three filters are arranged in the direction in which, for example, the gate wires extend. The color filter 6 can be prepared by, for example, pigment dispersion, printing, electrodeposition, or dyeing. To take an example, a method for preparing a color filter by pigment dispersion is described. That is, a curable colored composition for color filters is applied to a transparent substrate, patterned, and cured by heating or irradiation with light. Performing this process for the three colors of red, green, and blue will give pixel sections for the color filter. The color filter may alternatively be a so-called color filter on array, formed by placing a pixel electrode provided with active elements, such as TFTs or thin-film diodes, on the same substrate.

On the electrode layer 3 and the color filter 6 are a pair of alignment films 4 that are in direct contact with the element-production liquid crystal composition forming the liquid crystal layer 5 to induce homogeneous alignment.

The polarizers 1 and 8 can be customized to achieve a good viewing angle and contrast by adjusting the polarization axis of each polarizer. Preferably, these transmission axes have their transmission axes perpendicular to each other to ensure operation in the normally-black mode. It is particularly preferred that one of the polarizers 1 and 8 be positioned with its transmission axis parallel to the orientation of the liquid crystal molecules. Furthermore, it is preferred to adjust the product of the refractive index anisotropy Δn of the liquid crystal and the cell thickness d to maximize the contrast. A retardation film for expanding the viewing angle can also be used.

Other embodiments of the liquid crystal display element include, for the IPS method, the condition of the minimum clearance d between proximate common and pixel electrodes being longer than the minimum clearance G between the liquid crystal alignment films, such as a structure in which a common electrode and pixel electrodes are formed on the same substrate, the common and pixel electrodes alternate, and the minimum clearance d between proximate common and pixel electrodes is longer than the minimum clearance G between the liquid crystal alignment films.

In the method according to the present invention for producing a liquid crystal display element, it is preferred to form a coating on and/or on the surface of substrates having an electrode layer, then place the pair of substrates to make them spaced apart and face each other with the coatings inside, and then fill the space between the substrates with the liquid crystal composition. During this, it is preferred to adjust the spacing between the substrates using a spacer.

The substrate-to-substrate distance (average thickness of the resulting liquid crystal layer; also referred to as the coating-to-coating clearance) is preferably adjusted to be between 1 and 100 μm. The average coating-to-coating clearance is more preferably between 1.5 and 10 μm.

In the present invention, examples of spacers used to adjust the substrate-to-substrate distance include glass particles, plastic particles, alumina particles, and a columnar spacer, for example made of a photoresist material.

The FFS liquid crystal display element described using FIGS. 1 to 3 is merely an example. Various other embodiments are possible unless they depart from the technical ideas of the present invention.

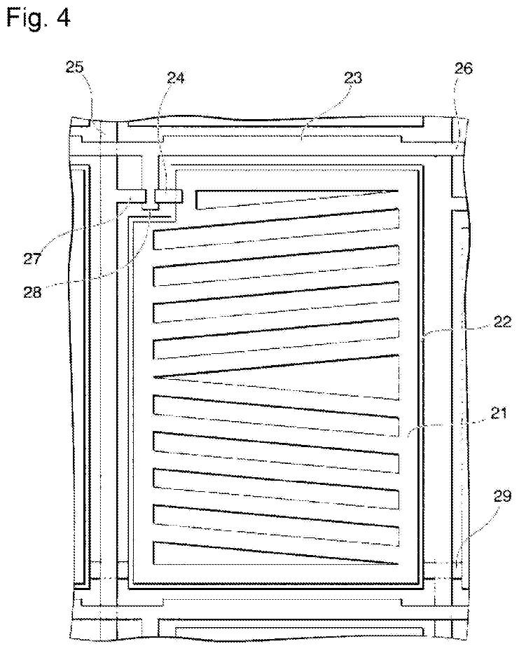

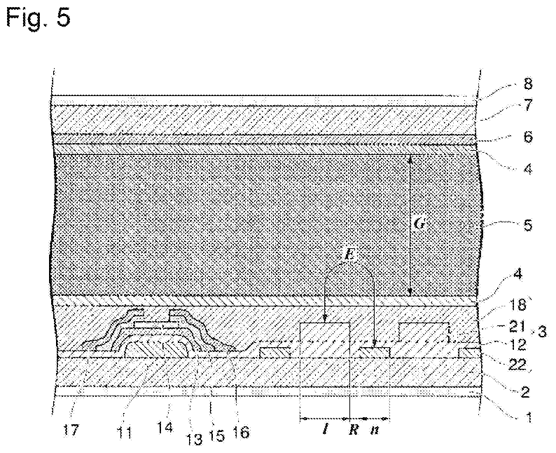

The following describes other embodiments of the liquid crystal display element according to the present invention using FIGS. 4 and 5.

For example, FIG. 4 is another embodiment of the enlarged plan view of the electrode layer 3 formed on the substrate 2 in FIG. 1 in its region surrounded by line II. As illustrated in FIG. 4, the display element may be configured with a slitted pixel electrode 21. The slit pattern may be formed to have a tilt angle with respect to the gate wires 26 or data wires 25.

The pixel electrode 21 illustrated in FIG. 4 has a shape formed by making substantially rectangular pane-like cuts in a substantially rectangular flat-plate electrode. Over the entire back of the pixel electrode 21 is a comb-shaped common electrode 22 with an insulating protective layer 18 (not illustrated) therebetween. If the minimum clearance R between adjacent common and pixel electrodes is shorter than the minimum clearance G between the alignment layers, the display element is an FFS one, and if longer, an IPS one. The surface of the pixel electrode is preferably coated with a protective insulating film and the layer of the alignment film. As in the foregoing, there may be storage capacitors 23 in the regions surrounded by the multiple gate wires 26 and multiple data wires 25, capacitors that store display signals supplied through the data wires 25. The cuts are not limited to any particular shape. Not only substantially rectangular cuts, illustrated in FIG. 4, known shapes of cuts can be used, such as ovals, circles, rectangles, diamonds, triangles, or parallelograms. If the minimum clearance R between adjacent common and pixel electrodes is longer than the minimum clearance G between the alignment layers, the display element is an IPS one.

FIG. 5 illustrates an embodiment different than FIG. 3 and is an example of a cross-sectional view of the liquid crystal display element illustrated in FIG. 1 cut along line III-III in FIG. 2. A first substrate 2 with an alignment layer 4 and an electrode layer 3 formed on its surface, the electrode layer 3 including thin-film transistors, and a second substrate 8 with an alignment film 4 formed on its surface are spaced apart by a predetermined distance D with the alignment layers facing each other, and the space is filled with a liquid crystal layer 5 containing a liquid crystal composition. On part of the surface of the first substrate 2, a gate insulating layer 12, a common electrode 22, an insulating protective layer 18, a pixel electrode 21, and the alignment layer 4 are stacked in this order. Moreover, as illustrated in FIG. 4, too, the pixel electrode 21 has a shape formed by making triangle cuts in the middle and at both edges of a flat-plate body and rectangular cuts in the remaining regions, and the common electrode 22 has a structure in which a comb-shaped common electrode is placed parallel to the substantially oval cuts in the pixel electrode 21 and closer to the first substrate than the pixel electrode is.

The example illustrated in FIG. 5 uses a comb-shaped or slitted common electrode 22, and in this example the electrode-to-electrode distance, between the pixel and common electrodes 21 and 22, is R=a (in FIG. 5, the horizontal component of the electrode-to-electrode distance is denoted by R for the sake of convenience). Moreover, FIG. 3 illustrates an example in which the common electrode 22 is on the gate insulating layer 12, the common electrode 22 may be formed on the first substrate 2 first and then the pixel electrode 21 placed with the gate insulating layer 12 interposed therebetween as illustrated in FIG. 5. The electrode width of the pixel electrode 21:1, the electrode width of the common electrode 22: n, and the electrode-to-electrode distance: R are preferably adjusted as needed to make the widths appropriate for all liquid crystal molecules in the liquid crystal layer 5 to be driven by the electric fields produced. If the minimum clearance R between adjacent common and pixel electrodes is shorter than the minimum clearance G between the alignment layers, the display element is an FFS one, and if longer, an IPS one. Although the pixel and common electrodes 21 and 22 in FIG. 5 are at different positions in the thickness direction, the two electrodes may be at the same position in the thickness direction, or even the common electrode may be closer to the liquid crystal layer 5.

(Vertical-Field Type)

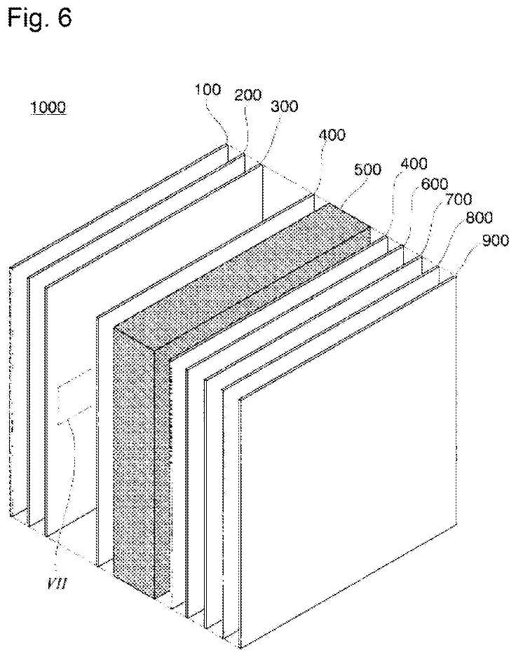

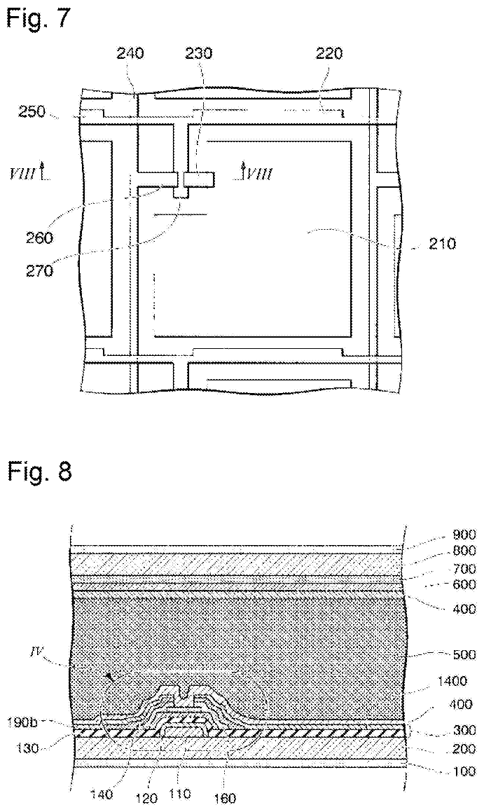

Another preferred embodiment of the present invention is a vertical-field liquid crystal display element using a liquid crystal composition. FIG. 6 is a diagram schematically illustrating the structure of a vertical-field liquid crystal display element. In FIG. 7, the components are illustrated spaced apart for the sake of convenience in explanation. FIG. 7 is an enlarged plan view of the electrode layer 300 including thin-film transistors (or alternatively referred to as a thin-film transistor layer 300.) formed on a substrate in FIG. 6 in its region surrounded by line VII. FIG. 8 is a cross-sectional view of the liquid crystal display element illustrated in FIG. 6 cut along line VIII-VIII in FIG. 7. The following describes a vertical-field liquid crystal display element according to the present invention with reference to FIGS. 6 to 9.

The configuration of the liquid crystal display element 1000 according to the present invention is, as depicted in FIG. 6, a liquid crystal display element that has a second substrate 800 equipped with a transparent electrode (layer) 600 (or alternatively referred to as a common electrode 600) made of a transparent electrically conductive material; a first substrate 200 including a thin-film transistor layer 300 with a pixel electrode and thin-film transistors formed thereon, the pixel electrode made of a transparent electrically conductive material and each thin-film transistor being a component of a pixel and used to control the pixel electrode; and an element-production liquid crystal composition (or liquid crystal layer 500) sandwiched between the first and second substrates 200 and 800. The orientation of the liquid crystal molecules in the element-production liquid crystal composition in the voltage-off state is substantially perpendicular to the substrates 200 and 800. As illustrated in FIGS. 6 and 8, the second and first substrates 800 and 200 may be sandwiched between a pair of polarizers 100 and 900. In FIG. 6, moreover, there is a color filter 700 between the first substrate 200 and the common electrode 600. There are also a pair of alignment films 400 formed on the surface of the transparent electrodes (layers) 600 and 1400, adjacent to the liquid crystal layer 500 according to the present invention and in direct contact with the element-production liquid crystal composition forming the liquid crystal layer 500.

That is, the liquid crystal display element 1000 according to the present invention has a structure in which a first polarizer 100, a first substrate 200, an electrode layer including thin-film transistors (or alternatively referred to as a thin-film transistor layer) 300, a photoalignment film 400, a layer 500 containing a liquid crystal composition, an alignment film 400, a common electrode 600, a color filter 700, a second substrate 800, and a second polarizer 900 are stacked one after another. The alignment film 400 is preferably a photoalignment film.

Regarding the alignment films, the liquid crystal cell is produced using an aligning process (masked rubbing or photoaligning), and the liquid crystal cell has, between its transparent electrodes (liquid crystal layer side), films for a vertical alignment slightly tilted (0.10 to 5.0°) from the normal of the glass substrates.

The orientation restriction force of the vertical alignment films makes the polymerizable monomer(s) vertically aligned. In this state, the polymerizable monomer(s) is polymerized and immobilized by ultraviolet irradiation, forming polymer networks. The polymer networks formed as such presumably have roughly four structures: (1) polymer networks are formed across the upper and lower substrates; (2) polymer networks are formed from the upper (lower) substrate toward the liquid crystal but partway; (3) polymer networks are formed only near the surface of the alignment films. (primarily in the case of a monofunctional monomer); and (4) polymer networks are joined together in the liquid crystal layer (without floating). In all these forms, two types of polymer networks that stabilize different states of alignment are in the mix, one having their refractive index anisotropy or easy axis or orientation formed to stabilize the alignment at the threshold voltage or higher and the other having their refractive index anisotropy or easy axis or orientation formed to stabilize the alignment at sub-threshold voltages.

The inventors believe that the anisotropic polymer polymer networks formed as such are almost completely separated from the liquid crystal layer, and that the liquid crystal molecules are oriented and aligned between these polymer networks. The polymer networks have a structure that is clearly different than in the molecular alignment structure of a so-called polymer-network liquid crystal, which is a mixture of liquid crystal molecules and polymer networks and causes light scattering in the voltage-off state, and at the same time is quite different from that of the alignment-sustaining layers localized near the alignment films, for example used in PSA.

The foregoing has presented, as an illustration, polymer networks and an alignment structure of liquid crystal molecules made by a method using alignment films. In the method called MVA, in which the display element has ribs, slits, or other structural features, or other methods like PVA, the essential structure is presumably the same as in the above drawings. Only the polymer networks near the interfaces with the substrates and the pretilt of liquid crystal molecules are slightly different, for example in accordance with the intensity of the oblique electric field applied using the structural features or slits.

If a VA liquid crystal display device has such a liquid crystal molecule alignment provided by polymer networks and liquid crystal molecules, the anchoring strength that acts on the liquid crystal molecules in the voltage-off state is enhanced by virtue of synergy between the anchoring strength of the liquid crystal alignment films and that of the polymer networks. As a result, the response rate when the voltage is off is accelerated.

(Transverse- and Oblique-Field Type)

As a new display technology whereby the display region of a liquid crystal can be made multidomain by a simple and convenient way, or simply by tweaking the electrode structure, without troublesome processing of the alignment film(s), such as masked rubbing or masked irradiation, a method has been proposed in which oblique and transverse electric fields are allowed to act on the liquid-crystal layer.

FIG. 13 is a schematic plan view of a minimum module for one pixel PX of a TFT liquid crystal display element using the above technology. The following briefly describes the structure and operation of a transverse- and oblique-field-mode liquid crystal display device.

A pixel electrode PE has a primary pixel electrode PA and a secondary pixel electrode PB. These primary and secondary pixel electrodes PA and PB are electrically coupled to each other, and both of these primary and secondary pixel electrodes PA and PB are on an array substrate AR. The primary pixel electrode PA extends along a second direction Y, and the secondary pixel electrode PB extends along a first direction X that is different from the second direction Y. In the illustrated example, the pixel electrode PE is substantially cruciform. The secondary pixel electrode PB joins substantially the middle of the primary pixel electrode PA and extends from the primary pixel electrode PA toward both sides thereof, i.e., the left and right sides of the pixel PX. These primary and secondary pixel electrodes PA and PB are substantially orthogonal to each other. The pixel electrode PE is electrically coupled, at its pixel electrode PB, to a switching element not illustrated.

A common electrode CE has primary common electrodes CA and secondary common electrodes CB, and these primary and secondary common electrodes CA and CB are electrically coupled to each other. The common electrode CE is electrically isolated from the pixel electrode PE. Of the common electrode CE, at least part of the primary and secondary common electrodes CA and CB is on a counter substrate CT. The primary common electrodes CA extend along the second direction Y. These primary common electrodes CA are on both sides of the primary pixel electrode PA, with, in the X-Y plane, none of the primary common electrodes CA overlapping the primary pixel electrode PA and each of the primary common electrodes CA spaced apart from the primary pixel electrode PA substantially equally. That is, the primary pixel electrode PA is substantially at the midpoint between adjacent primary common electrodes CA. The secondary common electrodes CB extend along the first direction X. The secondary common electrodes CB are on both sides of the secondary pixel electrode PB, with, in the X-Y plane, none of the secondary common electrodes CB overlapping the secondary pixel electrode PB and each of the secondary common electrodes CB spaced apart from the secondary pixel electrode PB substantially equally. That is, the secondary pixel electrode PB is substantially at the midpoint between adjacent secondary common electrodes CB.

In the illustrated example, a primary common electrode CA is in the shape of a strip extending linearly along the second direction Y. A secondary common electrode CB is in the shape of a strip extending linearly along the first direction X. It should be noted that two primary common electrodes CA extend along the first direction X, parallel to each other with a space therebetween. In the following, the left-hand primary common electrode in the drawing is designated CAL, and the right-hand primary common electrode in the drawing CAR for these to be distinguishable. Moreover, two secondary common electrodes CB extend along the second direction Y, parallel to each other with a space therebetween. In the following, the upper primary common electrode in the drawing is designated CBU, and the lower primary common electrode in the drawing CBB for these to be distinguishable. The primary common electrodes CAL and CAR are at the same potential as the secondary common electrodes CBU and CBB. In the illustrated example, the primary common electrodes CAL and CAR are each connected to the secondary common electrodes CBU and CBB.

The primary common electrodes CAL and CAR are between the pixel PX and the next pixels on the left and right sides, respectively. That is, the primary common electrode CAL stretches across the boundary between the illustrated pixel PX and the pixel on the left side (not illustrated), and the primary common electrode CAR stretches across the boundary between the illustrated pixel PX and the pixel on the right side (not illustrated). The secondary and primary common electrodes CBU and CBB are between the pixel PX and the next pixels on the upper and lower sides, respectively. That is, the secondary common electrode CBU stretches across the boundary between the illustrated pixel PX and the pixel on the upper side (not illustrated), and the secondary common electrode CBB stretches across the boundary between the illustrated pixel PX and the pixel on the lower side (not illustrated).

In the illustrated example, one pixel PX has four domains divided by a pixel electrode PE and a common electrode CE and formed as opening or transparent sections that contribute primarily to display. In this example, the initial orientation of the liquid crystal molecules LM is substantially parallel to the second direction Y. There is a first alignment film AL1 on the surface of the array substrate AR facing the counter substrate CT, extending substantially throughout the active area ACT. This first alignment film AL1 covers the pixel electrode PE and also extends on the second interlayer insulating film 13. Such a first alignment layer AL1 is made of a material that exhibits the quality of horizontal orientation. Besides this, the array substrate AR may be equipped with a first primary common electrode and a first secondary common electrode as part of the common electrode.

FIG. 14 is a schematic view of the electrode structure of an eight-domain oblique-field-mode liquid crystal cell. Dividing one pixel into eight domains in such a way further will expand the viewing angle.

Next, the operation of a liquid crystal display panel having the above configuration is described. In the state in which no voltage is applied to the liquid crystal layer, i.e., while no electric field is created between the pixel and common electrodes PE and CE or in the fieldless state (OFF state), the liquid crystal molecules LM in the liquid crystal layer LQ are oriented to align their major axis with the first direction PD1 of aligning, of the first alignment film AL1, and the second direction PD2 of aligning, of the second alignment film AL2 as indicated by broken lines in FIG. 13. Such an OFF state corresponds to the initial alignment, and the orientation of the liquid crystals LM in the OFF state corresponds to the initial orientation. To be precise, the liquid crystal molecules LM are not always oriented parallel to the X-Y plane and are often pretilted. The exact initial orientation of the liquid crystal molecules is therefore the direction faced by the orthogonal projection onto the X-Y plane of the orientation of the liquid crystal molecules LM in the OFF state.

The first and second directions PD1 and PD2 of aligning are both substantially parallel to the second direction Y. In the OFF state, the liquid crystal molecules LM are in their initial alignment, holding their major axis substantially parallel to the second direction Y, as indicated by broken lines in FIG. 13. The initial orientation of the liquid crystal molecules LM is therefore parallel to the second direction Y (or alternatively 0° to the second direction Y).

If the first and second directions PD1 and PD2 of aligning are parallel and the same as in the illustrated example, the liquid crystal molecules LM, in a cross-section of the liquid crystal layer LQ, are oriented substantially horizontal (pretilt angle being substantially zero) near the middle of the liquid crystal layer LQ and having pretilt angles that become symmetric in the vicinity of the first and second alignment films AL1 and AL2 with that middle point as the boundary (splay alignment). In such a state in which liquid crystal molecules LM are in splay alignment, the liquid crystal molecules LM in the vicinity of the first alignment film AL1 and the liquid crystal molecules LM in the vicinity of the second alignment film AL2 provide optical compensation even if the direction is tilted from the normal of the substrates. If the first and second directions PD1 and PD2 of aligning are parallel to and the same as each other, therefore, a black display can be produced with little leakage of light, enabling a high contrast ratio and improved display quality. If the first and second directions PD1 and PD2 of aligning are parallel to and opposite each other, the liquid crystal molecules LM, in a cross-section of the liquid crystal layer LQ, are oriented having substantially uniform pretilt angles in the vicinity of the first alignment layer AL1, in the vicinity of the second alignment layer AL2, and in the middle of the liquid crystal layer LQ (homogeneous alignment). Part of the backlight coming from a backlight source 4 travels through a first polarizer PL1 and enters the liquid crystal display panel LPN. The light that has entered the liquid crystal display panel LPN is a linearly polarized beam of light orthogonal to a first polarization axis AX1, of the first polarizer PL1. The state of polarization of such a linearly polarized beam of light changes little when the light passes through the liquid crystal display panel LPN in the OFF state. The linearly polarized light that has passed through the liquid crystal display panel LPN is therefore absorbed by a second polarizer PL2 that is in the crossed-nicols positional relationship with the first polarizer PL1 (black display).

In the state in which a voltage is applied to the liquid crystal layer LQ, i.e., in the state in which there is a potential different between the pixel and common electrodes PE and CE (ON state), a transverse electric field (or oblique electric field) substantially parallel to the substrates is created between the pixel and common electrodes PE and CE. Influenced by the electric field, the liquid crystal molecules LM experience a rotation of their major axis in a plane substantially parallel to the X-Y plane as indicated by the solid lines in the drawing.

In the example illustrated in FIG. 13, the liquid crystal molecule LM in the lower half of the domains between the pixel electrode PE and the primary common electrode CAL rotates clockwise from the second direction Y to face to the lower left in the drawing, and the liquid crystal LM in the upper half rotates counterclockwise from the second direction Y to face to the upper left in the drawing. The liquid crystal molecule LM in the lower half of the domains between the pixel electrode PE and the primary common electrode CAR rotates counterclockwise from the second direction Y to face to the lower right in the drawing, and the liquid crystal LM in the upper half rotates clockwise from the second direction Y to face to the upper right in the drawing. In this way, the state in which an electric field has been created between the pixel and common electrodes PE and CE in each pixel PX will result in the orientation of the liquid crystal molecules LM being divided into multiple directions at the points of overlap with the pixel electrode PE. Domains will be formed in the respective directions, making one pixel PX multidomain.

In the ON state as described above, a linearly polarized beam of light orthogonal to the first alignment axis AX1, of the first polarizer PL1, enters the liquid crystal display panel LPN, and when it passes through the liquid crystal layer LQ, its state of polarization changes in accordance with the alignment of the liquid crystal molecules LM. In this ON state, at least part of the light that has passed through the liquid crystal layer LQ is transmitted through the second polarizer PL2 (white display). By allowing four domains to be formed in one pixel, such a structure enables optical compensation of the viewing angle in four directions, thereby helping expand the viewing angle. The resulting liquid crystal display device is of good display quality by virtue of displays free from tone reversal and high in transmittance. Moreover, giving the four domains, divided by the pixel and common electrodes PE and CE, in one pixel a substantially equal area of the opening will make the transmittance of each domain substantially comparable. By virtue of mutual optical compensation of the beams of light passing through the openings of the different domains, the displays produced are uniform over a broad range of viewing angles.

(Fishbone Electrodes)

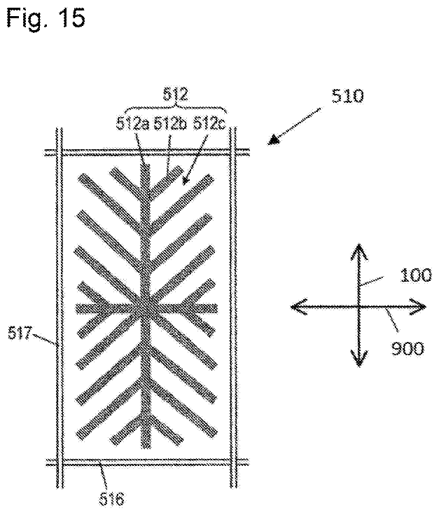

Here is presented the fishbone electrode structure illustrated in FIG. 15. A liquid crystal layer has been sealed between two glass substrates joined face-to-face with a predetermined cell gap therebetween. On the surface of each of the two opposite substrates facing the other's is a transparent electrode made of ITO. Approximately 0.7-mm-thick glass substrates are used, and there is a common electrode on the counter substrate. The transparent electrode has slits 512c cut by removing part of the electrode material (ITO). Approximately 3- to 5-μm-wide cruciform slits 512c cut between the midpoints of the opposite sides of the rectangular cell function as an orientation-restricting structure. From these slits 512c, multiple 5-μm-wide slits 512c extend at an oblique angle of 45° with a pitch of 8 μm, and these slits function as an auxiliary orientation-controlling factor that reduces the disorder in azimuthal direction during tilting. The width of the pixel electrode for display is 3 μm. Backbone pixel electrodes 512a and branch pixel electrodes 512b have a structure in which with the two sets of electrodes making an angle of 45°, the branch electrodes extend in four directions corresponding to 90° rotations around the center of the pixel as the center of symmetry. When a voltage is applied, the liquid crystal molecules are aligned tilted, but in such a manner that the orientations in the tilted alignment will coincide with these four directions. As a result, four separate domains are formed in one pixel, expanding the viewing angle of display.

### EXAMPLES

The following describes the present invention in further detail by providing examples, but the present invention is not limited to these examples. The term “% by mass” for the compositions in the examples and comparative examples below refers to ‘% by mass.’

The individual evaluation parameters in each example or comparative example represent the following symbols and meanings.

T0: Optical transmittance [%] when the applied voltage is zero; represents the magnitude of scattering, with smaller values indicating greater scattering.

T100: Optical transmittance [%] at an increased voltage at which the optical transmittance substantially plateaus

V10: Voltage [V] at which 10% of the total change in optical transmittance, defined as the difference between the T100 and T0 above, is reached

V90: Voltage [V] at which the optical transmittance is 90% of the total change in optical transmittance, defined as the difference between the T100 and T0 above

### Example 1

(Adjustment of Polymerizable Liquid Crystal Composition)

As an N-type liquid crystal composition, the composition represented by (LCN-1) below (Δn, 0.102; viscosity η, 16.8; Δε, −3.8) was prepared. The N-type liquid crystal composition (LCN-1) was heated to 60° C. and mixed with a solid polymerizable compound (V1-1-1) until dissolution. The mixture was observed under a polarized light microscope, and it was confirmed that polymerizable compound (V1-1-1) was dissolved uniformly and exhibited a nematic liquid crystal phase at room temperature. To this solution, photopolymerization initiator (I-1) was added. In this way, a polymerizable liquid crystal composition was prepared.

(Fabrication of Liquid Crystal Display Element and Evaluation of Electrooptical Characteristics)

For the resulting liquid crystal to achieve a uniaxial alignment (homogeneous alignment), vertical alignment films coated with a polyimide vertical alignment film and having a cell gap of 3.6 μm were rubbed to make the pretilt angle 3°. Two facing substrates were rubbed in opposite directions (antiparallel alignment). The resulting polymerizable liquid crystal compositions, obtained in Examples 1 to 3 and Comparative Examples 1 and 2, were filled into cells by vacuum filling. After the filling, the opening for filling was sealed with a sealant 3026B (ThreeBond). Using an ultraviolet LED light source with a wavelength of 365 nm, liquid crystal display elements were fabricated with varying durations of ultraviolet irradiation, from 15 seconds to 100 seconds, at an intensity of 20 mW/cm². Then, their electrooptical characteristics were measured.

In the measurement, a voltage was applied to the cell, and the alignment of the liquid crystal in the cell was observed under a polarized light microscope. The cell was positioned to make the direction of slits at 450 with respect to any of the two polarization axes of cross-nicols polarizers so that the bright field would be brightest. In the voltage-off state, there was a dark field, indicating that the liquid crystal was completely in a substantially vertical alignment and therefore was in the normally-black mode. When the voltage applied was increased gradually, the cell became brighter as a result of the tilted alignment in its slitted section changing from vertical alignment to align the orientation in tilted alignment with the direction of rubbing. To check the orientation in tilted alignment of the liquid crystal in this cell, a voltage of 7.5 V was applied to induce a tilted alignment, and the direction of slits was set parallel to any of the two polarization axes of the cross-nicols polarizers so that the transmittance would be minimized. The orientation in tilted alignment of the liquid crystal coincided with the direction of rubbing.

Voltage-transmittance characteristics and response times were measured with 60-Hz rectangular waves applied. The characteristics are summarized in Table 2, in which the maximum transmittance is represented by T100, the drive voltage is represented by V90, the rise response time is represented by Ton, and the decay time is represented by Toff.

### Comparative Example 1

The cell was of the same design as in Example 1, and the composition of Comparative Example 1 in Table 1 was filled into the cell. The makeup was the same as in Example 1 except for the photopolymerization initiator. The photopolymerization initiator used in Comparative Example 1 was Irgacure 651. Comparative Examples 1-1 to 1-5 were fabricated with the same polymerizable liquid crystal composition and under the same conditions except for the duration of ultraviolet exposure. After the end of irradiation, a voltage of 9 V was applied to the cell, in which polymer networks had been formed, to bring the liquid crystal into a tilted alignment. In polarized light microscopy, matching the direction of polarization to the direction of rubbing resulted in a dark field, confirming that the orientation in tilted alignment coincided with the direction of rubbing. In the voltage-off state, moreover, there was a dark field, indicating the liquid crystal was completely in a substantially vertical alignment and therefore was in the normally-black mode. The voltage-transmittance characteristics and response times of the fabricated cell were measured in the same way as in Example 1. The characteristics are summarized in Table 3, in which the maximum transmittance is represented by T100, the drive voltage is represented by V90, the rise response time is represented by Ton, and the decay time is represented by Toff.

### Comparative Example 2

The composition of Comparative Example 2 in Table 1 was filled into a cell in the same way as in Example 1. The photopolymerization initiator was (PI-1), and because of its slow reaction rate, the duration of UV exposure was 600 seconds. Even with the extended duration of UV exposure, Toff was as long as 6.6 ms.

### Examples 2 and 3

The photopolymerization initiator was (I-1), and the composition of Example 2 or 3 in Table 1 was filled into a cell in the same way as in Example 1.

After the filling, the glass cell was taken out, and its opening for filling was sealed with a sealant 3026B (ThreeBond). Using an ultraviolet LED light source with a wavelength of 365 nm, the cell was irradiated with ultraviolet radiation at an intensity of 20 mW/cm² at 25° C. for 60 seconds.

After the completion of ultraviolet irradiation, the alignment of the liquid crystal in the cell was observed under a polarized light microscope with the cell positioned to make the direction of rubbing at an oblique angle of 450 with respect to any of crossed-nicols polarizers. In the voltage-off state, there was a dark field, indicating that the liquid crystal was completely in a substantially vertical alignment. When the voltage applied was increased gradually, the cell became brighter as a result of its slitted section transitioning from vertical alignment to a tilted alignment. To check the orientation in tilted alignment, a voltage of 7.5 V was applied to induce a tilted alignment, and the direction of slits was set parallel to that of a polarizer so that the transmittance would be minimized. A dark field was observed to match the orientation in tilted alignment to the direction of rubbing. Examples 2 and 3 were fast in response time, as indicated by short decay times Toff of 2.9 ms and 2.8 ms, respectively.

TABLE 1

| | Liquid | Concentration | | Concentration | | Concentration | | Concentration |
|---|---|---|---|---|---|---|---|---|
| | crystal | (% by mass) | Monomer | (% by mass) | Monomer | (% by mass) | Initiator | (% by mass) |
| Comparative | LCN-1 | 97.8 | V1-1-1 | 2.156 | — | — | Irg.651 | 0.044 |
| Example 1 | | | | | | | | |
| Comparative | LCN-1 | 98 | V1-1-1 | 1.996 | | | (PI-1) | 0.2 |
| Example 2 | | | | | | | | |
| Example 1 | LCN-1 | 97.8 | V1-1-1 | 2.156 | — | — | (I-1) | 0.044 |
| Example 2 | LCN-1 | 98 | V1-1-2 | 1.96 | — | — | (I-1) | 0.04 |
| Example 3 | LCN-1 | 97.5 | V1-1-3 | 1.96 | V1-1-4 | 0.49 | (I-1) | 0.05 |

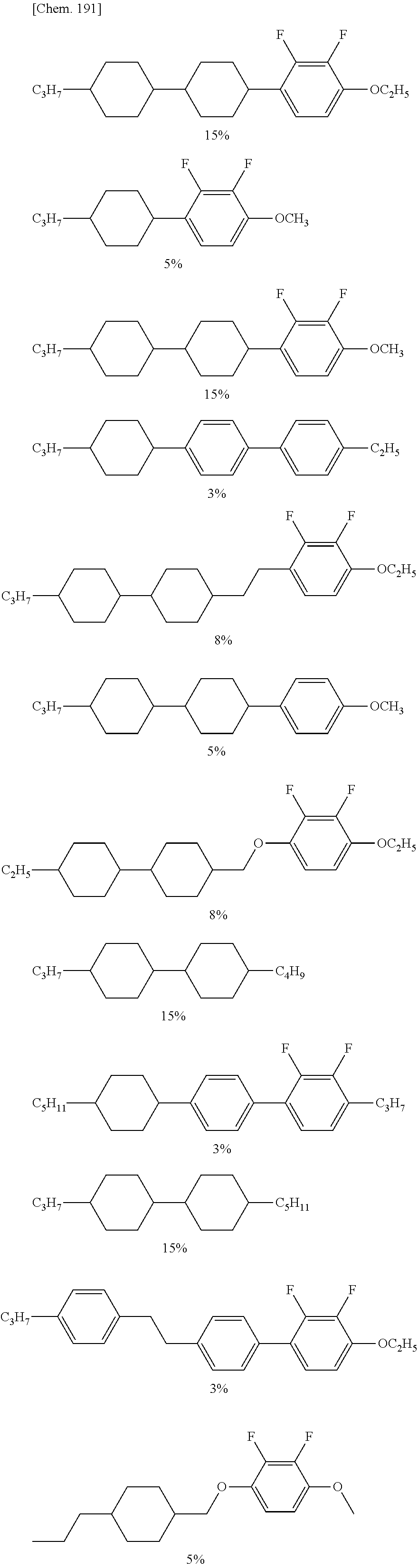

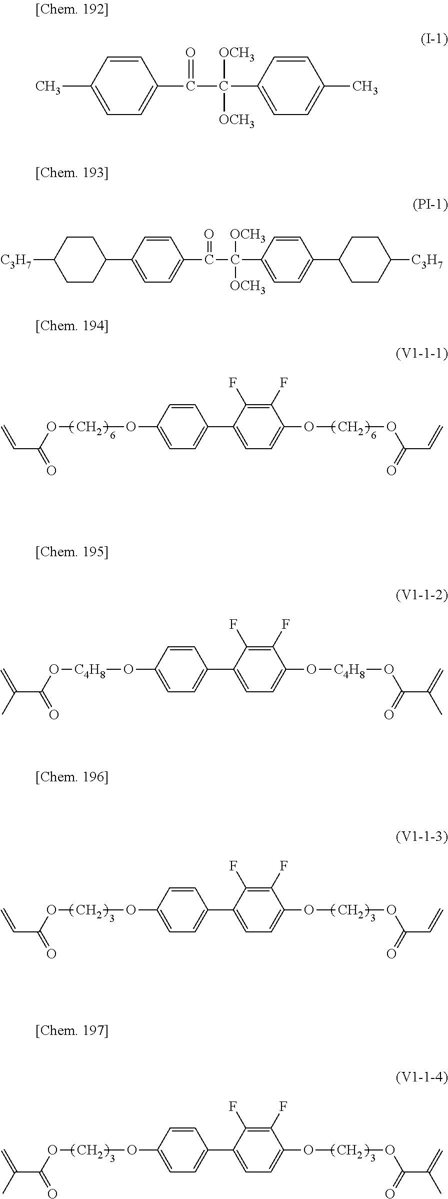

TABLE 2

| | Cell | UV | | | T0 | T100 | | |
|---|---|---|---|---|---|---|---|---|
| | thickness | intensity | Duration of | V90 | (% by | (% by | | |
| | (μm) | (mW/cm2) | exposure (s) | (Vo-p) | mass) | mass) | Toff (ms) | Ton (ms) |
| Example 1-1 | 3.6 | 20 | 15 | 5.3 | 0 | 83 | 6.5 | 7.3 |
| Example 1-2 | 3.6 | 20 | 30 | 5.8 | 0 | 82 | 5.5 | 6.1 |
| Example 1-3 | 3.6 | 20 | 60 | 6.3 | 0 | 83 | 4.8 | 5 |
| Example 1-4 | 3.6 | 20 | 100 | 6.3 | 0 | 83 | 4.7 | 4.3 |
| Example 1-5 | 3.6 | 20 | 200 | 6.8 | 0 | 82 | 4.2 | 4.1 |
| Comparative | 3.6 | 20 | 15 | 5.4 | 0 | 84 | 7.2 | 7.3 |
| Example 1-1 | | | | | | | | |
| Comparative | 3.6 | 20 | 30 | 6.4 | 0 | 82 | 5.6 | 4.9 |
| Example 1-2 | | | | | | | | |
| Comparative | 3.6 | 20 | 60 | 7 | 0 | 82 | 5 | 4.3 |
| Example 1-3 | | | | | | | | |
| Comparative | 3.6 | 20 | 100 | 7.5 | 0 | 82 | 4.9 | 4.1 |
| Example 1-4 | | | | | | | | |
| Comparative | 3.6 | 20 | 200 | 7.7 | 0 | 81 | 4.6 | 3.8 |
| Example 1-5 | | | | | | | | |
| Comparative | 3.6 | 20 | 600 | 5.4 | 0 | 84 | 6.6 | 7.1 |
| Example 2 | | | | | | | | |
| Example 2 | 3.6 | 20 | 60 | 9.5 | 0 | 77 | 2.9 | 1.3 |
| Example 3 | 3.6 | 20 | 60 | 9.8 | 0 | 75 | 2.8 | 1.7 |

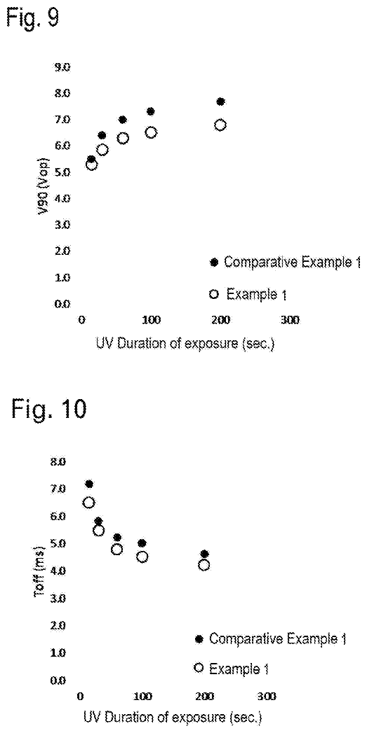

Examples 1-1 to 1-4 were fabricated with the same polymerizable liquid crystal composition and under the same conditions except for the duration of ultraviolet exposure. The relationship between the duration of ultraviolet exposure and drive voltage V90 is illustrated in FIG. 9, and the relationship between the duration of ultraviolet exposure and the Toff of decay time is illustrated in FIG. 10. When Comparative Examples 1-1 to 1-5, in which Irgacure 651 was used, are compared with Examples 1-1 to 1-5, all of Examples 1-1 to 1-5, although they were fabricated with varying durations of UV exposure, had drive voltages V90 lower than those of Comparative Examples 1-1 to 1-5, demonstrating their capability of low-voltage operation. The decay times Toff, moreover, were shorter than the Toff of Comparative Examples 1-1 to 1-4, although a decrease in the anchoring strength of polymer networks usually results in a decrease in drive voltage V90 and an extension of Toff. That is, Examples 1-1 to 1-5 were found to be short in Toff despite a lowered V90.

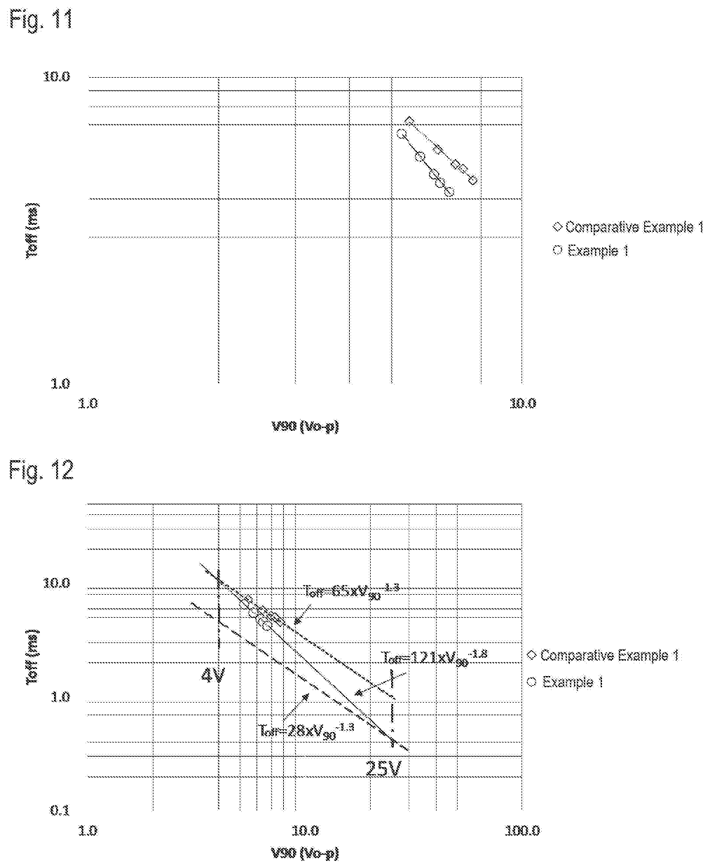

Constructing a Log-Log plot of V90 versus Toff gives FIG. 11. Plotting power approximations on this gives FIG. 12. In Comparative Example 1, the relationship between V90 and Toff is approximated by the equation

Toff=Rv*V90⁻¹³,

with Rv=65. In Example 1, it is approximated by

Toff=Rv*V90⁻¹8, with Rv=121.

Rv represents the intercept on the Toff axis at V90=1 in the Log-Log plot.

In FIGS. 11 and 12, Toff moves on the approximate line toward higher V90 and becomes shorter with increasing anchoring strength of polymer networks. Of the two approximate lines, the left one indicates that Toff is short even with a low anchoring strength of polymer networks. Examples 1-1 to 1-5 were shorter in Toff than Comparative Examples 1-1 to 1-5 when compared at the same V90, demonstrating that the Examples achieved a short Toff despite a low anchoring strength of polymer networks.

### Examples 4 and 5

As a liquid crystal composition having a P-type dielectric anisotropy, the composition represented by the formula (LCP-1) below (Δn, 0.109; viscosity η, 24 mPa·s; Vth, 1.62 Vrms) was prepared. The polymerizable compound was the compound represented by (V1-1-1) below.

A polymerizable liquid crystal composition was prepared that contained 98% to 97% by mass P-type liquid crystal composition (LCP-1), 1.96% to 2.94% by mass polymerizable compound (V1-1-1), and photopolymerization initiator (I-1) making up 2% by mass of polymerizable compound (V1-1-1).

For the resulting liquid crystal to achieve a uniaxial alignment (homogeneous alignment), a parallel-rubbed cell including ITO coated with a polyimide alignment film and having a cell gap of 3.6 μm was used. The polymerizable liquid crystal composition as a mixture of (LCP-1), (V1-1-1) and (I-1) was heated to 60° C. for dissolution and then filled into the glass cell by vacuum filling.

After the filling, the opening for filling was sealed with a sealant 3026B (ThreeBond). Using an ultraviolet LED light source with a wavelength of 365 nm, the cell was irradiated with ultraviolet radiation at an intensity of 20 mW/cm² at 25° C. for 90 seconds, polymerizing the polymerizable compound in the polymerizable liquid crystal composition and giving an ECB-mode liquid crystal display element.

Placing the fabricated cell between two orthogonal polarizers with the direction of rubbing matched to the direction of the polarization axis resulted in a dark field, confirming that a uniaxial alignment was achieved.

The fabricated cell was placed between crossed-nicols polarizers to make it in the normal-white mode by the orientation in uniaxial alignment of the liquid crystal, and its voltage-transmittance characteristics were measured with 60-Hz rectangular waves applied. The voltage-transmittance characteristics are presented in [Table 4]. As shown in [Table 4], Examples 4 and 5, in which polymerization initiator (I-1) was used, were found to be shorter in Toff than Comparative Examples 3 and 4, in which polymerization initiator Irg. 651 was used, despite a slightly lower drive voltage V10.

### Comparative Examples 3 and 4

The cell was of the same design as in Examples 4 and 5, and the composition of Comparative Example 3 or 4 in Table 3 was filled into the cell. The makeup was the same as in Examples 4 and 5, respectively, except for the photopolymerization initiator. The photopolymerization initiator used in Comparative Examples 3 and 4 was Irgacure 651. As for fabrication conditions, liquid crystal display elements were fabricated in the same way as in Examples 4 and 5. Their voltage-transmittance characteristics and switching response times were measured.

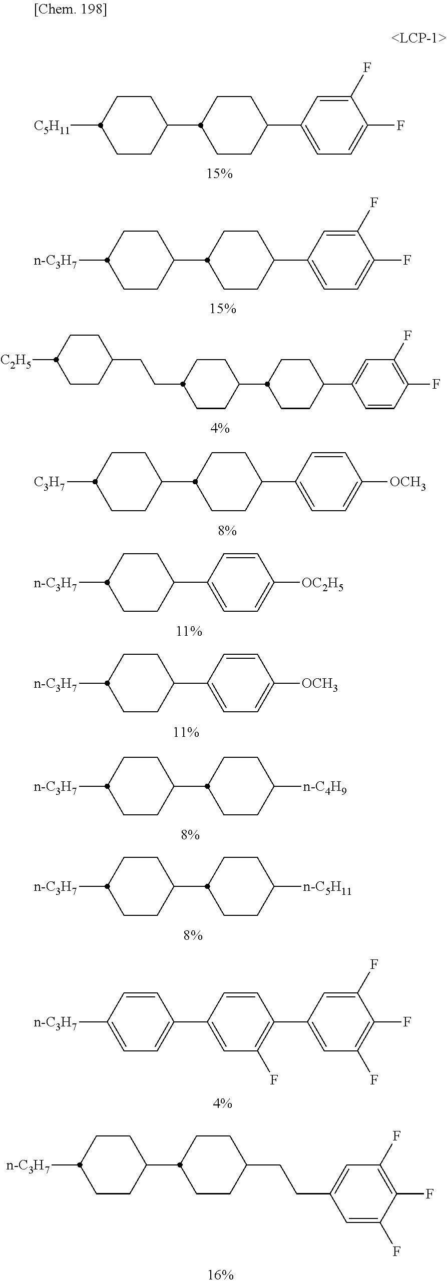

TABLE 3

| | Liquid | Concentration | | Concentration | | Concentration | | Concentration |
|---|---|---|---|---|---|---|---|---|
| | crystal | (% by mass) | Monomer | (% by mass) | Monomer | (% by mass) | Initiator | (% by mass) |
| Comparative | LCP-1 | 98 | V1-1-1 | 1.96 | — | — | Irg.651 | 0.04 |
| Example 3 | | | | | | | | |
| Comparative | LCP-1 | 97 | V1-1-1 | 2.94 | | | Irg.651 | 0.06 |
| Example 4 | | | | | | | | |
| Example 4 | LCP-1 | 98 | V1-1-1 | 1.96 | — | — | (I-1) | 0.04 |
| Example 5 | LCP-1 | 97 | V1-1-1 | 2.94 | — | — | (I-1) | 0.06 |

TABLE 4

| | Cell | UV | | | T0 | T100 | | |
|---|---|---|---|---|---|---|---|---|
| | thickness | intensity | Duration of | V10 | (% by | (% by | | |
| | (μm) | (mWcm2) | expposure (s) | (Vo-p) | mass) | mass) | Toff (ms) | Ton (ms) |
| Comparative | 3.6 | 20 | 90 | 5.6 | 0.3 | 81 | 2.5 | 1.3 |
| Example 3 | | | | | | | | |
| Comparative | 3.6 | 20 | 90 | 4.3 | 0.1 | 80 | 3.9 | 1.6 |
| Example 4 | | | | | | | | |
| Example 4 | 3.6 | 20 | 90 | 5.4 | 0.2 | 83 | 2.2 | 1.2 |
| Example 5 | 3.6 | 20 | 90 | 4 | 0.05 | 83 | 3.5 | 1.5 |

### REFERENCE SIGNS LIST

1 . . . polarizer, 2 . . . first transparent insulating substrate, 3 . . . electrode layer, 4 . . . alignment film, 4a . . . direction of alignment, 5 liquid crystal layer, 5a . . . liquid crystal molecule in the voltage-off state, 5b . . . liquid crystal molecule in the voltage-on state, 6 . . . color filter, 7 . . . second transparent insulating substrate, 8 . . . polarizer, 9 . . . continuous or discontinuous polymer networks, 10 . . . liquid crystal display element, 11 . . . gate electrode, 12 . . . gate insulating layer, 13 . . . semiconductor layer, 14 . . . protective layer, 15 . . . ohmic contact layer, 16 . . . drain electrode, 17 . . . source electrode, 18 . . . insulating protective layer, 21 . . . pixel electrode, 22 . . . common electrode, 23 . . . storage capacitor, 24 . . . drain electrode, 25 . . . data wire, 26 . . . gate wire drain electrode, 27 . . . source electrode, 28 . . . gate electrode, 29 . . . common line, 100 . . . polarizer, 110 . . . gate electrode, 120 . . . gate insulating layer, 130 . . . semiconductor layer, 140 . . . protective layer, 160 . . . drain electrode, 190b . . . organic insulating film, 200 . . . first substrate, 210 . . . pixel electrode, 220 . . . storage capacitor, 230 . . . drain electrode, 240 . . . data wire, 250 . . . gate wire, 260 . . . source electrode, 270 . . . gate electrode, 300 . . . thin-film transistor layer, 400 . . . alignment film, 500 . . . liquid crystal layer, 510 . . . liquid crystal display device, 512 . . . pixel electrode, 512a . . . backbone pixel electrode, 512b . . . branch pixel electrode, 512c . . . pixel slit, 516 . . . scan wire, 517 . . . signal wire, 600 . . . common electrode, 700 . . . color filter, 800 . . . second substrate, 900 . . . polarizer, 1000 . . . liquid crystal display element, 1400 . . . transparent electrode (layer), PX . . . pixel, PE . . . pixel electrode, PA . . . primary pixel electrode, PB . . . secondary pixel electrode, CE . . . common electrode, CA . . . primary common electrode, CAL . . . left primary common electrode, CAR . . . right primary common electrode, CB . . . secondary common electrode, CBU . . . upper secondary common electrode, CBB . . . lower secondary common electrode

1. A polymerizable liquid crystal composition comprising, as essential ingredients, a radically polymerizable monomer component (A), a liquid crystal material (B), and a polymerization initiator (C) having a molecular structure resulting from substituting any two or more hydrogen atoms in an aromatic nucleus in a molecular structure of an alkylphenone-based photopolymerization initiator with an alkyl group (i) having number of carbon atoms from 1 to 10 (hereinafter simply referred to as “C1-10”), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom.

2. The polymerizable liquid crystal composition, wherein the composition contains, as an essential ingredient, a polymerization initiator (C) represented by general formula (I) below 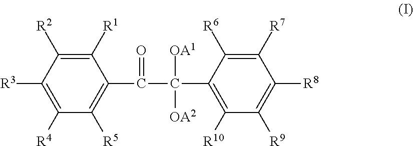
(where each of R¹, R², R³, R⁴, R⁵, R⁶, R⁷, R⁸, R⁹, and R¹⁰ is independently a hydrogen atom, a C1-10 alkyl group (i), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom, and A¹ and A² each represent a C1-5 alkyl group, with the proviso that at least two of R¹, R², R³, R⁴, R⁵, R⁶, R⁷, R⁸, R⁹, and R¹⁰
are the alkyl (i), organic (ii), or halogen-containing hydrocarbon groups (iii).).

3. The polymerizable liquid crystal composition according to claim 1, wherein the polymerizable liquid crystal composition contains 0.5% by mass to 20% by mass radically polymerizable monomer component (A).

4. The polymerizable liquid crystal composition according to claim 1, wherein the radically polymerizable monomer component (A) has a mesogenic structure.

5. The polymerizable liquid crystal composition according to claim 4, wherein the radically polymerizable monomer component (A) is represented by general formula (P1) below 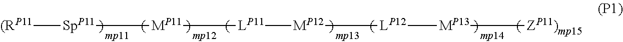
(where Z^{P11} represents a fluorine atom, a cyano group, a hydrogen atom, a C1-15 alkyl group optionally having hydrogen atom(s) substituted with a halogen atom, a C1-15 alkoxy group optionally having hydrogen atom(s) substituted with a halogen atom, a C1-15 alkenyl group optionally having hydrogen atom(s) substituted with a halogen atom, a C1-15 alkenyloxy group optionally having hydrogen atom(s) substituted with a halogen atom, or -Sp^{p12}-R^{p12},
R^{P11} and R^{p12} each independently represent any of formulae (RP11-1) to (RP11-4) below (* in the formulae indicates a binding site) 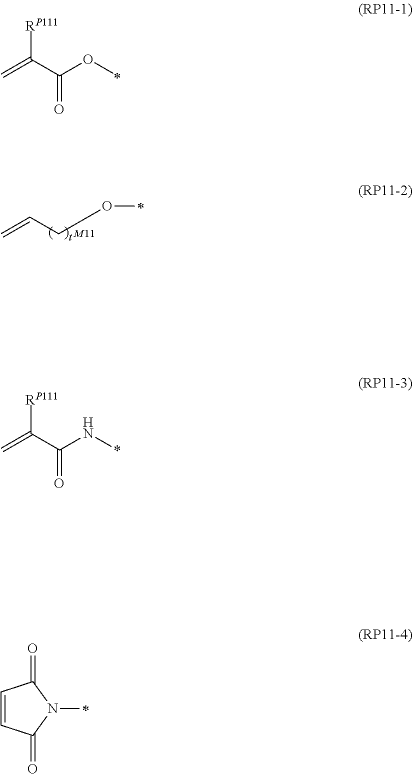
where each of R^{P111} and R^{P112} is independently a hydrogen atom or C1-5 alkyl group, and t^{M11} represents 0, 1, or 2,
Sp^{P11} and Sp^{p12} each independently represent a single bond, a linear or branched C1-12 alkylene group, or a structural unit resulting from substituting carbon atom(s) in the linear or branched alkylene structure with an oxygen atom or carbonyl group with no oxygen atoms at adjacent positions,
L^{P11} and L^{P12} each independently represent a single bond, —O—, —S—, —CH—, —OCH₂—, —CH₂O—, —CO—, —CH₄—, —COO—, —OCO—, —OCOOCH₂—, —CH₂OCOO—, —OCH₂CH₂O—, —CO—NR^{P113}—, —NR^{P113}—CO—, —SCH₂—, —CH₂S—, —CH═CR^{P113}—COO—, —CH═CR^{P113}—OCO—, —COO—CR^{P113}═CH—, —OCO—CR^{aP113}═CH—, —COO—CR^{P113}═CH—COO—, —COO—CR^{P113}═CH—OCO—, —OCO—CR^{P113}═CH—COO—, —OCO—CR^{P113}═CH—OCO—, —(CH₂)ₜₘ₁₂—C(═O)—O—, —(CH₂)ₜₘ₁₂—O—(C═O)—, —O—(C═O)—(CH₂)ₜₘ₁₂—, —(C═O)—O—(CH₂)ₜₘ₁₂—, —CH═CH—, —CF═CF—, —CF═CH—, —CH═CF—, —CF₂—, —CF—O—, —OCF₂—, —CF₂CH₂—, —CH₂CF₂—, —CF₂CF₂—, —C═C—, —N═N—, —CH═N—, or —C═N—N═C— (where each R^{P113} independently represents a hydrogen atom or C1-4 alkyl group, and tm12 in the formulae denotes an integer of 1 to 4),
each of M^{P11}, M^{P12}, and M^{P13} is independently a 1,4-phenylene, 1,3-phenylene, 1,2-phenylene, 1,4-cyclohexylene, 1,3-cyclohexylene, 1,2-cyclohexylene, 1,4-cyclohexenylene, 1,3-cyclohexenylene, 1,2-cyclohexenylene, anthracen-2,6-diyl, phenanthren-2,7-diyl, pyridin-2,5-diyl, pyrimidin-2,5-diyl, naphthalen-2,6-diyl, naphthalen-1,4-diyl, indan-2,5-diyl, fluoren-2,6-diyl, fluoren-1,4-diyl, phenanthren-2,7-diyl, anthracen-2,6-diyl, anthracen-1,4-diyl, 1,2,3,4-tetrahydronaphthalen-2,6-diyl, or 1,3-dioxan-2,5-diyl group, with the proviso that
each of M^{P11}, M^{P12}, and M^{P13} may independently be unsubstituted or substituted their aromatic nucleus with a C1-12 alkyl group, a C1-12 halogenated alkyl group, a C1-12 alkoxy group, a C1-12 halogenated alkoxy group, a halogen atom, a cyano group, a nitro group, or a group having the same meaning as -Sp^{P11}-R^{P11}, and mp12 represents 1 or 2, mp13 and mp14 each independently represent 0, 1, 2, or 3, mp11 and mp15 each independently represent 1, 2, or 3, with the proviso that multiple Z^{P11}s may be the same or different, multiple R^{p11}s may be the same or different, multiple R^{p12}s may be the same or different, multiple Sp^{P11}s may be the same or different, multiple Sp^{p12}s may be the same or different, multiple L^{P11}s may be the same or different, multiple L^{P12}s may be the same or different, multiple M^{P12}s may be the same or different, and multiple M^{P13}s may be the same or different.).

6. The polymerizable liquid crystal composition according to claim 4, wherein the radically polymerizable monomer component (A) is represented by general formula (V) below 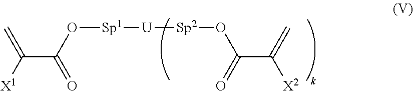
(where X¹ and X² each independently represent a hydrogen atom or methyl group, Sp¹ and Sp² each independently represent a single bond, a C1-12 alkylene group, or —O—(CH₂)— (where s represents an integer of 1 to 11, and the oxygen atom binds to an aromatic ring), and U represents a C2-20 linear or branched polyvalent aliphatic hydrocarbon group or C5-30 polyvalent cyclic substituent, with the proviso that carbon atom(S) of the polyvalent aliphatic hydrocarbon group may be substituted with oxygen atom(s) with no oxygen atoms at adjacent positions, with C5-20 alkyl group(s) (carbon atom(S) of the alkylene group(s) therein may be substituted with oxygen atom(s) with no oxygen atoms at adjacent positions.), or cyclic substituent(s). k represents an integer of 1 to 5. All 1,4-phenylene groups in the formula may have any of the hydrogen atoms thereof substituted with —CH₃, —OCH₃, a fluorine atom, or a cyano group.)
or general formula (VI) below 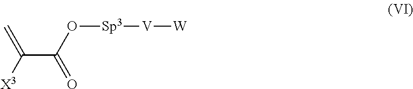
(where X³ represents a hydrogen atom or methyl group, Sp³ represents a single bond, a C1-12 alkylene group, or —O—(CH₂)ₜ— (where t represents an integer of 2 to 11, and the oxygen atom binds to an aromatic ring.), and V represents a C2-20 linear or branched polyvalent aliphatic hydrocarbon group or C5-30 polyvalent cyclic substituent or a structural unit resulting from substituting carbon atom(s) in a C2-20 linear or branched alkylene structure with an oxygen atom except at adjacent positions, with the proviso that the chemical structures may have hydrogen atom(s) on carbon atom(s) thereof substituted with a C5-20 alkyl group (carbon atom(s) of the alkylene group(s) therein may be substituted with an oxygen atom with no oxygen atoms at adjacent positions.), or a cyclic substituent. W represents a hydrogen atom, a halogen atom, or a C1-15 alkyl group. All 1,4-phenylene groups in the formula may have any of the hydrogen atoms thereof substituted with —CH₃, —OCH₃, a fluorine atom, or a cyano group.).

7. The polymerizable liquid crystal composition according to claim 6, wherein the radically polymerizable monomer component (A) includes one or two or more compounds represented by general formula (V) with Sp¹ and Sp² being the same.

8. The polymerizable liquid crystal composition according to claim 1, wherein the liquid crystal material (B) contains one or more compounds selected from the group consisting of compounds represented by general formulae (N-1), (N-2), (N-3), and (N-4) below and having a negative dielectric constant anisotropy 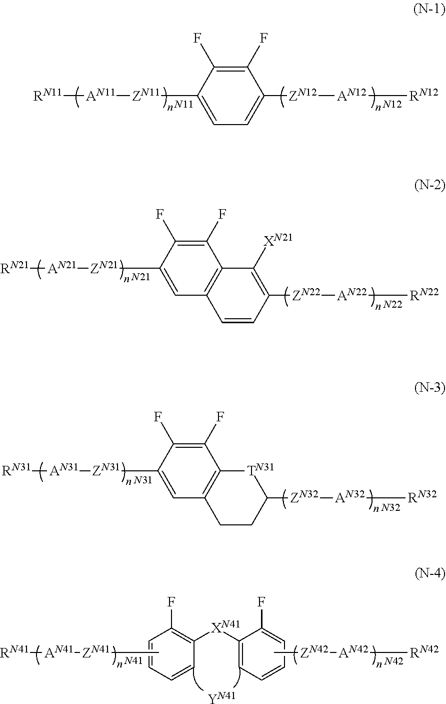
(where R^{N11}, R^{N12}, R^{N21}, R^{N22}, R^{N31}, R^{N32}, R^{N41}, and R^{N42} each independently represent a C1-8 alkyl group or a, C1-8 alkyl group or a structural unit having a chemical structure resulting from substituting one —CH₂— in a C2-8 alkyl chain, or each of nonadjacent two or more independently, with —CH═CH—, —C≡C—, —O—, —CO—, —COO—, or —OCO—, and
A^{N11}, A^{N12}, A^{N21}, A^{N22}, A^{N31}, A^{N32}, A^{N41}, and A^{N42} each independently represent a group selected from the group consisting of:
(a) a 1,4-cyclohexylene group;
(b) a divalent organic group having a structure resulting from substituting one —CH₂— or two or more nonadjacent —CH₂— present in a 1,4-cyclohexylene structure with —O—;
(c) a 1,4-phenylene group;
(d) a divalent organic group having a structure resulting from substituting one —CH═ or two or more nonadjacent —CH=present in a 1,4-phenylene structure with —N═;
(e) a naphthalen-2,6-diyl, 1,2,3,4-tetrahydronaphthalen-2,6-diyl, or decahydronaphthalen-2,6-diyl group;
(f) a divalent organic group having a structure resulting from substituting one —CH═ or two or more nonadjacent —CH=present in a naphthalen-2,6-diyl or 1,2,3,4-tetrahydronaphthalen-2,6-diyl structure with —N═; and
(g) a 1,4-cyclohexenylene group, and
the groups (a), (b), (c), (d), (e), (t), and (g) may each independently be substituted with a cyano group, a fluorine atom, or a chlorine atom,
Z^{N11}, Z^{N12}, Z^{N21}, Z^{N22}, Z^{N31}, Z^{N32}, Z^{N41}, and Z^{N42} each independently represent a single bond, —CH₂CH—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,
X^{N21} represents a hydrogen or fluorine atom,
T^{N31} represents —CH₂— or an oxygen atom,
X^{N41} represents an oxygen atom, a nitrogen atom, or —CH₂—,
Y^{N41} represents a single bond or —CH₂—, and
n^{N11}, n^{N12}, n^{N21}, n^{N22}, n^{N31}, n^{N32}, n^{N41}, and n^{N42} each independently represent an integer of 0 to 3, with the proviso that
each of n^{N11}+n^{N12}, n^{N21}+n^{N22}, and n^{N31}+n^{N32} is independently 1, 2, or 3, and, for A^{N11}, A^{N12}, A^{N21}, A^{N22}, A^{N31}, A^{N32}, Z^{N11}, Z^{N12}, Z^{N21}, Z^{N22}, Z^{N31}, and Z^{N32}, multiple groups may be the same or different, and
n^{N41}+n^{N42} represents an integer of 0 to 3, with the proviso that for A⁴¹ and A^{N42} and for Z^{N41} and Z^{N42}, multiple groups may be the same or different.) and
at least one compound represented by general formula (L) and whose dielectric constant anisotropy Δε is in a range of −2 to 2 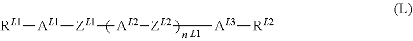
(where R^{L1} and R^{L2} each independently represent a C1-8 alkyl group or a structural unit having a chemical structure resulting from substituting one —CH₂— present in a C2-8 alkyl chain or each of nonadjacent two or more independently, with —CH═CH—, —C≡C—, —O—, —CO—, —COO—, or —OCO—,
n^{L1} represents 0, 1, 2, or 3,
A^{L1}, A^{L2}, and A^{L3} each independently represent a group selected from the group consisting of:
(a) a 1,4-cyclohexylene group;
(b) a divalent organic group having a chemical structure resulting from substituting one —CH₂— or two or more nonadjacent —CH₂— present in a 1,4-cyclohexylene structure with —O—;
(c) a 1,4-phenylene group;
(d) a divalent organic group having a chemical structure resulting from substituting one —CH═ or two or more nonadjacent —CH=present in a 1,4-phenylene structure with —N═;
(e) a naphthalen-2,6-diyl, 1,2,3,4-tetrahydronaphthalen-2,6-diyl, or decahydronaphthalen-2,6-diyl group; and
(f) a divalent organic group having a structure resulting from substituting one —CH═ or two or more nonadjacent —CH=present in a naphthalen-2,6-diyl or 1,2,3,4-tetrahydronaphthalen-2,6-diyl structure with —N═, and the groups (a), (b), (c), (d), (e), and (f) may each independently be substituted with a cyano group, a fluorine atom, or a chlorine atom,
Z^{L1} and Z^{L} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—, and
if n^{L1} is 2 or 3 and there are multiple A^{L2}s, the A^{L2}s may be the same or different, and if n^{L1} is 2 or 3 and there are multiple Z^{L2}s, the Z^{L2}s may be the same or different).

9. The polymerizable liquid crystal composition according to claim 1, wherein the liquid crystal material (B) contains at least one compound represented by general formula (J) below and having a positive dielectric constant anisotropy 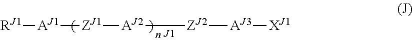
(where R^{J1} represents a C1-8 alkyl group or a structural unit having a chemical structure resulting from substituting one —CH₂— in a C2-8 alkyl chain, or each of nonadjacent two or more independently, with —CH═CH—, —C≡C—, —O—, —CO—, —COO—, or —OCO—,
n^{J1} represents 0, 1, 2, 3, or 4,
A^{J1}, A^{J2}, and A^{J3} each independently represent a group selected from the group consisting of:
(a) a 1,4-cyclohexylene group;
(b) a divalent organic group having a chemical structure resulting from substituting one —CH₂— or two or more nonadjacent —CH₂— present in a 1,4-cyclohexylene structure with —O—;
(c) a 1,4-phenylene group;
(d) a divalent organic group having a chemical structure resulting from substituting one —CH═ or two or more nonadjacent —CH=present in a 1,4-phenylene structure with —N═;
(e) a naphthalen-2,6-diyl, 1,2,3,4-tetrahydronaphthalen-2,6-diyl, or decahydronaphthalen-2,6-diyl group; and
(f) a divalent organic group having a structure resulting from substituting one —CH═ or two or more nonadjacent —CH=present in a naphthalen-2,6-diyl or 1,2,3,4-tetrahydronaphthalen-2,6-diyl structure with —N═, and the groups (a), (b), (c), (d), (e), and (f) may each independently be substituted with a cyano group, a fluorine atom, a chlorine atom, a methyl group, a trifluoromethyl group, or a trifluoromethoxy group,
Z^{J1} and Z^{J2} each independently represent a single bond, —CH₂CH₂—, —(CH₂)₄—, —OCH₂—, —CH₂O—, —OCF₂—, —CF₂O—, —COO—, —OCO—, or —C≡C—,
if n^{J1} is 2, 3, or 4 and there are multiple A²s, the A²s may be the same or different, and if n^{J1} is 2, 3, or 4 and there are multiple Z's, the Z's may be the same or different, and
X^{J1} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.) and
at least one compound represented by general formula (L) and whose dielectric constant anisotropy Δε is in a range of −2 to 2 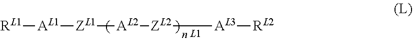
(where R^{L1} and R^{L2} each independently represent a C1-8 alkyl group or an organic group having a chemical structure resulting from substituting one —CH₂— present in a C2-8 alkyl chain, or each of nonadjacent two or more independently, with —CH═CH—, —C═C—, —O—, —CO—, —COO—, or —OCO—,
n^{L1} represents 0, 1, 2, or 3,
A^{L1}, A^{L2}, and A^{L3} each independently represent a group selected from the group consisting of:
(a) a 1,4-cyclohexylene group;
(b) a divalent organic group having a chemical structure resulting from substituting one —CH₂— or two or more nonadjacent —C—H₂— present in a 1,4-cyclohexylene structure with —O—;
(c) a 1,4-phenylene group;
(d) a divalent organic group having a chemical structure resulting from substituting one —CH═ or two or more nonadjacent —CH=present in a 1,4-phenylene structure with —N═;
(e) a naphthalen-2,6-diyl, 1,2,3,4-tetrahydonaphthalen-2,6-diyl, or decahydronaphthalen-2,6-diyl group; and
(f) a divalent organic group having a structure resulting from substituting one —CH═ or two or more nonadjacent —CH=present in a naphthalen-2,6-diyl or 1,2,3,4-tetrahydronaphthalen-2,6-diyl structure with —N═, and the groups (a), (b), (c), (d), (e), and (f) may each independently be substituted with a cyano group, a fluorine atom, or a chlorine atom,
Z^{L1} and Z^{L2} each independently represent a single bond, —CH₂CH₂—, —(CH₂)₄—, —OCH₂—CH₂O—, —COO—, —OCO—, —OCF₂—, —CF₂O—, —CH═N—N═CH—, —CH═CH—, —CF═CF—, or —C≡C—, and
if n^{L1} is 2 or 3 and there are multiple A^{L}s, the A^{LZ}s may be the same or different, and if n^{L1} is 2 or 3 and there are multiple Z^{L2}s, the Z^{L2}s may be the same or different).

10. A liquid crystal display element comprising two transparent substrates at least one of which has electrodes and a polymer of a radically polymerizable monomer component (A) and a liquid crystal material (B) sandwiched therebetween, wherein the liquid crystal material (B) is a polymer of a polymerizable liquid crystal composition according to claim 1.

11. The liquid crystal display element according to claim 10, wherein the polymer of a radically polymerizable monomer component (A) forms polymer networks in the liquid crystal material (B), and the liquid crystal display element has an alignment layer, for aligning the liquid crystal composition, on the transparent substrates.

12. The liquid crystal display element according to claim 10, wherein the polymer networks have a uniaxial refractive index anisotropy, and an optical axis or easy axis of orientation of the polymer networks is in the same direction as an easy axis of orientation of the liquid crystal material (B).

13. The liquid crystal display element according to claim 10, wherein liquid crystal molecules forming the liquid crystal material (B) make a pretilt angle of 0.1° to 30° to normal of the transparent substrates.

14. The liquid crystal display element according to claim 10, wherein in a cross-section of a cell, a polymer network layer has a thickness of 0.5% or more of cell thickness.

15. A method for producing a liquid crystal display element according to claim 10, wherein a cell structure of the liquid crystal display element is a VA, IPS, FFS, VA-TN, TN, or ECB mode.

16. A method for producing a liquid crystal display element, the method comprising sandwiching a polymerizable liquid crystal composition according to claim 1 between two transparent substrates at least one of which has electrodes, and polymerizing the polymerizable liquid crystal composition by irradiation with active energy radiation with a liquid crystal layer at −50′C to 30° C. to form a polymer having refractive index anisotropy or an easy axis of orientation.

17. The method according to claim 16 for producing a liquid c ystal display element, wherein the method includes sandwiching a polymerizable liquid crystal composition between two transparent substrates at least one of which has electrodes, and polymerizing the polymerizable liquid crystal composition by irradiation with active energy radiation while applying a voltage that induces a pretilt angle, as measured before the irradiation with active energy radiation, of 0.10 to 30° to normal of the substrates to form a polymer having refractive index anisotropy or an easy axis of orientation in the liquid crystal composition,
wherein the polymerizable liquid crystal composition comprising, as essential ingredients, a radically polymerizable monomer component (Al) a liquid crystal material (BY) and a polymerization initiator (C) having a molecular structure resulting from substituting any two or more hydrogen atoms in an aromatic nucleus in a molecular structure of an alkylphenone-based photopolymerization initiator with an alkyl group (i) having number of carbon atoms from 1 to 10 (hereinafter simply referred to as “C1-10”), an organic group (ii) having a chemical structure resulting from substituting one —CH₂— present in a C2-10 alkyl chain, or each of nonadjacent two or more independently, with —O—, —CO—, —COO—, —OCO—, or —O—CO—O—, or a halogen-containing hydrocarbon group (iii) resulting from substituting one hydrogen atom present in the alkyl group or organic group, or each of two or more independently, with a fluorine or chlorine atom.
